(19) United States
(12) Patent Application Publication
(10) Pub. No.: US 2009/0066313 A1
(43) Pub. Date: Mar. 12, 2009

(54) Reference voltage circuit compensated for temprature non-linearity

(75) Inventor: Katsuji Kimura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/230,856

(22) Filed: Sep. 5, 2008

(30) Foreign Application Priority Data
Sep. 7, 2007 (JP) 2007-233003
Feb. 15, 2008 (JP) 2008-034748

(51) Int. Cl. G05F 3/26

(52) U.S. Cl. 323/313

(57) ABSTRACT

Disclosed is a reference voltage circuit including first, second and third current-to-voltage converters, a current mirror circuit that supplies the currents to the first, second and third current-to-voltage converters, and a control unit that exercises control so that a preset output voltage of the first current-to-voltage converter will be equal to a preset output voltage of the second current-to-voltage converter. A preset voltage of the third current-to-voltage converter is output as a reference voltage. The first current-to-voltage converter includes a diode and a resistor connected in parallel with the diode. The second current-to-voltage converter includes a plurality of diodes, connected in parallel with one another, a resistor connected in parallel with the parallel-connected diodes, a resistor connected in series with the parallel connection of the diodes and the resistor, and a resistor connected in parallel with the serial connection of the parallel circuit and the resistor. The third current-to-voltage converter includes a resistor.

### REFERENCE TO RELATED APPLICATION

This application is based upon and claims the benefit of the priority of Japanese patent applications No.2007-233003 filed on Sep. 7, 2007 and No. 2008-034748 filed on Feb. 15, 2008, the disclosures of which are incorporated herein in its entirety by reference thereto.

### TECHNICAL FIELD

This invention relates to a CMOS reference voltage generating circuit and, more particularly, to a CMOS reference voltage generating circuit which is formed on a semiconductor integrated circuit, has a small chip area and which may operate from a low voltage to supply a reference voltage not higher than IV having small temperature characteristic.

### BACKGROUND

[Patent Document 1] JP Patent Kokai Publication No. JP-A-11-45125 and JP Patent No.3586073
[Patent Document 2] U.S. Pat. No. 7,253,597 B2 (Aug. 7, 2007)
[Patent Document 3] JP Patent Kokai Publication No. JP-P2006-209212A

The entire disclosures of Patent Documents 1 to 3 are incorporated herein by reference thereto.

The following analysis has been given according to the present invention.

A reference voltage circuit has long been known as being a circuit that supplies a temperature-compensated reference voltage of the order of 1.2V. The circuit is designed to generate a PTAT (Proportional to Absolute Temperature) current in and converts the generated current to a voltage by a resistor. The generated voltage is added by a forward voltage of a diode having a positive temperature characteristic to cancel a temperature characteristic. The circuit may be termed a first-generation reference voltage circuit.

A representative example of the first-generation reference voltage circuit is shown in FIG. 1. The circuit includes a first current-to-voltage converting circuit, having a diode D1, and a second current-to-voltage converting circuit, including N-number of diodes D2, connected in parallel with one another, and a resistor R1 connected in series with the parallel connection of the diodes D2. The circuit also includes a third current-to-voltage converting circuit, composed of a series connection of a resistor R2 and a diode D3, and p-channel MOS transistors M1 to M3 having sources connected to a power supply VDD and having gates coupled together. The circuit further includes an operational amplifier (OP amp) AP1, having an inverting terminal (−) connected to a connection node of a drain of the transistor M1 and the diode D1, having a non-inverting terminal (+) connected to a connection node of the drain of the transistor M2 and the resistor R1 and having an output connected to commonly coupled gates of the transistors M1 to M3. A reference voltage Vref is taken out from a connection node of the drain of the transistor M3 and the resistor R2.

The current mirror ratio is assumed to be equal, such that the output currents 11, 12 and 13 are equal to one another. The current 11 directly flows through a diode D1 that forms a first current-to-voltage converter I-V1 so as to be thereby converted to voltage. However, in a second current-to-voltage converter I-V2, the current flows through a resistor R1 and thence through the parallel connection of the diodes D2.

In FIG. 1, since the OP amp exercises control so that VA=VB, the following equation holds.

VA=VF1=VB (1)

I2 is given as a voltage difference between the forward voltage VF1 of the diode D1 and the forward voltage VF2 of the diode D2 divided by the resistance of the resistor R1, such that

$$\begin{matrix}I 1 = I 2 = I 3 \\ = ( VF 1 - VF 2 ) / R 1 \\ = Δ VF / R 1\end{matrix} \qquad ( 2 )$$

If D1 is a unit diode, VF1=V_{T}ln(I1/IS) and VF2=V_{T}ln{I1/(N*IS)}, where IS denotes a saturation current and V_{T} denotes a thermal temperature given by V_{T}=kT/q, where T is the absolute temperature [K], k is the Boltzmann constant and q is the unit electron charge.

Hence, ΔVF=(VF1−VF2)=V_{T} ln(N) (3)

Therefore,

Vref=VF3+R2I3=VF3+V_{T}(R2/R1)ln(N) (4)

It is noted that VF3 has a temperature characteristic of approximately −1.9 mV/° C. The thermal characteristic of the thermal voltage V_{T} is approximately proportionate to 0.0853 mV/° C. That is, the temperature characteristic of Vref may approximately be canceled by weighted summation of VF3 having the negative temperature coefficient and V_{T} having the positive temperature coefficient weighted by (R2/R1)ln(N). This scheme of temperature compensation is shown in FIG. 2.

FIG. 3 shows actual simulated values. For VDD=1.8V, N is set so that N=4, while R1 and R2 are set so that R1=1.08 kΩ and R2=17.8 kΩ. In this case, the values of Vref become 1.38827V, 1.3934V, 1.39399V and 1.3889V for −53° C., −10° C., 0° C., 27° C. and 107° C., respectively, such that characteristic similar to that of a bowl placed upside down was obtained. In the reference voltage circuit of the first-generation, the non-linear temperature characteristic proper to diode present themselves unmodified in the temperature characteristic, with the width of temperature variations being on the order of 0.5%.

In 1990s, the process miniaturization in the semiconductor fabrication technology went on further such that the power supply voltage decreased from 5V to 3.3V. The process miniaturization continued further, such that the power supply voltage decreased to not greater than 2V, such as 1.2V, occasionally not greater than 1V, and even the power supply voltage of the order of 0.5V is adopted. This has naturally led to an ever increasing demand for a reference voltage of a reference voltage circuit of 1V or less. It was under these circumstances that a variety of reference voltage circuits that generate a desired voltage by generating a temperature-compensated current and by converting the so generated current to a voltage made their debut. Of these, the Bamba's reference voltage circuit is excellent and is a circuit termed ‘current mode reference voltage circuit’ by the present inventor. The reference voltage circuit, employing the temperature-compensated current, may well be termed a second-generation reference voltage circuit.

FIG. 4 shows the Bamba's reference voltage circuit, which is a circuit representative of the second-generation reference voltage circuit. In FIG. 4, the common gate voltage of the transistors P1 and P2 is controlled by the OP amp DA1 so that VA=VB. Hence,

VA=VB (5)

and

I1=I2. (6)

The current I1 is divided into a current I1A flowing through a diode D1 and a current I1B flowing through a resistor R3. In similar manner, the current I2 is divided into a current I2A flowing common through a series connection of the resistor R1 and the parallel connection of N-number of diodes D2 and a current I2B flowing through the resistor R2.

If R2=R3 (7)

then

I1A=I2A (8)

and

I1B=I2B (9)

Also,

VA=VF1 (10)

and

VB=VF2+ΔVF (11)

may hold, so that

ΔVF=VF1−VF2 (12)

The voltage drop across R1 is ΔVF, and

I2A =Δ VF/R1 (13)

and

I1B=I2B=VF1/R2 (14)

In the above equations,

ΔVF=V_{T} ln(N) (15)

where V_{T} is the thermal voltage.

Hence, I3 (=I2) is converted by the resistance of the resistor R4 to a voltage, and the reference voltage Vref is expressed as

$$\begin{matrix}Vref = R 4 * I 3 \\ = R 4 \{ VF 1 / R 2 + ( {V}_{T} ln ( N ) ) / R 1 \} \\ = ( R 4 / R 2 ) \{ VF 1 + ( R 2 / R 1 ) ( {V}_{T} ln ( N ) ) \}\end{matrix} \qquad ( 16 )$$

FIG. 5 shows the scheme for temperature compensation.

FIG. 6 shows actual simulated values. For VDD=1.3V, N is set so that N=2, while R1 to R4 are set so that R1=0.5178 kΩ, R2=R4=19 kΩ and R3=5 kΩ. In this case, the values of Vref were 367.858 mV, 368.47 mV, 368.55 mV and 368.645 mV and 368.847 for −53° C., −10° C., 0° C., 27° C. and 107° C., such that characteristic similar to that of a bowl placed upside down was obtained.

The temperature characteristic of this second-generation reference voltage circuit (Bamba's reference voltage circuit) includes temperature variations slightly higher than 0.2%. That is, noteworthy is the fact that improvement has now been made in temperature non-linearity proper to a diode in the Bamba's reference voltage circuit which is representative of the second-generation reference voltage circuits.

The reason the temperature non-linearity of diodes may be improved in the Bamba's reference voltage circuit is as follows: In FIG. 4, the current ascribable to temperature non-linearity proper to a diode flows through the resistor R3, whereas the current component ascribable to temperature non-linearity proper to a diode is not contained in the current flowing through the diode D1. Hence, the temperature non-linearity proper to a diode may be improved based on the ratio of the current flowing through the resistor R3 and that flowing through the diode D1.

Since about 2005, such reference voltage circuits, which are of an equivalent circuit size as the Bamba's reference voltage circuit and which are able to generate a curvature-compensated current to improve temperature flatness, made their debut. These reference voltage circuits may be said to be a sort of the ‘current mode reference voltage circuit’.

The reference voltage circuit that makes use of the reference voltage circuit may well be termed a third-generation reference voltage circuit. The manner in which the third-generation reference voltage circuit compensates the temperature non-linearity proper to a diode is shown in FIG. 7

It is thus sufficient that the PTAT current is caused to transition so as to present a temperature characteristic which is precisely the opposite of the temperature non-linearity proper to a diode. This may be achieved, in terms of an actual circuit, by a resistor connected in parallel with a diode, thus without marked changes in the circuit size.

The reference voltage circuit, shown in FIG. 8, was applied for patent in US and was registered only of late. The first inventor is Brokaw who is one of veteran engineers in the related field. This reference voltage circuit allows us to perform circuit analysis.

In FIG. 8, VA=VB=VF1 because the OP amp exercises control so that VA=VB. Hence,

$${I}_{2} = \frac{{V}_{F 1} - {V}_{1}}{{R}_{1}} = \frac{{V}_{1} - {V}_{F 2}}{{R}_{2}} + \frac{{V}_{1}}{{R}_{3}} \qquad ( 17 )$$

is obtained.

From the equation (1), V1 is expressed as

$${V}_{1} = \frac{{R}_{2} {R}_{3} {V}_{F 1} + {R}_{3} {R}_{1} {V}_{F 2}}{{R}_{1} {R}_{2} + {R}_{2} {R}_{3} + {R}_{3} {R}_{1}} \qquad ( 18 )$$

so that the equation (1) is found as

$$\begin{matrix}{I}_{2} = \frac{( {R}_{2} + {R}_{3} ) {V}_{F 1} - {R}_{3} {V}_{F 2}}{{R}_{1} {R}_{2} + {R}_{2} {R}_{3} + {R}_{3} {R}_{1}} \\ = \frac{{R}_{2} {V}_{F 1} + {R}_{3} Δ {V}_{F}}{{R}_{1} {R}_{2} + {R}_{2} {R}_{3} + {R}_{3} {R}_{1}} \\ = \frac{{R}_{2}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} )\end{matrix} \qquad ( 19 )$$

Since the current I2A flowing through the diode D2 is given by

$${I}_{2 , A} = \frac{{V}_{1} - {V}_{F 2}}{{R}_{2}} = \frac{{R}_{3} Δ {V}_{F} - {R}_{1} {V}_{F 2}}{{R}_{1} {R}_{2} + {R}_{2} {R}_{3} + {R}_{3} {R}_{1}} \qquad ( 20 )$$

Δ VF is expressed as

$$Δ {V}_{F} = V - {V}_{F 2} = {V}_{T} ln ( \frac{{NI}_{1}}{{I}_{2 A}} ) = {V}_{T} ln \{ \frac{N ( 1 + \frac{{R}_{2}}{{R}_{3}} \frac{{V}_{F 1}}{Δ {V}_{F}} )}{1 - \frac{{R}_{1}}{{R}_{3}} \frac{{V}_{F 2}}{Δ {V}_{F}}} \} \qquad ( 21 )$$

Since R1, R2<<R3, Δ VF may be approximated by

Δ VF≈V_{T} ln(N) (22)

Thus, if I1=I2=I3, the reference voltage obtained may be expressed by

$$\begin{matrix}{V}_{REF} = {R}_{4} {I}_{2} \\ = \frac{{R}_{2} {R}_{4}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} ) \\ \approx \frac{{R}_{2} {R}_{4}}{{R}_{1} {R}_{2} + {R}_{2} {R}_{3} + {R}_{3} {R}_{1}} \{ {V}_{F 1} + \frac{{R}_{3}}{{R}_{2}} {V}_{T} ln ( N ) \}\end{matrix} \qquad ( 28 )$$

It is noted that {V_{F1}+(R3/R2)Δ V_{F}} may be set to a voltage of approximately 1.2V in which the temperature characteristic has been compensated. Thus, from the voltage division ratio of {R₂R₄/(R₁R₂+R₂R₃+R₃R₁)}(<1), a reference voltage less than or equal to 1.2V may be obtained. However, since the term of ln in the temperature characteristic of Δ V_{F}, shown by the equation (21), is varied with the temperature, the temperature characteristic has a second-order coefficient and hence has a positive temperature characteristic having the PTAT line of FIG. 7 as an asymptotic line.

FIG. 9 shows actual simulated values. For VDD=1.3V, N=5, R1=1.8 kΩ, R2=0.502 kΩ, R3=27 kΩ and R3=10 kΩ, the values of Vref were 365.434 mV, 364.74 mV, 364.8 mV, 365.08 mV and 365.183 mV for −53° C., −10° C., 0C., 27° C. and 107° C., respectively, with the curve of Vref being of an undulating shape. The width of temperature variations is suppressed to slightly less than 0.2%, which is lower than 0.3% shown in the Patent Document. If now the position of insertion of the resistor R3 is changed so that it is connected to a grounding point, more specifically, if R3 is connected between the connection node of a cathode of the diode D2 and the resistor R2 and the ground, the reference voltage of 66 mV, compensated for temperature non-linearity proper to a transistor, may be obtained from the opposite terminal of the resistor R3 as well. It should be noted however that, even when the constant is changed, its voltage is tens of mV to one hundred and tens of mV, and 200 mV at most.

It may thus be expected that the width of temperature variations of the third generation reference voltage circuit is smaller than that of the first or second generation reference voltage circuit. However, it will be understood that, if viewed in an enlarged state, the width of temperature variations is suppressed by suppressing the temperature characteristic to an undulating profile.

It may thus be verified that temperature non-linearity proper to a diode is compensated with the known reference voltage circuits. In most cases, the temperature characteristic of the reference voltage circuit of the first or second generation becomes undulated usually when the transistor's drain-to-source voltage is in shortage. If the power supply voltage is increased, the inherent shape of a bowl placed upside down may be restored.

In this manner, the function of compensating for non-linear characteristic proper to a diode may be provided by simply adding a resistor, most effectively by connecting a resistor connected in parallel with a diode.

It is noted however that the resistor R1 in the Brokaw's reference voltage circuit is redundant, and that, as may be understood, this resistor R1 may safely be removed to give the circuit of FIG. 15 as later described, thereby improving the characteristic.

Connecting a resistor in series with a parallel connection of diodes is a technique indispensable to the configuration of reference voltage circuits such as that described above. This resistor is added to match the operating points of two diodes that are compared, that is, a unit diode and a diode connected in parallel therewith. In the Brokaw's reference voltage circuit, this function is performed by the resistor R3.

It may thus be understood that the resistor R1 is meaningless from the circuit point of view. In proposing a new circuit, as in the Brokaw's case, adding a meaningless circuit component might be the to be fatal.

Those with an ordinary skill in the related field may fail to understand the technical contents of the proposed circuit and even the Examiner may have failed to understand the technical contents. Even granting that the Examiner could understand the technical contents, he may entertain a feeling of distrust in the meaningless addition of the redundant circuit component, with consequent protraction of the period of examination.

If conversely the resistor R3 is removed, temperature non-linearity proper to a diode presents itself in the temperature characteristic. It is because the PTAT (Proportional to Absolute Temperature) current is on the underside of a straight line at lower temperature.

This may help appreciate the fact that the resistor R1 in FIG. 8 is a nonsensical resistor. Or, the resistor R1 in FIG. 8 may be set to as small a value as possible, specifically 0 Ω, thereby possibly arriving at the desired characteristic.

It may possibly not be too much to say that the Brokaw's reference voltage circuit is unripe. Nevertheless, it may safely be asserted that the Brokaw's circuit gave a clue to the concept of the third-generation reference voltage circuit disclosed in the present application, in JP Patent Kokai JP-A-2006-209212 or in JP Patent Kokai JP-A-2006-281619.

The reference voltage generating circuit, which has built therein the function of compensating the temperature non-linearity proper to a diode, is shown in FIG. 10. The inventor of this circuit is the same as the present inventor. The circuit of interest is disclosed in FIG. 12 of JP Patent Kokai JP-A-2006-209212 (Aug. 10, 2006).

FIG. 10 hereof shows a reference voltage generating circuit in which both the current-voltage converters I-V1 and I-V2 have been changed to a current-voltage converter in which a resistor is connected in parallel with a plurality of diodes and another resistor is further connected in series with the parallel connection of the first-stated resistor and the diodes. However, the circuit of FIG. 10 is not shown analytically.

Referring to FIG. 10, it is assumed that the current mirror ratio is equal, such that output currents 11, 12 and 13 are all equal, that is,

I₁=I₂=I₃ (24)

On the other hand, the OP amp exercises control so that VA=VB. Since

V_{A}=V_{F1}+R₁I₁ (25)

and

V_{B}=V_{F2}+R₃I₂ (26)

we obtain

V_{F1}−V_{F2}=Δ V_{F}=I₁(R₃−R₁) (27).

Hence,

I₁=I₂=I₃=Δ V_{F}/(R₃−R₁) (28)

The resulting reference voltage Vref may be expressed by

V_{ref}=R₅I₃=Δ V_{F}R₅/(R₃−R₁) (29)

It is noted that, in order for Vref not to exhibit a temperature characteristic, Δ V_{F} needs to be set so as not to exhibit a temperature characteristic.

Δ V_{F} may also be expressed by

$$Δ {V}_{F} = {V}_{T} ln \{ N ( \frac{1 - \frac{{V}_{F 1}}{{I}_{1} {R}_{2}}}{1 - \frac{{V}_{F 2}}{{I}_{1} {R}_{4}}} ) \} \qquad ( 30 )$$

V_{T} is proportionate to absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most.

It appears that this order of temperature change may be coped with by {1−V_{F1}/(I₁R₂)}/{1−V_{F2}/(I₁R₄)}. That is, since the term of ln is changed with temperature, the temperature characteristic of Δ V_{F} in the equation (30) has a second-order coefficient. The forward voltages VF1 and VF2 of the respective diodes are related with each other in a manner shown by a chain-dotted line and a double-dotted chain line in FIG. 11, with the voltage difference Δ VF being a constant value despite changes in temperature. VF2, shown by a chain line for reference, is of a characteristic obtained with the circuit of FIG. 1 or 4, in which the voltage difference Δ VF between VF1 and VF2 is varied in proportion to the temperature.

Thus, there are two ways of compensating for temperature non-linearity proper to the forward voltage of diodes, that is, the way shown in FIG. 7 and the way shown in FIG. 11. These two ways are used alternatively, or in a commingled state.

FIG. 12 shows actual simulated values. For VDD=1.3V, N=5, R1=1.2 kΩ, R2=80 kΩ, R3=2.311 kΩ, R4=34 kΩ and R5=20 kΩ, the values of Vref were set to 633.13 mV, 632.692 mV, 632.74 mV, 632.948 mV and 632.799 mV for −53° C., −10° C., 0°C., 27° C. and 107° C., respectively, with the curve of Vref being of an undulating shape. The width of temperature variations was suppressed to slightly greater than 0.07%. It was seen that the temperature non-linearity proper to a diode may be compensated with this reference voltage generating circuit as well. The points of connection of the resistors R1 and R3 may be changed so that the resistor R1 is connected between the connection node of the diode D1 (more precisely the cathode of the diode D1) and the resistor R2 and the ground and so that the resistor R2 is connected between the connection node of the diode D2 (more precisely the cathode of the diode D2) and the resistor R4 and the ground. In this case, the reference voltages of 38 mV and 73 mV may be obtained from the opposite side terminals of the resistors R1 and R3 (the terminals opposite to the grounded terminals) as well, in a state in which compensation has been made for temperature non-linearity proper to a transistor. However, even if the constants are changed, the voltage obtained is roughly tens of mV to one hundred and tens of mV and 200 mV at most.

Four patent applications for other third-generation reference voltage circuits of the above type by the same inventor as the present inventor are now pending. These other third-generation reference voltage circuits are all described hereinbelow since the number of these other circuits is as yet only few.

FIG. 13 depicts a circuit corresponding to the circuit of FIG. 10 from which the resistor R1 (resistor connected between the drain of the MOS transistor M1 and D1/R2) is removed. R1 and R3 of FIG. 13 correspond to R3 and R4 of FIG. 10, respectively.

If, in FIG. 13, the currents I1, I2 and I3 are equal to one another,

$${I}_{1} = {I}_{2} = {I}_{3} = \frac{{V}_{F 1} - {V}_{F 2}}{{R}_{1}} = \frac{Δ {V}_{F}}{{R}_{1}} \qquad ( 31 )$$

The reference voltage Vref obtained may be expressed by

Vref =R₄I₃=Δ V_{F}R₄/R₁ (32)

Δ V_{F} may be expressed by

$$Δ {V}_{F} = {V}_{T} ln \{ N ( \frac{1 - \frac{{V}_{F 1}}{{I}_{1} {R}_{2}}}{1 - \frac{{V}_{F 2}}{{I}_{1} {R}_{3}}} ) \} \qquad ( 33 )$$

V_{T} is proportionate to absolute temperature, and hence is varied from 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/> C. at most.

It appears that this order of temperature change may be coped with by {1−V_{F1}/(I₁R₂)}/{1−V_{F2}/(I₁R₃)}. That is, the circuit of FIG. 13 is equivalent to the circuit of FIG. 10 in which R3-R1 is replaced by R₁.

However, since the term of ln is changed with temperature, the temperature characteristic of Δ VF, shown by the equation (33), has a second-order coefficient. The forward voltages VF1, VF2 of the respective diodes are as indicated by a chain-dotted line and a double-dotted chain line in FIG. 11, respectively, with the voltage difference Δ VF being at a constant value despite changes in temperature.

FIG. 12 shows actual simulated values. For VDD=1.3V, N=2, R1=0.9887 kΩ, R2=70 kΩ, R3=30 kΩ, and R4=20 kΩ, were set, the values of Vref were 709.6 mV, 709.16 mV, 709.21 mV, 709.425 mV and 709.221 mV for −53° C., −10° C., 0° C., 27° C. and 107° C., respectively, with the curve of Vref being of an undulating shape. The width of temperature variations was suppressed to 0.065%. The point of connection of the resistor R1 may be changed to the grounding point, that is, if the resistor R1 is connected between the point of connection of the diode D2 (more precisely the cathode of the diode D2) to the resistor R3 and the ground. In this case, the reference voltage of 35 mV, compensated for temperature non-linearity proper to a transistor, may be obtained from the opposite side terminal of the resistor R1 (the terminal opposite to the grounded terminal) as well. However, even if the constants are changed, the voltage achieved roughly ranges from tens of mV to one hundred and tens of mV, and is 200 mV at most.

In FIG. 15, a resistor R5 is added to the circuit of FIG. 10. The resistor R5 is connected in parallel with a series connection composed of a resistor R3 and a parallel connection composed in turn of a plurality of diodes D2 and a resistor R4. In FIG. 15, the currents I1, I2 and I3 are equal to one another, and are given by

$${I}_{1} = \frac{{V}_{A} - {V}_{F 1}}{{R}_{1}} = \frac{{V}_{B} - {V}_{F 2}}{{R}_{3}} + \frac{{V}_{B}}{{R}_{5}} = {I}_{2} \qquad ( 34 )$$

Since the OP amp (AP1) exercises control so that VA=VB, VA may be found from the equation (34) by

$${V}_{A} = {V}_{B} = \frac{{R}_{3} {R}_{5} {V}_{F 1} - {R}_{1} {R}_{5} {V}_{F 2}}{{R}_{3} {R}_{5} - {R}_{1} {R}_{3} - {R}_{1} {R}_{5}} \qquad ( 35 )$$

Thus, I1 and I2 may be found by

$${I}_{1} = {I}_{2} = \frac{{R}_{3}}{{R}_{3} {R}_{5} - {R}_{1} {R}_{3} - {R}_{1} {R}_{5}} ( {V}_{F 1} + \frac{{R}_{5}}{{R}_{3}} Δ {V}_{F} ) = {I}_{3} \qquad ( 36 )$$

Thus, the reference voltage Vref obtained may be expressed by

$$Vref = {R}_{6} {I}_{3} = \frac{{R}_{3} {R}_{6}}{{R}_{3} {R}_{5} - {R}_{1} {R}_{3} - {R}_{1} {R}_{5}} ( {V}_{F 1} + \frac{{R}_{5}}{{R}_{3}} Δ {V}_{F} ) \qquad ( 37 )$$

Qualitatively, the term of {V_{F1}+(R₅/R₃)Δ V_{F}} in the equation (37) is of a negative temperature characteristic, and the term (R₅/R₃) ΔV_{F} is of a positive temperature characteristic. The temperature characteristic of the term of {V_{F1}+(R₅/R₃)Δ V_{F}} may thus be compensated by properly setting (R₅/R₃).

Also, by setting the coefficient {R₃R₆/(R₃R₅−R₁R₃−R₁R₅ )}(<1), the reference voltage not higher than 1.2V may be obtained. However, the temperature characteristic of Δ V_{F}, shown by the equation (36), has a second-order coefficient because the term of ln is varied with temperature. The temperature characteristic of Δ V_{F} is of a positive characteristic having the PTAT line shown in FIG. 7 as an asymptotic line.

FIG. 12 shows actual simulated values. For VDD=1.3V, N =2, R1=1 kΩ, R2=36 kΩ, R3=2.2147 kΩ, R4=59 kΩ, R5=90 kΩ and R6=10 kΩ, were set. In this case, the values of Vref were 304.308 mV, 304.06 mV, 304.082 mV, 304.18 mV and 304.25 mV for −53° C., −10° C., 0° C., 27° C. and 107° C., respectively, with the curve of Vref being of an undulating shape. The width of temperature variations was suppressed to slightly greater than 0.08%. If the point of connection of the resistor R1 is changed to the grounding point, the reference voltage of 30.4 mV, compensated for temperature non-linearity proper to a transistor, may be obtained from the opposite side terminal of the resistor R1 (the terminal opposite to its grounded terminal). However, even if the constants are changed, the voltage obtained roughly ranges from tens of mV to one hundred and tens of mV, and is 200 mV at most.

In FIG. 17, in which resistors R3 and R6 are added to the circuit of FIG. 10, the resistor R3 is connected in parallel with a series connection composed of a resistor R1 and a parallel connection composed in turn of a diode D1 and a resistor R2. The resistor R6 is connected in parallel with a series connection composed of a resistor R4 and a parallel connection composed in turn of a plurality of diodes D2 and a resistor R5. In FIG. 15, the currents I1, I2 and I3 are equal to one another, and are given by

$${I}_{1} = \frac{{V}_{A} - {V}_{F 1}}{{R}_{1}} + \frac{{V}_{A}}{{R}_{3}} = \frac{{V}_{B} - {V}_{F 2}}{{R}_{4}} + \frac{{V}_{B}}{{R}_{6}} = {I}_{2} \qquad ( 38 )$$

Since the OP amp (AP1) exercises control so that VA=VB, VA and VB may be found from the equation (38) by

$${V}_{A} = {V}_{B} = \frac{{R}_{3} {R}_{6} ( {R}_{4} {V}_{F 1} - {R}_{1} {V}_{F 2} )}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} \qquad ( 39 )$$

Thus, I1 and I2 may be found by

$${I}_{1} = {I}_{2} = \frac{{R}_{3} ( {R}_{4} + {R}_{6} ) {V}_{F 1} - {R}_{6} ( {R}_{1} + {R}_{3} ) {V}_{F 2}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} = {I}_{3} \qquad ( 40 )$$

Hence, the reference voltage Vref may be expressed by

$$\begin{matrix}Vref = {R}_{7} {I}_{3} \\ = \frac{{R}_{7} \{ {R}_{3} ( {R}_{4} + {R}_{6} ) {V}_{F 1} - {R}_{6} ( {R}_{1} + {R}_{3} ) {V}_{F 2} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} \\ = \frac{{R}_{7} \{ ( {R}_{3} {R}_{4} {V}_{F 1} - {R}_{6} {R}_{1} {V}_{F 2} ) + {R}_{3} {R}_{6} Δ {V}_{F} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}}\end{matrix} \qquad ( 41 )$$

Qualitatively, if, in the equation (41), R₃R₄>R₁R₆, (R₃R₄V_{F1}−R₁R₆V_{F2}) has a negative temperature characteristic, while R₃R₆Δ V_{F} has a positive temperature characteristic. Thus, the temperature characteristic may be compensated. However, the temperature characteristic of Δ V_{F}, shown by the equation (40), has a second-order coefficient, and is of a positive temperature characteristic having the PTAT line of FIG. 7 as an asymptotic line.

FIG. 18 shows actual simulated values. For VDD1.3V, N=2, R1=1.2 kΩ, R2=76 kΩ, R3=97 kΩ, R4=2.00505 kΩ, R5=35 kΩ, R6=100 kΩ and R7=10 kΩ, were set. In this case, the values of Vref were 448.564 mV, 448.3948 mV, 448.4137 mV, 448.4928 mV and 448.446 mV for −53° C., −10° C., 0° C., 27° C. and 107° C., respectively, with the curve of Vref being of an undulating shape. The width of temperature variations is suppressed to slightly less than 0.04%. The temperature characteristic may be lesser than that of the circuit of FIG. 7 as a result of newly adding parallel resistors.

The circuit of FIG. 19 corresponds to the circuit of FIG. 10 less the resistors R1 and R2. R1 and R2 of FIG. 19 are respectively equivalent to R3 and R4 of FIG. 10. If, in FIG. 19, the currents I1, I2 and I3 are equal to one another,

$${I}_{1} = {I}_{2} = {I}_{3} = \frac{{V}_{F 1} - {V}_{F 2}}{{R}_{1}} = \frac{Δ {V}_{F}}{{R}_{1}} \qquad ( 42 )$$

The reference voltage Vref obtained may be expressed by

Vref=R₃I₃=Δ V_{F}R₃/R₁ (43)

The following expression also is valid:

$$Δ {V}_{F} = {V}_{T} ln ( \frac{N}{1 - \frac{{V}_{F 2}}{{I}_{1} {R}_{2}}} ) \qquad ( 44 )$$

In the equation (44), V_{T} is proportionate to absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−V_{F2}/(I₁R₂)}.

However, since the term of ln is changed with temperature, the temperature characteristic of Δ V_{F}, shown by the equation (44), has a second-order coefficient. The forward voltages VF1, VF2 of the respective diodes are as indicated by a chain-dotted line and a double-dotted chain line in FIG. 11, respectively, with the voltage difference Δ VF between VF1 and Vf2 being a constant value despite changes in temperature.

FIG. 20 shows actual simulated values. For VDD=1.3V, N=3, R1=6.8065 kΩ, R2=120 kΩ and R3=20 kΩ, were set, the values of Vref were 165.872 mV, 165.602 mV, 165.637 mV, 165.77 mV and 165.592 mV for −53° C., −10° C., 0° C., 27° C. and 107° C., respectively, with the curve of Vref being of an undulating shape. The width of temperature variations was suppressed to 0.17%. If the point of connection of the resistor R1 is changed to the grounding point, the reference voltage of 56.4 mV, compensated for temperature non-linearity proper to a transistor, may be obtained from the opposite side terminal of the resistor R1 (the terminal opposite to the grounded terminal) as well. However, even if the constants (element values) are changed, the voltage achieved roughly ranges from tens of mV to one hundred and tens of mV, and is 200 mV at most.

It has been shown in detail above that a third generation reference voltage circuit, compensated for temperature non-linearity proper to a diode, may be implemented without significantly increasing the circuit size as in the first and second generation circuits shown in FIGS. 1 and 4, or without significantly increasing the circuit current as in the second generation circuit shown in FIG. 4.

In the present invention proposes another third generation reference voltage circuits are proposed.

### SUMMARY OF THE DISCLOSURE

The entire disclosures in the above-mentioned Patent Documents are incorporated herein by reference. The analysis below is given by the present invention. The reference voltage circuit suffers the following problems:

The first problem is that the effects of temperature non-linearity proper to a diode are drastically demonstrated. The reason is that the circuit is not designed with the intention of compensating for temperature non-linearity proper to a diode.

The second problem is that addition of a circuit designed to compensate for temperature non-linearity proper to a diode leads to an increased circuit size. The reason is that the circuit simply changes the combinations of the diodes and the resistors in order to compensate for temperature non-linearity proper to a diode.

The third problem is that addition of a circuit that compensates for temperature non-linearity of diodes leads to increased current consumption. It is because the resistor inserting position has been modified without adding a circuit.

It is an object of the present invention to provide a reference voltage circuit of low current consumption capable of compensating for temperature non-linearity of diodes without increasing the circuit size and which may operate at a low voltage.

According to the present invention, there is provided a reference voltage circuit comprising first, second and third current-to-voltage converters, a current mirror circuit that supplies currents to the first, second and third current-to-voltage converters, and control means for exercising control so that a preset output voltage of the first current-to-voltage converter will be equal to a preset output voltage of the second current-to-voltage converter. A preset voltage of the third current-to-voltage converter becomes a reference voltage. The first current-to-voltage converter includes a diode and a resistor connected in parallel with the diode. The second current-to-voltage converter includes a plurality of diodes connected in parallel with one another, a resistor connected in parallel with the diodes, a resistor connected in series with the parallel circuit composed of the diodes and the resistor, and a resistor connected in parallel with a series circuit of the parallel circuit and the resistor. The third current-to-voltage converter includes a resistor.

According to the present invention, there is provided a reference voltage circuit comprising first, second and third current-to-voltage converters, a current mirror circuit that supplies currents to the first, second and third current-to-voltage converters, and control means for exercising control so that a preset intermediate terminal voltage of the first current-to-voltage converter will be equal to a preset intermediate terminal voltage of the second current-to-voltage converter. A preset voltage of the third current-to-voltage converter becomes a reference voltage. The first current-to-voltage converter includes a diode, a resistor connected in parallel with the diode, a resistor connected in series with the parallel circuit of the diode and the resistor, and a resistor connected in parallel with the series circuit of the parallel circuit and the resistor. The intermediate terminal voltage of the first current-to-voltage converter is output at the parallel-connected resistor. The second current-to-voltage converter includes a plurality of parallel-connected diodes, a resistor connected in parallel with the diodes, a resistor connected in series with the parallel circuit of the diodes and the resistor, and a resistor connected in parallel with the series circuit of the parallel circuit and the resistor. The intermediate terminal voltage of the second current-to-voltage converter is output at the parallel-connected resistor. The third current-to-voltage converter includes a resistor.

According to the present invention, there is provided a reference voltage circuit comprising first, second and third current-to-voltage converters, a current mirror circuit that supplies currents to the first, second and third current-to-voltage converters, and control means for exercising control so that a preset output voltage of the first current-to-voltage converter will be equal to a preset output voltage of the second current-to-voltage converter. A preset voltage of the third current-to-voltage converter becomes a reference voltage. The first current-to-voltage converter includes a diode, and the second current-to-voltage converter includes a plurality of parallel-connected diodes, a resistor connected in parallel with the diodes, a resistor connected in series with the parallel circuit of the diodes and the resistor, and a resistor connected in parallel with the series circuit of the parallel circuit and the resistor. The third current-to-voltage converter includes a resistor.

According to the present invention, there is provided a reference voltage circuit comprising first, second and third current-to-voltage converters, a current mirror circuit that supplies currents to the first, second and third current-to-voltage converters, and control means for exercising control so that a preset intermediate terminal voltage of the first current-to-voltage converter will be equal to a preset intermediate terminal voltage of the second current-to-voltage converter. A preset voltage of the third current-to-voltage converter becomes a reference voltage. The first current-to-voltage converter includes a diode, and the second current-to-voltage converter includes a plurality of parallel-connected diodes, a resistor connected in parallel with the diodes, a resistor connected in series with the parallel circuit of the diodes and the resistor, and a resistor connected in parallel with the series circuit of the parallel circuit and the resistor. The intermediate terminal voltage of the second current-to-voltage converter is output at the parallel connected resistor. The third current-to-voltage converter includes a resistor.

In the present invention, the control means includes an operational amplifier (OP amp) an inverting input terminal and a non-inverting input terminal of which respectively receive two voltages and an output terminal of which is connected to commonly coupled gates of the current mirror circuit.

In the present invention, the control means includes a current mirror circuit arranged between the current mirror circuit and the current-to-voltage converter.

In the present invention, the diode is a bipolar junction transistor connected as a diode.

According to the present invention, there is provided a reference voltage circuit comprising a non-linear current mirror circuit that includes first and second bipolar transistors, a third bipolar transistor connected to an output of the non-linear current mirror circuit, an output resistor, a linear current mirror circuit that supplies currents to the non-linear current mirror circuit, the third bipolar transistor and the output resistor, and an operational amplifier, as control means, for controlling an input terminal voltage and an output terminal voltage of the non-linear current mirror circuit to be equal to each other. A preset terminal voltage of the output resistor becomes a reference voltage.

In the present invention, the third bipolar transistor and the current mirror circuit that supplies the current thereto are deleted.

According to the present invention, there is provided a reference voltage circuit comprising a non-linear current mirror circuit that includes first and second bipolar transistors, a third bipolar transistor connected to an output of the non-linear current mirror circuit, an output resistor, and a linear current mirror circuit that supplies currents to the non-linear current mirror circuit and the output resistor. The linear current mirror circuit is driven by the third bipolar transistor. A preset terminal voltage of the output resistor becomes a reference voltage.

According to the present invention, there is provided a reference voltage circuit comprising a non-linear current mirror circuit that includes first and second bipolar transistors, an output resistor and a linear current mirror circuit that supplies currents to the non-linear current mirror circuit and the output resistor. The linear current mirror circuit is driven by an output of the third bipolar transistor. A preset terminal voltage of the output resistor becomes a reference voltage.

According to the present invention, there is provided a reference voltage circuit comprising a non-linear current mirror circuit that includes first and second bipolar transistors, an output resistor, and a linear current mirror circuit that supplies the current to the non-linear current mirror circuit. The linear current mirror circuit is self-biased by being driven by an output current of the non-linear current mirror circuit, and is grounded via the output resistor. A preset terminal voltage of the output resistor becomes a reference voltage.

According to the present invention, there is provided a reference voltage circuit comprising first, second and third current-to-voltage converters, a current mirror circuit that supplies currents to the first and second current-to-voltage converters, and control means for exercising control so that a preset output voltage of the first current-to-voltage converter will be equal to a preset output voltage of the second current-to-voltage converter. A terminal voltage of the third current-to-voltage converter, connected in series with the first and second current-to-voltage converters and grounded, becomes a reference voltage. The first current-to-voltage converter includes a diode or a combination of a diode and a resistor. The second current-to-voltage converter includes a combination of a parallel connection of a plurality of diodes and a resistor. The third current-to-voltage converter includes a resistor.

According to the present invention, there is provided a reference voltage circuit comprising first, second and third current-to-voltage converters, a first current mirror circuit that supplies the currents to the first and second current-to-voltage converters, and a second current mirror circuit that self-biases the first current mirror circuit. The terminal voltage of the third current-to-voltage converter, connected in series with the first and second current-to-voltage converters and grounded, becomes a reference voltage. The first current-to-voltage converter includes a diode or a combination of a diode and a resistor. The second current-to-voltage converter includes a combination of a parallel connection of a plurality of diodes and a resistor. The third current-to-voltage converter includes a resistor.

According to the present invention, there is provided a reference voltage circuit comprising first to fifth current-to-voltage converters, first and second transistors, respectively supplying currents to the first and second current-to-voltage converters, having gates connected together to form a first current mirror circuit, a second current mirror circuit that supplies currents flowing through the first transistor to the third transistor, and a third current mirror circuit that supplies currents flowing through the second transistor to a fourth transistor. The third transistor and the fourth transistor respectively deliver the currents to the fourth and fifth current-to-voltage converters. The third and fourth transistors have gates connected together to form a fourth current mirror circuit. The third transistor has a drain connected to the common gates of the first and second transistors. The terminal voltage of the third current-to-voltage converter, connected in series with the first, second, fourth and fifth current-to-voltage converters and grounded, become a reference voltage. The first current-to-voltage converter includes a diode or a diode/resistor combination, and the second current-to-voltage converter includes a combination of a parallel connection of a plurality of diodes and a resistor. The third current-to-voltage converter includes a resistor. The fourth and fifth current-to-voltage converters are of the same configuration as the first current-to-voltage converter.

According to the present invention, there is provided a reference voltage circuit comprising first to fourth current-to-voltage converters, first to third transistors, respectively supplying currents to the first to third current-to-voltage converters, having gates connected together to form a first current mirror circuit, a second current mirror circuit that self-biases the first and second transistors and a fourth transistor controlled by an output signal of the second current mirror circuit and connected in cascode to the third transistor. The second current mirror circuit includes a non-linear current mirror circuit (reverse Widlar current mirror circuit). A terminal voltage of the third current-to-voltage converter, connected in series with the first, second and fourth current-to-voltage converters and grounded, becomes a reference voltage. The first current-to-voltage converter includes a diode or diode/resistor combination. The second current-to-voltage converter includes a combination of a plurality of parallel-connected diodes and a resistor. The third current-to-voltage converter includes a resistor. The fourth current-to-voltage converter is of the same configuration as the first current-to-voltage converter.

According to the present invention, there is provided a reference voltage circuit comprising a non-linear current mirror circuit that includes first and second bipolar transistors, a third bipolar transistor connected to an output of the non-linear current mirror circuit, an operational amplifier having an inverting input terminal and a non-inverting input terminal respectively connected to an input terminal and an output terminal of the non-linear current mirror circuit, an output resistor, and a linear current mirror circuit that supplies the current to the non-linear current mirror circuit. The linear current mirror circuit is self-biased by being driven by an output current of the non-linear current mirror circuit. The operational amplifier controls the linear current mirror circuit by an output thereof and operates so that an input terminal voltage and an output terminal voltage of the non-linear current mirror circuit will be equal to each other. The current flowing through the non-linear current mirror circuit and the current flowing through the third bipolar transistor flow through the output resistor. A preset terminal voltage of the output resistor is a reference voltage.

According to the present invention, there is provided a reference voltage circuit comprising a non-linear current mirror circuit that includes first and second bipolar transistors, a third bipolar transistor connected to an output of the non-linear current mirror circuit, an output resistor and a linear current mirror circuit that supplies to the non-linear current mirror circuit a current proportionate or equal to the current flowing through the third bipolar transistor. The linear current mirror circuit is self-biased by being driven by an output current of the non-linear current mirror circuit. The current flowing through the non-linear current mirror circuit and the current flowing through the third bipolar transistor flow through the output resistor. A preset terminal voltage of the output resistor becomes a reference voltage.

In the present invention, first and second bipolar transistors, having an emitter area ratio of 1:N, where N>0, have bases connected together to form an output terminal. The second bipolar transistor has a base and a collector connected together. A first resistor is connected between its base and emitter, and a second resistor is connected between an emitter of the first bipolar transistor and the emitter of the second bipolar transistor. The first bipolar transistor has the emitter grounded via a third resistor. The first and second bipolar transistors are self-biased by a current mirror circuit.

According to the present invention, there is provided a reference voltage circuit comprising a first diode, second diodes made up of a plurality of parallel-connected diodes, a first resistor connected in parallel with the second diodes, a second resistor connected in series with the second diodes and the first resistor, an output circuit made up of a series connection of a third resistor and a third diode, a linear current mirror circuit that supplies the current to the first diode, the second diodes, the first and second resistors and the output circuit, and an operational amplifier, as control means, exercising control so that the terminal voltage of the first diode and the terminal voltage of the second diodes and the first and second resistors will be equal to each other. A preset terminal voltage of the output circuit becomes a reference voltage.

According to the present invention, there is provided a reference voltage circuit comprising a first diode, second diodes made up of a plurality of parallel-connected diodes, a first resistor connected in parallel with the second diodes, a second resistor connected in series with the second diodes and the first resistor, an output circuit made up of a series connection of a third resistor and a third diode and a fourth resistor connected in parallel with the series connection, a linear current mirror circuit that supplies the currents to the first diode, the second diodes, the first and second resistors and the output circuit, and an operational amplifier, as control means, exercising control so that a terminal voltage of the first diode and a terminal voltage of the second diodes and the first and second resistors will be equal to each other. A preset terminal voltage of the output circuit becomes a reference voltage.

According to the present invention, there is provided a reference voltage circuit comprising a first diode, second diodes made up of a plurality of parallel-connected diodes, a first resistor connected in parallel with the second diodes, a second resistor connected in series with the second diodes and the first resistor, a third resistor and a fourth resistor, and an operational amplifier, as control means, having an output connected to the third and fourth resistors, and exercising control so that a terminal voltage of the first diode will be equal to a terminal voltage of the second diodes and the first and second resistors. The third resistor is connected in series with the first diode and the fourth resistor is connected in series with the second diodes and the first and second resistors. An output voltage of the operational amplifier becomes a reference voltage.

In the present invention, the first and second bipolar transistors, having an emitter area ratio of 1:N, where N>0, have emitters connected together and are driven with a constant current source. A voltage across the emitter of the first bipolar transistor and the ground, divided by first and second resistors, is applied to the base of the first bipolar transistor. The base and the collector of the second bipolar transistor are connected together to form an output terminal. A third resistor is connected between the base and the collector of the second bipolar transistor. The first and second bipolar transistors are self-biased by the current mirror circuit.

In the present invention, in a non-linear current mirror circuit, if such non-linear current mirror circuit is provided, a collector and a base of the first bipolar transistor are connected together, a first resistor is connected across the base and an emitter of the first bipolar transistor, and the emitter is grounded via a second resistor. A base of the second bipolar transistor is connected to a base of the first bipolar transistor, and its emitter is grounded. An emitter area ratio of the first and second bipolar transistors is N:1. The collectors of the first and second bipolar transistors respectively form an input terminal and an output terminal of the non-linear current mirror circuit.

In case of a configuration in which the non-linear current mirror circuit is grounded via an output resistor, the first bipolar transistor has a collector and a base connected together, and a first resistor is connected between its base and emitter, which emitter is connected via a second resistor to one end of the output resistor.

The second bipolar transistor has a base connected to a base of the first bipolar transistor, while having an emitter connected to one end of the output resistor.

In the present invention, in a non-linear current mirror circuit, if such non-linear current mirror circuit is provided, the first bipolar transistor has a collector and a base connected together, while having an emitter grounded via a series connection of first and second resistors. A third resistor is connected between the base of the transistor and a connection node of the first and second resistors.

The second bipolar transistor has a base connected to the base of the first bipolar transistor, while having an emitter grounded.

The emitter area ratio of the first and second bipolar transistors is set to N:1.

The collectors of the first and second bipolar transistors form input and output terminals of the non-linear current mirror circuit.

In the present invention, in the non-linear current mirror circuit, in case of a configuration in which the non-linear current mirror circuit is grounded via output resistor, the first bipolar transistor has a collector and a base connected together, while having an emitter connected to one end of the output resistor via a series connection of the first and second resistors. A third resistor is connected between the base and a connection node of the first and second resistors.

The second bipolar transistor has a base connected to the base of the first bipolar transistor, while having an emitter connected to one end of the output resistor.

In the present invention, in a non-linear current mirror circuit, if such non-linear current mirror circuit is provided, the first bipolar transistor has a collector and a base connected together. A first resistor is connected between the base and the emitter of the transistor. The emitter and the collector of the transistor are respectively grounded via the second resistor and the third resistor. The second bipolar transistor has a base connected to the base of the first bipolar transistor, while having an emitter grounded. The emitter area ratio of the first and second bipolar transistors is set to N:1, and the collectors of the first and second bipolar transistors respectively form input and output terminals of the non-linear current mirror circuit: Or, in the configuration in which the non-linear current mirror circuit is grounded via an output resistor, the first bipolar transistor in the non-linear current mirror circuit has a collector and a base connected together, and a first resistor is connected between its base and emitter. The first bipolar transistor has an emitter connected via a second resistor to one end of the output resistor, while having a collector connected via a third resistor to one end of the output resistor.

The second bipolar transistor has a base and an emitter connected respectively to the base of the first bipolar transistor and to one end of the output resistor.

In the present invention, in a configuration in which a non-linear current mirror circuit is provided, the first bipolar transistor in the non-linear current mirror circuit has an emitter grounded, while having a collector connected to the base of the second bipolar transistor and to one end of the first resistor, the other end of which is connected to the base of the first bipolar transistor. The emitter of the second bipolar transistor is grounded. The emitter area ratio of the first and second bipolar transistors is set to 1:N. The opposite end of the first resistor and the collector of the second bipolar transistor form an input terminal and an output terminal of the non-linear current mirror circuit, respectively. Or, in the non-linear current mirror circuit, in case it is grounded via an output resistor, the first bipolar transistor has an emitter connected to one end of the output resistor, while having a collector connected to the base of the second bipolar transistor and to one end of the first resistor, the opposite end of which is connected to the base of the first bipolar transistor. The emitter of the second bipolar transistor is connected to one end of the output resistor.

According to the present invention, the width of temperature variations may be made smaller or minimized because the present invention allows generating the current compensated for temperature non-linearity proper to a diode. According to the present invention, the operation at a low voltage is enabled because the present invention allows setting the output voltage to lower values.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a circuit diagram showing a widely known instance of a conventional (first generation) circuit.

FIG. 2 is a schematic view showing the scheme of temperature compensation of the conventional (first generation) circuit.

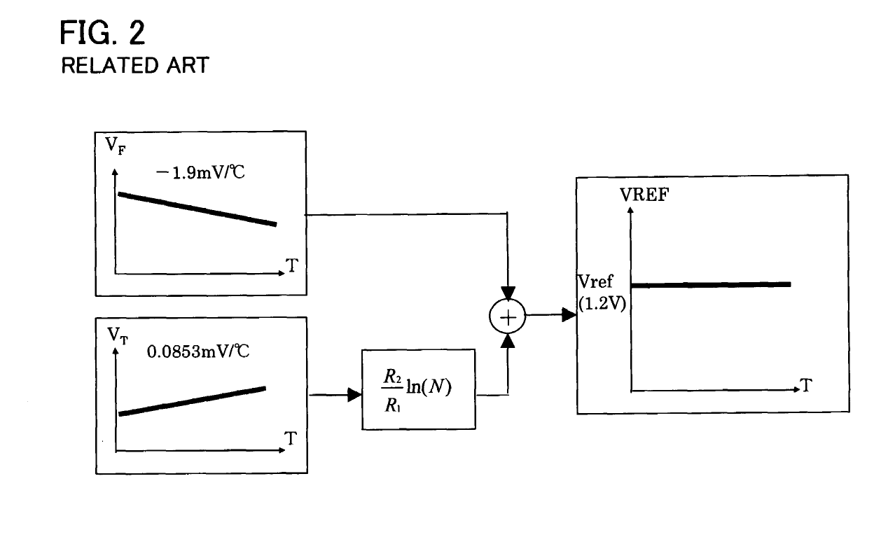

FIG. 3 is a graph showing a temperature characteristic of the conventional (first generation) circuit.

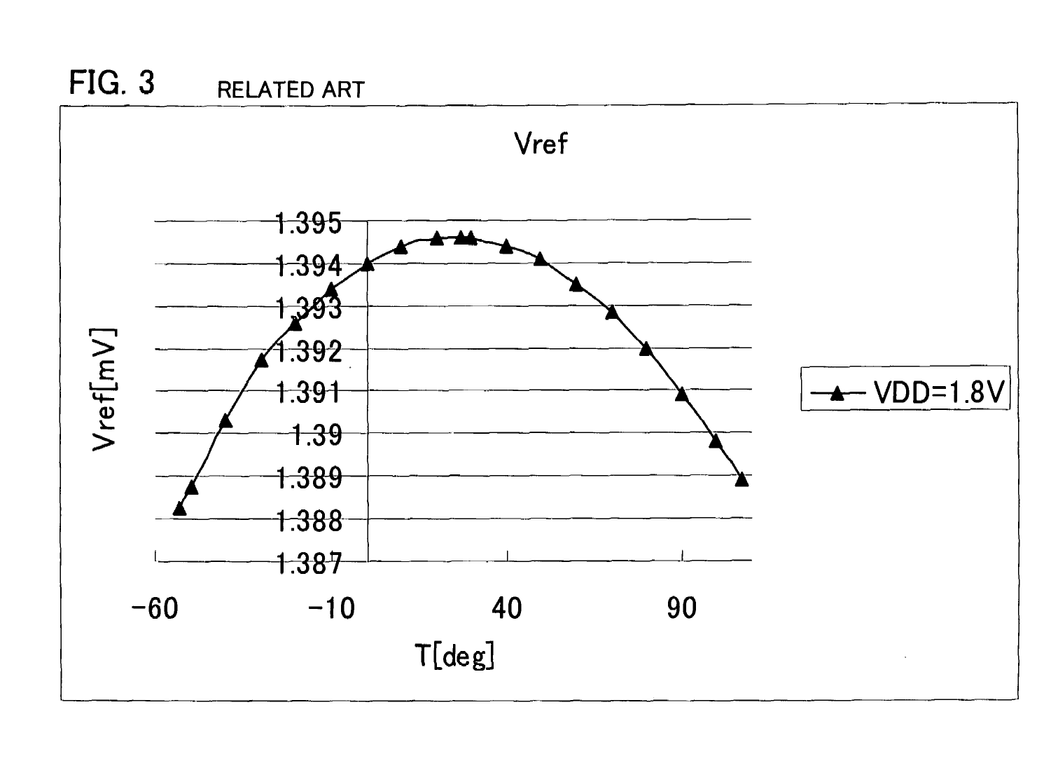

FIG. 4 is a circuit diagram showing a well-known instance of a conventional (second generation) circuit.

FIG. 5 is a schematic view showing the scheme of temperature compensation of the conventional (second generation) circuit.

FIG. 6 is a graph showing a temperature characteristic of the conventional (second generation) circuit.

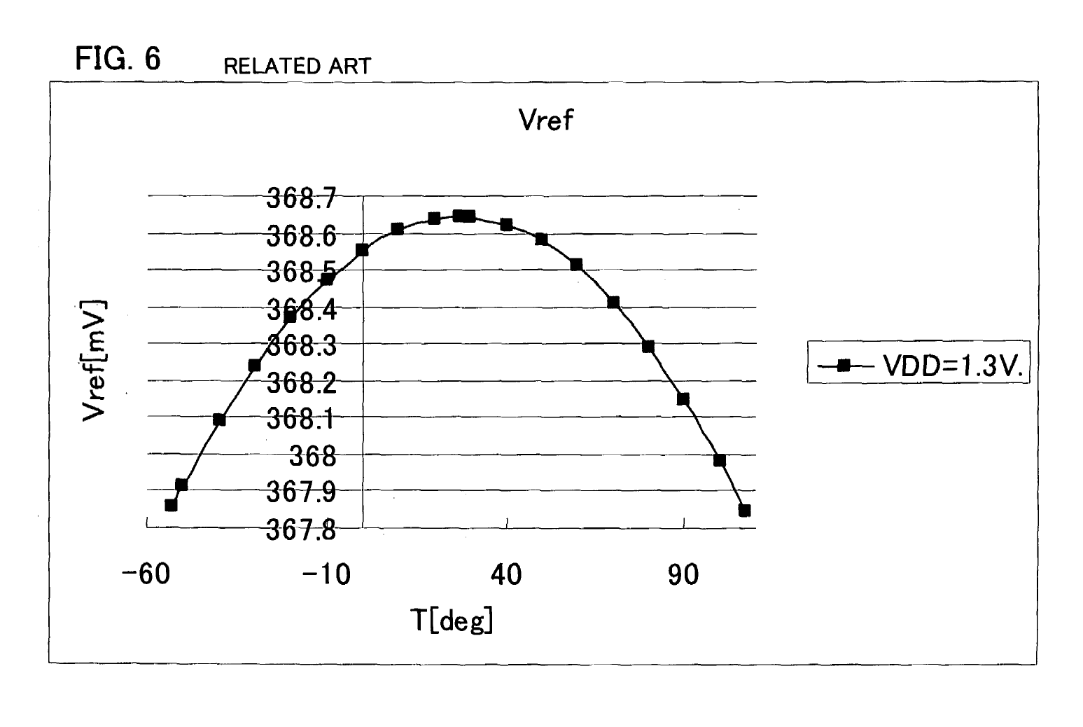

FIG. 7 is a schematic view showing the scheme of temperature compensation of a conventional (third generation) circuit.

FIG. 8 is a circuit diagram showing an instance of a conventional (third generation) circuit as proposed by Brokaw.

FIG. 9 is a graph showing a temperature characteristic of the conventional (third generation) circuit as proposed by Brokaw.

FIG. 10 is a circuit diagram showing an instance of the first circuit (third generation) as proposed by the present inventor.

FIG. 11 is a graph showing temperature characteristics of two diodes of the first circuit as proposed by the present inventor.

FIG. 12 is a graph showing a temperature characteristic of the first circuit as proposed by the present inventor.

FIG. 13 is a circuit diagram showing an instance of a second circuit (third generation) as proposed by the present inventor.

FIG. 14 is a graph showing a temperature characteristic of the second circuit as proposed by the present inventor.

FIG. 15 is a circuit diagram showing an instance of a third circuit (third generation) as proposed by the present inventor.

FIG. 16 is a graph showing a temperature characteristic of the third circuit as proposed by the present inventor.

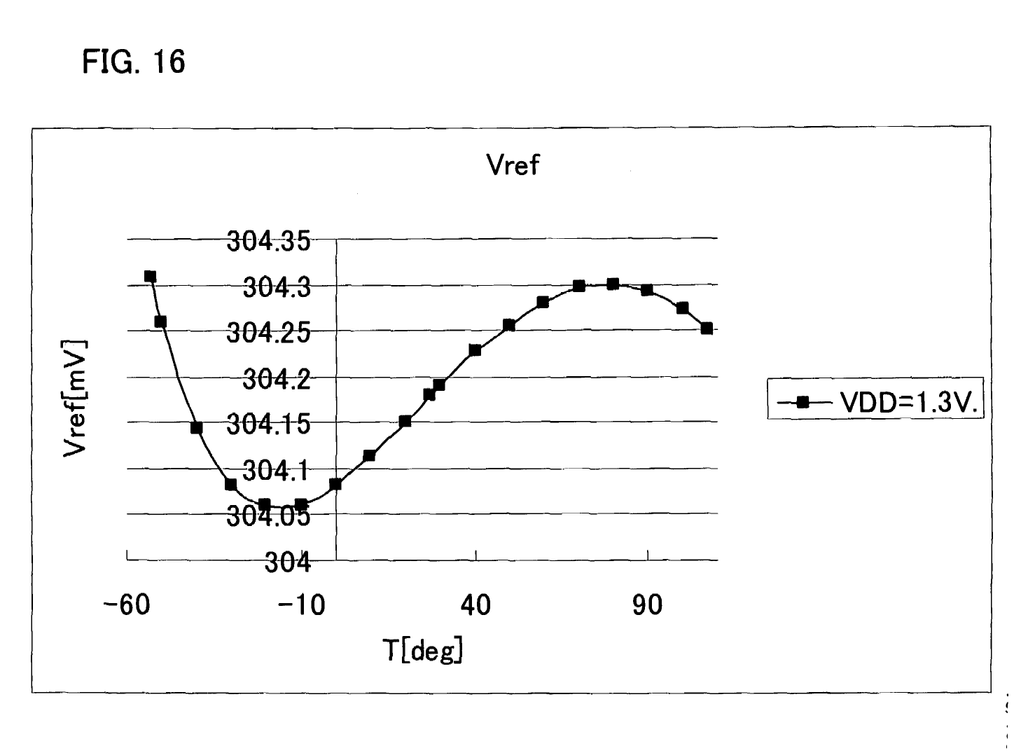

FIG. 17 is a circuit diagram showing an instance of a fourth circuit (third generation) as proposed by the present inventor.

FIG. 18 is a graph showing a temperature characteristic of the fourth circuit as proposed by the present inventor.

FIG. 19 is a circuit diagram showing an instance of a fifth circuit (third generation) as proposed by the present inventor.

FIG. 20 is a graph showing a temperature characteristic of the fifth circuit as proposed by the present inventor.

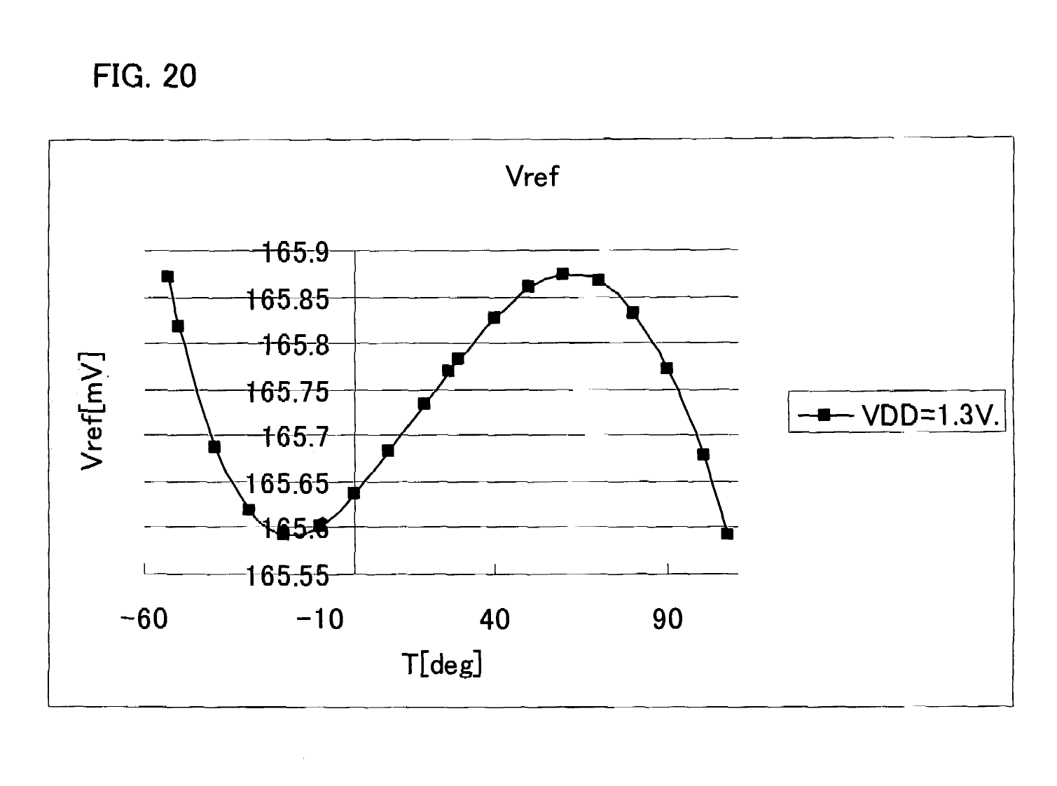

FIG. 21 is a block diagram of a third generation reference voltage circuit.

FIG. 22 is a circuit diagram showing the circuit configuration of an example according to claim 1.

FIG. 23 is a graph showing a temperature characteristic of a circuit of an example according to claim 1.

FIG. 24 is a block diagram showing another first example of a reference voltage circuit of the third generation.

FIG. 25 is a block diagram showing another second example of the reference voltage circuit of the third generation.

FIG. 26 is a block diagram showing another third example of the reference voltage circuit of the third generation.

FIG. 27 is a circuit diagram showing the circuit configuration of another first example according to claim 1.

FIG. 28 is a circuit diagram showing the circuit configuration of another second example according to claim 1.

FIG. 29 is a circuit diagram showing the circuit configuration of another third example according to claim 1.

FIG. 30 is a circuit diagram showing the circuit configuration of an example according to claim 2.

FIG. 31 is a circuit diagram showing the circuit configuration of an example according to claim 3.

FIG. 32 is a graph showing a temperature characteristic of a circuit of an example according to claim 3.

FIG. 33 is a circuit diagram showing the circuit configuration of another first example of claim 3.

FIG. 34 is a circuit diagram showing the circuit configuration of another second example of claim 3.

FIG. 35 is a circuit diagram showing the circuit configuration of a third example according to claim 3.

FIG. 36 is a circuit diagram showing the circuit configuration of an example according to claim 4.

FIG. 37 is a graph showing a temperature characteristic of a circuit of an example according to claim 4.

FIG. 38 is a circuit diagram showing the circuit configuration of a non-linear current mirror circuit as used in an example according to claim 8.

FIG. 39 is a circuit diagram showing the circuit configuration of an example according to claim 8.

FIG. 40 is a circuit diagram showing the circuit configuration of a first example according to claim 8.

FIG. 41 is a circuit diagram showing the circuit configuration of a second example according to claim 8.

FIG. 42 is a circuit diagram showing the circuit configuration of a third example according to claim 8.

FIG. 43 is a circuit diagram showing the circuit configuration of an example according to claim 9.

FIG. 44 is a circuit diagram showing the circuit configuration of a first example according to claim 9.

FIG. 45 is a circuit diagram showing the circuit configuration of a second example according to claim 9.

FIG. 46 is a circuit diagram showing the circuit configuration of a third example according to claim 9.

FIG. 47 is a circuit diagram showing the circuit configuration of a fourth example according to claim 9.

FIG. 48 is a circuit diagram showing the circuit configuration of a fifth example according to claim 9.

FIG. 49 is a circuit diagram showing the circuit configuration of an example according to claim 10.

FIG. 50 is a circuit diagram showing the circuit configuration of a first example according to claim 10.

FIG. 51 is a circuit diagram showing the circuit configuration of a second example according to claim 10.

FIG. 52 is a circuit diagram showing the circuit configuration of a third example according to claim 10.

FIG. 53 is a circuit diagram showing the circuit configuration of a fourth example according to claim 10.

FIG. 54 is a circuit diagram showing the circuit configuration of a fifth example according to claim 10.

FIG. 55 is a circuit diagram showing the circuit configuration of a sixth example according to claim 10.

FIG. 56 is a circuit diagram showing the circuit configuration of a seventh example according to claim 10.

FIG. 57 is a circuit diagram showing the circuit configuration of an eighth example according to claim 10.

FIG. 58 is a circuit diagram showing the circuit configuration of a ninth example according to claim 10.

FIG. 59 is a circuit diagram showing the circuit configuration of a tenth example according to claim 10.

FIG. 60 is a circuit diagram showing the circuit configuration of an eleventh example according to claim 10.

FIG. 61 is a circuit diagram showing the circuit configuration of an example according to claim 11.

FIG. 62 is a circuit diagram showing the circuit configuration of a first example according to claim 11.

FIG. 63 is a circuit diagram showing the circuit configuration of a second example according to claim 11.

FIG. 64 is a circuit diagram showing the circuit configuration of a third example according to claim 11.

FIG. 65 is a circuit diagram showing the circuit configuration of an example according to claim 12.

FIG. 66 is a circuit diagram showing the circuit configuration of a first example according to claim 12.

FIG. 67 is a circuit diagram showing the circuit configuration of a second example according to claim 12.

FIG. 68 is a circuit diagram showing the circuit configuration of a third example according to claim 12.

FIG. 69 is a circuit diagram showing the circuit configuration of an example according to claim 13.

FIG. 70 is a circuit diagram showing the circuit configuration of a first example according to claim 13.

FIG. 71 is a circuit diagram showing the circuit configuration of a second example according to claim 13.

FIG. 72 is a circuit diagram showing the circuit configuration of a third example according to claim 13.

FIG. 73 is a circuit diagram showing the circuit configuration of a fourth example according to claim 13.

FIG. 74 is a circuit diagram showing the circuit configuration of a fifth example according to claim 13.

FIG. 75 is a circuit diagram showing the circuit configuration of a sixth example according to claim 13.

FIG. 76 is a circuit diagram showing the circuit configuration of a seventh example according to claim 13.

FIG. 77 is a circuit diagram showing the circuit configuration of an eighth example according to claim 13.

FIG. 78 is a circuit diagram showing the circuit configuration of a ninth example according to claim 13.

FIG. 79 is a circuit diagram showing the circuit configuration of a tenth example according to claim 13.

FIG. 80 is a circuit diagram showing the circuit configuration of an example according to claim 14.

FIG. 81 is a circuit diagram showing the circuit configuration of a first example according to claim 14.

FIG. 82 is a circuit diagram showing the circuit configuration of a second example according to claim 14.

FIG. 83 is a circuit diagram showing the circuit configuration of a third example according to claim 14.

FIG. 84 is a circuit diagram showing the circuit configuration of a fourth example according to claim 14.

FIG. 85 is a circuit diagram showing the circuit configuration of a fifth example according to claim 14.

FIG. 86 is a circuit diagram showing the circuit configuration of a sixth example according to claim 14.

FIG. 87 is a circuit diagram showing the circuit configuration of a seventh example according to claim 14.

FIG. 88 is a circuit diagram showing the circuit configuration of an eighth example according to claim 14.

FIG. 89 is a circuit diagram showing the circuit configuration of a ninth example according to claim 14.

FIG. 90 is a circuit diagram showing the circuit configuration of an example according to claim 15.

FIG. 91 is a circuit diagram showing the circuit configuration of a first example according to claim 15.

FIG. 92 is a circuit diagram showing the circuit configuration of a second example according to claim 15.

FIG. 93 is a circuit diagram showing the circuit configuration of a third example according to claim 15.

FIG. 94 is a circuit diagram showing the circuit configuration of a fourth example according to claim 15.

FIG. 95 is a circuit diagram showing the circuit configuration of a fifth example according to claim 15.

FIG. 96 is a circuit diagram showing the circuit configuration of a sixth example according to claim 15.

FIG. 97 is a circuit diagram showing the circuit configuration of a seventh example according to claim 15.

FIG. 98 is a circuit diagram showing the circuit configuration of an eighth example according to claim 15.

FIG. 99 is a circuit diagram showing the circuit configuration of a ninth example according to claim 15.

FIG. 100 is a circuit diagram showing the circuit configuration of an example according to claim 16.

FIG. 101 is a circuit diagram showing the circuit configuration of a first example according to claim 16.

FIG. 102 is a circuit diagram showing the circuit configuration of a second example according to claim 16.

FIG. 103 is a circuit diagram showing the circuit configuration of a third example according to claim 16.

FIG. 104 is a circuit diagram showing the circuit configuration of a fourth example according to claim 16.

FIG. 105 is a circuit diagram showing the circuit configuration of a fifth example according to claim 16.

FIG. 106 is a circuit diagram showing the circuit configuration of a sixth example according to claim 16.

FIG. 107 is a circuit diagram showing the circuit configuration of a seventh example according to claim 16.

FIG. 108 is a circuit diagram showing the circuit configuration of an eighth example according to claim 16.

FIG. 109 is a circuit diagram showing the circuit configuration of a ninth example according to claim 16.

FIG. 110 is a circuit diagram showing the circuit configuration of an example according to claim 17.

FIG. 111 is a circuit diagram showing the circuit configuration of a first example according to claim 17.

FIG. 112 is a circuit diagram showing the circuit configuration of a second example according to claim 17.

FIG. 113 is a circuit diagram showing the circuit configuration of a third example according to claim 17.

FIG. 114 is a circuit diagram showing the circuit configuration of an example according to claim 18.

FIG. 115 is a circuit diagram showing the circuit configuration of a first example according to claim 18.

FIG. 116 is a circuit diagram showing the circuit configuration of a second example according to claim 18.

FIG. 117 is a circuit diagram showing the circuit configuration of a third example according to claim 18.

FIG. 118 is a circuit diagram showing the circuit configuration of a fourth example according to claim 18.

FIG. 119 is a circuit diagram showing the circuit configuration of a fifth example according to claim 18.

FIG. 120 is a circuit diagram showing the circuit configuration of a sixth example according to claim 18.

FIG. 121 is a circuit diagram showing the circuit configuration of a seventh example according to claim 18.

FIG. 122 is a circuit diagram showing the circuit configuration of an eighth example according to claim 18.

FIG. 123 is a circuit diagram showing the circuit configuration of a ninth example according to claim 18.

FIG. 124 is a circuit diagram showing the circuit configuration of a tenth example according to claim 18.

FIG. 125 is a circuit diagram showing the circuit configuration of an eleventh example according to claim 18.

FIG. 126 is a circuit diagram showing the circuit configuration of an example according to claim 19.

FIG. 127 is a circuit diagram showing the circuit configuration of an example according to claim 20.

FIG. 128 is a circuit diagram showing the circuit configuration of an example according to claim 21.

FIG. 129 is a graph showing a temperature characteristic of the example according to claim 21.

FIG. 130 is a circuit diagram showing the circuit configuration of an example according to claim 22.

FIG. 131 is a circuit diagram showing the circuit configuration of an example according to claim 23.

FIG. 132 is a circuit diagram showing the circuit configuration of an example according to claim 24.

FIG. 133 is a circuit diagram showing the circuit configuration of another example according to claim 24.

FIG. 134 is a circuit diagram showing the circuit configuration of an example according to claim 25.

FIG. 135 is a circuit diagram showing the circuit configuration of an example according to claim 26.

FIG. 136 is a circuit diagram showing the circuit configuration of an example according to claim 27.

### PREFERRED MODES OF THE INVENTION

Referring to the drawings, certain exemplary embodiments of the present invention are now described in detail.

### EXAMPLE 1

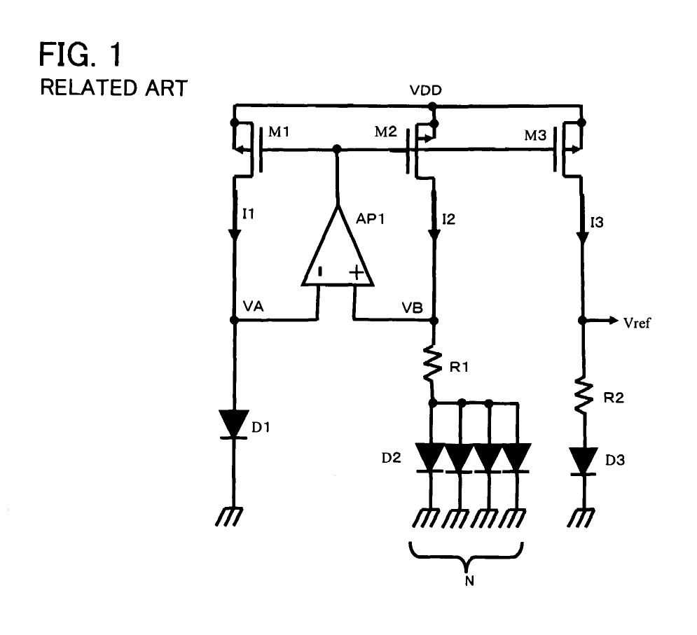

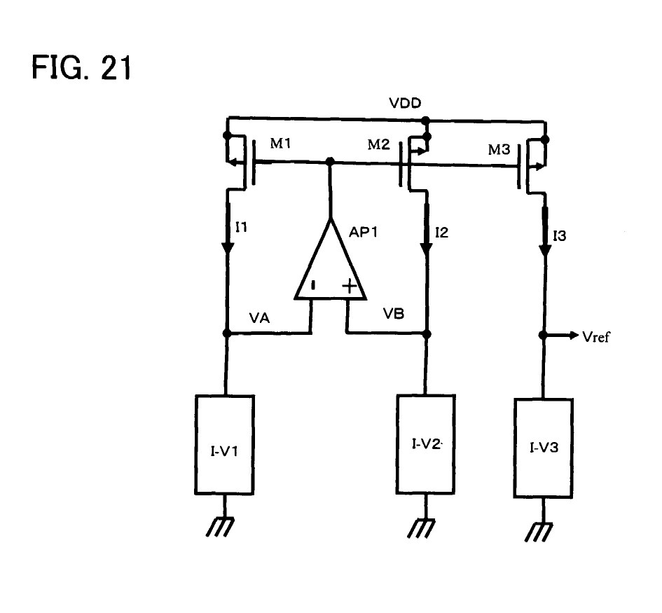

FIG. 21 is a circuit diagram showing the configuration of a CMOS reference voltage generating circuit of claim 1, with a portion of the circuit being shown in a block form for generalization. In fact, FIG. 21 is applicable to any of FIGS. 1, 4, 8, 10, 13, 15, 18 and 19 showing the conventional circuits.

Referring to FIG. 21, the above-described circuits may be derived by incorporating networks, composed of resistor(s) and diode(s) or composed only of resistor(s), in each of the first current-to-voltage converter I-V1, second current-to-voltage converter I-V2 and the third current-to-voltage converter I-V3 of the reference voltage generating circuit. The reference voltage generating circuit has the circuit topology of high universality in that it may be applied to many circuits as account is taken of avoiding waste and reducing the circuit size and current consumption.

Referring to FIG. 21, a current I1 is supplied to the first current-to-voltage converter I-V1 to generate the terminal voltage VA, while a current I2 is supplied to the second current-to-voltage converter I-V2 to generate the terminal voltage VB. A current I3 is supplied to the third current-to-voltage converter I-V3 to supply a terminal voltage as reference voltage Vref.

The currents I1, I2 and I3, supplied to the first current-to-voltage converter I-V1, second current-to-voltage converter I-V2 and to the third current-to-voltage converter I-V3, respectively, are supplied from the drains of the p-channel MOS transistors M1, M2 and M3, respectively. These p-channel MOS transistors, having sources connected to a power supply VDD and having gates connected together, compose a current mirror circuit.

An output terminal of the OP amp (AP1) is connected to a common gate of the MOS transistors M1, M2 and M3. The voltage at the common gate of the MOS transistors M1, M2 and M3 is controlled by the output voltage of the OP amp (AP1).

The OP amp (AP1) has an inverting terminal (−) connected to an output of the first current-to-voltage converter I-V1, while having a non-inverting terminal (+) connected to an output end of the second current-to-voltage converter I-V2. This OP amp (AP1) exercises control so that the terminal voltage VA of the first current-to-voltage converter I-V1 will be equal to the terminal voltage VB of the second current-to-voltage converter I-V2.

The reference voltage Vref appears as a terminal voltage of the third current-to-voltage converter I-V3 that receives the current I3 from the MOS transistor M3.

The first current-to-voltage converter I-V1, second current-to-voltage converter I-V2 and the third current-to-voltage converter I-V3 are respectively supplied with the currents I1, I2 and I3 from the current mirror circuits M1, M2 and M3, and possess equal temperature characteristics.

It is noted that, if the first current-to-voltage converter I-V1 and the second current-to-voltage converter I-V2 are of the same circuit configuration, numerous operating points are produced to render the operation indefinite. It is therefore necessary that the first current-to-voltage converter I-V1 and the second current-to-voltage converter I-V2 differ from each other in circuit configuration. A startup circuit is here dispensed with for simplicity. In the following description on the operation and in the respective examples, the description on the startup circuit is dispensed with.

### EXAMPLE 1-1-1

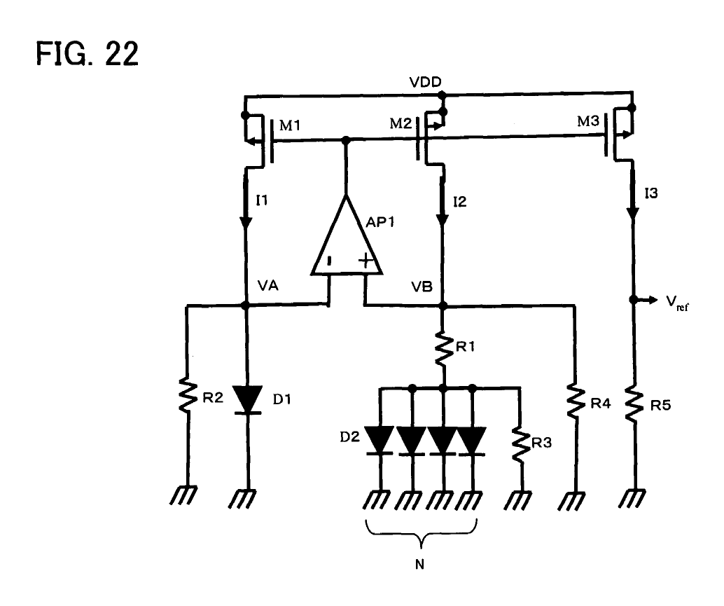

FIG. 22 shows a circuit the configuration of an example of a CMOS reference voltage generating circuit which is the subject-matter of claim 1. In FIG. 22, the first current-to-voltage converter I-V1 is formed as a parallel connection of a diode D1 and a resistor R2, and the second current-to-voltage converter I-V2 is a composite parallel circuit made up of a parallel connection of a plurality of diodes D2 and a resistor R3, a resistor R1 connected in series with the parallel connection, and a resistor R4 connected in parallel with the resulting series connection. The third current-to-voltage converter I-V3 is made up only of a sole resistor.

If the first current-to-voltage converter I-V1 and the second current-to-voltage converter I-V2 are of the same circuit configuration, numerous operating points are produced to render the operation indefinite. Here, the number of the diodes of the first current-to-voltage converter I-V1 and that of the second current-to-voltage converter I-V2 are made to differ from each other.

The ratio of the numbers of the parallel-connected diodes (or bipolar transistors connected as diodes) of the first current-to-voltage converter I-V1 and the second current-to-voltage converter I-V2, compared to each other, is here set to 1:N.

More specifically, it is contemplated that the first current-to-voltage converter I-V1 is made up of a sole diode D1 and that the second current-to-voltage converter I-V2 is made up of a parallel connection of two to four diodes D2.

If, in FIG. 22, the forward voltages of the diodes (or bipolar transistors connected as diodes) D1 and D2 are labeled VF1 and VF2, respectively, an OP amp (AP1) exercises control so that two input voltages VA and VB will be equal to each other (VA=VB).

It is assumed that, in FIG. 22, the currents I1, I2 and I3 from the MOS transistors M1 to M3 are equal to one another. Since the OP amp performs control so that VA=VB,

$${I}_{1} = {I}_{2} = {I}_{3} = \frac{{V}_{F 1} - {V}_{F 1}}{{R}_{1}} + \frac{{V}_{F 1}}{{R}_{4}} = \frac{Δ {V}_{F}}{{R}_{1}} + \frac{{V}_{F 1}}{{R}_{4}} \qquad ( 45 )$$

Hence, the reference voltage Vref obtained may be found as

$$Vref = {R}_{5} {I}_{3} = \frac{{R}_{5}}{{R}_{4}} ( {V}_{F 1} + \frac{{R}_{4}}{{R}_{1}} Δ {V}_{F} ) \qquad ( 46 )$$

The currents I_{1A} and I_{2A} flowing through the diodes D1 and D2, respectively, are given by:

$$\begin{matrix}{I}_{1 A} = {I}_{1} - \frac{{V}_{F 1}}{{R}_{2}} \\ and by & ( 47 ) \\ {I}_{2 A} = \frac{Δ {V}_{F}}{{R}_{1}} - \frac{{V}_{F 2}}{{R}_{3}} & ( 48 )\end{matrix}$$

so that

$$Δ {V}_{F} = {V}_{T} ln ( \frac{{NI}_{1 A}}{{I}_{2 A}} ) = {V}_{T} ln \{ \frac{N ( 1 - \frac{{V}_{F 1}}{{R}_{2} {I}_{1}} )}{\frac{Δ {V}_{F}}{{R}_{1} {I}_{1}} - \frac{{V}_{F 2}}{{R}_{3} {I}_{1}}} \} \qquad ( 49 )$$

Δ V_{F} roughly has a positive temperature characteristic, and hence the temperature characteristic within the round brackets ( ) of the equation (46) may substantially be compensated.

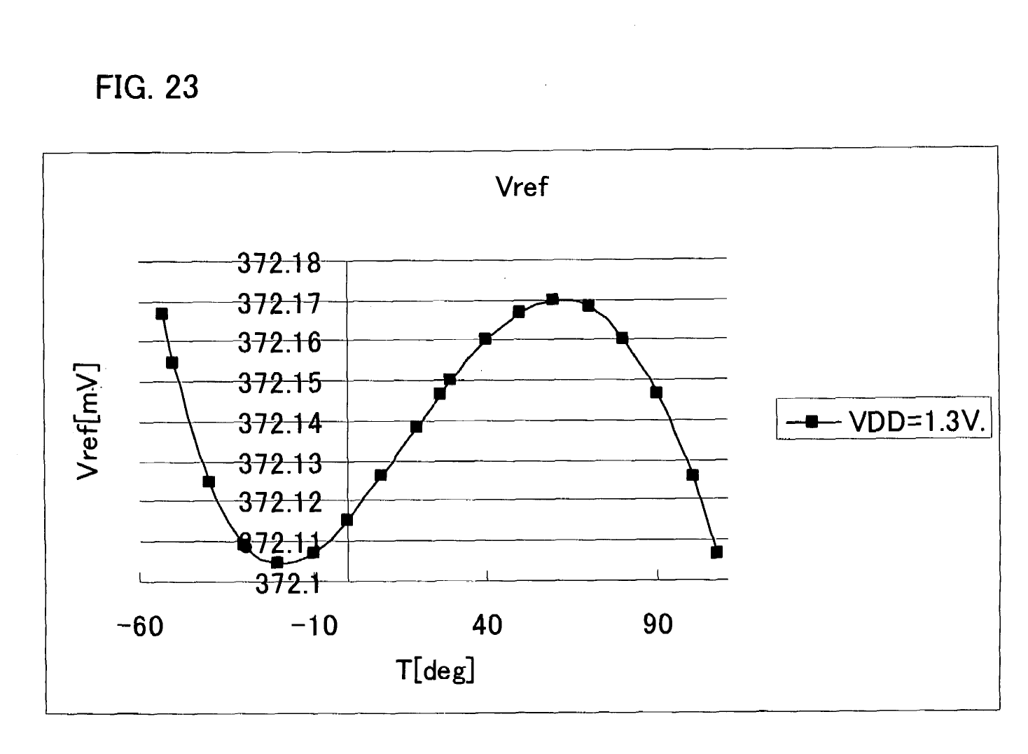

FIG. 23 shows actual simulated values. For VDD=1.3V, N=2, R1=0.9578 kΩ, R2=43.4 kΩ, R3=55 kΩ, R4=75 kΩ and R5=10 kΩ were set. In this case, the values of Vref were 372.167 mV, 372.1072 mV, 372.1152 mV, 372.1468 mV and 372.1067 mV for −53° C., −10° C., 0° C., 27° C. and 107° C., respectively, with the curve of Vref being of an undulating shape. The width of temperature variations was suppressed to slightly less than 0.018%.

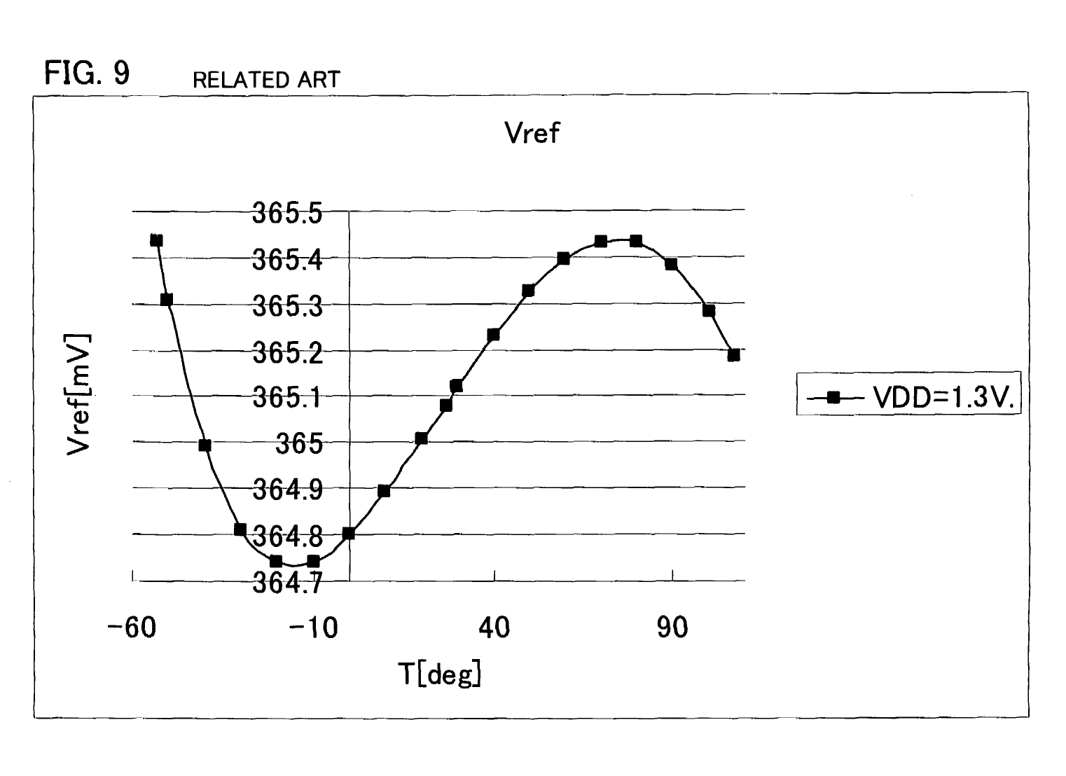

With the present Example, in which a parallel resistor R4 is added to the second current-to-voltage converter I-V2, the temperature characteristic may be made lesser than that of the circuit of FIG. 9.

### EXAMPLE 1-1-2

In the first example (FIG. 21) for claim 1, discussed thus far in detail, the OP amp is used as control means for exercising control so that preset plural voltages are equal to one another. It is however possible to use a current mirror circuit, in place of the OP amp, as control means for exercising control so that preset plural voltages are equal to one another.

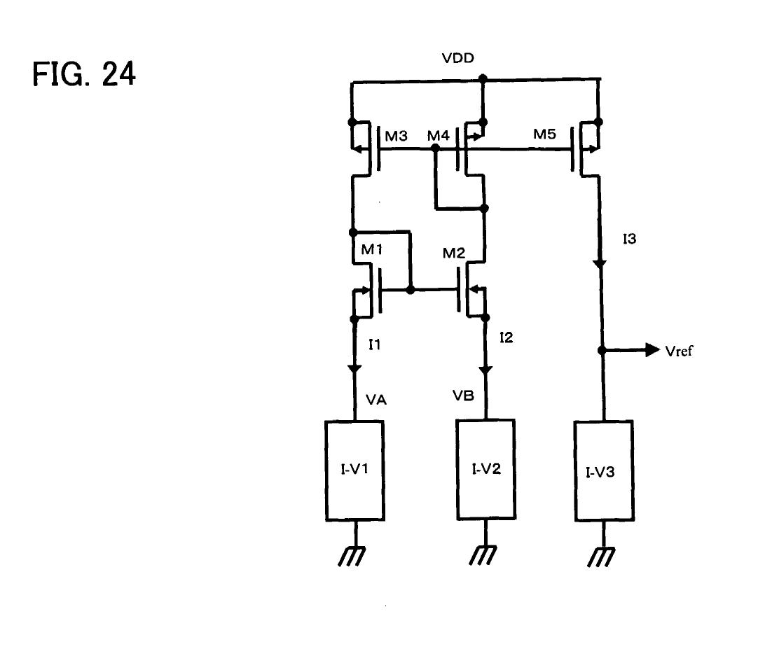

Specifically, from FIG. 21, a circuit block diagram of a reference voltage generating circuit employing the OP amp as control means, various circuit forms shown in FIGS. 24, 25 and 26 may be derived.

It is noted that selecting the first current-to-voltage converter I-V1, with the smaller number of the diodes, as current-to-voltage converter I-V within a control circuit, serves more adequately for reducing the chip area. However, selecting the second current-to-voltage converter I-V2, with the increased number of diodes, yields the same favorable effect.

Referring to FIG. 24, n-channel MOS transistors M1 and M2 have gates connected together, and the n-channel MOS transistor M1 has its gate and drain connected together. p-channel MOS transistors M3, M4 and M5 have gates connected together, and the p-channel MOS transistor M4 has the gate and the drain connected together. Hence, the n-channel MOS transistors M1 and M2 form a current mirror circuit, while the p-channel MOS transistors M3, M4 and M5 also form a current mirror circuit. The current mirror circuit of the p-channel MOS transistors M3 and M4 self-biases the current mirror circuit of the n-channel MOS transistors M1 and M2.

The current I1 thus flows through the MOS transistors M1, M3 to drive the first current-to-voltage converter I-V1. In similar manner, the current I2 flows through the MOS transistors M2 and M4 to drive the second current-to-voltage converter I-V2. Also, the current I3 flows through the MOS transistor M5 to drive the third current-to-voltage converter I-V3 to generate an output voltage Vref.

The operation of the present example is now described. By the self-biasing, the OP amp in the configuration shown in FIG. 21 may be dispensed with, as shown in FIG. 24.

Referring to FIG. 24, n-channel MOS transistors M1 and M2 have gates connected together, and the n-channel MOS transistor M1 has its gate and drain connected together. p-channel MOS transistors M3, M4 and M5 have gates connected together, and the p-channel MOS transistor M4 has the gate and the drain connected together. Hence, the n-channel MOS transistors M1 and M2 form a current mirror circuit, while the p-channel MOS transistors M3, M4 and M5 also form a current mirror circuit. The current mirror circuit of the p-channel MOS transistors M3 and M4 self-biases the current mirror circuit of the n-channel MOS transistors M1 and M2.

It is noted that the currents flowing through the n-channel MOS transistors M1 and M2 are proportionate to each other. If the sizes of the n-channel MOS transistors M1 and M2 are equal to each other and the sizes of the p-channel MOS transistors M3 and M4 are equal to each other, the currents flowing through the n-channel MOS transistors M1 and M2 are equal to each other.

Thus, by the self-biasing, the gate-to-source voltages of the n-channel MOS transistors M1 and M2 are equal to each other. The terminal voltage VA of the first current-to-voltage converter I-V1 may thus be equal to the terminal voltage VB of the gate-to-source voltage of the second current-to-voltage converter I-V2, and hence the operating condition equivalent to that in case of using the OP amp as described above may be achieved. That is, the characteristic equivalent to that of FIG. 21 may be achieved, thus implementing the reference voltage generating circuit.

It should be noted that the reference voltage generating circuit, described above with reference to FIG. 24, is liable to be influenced by channel length modulation of transistors. A startup circuit is not shown only for simplicity.

### EXAMPLE 1-1-3

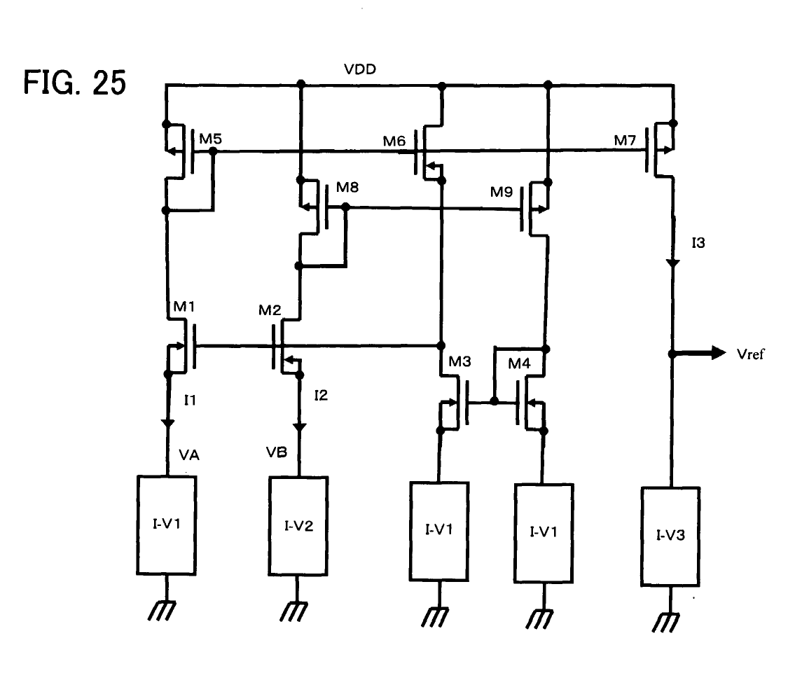

Referring to FIG. 25, the n-channel MOS transistors M1 and M2, n-channel MOS transistors M5 and M8, and the n-channel MOS transistors M3 and M4 form a current mirror circuit. The n-channel MOS transistors M1 and M2 have sources connected to the first current-to-voltage converter I-V1 and the second current-to-voltage converter I-V2. The n-channel MOS transistors M5, M8 are connected between the drains of the n-channel MOS transistors M1 and M2 and the power supply VDD and each have a drain and a gate connected together. The n-channel MOS transistors M3 and M4 have sources connected to two first current-to-voltage converters I-V1 and have gates connected together. p-channel MOS transistors M6 and M9 are connected between the drains of the n-channel MOS transistors M3 and M4 and the power supply VDD. The gates of the n-channel MOS transistors M1 and M2 are connected in common and connected to the drain of the n-channel MOS transistor M3. P-channel MOS transistors M8 and M9 are connected in common to form a current mirror circuit.

A p-channel transistor M7 has a drain connected to the third current-to-voltage converter I-V3, while having a source connected to the power supply VDD and having a gate connected in common to the gates of the transistors M5, M6. The p-channel transistors M5, M6 and M7 form a current mirror circuit.

Hence, the current I1 flows through the transistors M1 and M5 to drive the first current-to-voltage converter I-V1 to generate the terminal voltage VA.

In similar manner, the current I2 flows through the transistors M2 and M8 to drive the second current-to-voltage converter I-V2 to generate the terminal voltage VB. The current I2 also flows through the transistor M7 to drive the third current-to-voltage converter I-V3 to generate the terminal voltage Vref.

It is noted that the MOS transistor M7 forms a current mirror circuit with the transistors M5 and M6. It is however also possible to connect the gate of the MOS transistor M7 and the gates of the MOS transistors M8, M9 together so that the MOS transistor M7 forms a current mirror circuit with the MOS transistors M8, M9.

The operation of the present example is now described. In FIG. 25, the currents flowing through the n-channel MOS transistors M1 and M2, connected to the first current-to-voltage converter I-V1 and to the second current-to-voltage converter I-V2, respectively, are compared to each other in the current mirror circuit, composed of the n-channel MOS transistors M3 and M4, via the current mirror circuit, composed of the p-channel MOS transistors M5 and M6 and the current mirror circuit, composed of the p-channel MOS transistors M8 and M9. The common gates of the n-channel MOS transistors M1 and M2 are controlled so that the currents flowing through the n-channel MOS transistors M1 and M2 will be equal to each other.

Thus, the gate-to-source voltages of the n-channel MOS transistors M1 and M2 are equal to each other, and hence the voltage VA applied to the first current-to-voltage converter I-V1 is equal to the voltage VB applied to the second current-to-voltage converter I-V2, thus achieving the operating condition similar to that obtained with the use of the OP amp as described above.

That is, the characteristic similar to that of FIG. 21 may be achieved to implement the reference voltage generating circuit. It is noted that two first current-to-voltage converters I-V1 are used to render the gate-to-source voltages of the n-channel MOS transistors M3 and M4 equal to each other and to render the drain voltages of the n-channel MOS transistors M3 and M4 equal to each other.

Hence, the current I3 proportionate to the current I1 flows through the MOS transistor M7, via the current mirror circuit formed by the p-channel MOS transistors M5, M6 and M7, thereby driving the third current-to-voltage converter I-V3 to generate the terminal voltage Vref.

### EXAMPLE 1-1-4

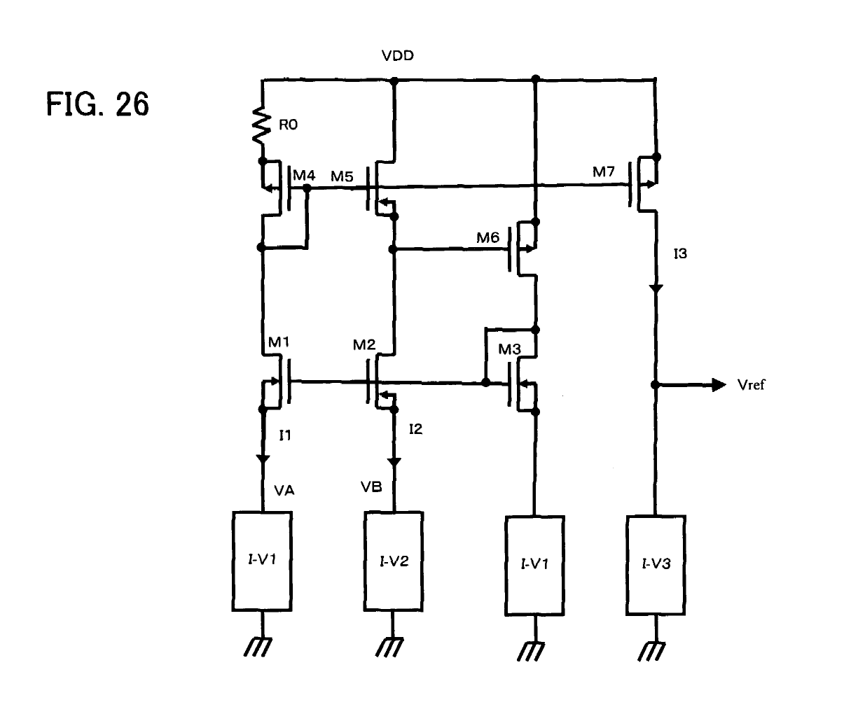

Referring to FIG. 26, a resistor R0 is connected between the source of the p-channel MOS transistor M4 and the power supply VDD, and the p-channel MOS transistor M4 has the gate voltage in common with the p-channel MOS transistor M5. Hence, to allow the equal currents to flow through these transistors, the transistor size of the p-channel MOS transistor M4 is selected to be larger than that of the p-channel MOS transistor M5.

It is noted that the current mirror circuit, formed by the p-channel MOS transistors M4 and M5, forms a reverse Widlar current mirror circuit. This reverse current mirror circuit (M4, M5) reverse-biases the n-channel MOS transistors M1 and M2 to drive the first and second current-to-voltage converters I-V1 and I-V2, respectively. The gate and the drain of the p-channel MOS transistor M3 are connected in common and connected to the gates of the n-channel MOS transistors M1 and M2, with the n-channel MOS transistors M1, M2 and M3 forming a current mirror circuit.

The p-channel MOS transistor M6, driving the n-channel MOS transistor M3, has its gate connected to a drain of the p-channel MOS transistor M5 that forms an output of the reverse Widlar current mirror circuit.

The source of the n-channel MOS transistor M3 is connected to a fourth current-to-voltage converter I-V1 to drive the fourth current-to-voltage converter I-V1. This fourth current-to-voltage converter I-V1 is provided so that the currents flowing through the n-channel MOS transistors M1 to M3 will be equal to one another.

The p-channel MOS transistor M7 has a gate connected in common to the gate of the p-channel MOS transistor M5 to form a current mirror circuit with the p-channel MOS transistor M5. The current I3 flowing through the p-channel MOS transistor M7 drives the third current-to-voltage converter I-V3 to yield the reference voltage Vref on current-to-voltage conversion.

The operation of the present example is now described. When the current flowing through the n-channel MOS transistor M1 is increased, the current flowing through the p-channel MOS transistor M4 is correspondingly increased. However, the current flowing through the p-channel MOS transistor M5 is increased to a greater extent, and hence the n-channel MOS transistor M2 is unable to allow the so increased current to flow therethrough. Thus, the drain voltage of the p-channel MOS transistor M5 increases, thus reducing the current flowing through the p-channel MOS transistor M6 the gate of which is connected to the drain of the p-channel MOS transistor M5. Hence, the current flowing through the n-channel MOS transistor M3 having the drain current in common with the transistor M6 is also decreased.

The n-channel MOS transistor M3 and the n-channel MOS transistor M2 form a current mirror circuit, while the n-channel MOS transistor M1 and the n-channel MOS transistor M2 have the gate voltage in common. Thus, the common gate voltage of the transistors M1 to M3 is decreased and hence the current flowing through the n-channel MOS transistor Ml also decreases.

Thus, the gate-to-source voltages of the n-channel MOS transistors M1 and M2 are equal to each other, and hence the voltage VA applied to the first current-to-voltage converter I-V1 is equal to the voltage VB applied to the second current-to-voltage converter I-V2, thus achieving the operating condition similar to that obtained with the use of the OP amp described above. That is, the characteristic similar to that of FIG. 21 may be achieved to implement the reference voltage generating circuit. It is noted that the first current-to-voltage converters I-V1 operates to render the gate-to-source voltage of the n-channel MOS transistor M3 equal to the drain voltages of the n-channel MOS transistors M1 and M2.

In this manner, the currents I1 and I2 flowing through the n-channel MOS transistors M1 and M2 are controlled to be equal to each other. The current I3 flowing through the p-channel MOS transistor M7 is proportionate to the currents I1 and I2. Hence, the current I3 is supplied to the third current-to-voltage converter I-V3 to yield the terminal voltage Vref.

### EXAMPLE 1-2-1

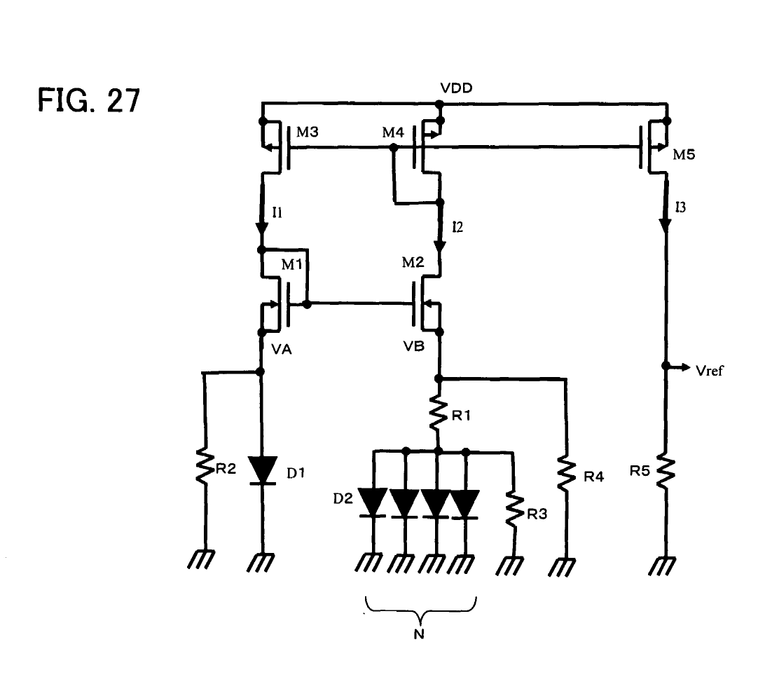

It is now supposed that, in the example as described with reference to FIG. 24, the first current-to-voltage converter I-V1, second current-to-voltage converter I-V2 and the third current-to-voltage converter I-V3 are respectively replaced by the first current-to-voltage converter I-V1 (a parallel circuit of the diode D1 and the resistor R2), second current-to-voltage converter I-V2 (a series circuit of a resistor R1 and a parallel connection of a plurality of diodes D2 and a resistor R3 and a resistor R4 connected in parallel with the series connection) and the third current-to-voltage converter I-V3 (resistor R5) of the basic configuration of FIG. 22 which makes use of the OP amp. This gives a reference voltage circuit in which a current mirror circuit is used in place of the OP amp as control means for controlling preset voltages to be equal to each other. FIG. 27 shows a concrete implementing circuit.

The circuit of FIG. 27 corresponds to the circuit of FIG. 22 in which the OP amp of FIG. 22 is replaced by the current mirror circuit (M1, M2) of FIG. 24. Referring to FIG. 27, the circuit of FIG. 27 includes p-channel MOS transistors M3, M4 and M5 having sources connected to the power supply VDD and having the gates connected together. The MOS transistor M4 has the drain and the gate connected together. The circuit of FIG. 27 further includes an n-channel MOS transistor M1, having its drain and gate connected to the drain of the p-channel MOS transistor M3, and an n-channel MOS transistor M2 having its drain connected to the drain of the p-channel MOS transistor M4. The first current-to-voltage converter I-V1, made up of a parallel connection of a diode D1 and a resistor R2, is connected between the source of the MOS transistor M1 and the ground. The second current-to-voltage converter I-V2, made up of a parallel circuit of a plurality of diodes D2 and a resistor R3, the resistor R1 connected in series with the parallel circuit and the resistor r1 connected with the resulting series connection, is connected between the source of the MOS transistor M2 and the ground. The third current-to-voltage converter I-V3, made up of the resistor R5, is connected between the source of the MOS transistor M5 and the ground.

### EXAMPLE 1-2-2

If, in the example described with reference to FIG. 25, the first current-to-voltage converter I-V1, second current-to-voltage converter I-V2 and the third current-to-voltage converter I-V3 are respectively replaced by the first current-to-voltage converter I-V1, second current-to-voltage converter I-V2 and the third current-to-voltage converter I-V3 of the basic configuration of FIG. 22 that makes use of the OP amp, a reference voltage circuit may be obtained in which a current mirror circuit is used in place of the OP amp as control means for controlling preset voltages to be equal to each other.

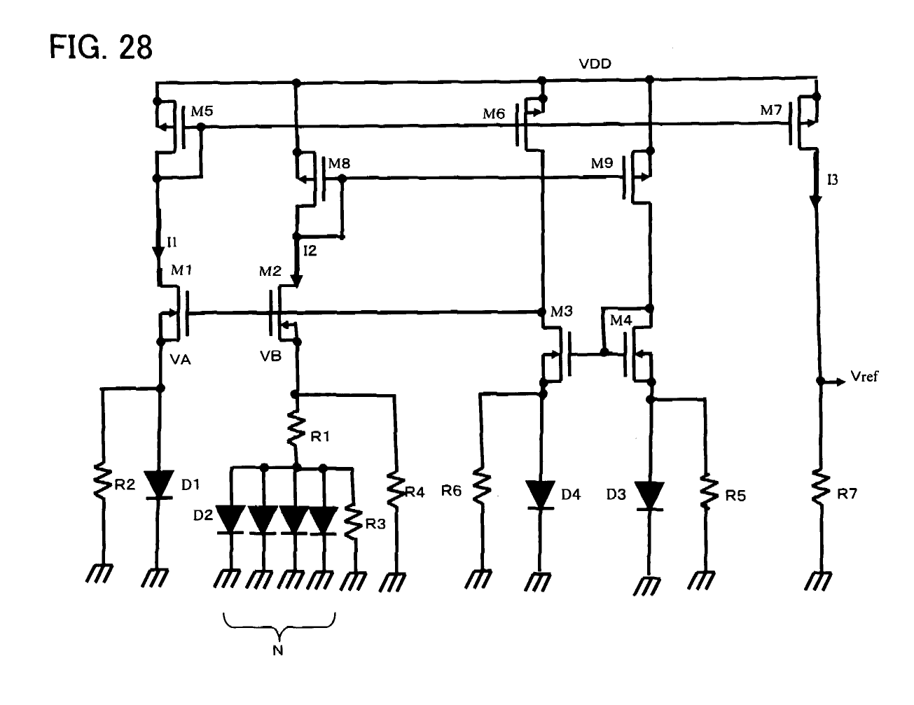

FIG. 28 shows an example of an implemented circuit. Referring to FIGS. 25 and 28, the first current-to-voltage converter I-V1, connected between the source of the transistor M1 and the ground, is made up of a parallel connection of a diode D1 and a resistor R2. Another first current-to-voltage converter I-V1, connected between the sources of the n-channel MOS transistors M3 and M4 and the ground, is made up of a parallel connection of a diode D4 and a resistor R6 and another parallel connection of a diode D3 and a resistor R5. A second current-to-voltage converter I-V2, connected between the source of the n-channel MOS transistor M2 and the ground, is made up of a resistor R4 connected in parallel with a series connection of a resistor R1 and a parallel connection of a plurality of diodes D2 and a resistor R3. A third current-to-voltage converter I-V3, connected between the drain of the p-channel MOS transistor M7 and the ground, is made up of a resistor R7.

### EXAMPLE 1-2-3

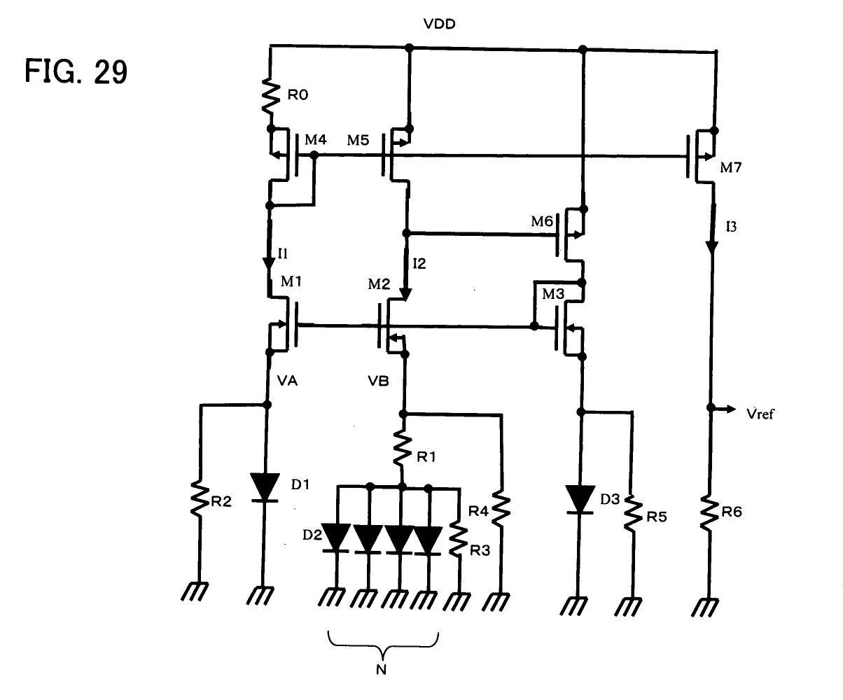

If, in the example described with reference to FIG. 26, the first current-to-voltage converter I-V1, second current-to-voltage converter I-V2 and the third current-to-voltage converter I-V3 are respectively replaced by the first current-to-voltage converter I-V1, second current-to-voltage converter I-V2 and the third current-to-voltage converter I-V3 of the basic configuration of FIG. 22 that makes use of the OP amp, the result is a reference voltage circuit in which a current mirror circuit is used in place of the OP amp as control means for controlling preset voltages to be equal to each other. FIG. 29 shows an example of a concrete circuit. Referring to FIGS. 25 and 29, the first current-to-voltage converter I-V1, connected between the source of the transistor M1 and the ground, is made up of a parallel connection of a diode D1 and a resistor R2. Another first current-to-voltage converter I-V1, connected between the source of the transistor M3 and the ground, is made up of a parallel connection of a diode D3 and a resistor R5. A second current-to-voltage converter I-V2, connected between the source of the transistor M2 and the ground, is made up of a resistor R4 connected in parallel with a series connection of a resistor R1 and a parallel connection of a plurality of diodes D2 and a resistor R3. A third current-to-voltage converter I-V3, connected between the drain of the p-channel MOS transistor M7 and the ground, is made up of a resistor R7.

### EXAMPLE 2

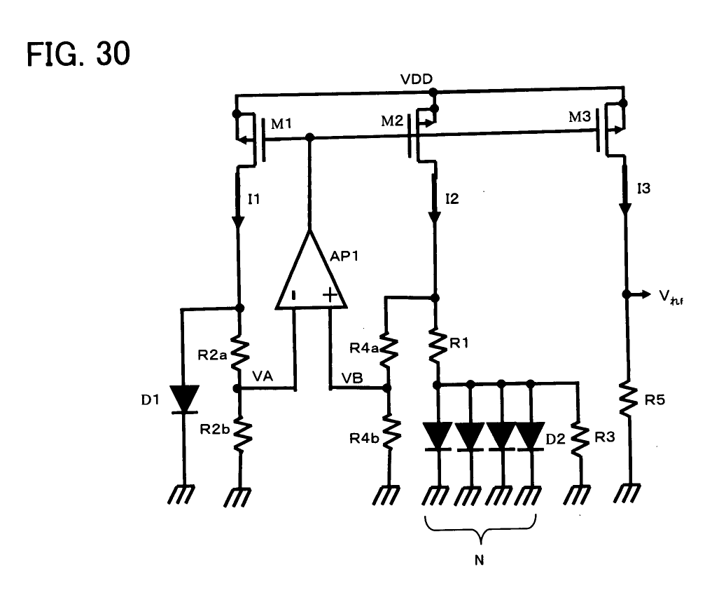

FIG. 30 shows a circuit the configuration of an example of a CMOS reference voltage generating circuit which is the subject-matter of claim 2.

Referring to FIG. 30, the present example is the example of FIG. 21 in which the first current-to-voltage converter I-V1 is a parallel connection of a diode D1 and a series connection of resistors R2a and R2b. An intermediate terminal voltage of the resistors R2a and R2b in a branch of the parallel connection represents a preset output voltage. The second current-to-voltage converter I-V2 is made up of a series circuit of a resistor R1 and a parallel connection of a plurality of diodes D2 and a resistor R3 and resistors R4a, R4b connected in parallel with the series connection to form a composite parallel circuit. An intermediate terminal voltage of the resistors R4a and R4b in a branch of the parallel connection represents another preset output voltage. The third current-to-voltage converter I-V3 is made up solely of a resistor R5.

It is noted however that the first current-to-voltage converter I-V1 and the second current-to-voltage converter I-V2 differ from each other as to the number of the diodes. The ratio of the numbers of the parallel-connected diodes or bipolar transistors connected as diodes of the first current-to-voltage converter I-V1 and the second current-to-voltage converter I-V2, compared to the first current-to-voltage converter I-V1, is here set to 1:N. More specifically, it is contemplated that the first current-to-voltage converter I-V1 includes a sole diode and that the second current-to-voltage converter I-V2 includes a parallel connection of two to four diodes D2.

With the present example, it is possible to lower the input voltage of the OP amp (API) of FIG. 22. Referring to FIG. 30, the resistor R2, connected in parallel with the diode D1 of FIG. 22, is divided into R2a and R2b. Similarly, the resistor R4 in a branch of the parallel connection is divided to R4a and R4b. The intermediate terminals of the resistance-divided voltages VA and VB are respectively connected to the inverting input terminal (−) and the non-inverting input terminal (+) for lowering the input voltage to the OP amp (AP1).

If R3a+R3b=R3 (50)

and

R6a+R6b=R6 (51)

and if the voltage-dividing ratio is set in such a way that

R3a/R3b=R6a/R6b (52)

holds, the present example is not vitally different in circuit operation from the example of FIG. 22. Hence, the reference voltage Vref similar to that of FIG. 22 may be obtained.

### EXAMPLE 3

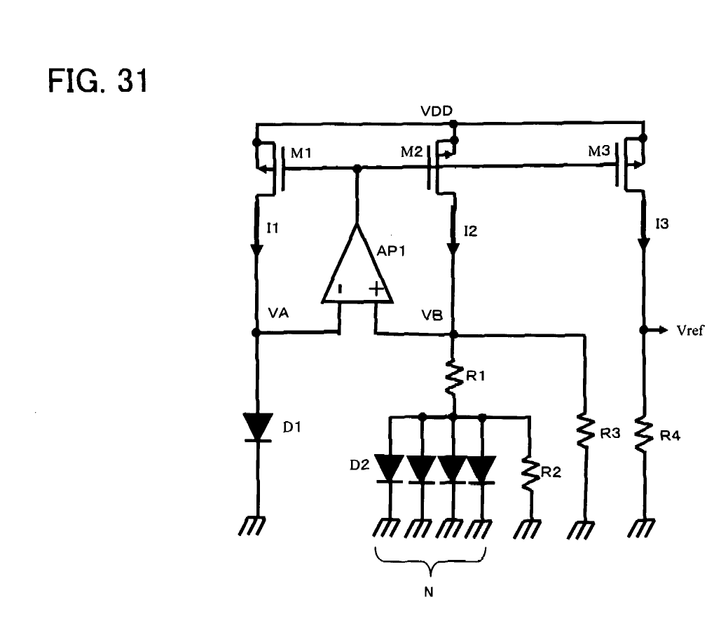

FIG. 31 shows a circuit configuration of an example of a CMOS reference voltage generating circuit which is the subject-matter of claim 3. The configuration of FIG. 31 corresponds to the configuration of FIG. 21 in which the first current-to-voltage converter I-V1 is made up only of a diode D1, the second current-to-voltage converter I-V2 is composed of a parallel connection of a plurality of diodes D2 and a resistor R2, a resistor R1 connected in series with the parallel connection and a resistor R3 connected in parallel with the resulting series connection to form a composite parallel circuit. The third current-to-voltage converter I-V3 is made up solely of a resistor.

It is noted however that the first current-to-voltage converter I-V1 and the second current-to-voltage converter I-V2 differ from each other as to the number of the diodes. The ratio of the numbers of the parallel-connected diodes or bipolar transistors connected as diodes of the first current-to-voltage converter I-V1 and the second current-to-voltage converter I-V2, compared to the first current-to-voltage converter I-V1, is here set to 1:N. More specifically, it is contemplated that the first current-to-voltage converter I-V1 includes a sole diode D1 and that the second current-to-voltage converter I-V2 includes a parallel connection of two to four diodes D2.

In FIG. 27, the p-channel MOS transistors M1, M2 and M3, having sources connected together to the power supply VDD and having gates connected together, form a current mirror circuit. The common gate voltage of the p-channel MOS transistors M1, M2 and M3 is controlled by the OP amp (AP1) so that two input terminal voltages of the OP amp will be equal to each other. This determines the currents I1 to I3 flowing through the current mirror circuit.

If, in FIG. 31, the forward voltages of the diodes D1 and D2 (or bipolar transistors connected as diodes) are labeled VF1 and VF2, the two input terminal voltages are controlled by the OP amp (AP1) so as to be equal to each other (VA=VB).

If the output currents (drain currents) I1, I2 and I3, from the current mirror circuits M1, M2 and M3, are equal to one another, then

I1=I2=I3 (53)

The current I1 flows through the diode D1. The current I2 is divided into a current I2A that flows through N-number of diodes D2, connected in parallel with one another, a current I2B that flows through the resistor R2 connected in parallel therewith and into current I2C that flows through the parallel-connected resistor R3.

Hence,

I2=I2A+I2B+I2C (54)

where

I2B=VF2/R2 (55)

and

I2C=VF1/R3 (56)

Putting

Δ VF=VF1−VF2 (57)

then

I2=VF1/R3+Δ VF/R1 (58)

The resulting reference voltage Vref is expressed by

Vref=R4I3=(R4/R3){VF1+(R3/R1)Δ VF} (59)

It is sufficient to set to R4/R3<1 in the equation (59) and to set the value of R3/R1 and to set the value of R3/R1 so that, within the braces { }, the temperature characteristic will be compensated by VF1 having a negative temperature characteristic and by Δ VF having a positive temperature characteristic.

The following equation now holds:

$$Δ {V}_{F} = {V}_{T} ln \{ \frac{N}{1 - ( \frac{{V}_{F 1}}{{I}_{1} {R}_{3}} + \frac{{V}_{F 2}}{{I}_{1} {R}_{2}} )} \} \qquad ( 60 )$$

Δ VF does not possess a linear positive temperature characteristic. The denominator within the braces { } of ln { } is a function having a positive temperature characteristic, such that { } has a negative temperature characteristic. Further, as a result of logarithmically compression, Δ VF does not possess a linear positive temperature characteristic but its value is increased and decreased at lower temperature and higher temperature, respectively.

Thus, in the equation (59), the term within the braces { } may be set so that the temperature non-linearity proper to a diode will be compensated by Δ VF.

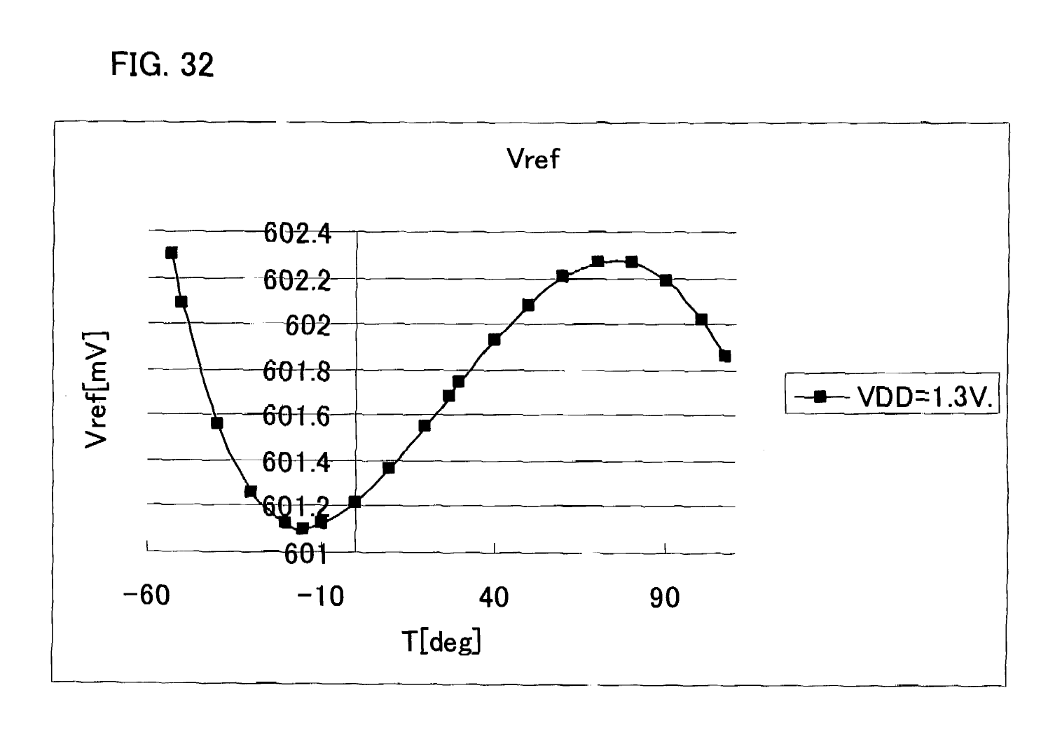

FIG. 32 shows actual simulated values. For VDD=1.3V, N=4, R1=1.2405 kΩ, R2=20 kΩ, R3=100 kΩ and R4=10 kΩ were set. In this case, the values of Vref were 602.3 mV, 601.123 mV, 601.215 mV, 601.683 mV and 601.856 mV for −53° C., −10° C., 0° C., 27° C. and 107° C., respectively, with the curve of Vref being of an undulating shape. The width of temperature variations was suppressed to slightly less than 0.2%.

### EXAMPLE 3-1

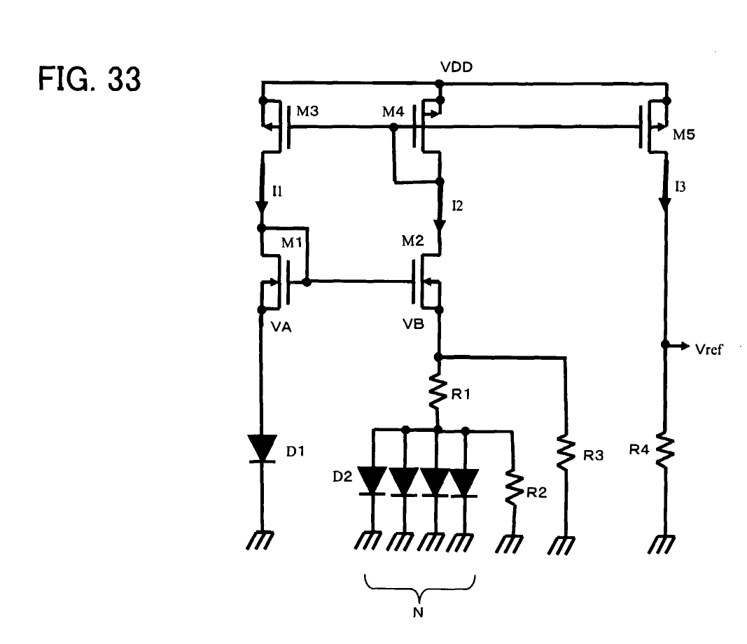

In the example described with reference to FIG. 31, there may be obtained a reference voltage circuit in which a current mirror circuit is used in place of the OP amp as control means for exercising control so that the preset voltages will be equal to each other. FIG. 33 shows an example of an actually implemented circuit. In FIG. 33, a current mirror circuit (M1, M2) is used in place of the OP amp of FIG. 31.

### EXAMPLE 3-2

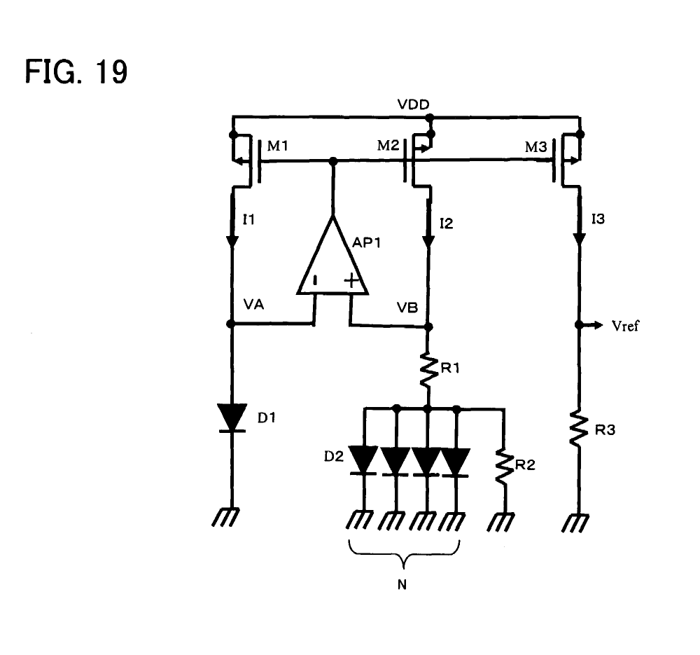

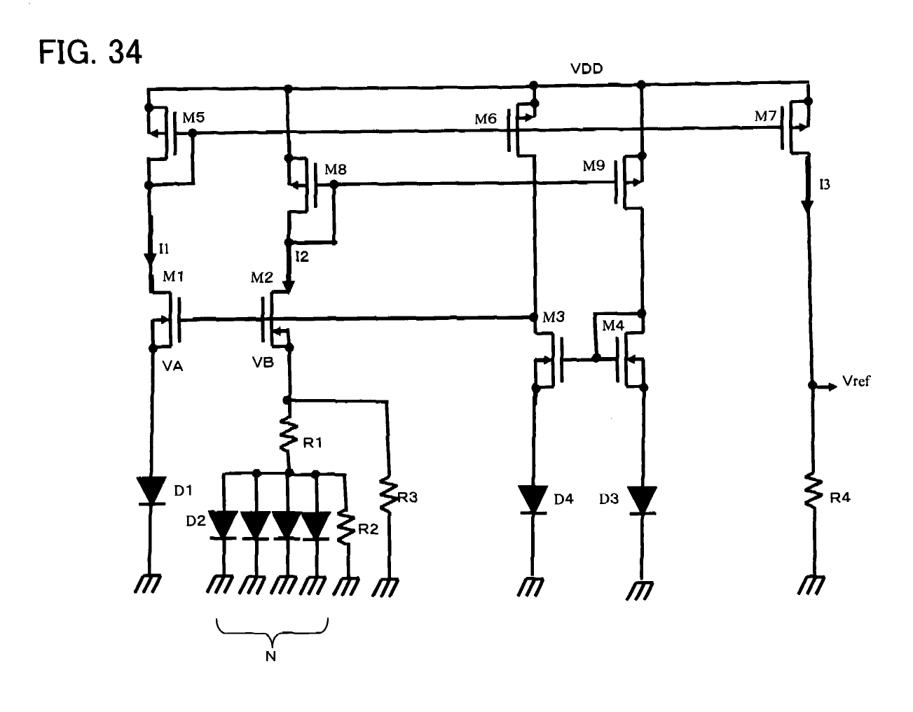

If, in the example described with reference to FIG. 31, the first current-to-voltage converter I-V1, second current-to-voltage converter I-V2 and the third current-to-voltage converter I-V3 are respectively replaced by the first current-to-voltage converter I-V1, second current-to-voltage converter I-V2 and the third current-to-voltage converter I-V3 of the basic configuration of FIG. 19 that makes use of the OP amp as control means, the result is a reference voltage circuit in which a current mirror circuit is used in place of the OP amp as control means for controlling preset voltages to be equal to each other. FIG. 34 shows an actual implementing circuit.

The circuit the configuration of FIG. 34 is now described. A first current-to-voltage converter I-V1, connected between the source of the transistor M1 and the ground in FIG. 25, is composed of a diode D1. Another first current-to-voltage converter I-V1, connected between the sources of the transistors M3 and M4 and the ground, is made up of diodes D4 and D3. A second current-to-voltage converter I-V2, connected between the source of the transistor M2 and the ground, is made up of a parallel connection of a plurality of diodes D2 and a resistor R2, a resistor R1 connected in series with the parallel connection, and a resistor R3 connected in parallel with the resulting series connection. A third current-to-voltage converter I-V3, connected between the drain of the transistor M7 and the ground, is composed of a resistor R4.

### EXAMPLE 3-3

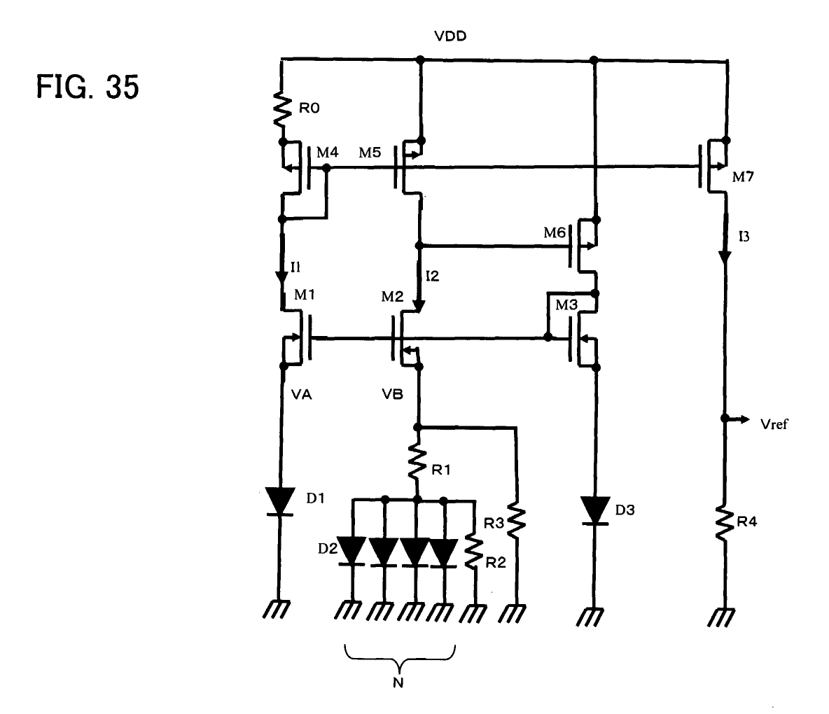

If, in the example described with reference to FIG. 31, the first current-to-voltage converter I-V1, second current-to-voltage converter I-V2 and the third current-to-voltage converter I-V3 are respectively replaced by the first current-to-voltage converter I-V1, second current-to-voltage converter I-V2 and the third current-to-voltage converter I-V3 of the basic configuration of FIG. 19 that makes use of the OP amp as control means, the result is a reference voltage circuit in which a current mirror circuit is used in place of the OP amp as control means for controlling preset voltages to be equal to each other. FIG. 35 shows an actual implementing circuit.

Referring to FIG. 35, the present example includes, in the configuration of FIG. 26 including a reverse Widlar current mirror circuit (M4, M5), a first current-to-voltage converter I-V1, another first current-to-voltage converter I-V1, a second current-to-voltage converter I-V2 and a third current-to-voltage converter I-V3. The first current-to-voltage converter I-V1 is connected between the source of the transistor M1 and the ground, and is composed of a diode D1. The other first current-to-voltage converter I-V1 is connected between the source of the transistor M3 and the ground, and is composed of a diode D3. The second current-to-voltage converter I-V2 is connected between the source of the transistor M2 and the ground, and is composed of a parallel connection of a plurality of diodes d2 and a resistor R2, a resistor R1 connected in series with the parallel connection, and a resistor R3 connected in parallel with the resulting series connection. The third current-to-voltage converter I-V3 is connected between the drain of the transistor M7 and the ground, and is composed of a resistor R4.

### EXAMPLE 4

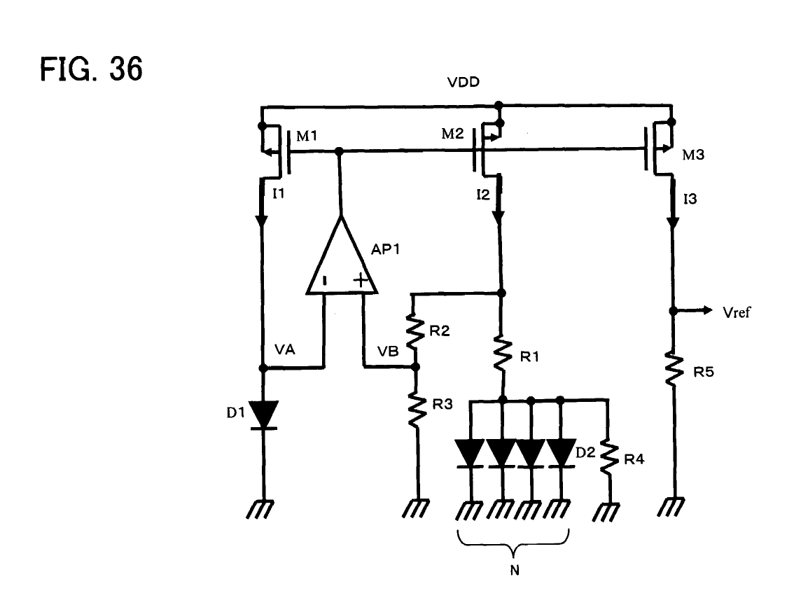

FIG. 36 is a circuit diagram showing the circuit configuration of an example of a CMOS reference voltage generating circuit which forms the subject-matter of claim 4. Referring to FIG. 36, the present example includes, in the configuration of FIG. 21, a first current-to-voltage converter I-V1, made up of a diode D1, and a second current-to-voltage converter I-V2, made up of a parallel connection of a plurality of diodes D2 and a resistor R4, a resistor R1 connected in series with the parallel connection, and a resistor (R2, R3) connected in parallel with the resulting series connection to provide a composite parallel circuit. The present example further includes a third current-to-voltage converter I-V3 made up only of a resistor.

It is noted however that the first current-to-voltage converter I-V1 and the second current-to-voltage converter I-V2 differ from each other as to the number of the diodes. The ratio of the numbers of the parallel-connected diodes or bipolar transistors connected as diodes of the first current-to-voltage converter I-V1 and the second current-to-voltage converter I-V2, compared to each other, is here set to 1:N. More specifically, it is contemplated that the first current-to-voltage converter I-V1 is made up of a sole diode D1 and that the second current-to-voltage converter I-V2 is made up of a parallel connection of two to four diodes D2.

If, in FIG. 36, the forward voltages of the diodes D1 and D2 (or bipolar transistors connected as diodes) are labeled VF1 and VF2, the two input terminal voltages are controlled by the OP amp (AP1) to be equal to each other (VA=VB).

If assumed that the output currents I1, I2 and I3 from the current mirror circuits M1, m2 and M3 are equal to one another, then

I1=I2=I3 (61)

The current I1 flows through the diode D1. The current I2 is divided into a current I2A flowing through the parallel-connected N-number of diodes D2, a current I2B flowing through the resistor R4 connected in parallel therewith, and a current I2C flowing through the resistors (R2+R3) in a branch of the parallel connection. Hence,

I2=I2A+I2B+I2C (62)

where

I2B=VF2/R2 (63)

and

I2C=VF1/R3 (64)

Putting

Δ VF=VF1−VF2 (65)

we obtain

$${I}_{2} = \frac{{V}_{F 1}}{{R}_{3}} + \frac{( \frac{{R}_{2} + {R}_{3}}{{R}_{3}} ) {V}_{F 1} - {V}_{F 2}}{{R}_{1}} = \frac{{R}_{1} + {R}_{2}}{{R}_{1} {R}_{3}} {V}_{F 1} + \frac{Δ {V}_{F}}{{R}_{1}} \qquad ( 66 )$$

Hence, the reference voltage obtained Vref may be expressed by

$$Vref = {R}_{5} {I}_{3} = \frac{{R}_{5} ( {R}_{1} + {R}_{5} )}{{R}_{1} {R}_{3}} \{ {V}_{F 1} + \frac{{R}_{3}}{{R}_{1} + {R}_{2}} Δ {V}_{F} \} \qquad ( 67 )$$

It is sufficient if R5(R1+R2)/(R1R3)<1 is set in the equation (67) and the value of R3/(R1+R2) in a term within the braces { } is set so that temperature characteristic will be compensated by VF1 having a negative temperature characteristic and Δ V_{F} having a positive temperature characteristic.

Since

$$Δ {V}_{F} = {V}_{T} ln \{ \frac{N}{1 - ( \frac{{V}_{F 1}}{{I}_{1} {R}_{3}} + \frac{{V}_{F 2}}{{I}_{1} {R}_{4}} )} \} \qquad ( 68 )$$

Δ V_{F} does not possess a linear positive temperature characteristic. The denominator within the braces { } of ln { } is a function having a positive temperature characteristic, such that { } has a negative temperature characteristic. Further, as a result of logarithmic compression. Δ V_{F} does not possess a linear positive temperature characteristic but its value is increased and decreased at lower temperature and higher temperature, respectively.

Thus, in the equation (67), the term within the braces { } may be set so that the temperature non-linearity proper to a diode will be compensated by Δ V_{F}.

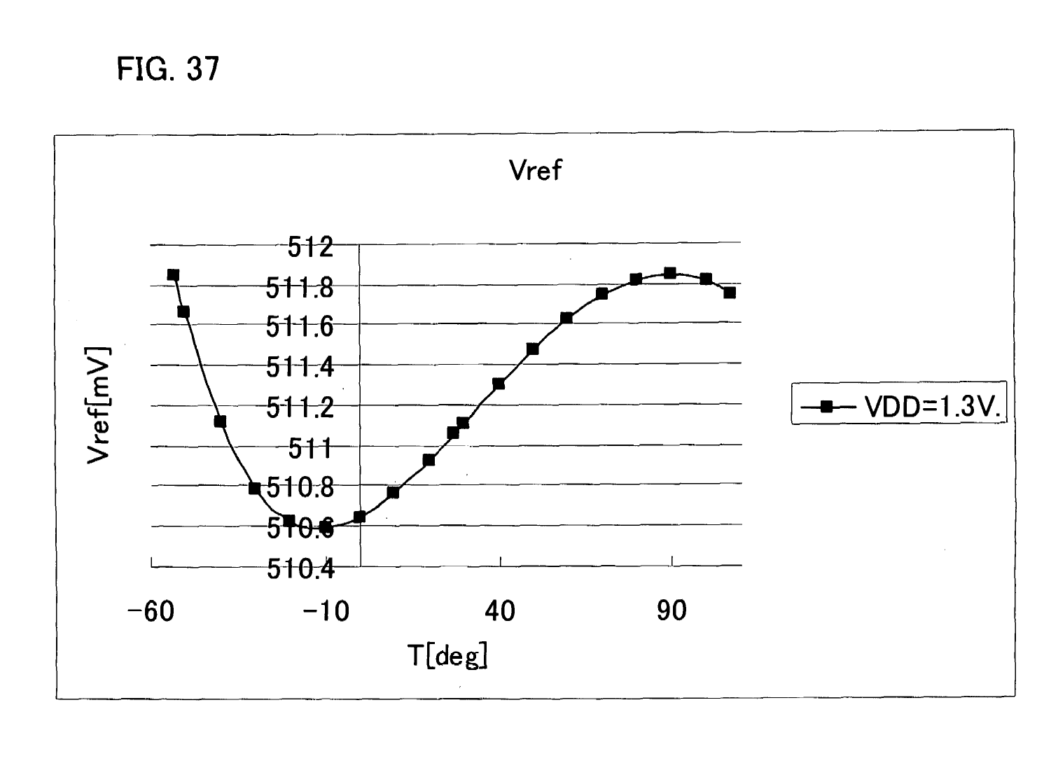

FIG. 37 shows actual simulated values. For VDD=1.3V, N=6, R1=1.829 kΩ, R2=10 kΩ, R3=500 kΩ, R4=20 kΩ and R5=10 kΩ were set. In this case, the values of Vref were 511.85 mV, 510.589 mV, 510.645 mV, 511.06 mV and 511.75 mV for −53° C., −10° C., 0° C., 27° C. and 107° C., respectively, with the curve of Vref being of an undulating shape. The width of temperature variations was suppressed to slightly less than 0.25%.

### EXAMPLE 5

In the description, made thus far, the first current-to-voltage converter I-V1 and the second current-to-voltage converter I-V2 are each made up of a diode(s) or bipolar transistor(s) connected as diode(s).

However, if it is possible to construct a bipolar transistor, as a three-terminal device, having a base, a collector and an emitter isolated from one another, the first current-to-voltage converter I-V1 and the second current-to-voltage converter I-V2 may be of a non-linear current mirror configuration with common base connection.

That is, the third generation reference voltage circuit may be implemented as the non-linear current mirror circuit that includes first and second bipolar transistors is self-biased by a linear current mirror circuit. Or, the third-generation reference voltage circuit may be implemented as the non-linear current mirror circuit that includes first and second bipolar transistors is reciprocally biased by a non-linear current mirror circuit. However, for simplicity, solely the third generation reference voltage circuit, implemented by self-biasing the non-linear current mirror circuit that includes first and second bipolar transistors with the linear current mirror circuit, is here described.

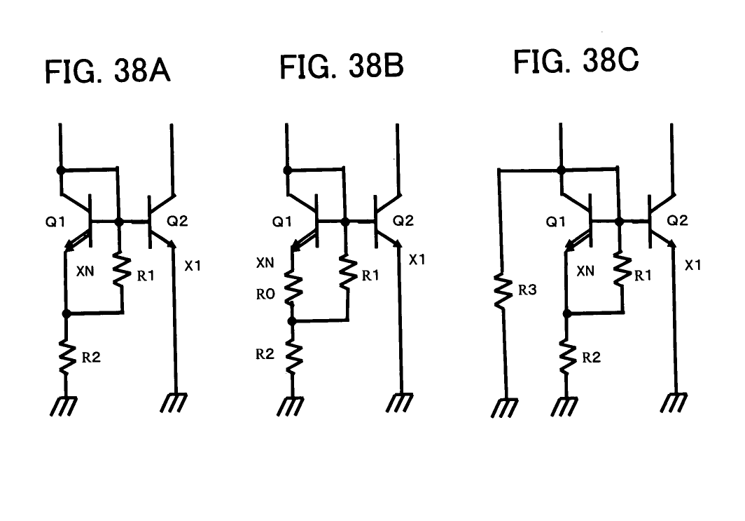

FIGS. 38A to 38C are circuit diagrams for illustrating the configuration of a non-linear current mirror circuit that includes first and second bipolar transistors configured for forming the reference voltage generating circuit which is to form the subject-matter of claim 8.

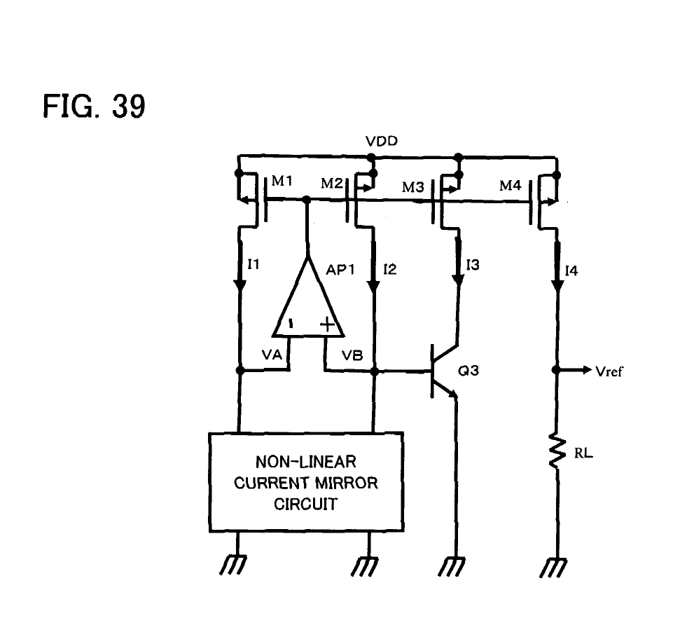

FIG. 39 is a circuit diagram showing the circuit configuration of an example of the reference voltage generating circuit which is to form the subject-matter of claim 8.

The non-linear current mirror circuit of FIG. 38A includes an npn bipolar transistor Q1, having an emitter area N times that of a unit transistor, and an npn bipolar transistor Q2 (unit transistor). The npn bipolar transistor Q1 has a collector and a base connected together and has an emitter grounded via resistor R2. The npn bipolar transistor Q1 includes a resistor R1 connected between its base and emitter. The npn bipolar transistor Q2 has a base connected to the base of the transistor Q1 and has an emitter grounded.

The non-linear current mirror circuit of FIG. 38B corresponds to the configuration of FIG. 38A but is added by a resistor R0. The emitter of the transistor Q1 is grounded via series connected resistors R0 and R2. The resistor R1, having one end connected to the base of the transistor Q1, has its opposite end connected to a junction point between the resistors R0 and R2.

The configuration of FIG. 38C corresponds to the configuration of FIG. 38A but is added by a resistor R3 which is connected between the collector of the transistor Q1 and the ground.

The circuit configuration, shown in FIGS. 38A to 38C, is termed the reverse Widlar current mirror circuit by the present inventor.

The present application provides a reference voltage circuit compensated for temperature non-linearity proper to the base-to-emitter voltage VBE of a bipolar transistor. Hence, a resistor is further added on the side of the bipolar transistor Q1 of the reverse Widlar current mirror circuit connected as a diode (input side). Basically, a resistor R1 is connected between the base and the emitter of the bipolar transistor Q1.

The circuits of FIGS. 38A and 38C are used in the form described above. However, with the circuit of FIG. 38B, an emitter resistor R0, though redundant, is added. If, in FIG. 38B, the emitter resistor R0 is zeroed for shorting, the resulting circuit is the same as the circuit of FIG. 38A. Further, in FIG. 38C, a resistor R3 is grounded from the base (collector).

To construct a reference voltage circuit, with the use of the non-linear current mirror circuit, shown in FIGS. 38A to 38C, it is sufficient to add a bipolar transistor Q3 composed of an emitter-grounded unit transistor, which has its base connected to the collector of the bipolar transistor Q2, not shown, within the non-linear current mirror circuit, and to self-bias the three bipolar transistors Q1 to Q3.

The circuit shown in FIG. 39 is a 1:1:1 current mirror circuit, made up of MOS transistors M1, M2 and M3, having sources connected together to the power supply VDD and having gates connected together. These MOS transistors M1 to M3 drive the bipolar transistors Q1 to Q3, respectively.

The common gates of the MOS transistors M1, M2 and M3 are connected to an output of the OP amp (AP1). The inverting input terminal (−) and the non-inverting input terminal (+) of the OP amp (AP1) are connected to an input terminal and to an output terminal of the non-linear current mirror circuit, respectively. The input terminal is the base (collector) of the bipolar transistor Q1, while the output terminal is the collector of the bipolar transistor Q2 (base of the bipolar transistor Q3).

Even if, in FIG. 38A, the collector current IC1 of the bipolar transistor Q1, connected as diode, is increased to some extent, the base-to-emitter voltage VBE1, logarithmically compressed, is changed only slightly. Hence, the current through resistor R1, proportionate to VBE1, remains substantially constant.

If it is assumed that the d.c. current amplification factor hFE of the bipolar transistor Q1 is high and that the base current is negligible, the collector current IC1 and the current flowing through the resistor R1, summed together, flow through the resistor R2. Hence, the base-to-emitter voltage VBE2 of the emitter-grounded bipolar transistor Q2 is increased to some extent, so that a high collector current IC2 flows. This operation is similar to the known input/output current characteristic of the reverse Widlar current mirror circuit.

In FIG. 38B, including the resistor R0, the circuit operation is approximately the same.

In FIG. 38C, the non-linear current mirror circuit, shown in FIG. 38A, further includes the resistor R3 connected to the base and grounded. The current flowing through the resistor R3 is proportionate to the base-to-emitter voltage VBE2 of the bipolar transistor Q2, such that, when the base-to-emitter voltage VBE2 of the bipolar transistor Q2 becomes slightly higher, the current through the resistor R3 is increased only slightly correspondingly. Yet, the current as the collector current IC2 is increased. This operation is similar to the input/output characteristic of the known reverse Widlar current mirror circuit.

To construct the reference voltage circuit with the use of the non-linear current mirror circuit, shown in FIGS. 38A, 38B and 38C, it is sufficient to add a bipolar transistor Q3, which is an emitter-grounded unit transistor that has a base connected to the collector of the bipolar transistor Q2, and to self-bias these three bipolar transistors, as shown in FIG. 39. In the configuration of FIG. 39, an equal value of the current is caused to flow through the bipolar transistors Q2 and Q3 to render the base-to-emitter voltages VBE2 and VBE3 equal to each other.

In FIG. 39, the common gates of the MOS transistors M1 to M4 are connected to the output of the OP amp (AP1). The inverting input terminal (−) and the non-inverting input terminal (+) of the OP amp (AP1) are controlled so that the input terminal voltage of the non-linear current mirror circuit will be equal to its output terminal voltage. It is noted that the input terminal voltage of the non-linear current mirror circuit is the terminal voltage of the base (collector) of the bipolar transistor Q1, while the output terminal of the non-linear current mirror circuit is the terminal voltage of the collector of the bipolar transistor Q2 or the terminal voltage of the base of the bipolar transistor Q3.

Hence,

VA=VB (69)

and the output currents I1 to I4 of the 1:1:1:1 current mirror circuit, composed of the MOS transistor circuits M1 to M4, are equal to one another, that is,

I1=I2=I3=I4 (70)

### EXAMPLE 5-1

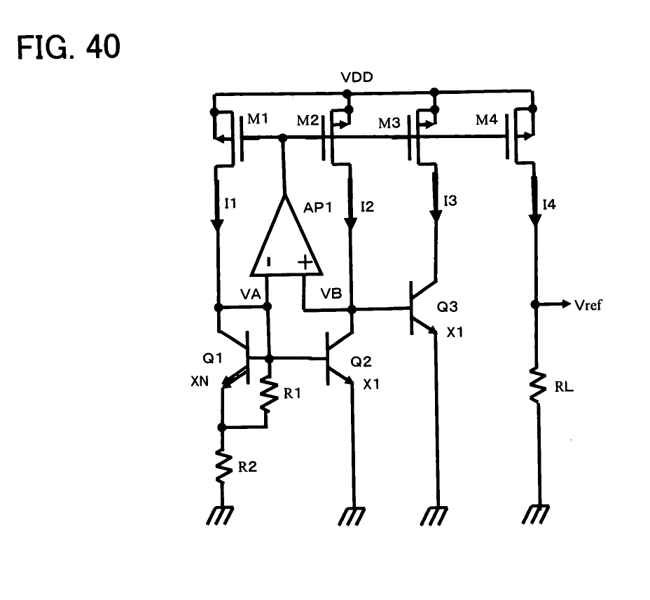

If the configuration of FIG. 38A is used as a non-linear current mirror circuit in FIG. 39, the circuit shown in FIG. 40 is obtained.

In FIG. 40, the collector currents IC1 and IC2 of the bipolar transistors Q1 and Q2 are respectively expressed by

$$\begin{matrix}{I}_{C 1} = {NI}_{s} exp ( \frac{{V}_{BE 1}}{{V}_{T}} ) \\ and by & ( 71 ) \\ {I}_{C 2} = {I}_{s} exp ( \frac{{V}_{BE 2}}{{V}_{T}} ) = {I}_{2} & ( 72 )\end{matrix}$$

where IS denotes the saturation current and V_{T} denotes the thermal voltage.

The output current I1 of the MOS transistor M1 is given by I1=IC1+VBE1/R1.

From the output current I2 of the MOS transistor M1 (I2=IC2), the difference Δ VBE between the base-to-emitter voltage VBE2 of the bipolar transistor Q2 and the base-to-emitter voltage VBE1 of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1}}{{R}_{1} {I}_{1}}} ) = {R}_{2} {I}_{1}\end{matrix} \qquad ( 73 )$$

Since V_{BE2}=V_{BE1}+R₂I₁ from FIG. 40, Δ VBE=R2I1 of the equation (73) holds.

In the equation (73), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−VBE1/(I₁R₁)}.

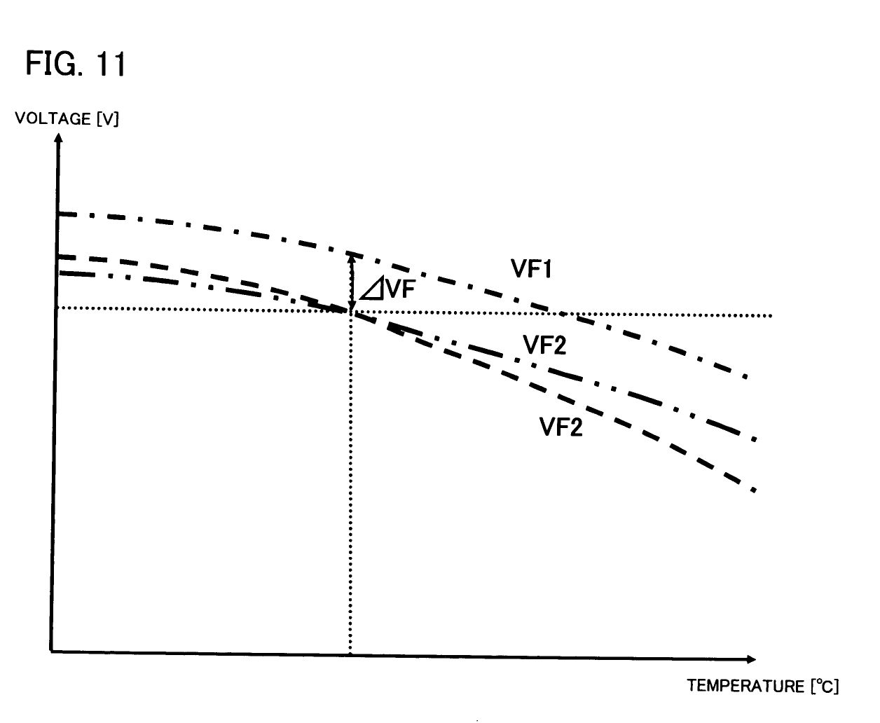

That is, since the term of ln is changed with temperature, the temperature characteristic of Δ V_{F}, shown by the equation (73), has a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₄=(R_{L}/R₂)Δ V_{BE} (74)

It may thus be expected that characteristic equivalent to that of the reference voltage circuit shown in FIG. 22 may be obtained. The reference voltage, compensated for temperature non-linearity proper to a transistor, may be obtained from the opposite side terminal of the resistor R2 (the terminal distinct from the grounded terminal) as well.

### EXAMPLE 5-2

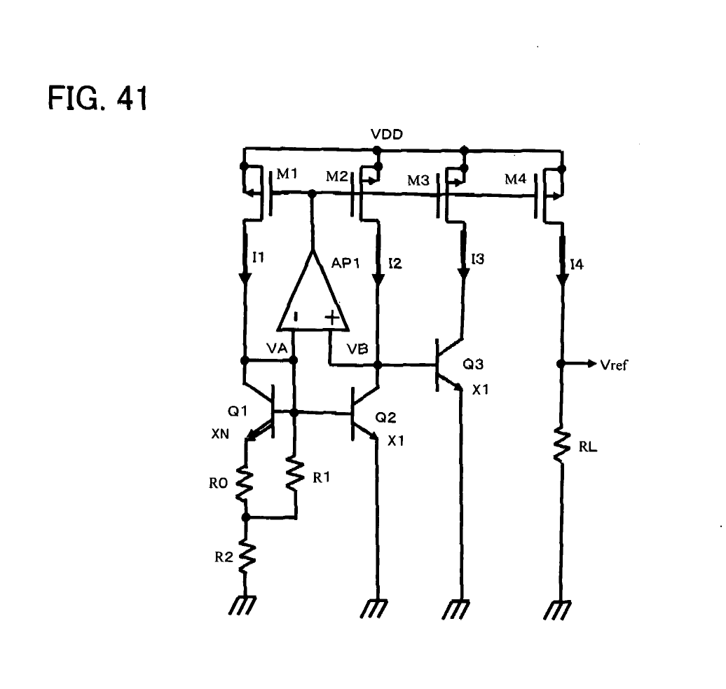

In similar manner, if the configuration of FIG. 38B is used as the non-linear current mirror circuit in FIG. 39, the configuration of FIG. 41 may be obtained.

With the present example, the collector currents IC1 and IC2 of the bipolar transistors Q1 and Q2 are given by the equations (71) and (72), respectively. The output current I1 from the MOS transistor M1 is given by

I₁=I_{C1}+(V_{BE1}+R₀I_{C1})/R₁ (75)

From the output current I2 from the MOS transistor M1 such that I2=I_{C2}, the difference Δ V_{BE} between the base-to-emitter voltages V_{BE2} Of the bipolar transistor Q2 and the base-to-emitter voltages V_{BE1} of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) = {V}_{T} ln ( \frac{N}{1 - \frac{{V}_{BE 1} + {R}_{0} {I}_{C 1}}{{R}_{1} {I}_{1}}} ) \\ = {R}_{2} {I}_{1} + {R}_{0} {I}_{C 1}\end{matrix} \qquad ( 76 )$$

In the equation (75), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−(V_{BE1}+R₀I_{C1})/(R₁I₁)}.

That is, since the term of ln is changed with temperature, the temperature characteristic of Δ VF, shown by the equation (75), includes a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₄=(R_{L}/R₂)(Δ V_{BE}−R₀I_{C1}) (77)

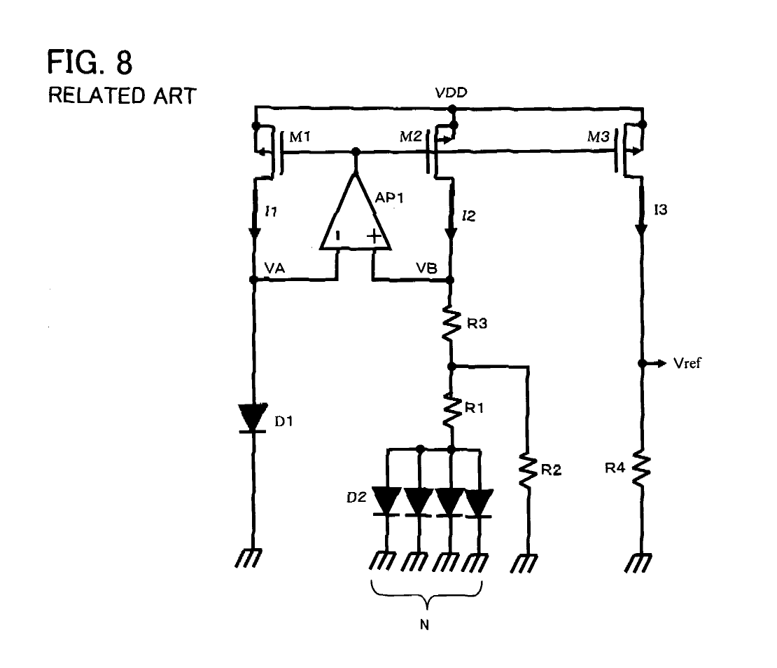

It may thus be expected that characteristic equivalent to that of the reference voltage circuit shown in FIG. 8 may be obtained. The reference voltage, compensated for temperature non-linearity proper to a transistor, may be obtained from the opposite side terminal of the resistor R2 (the terminal distinct from the grounded terminal) as well.

### EXAMPLE 5-3

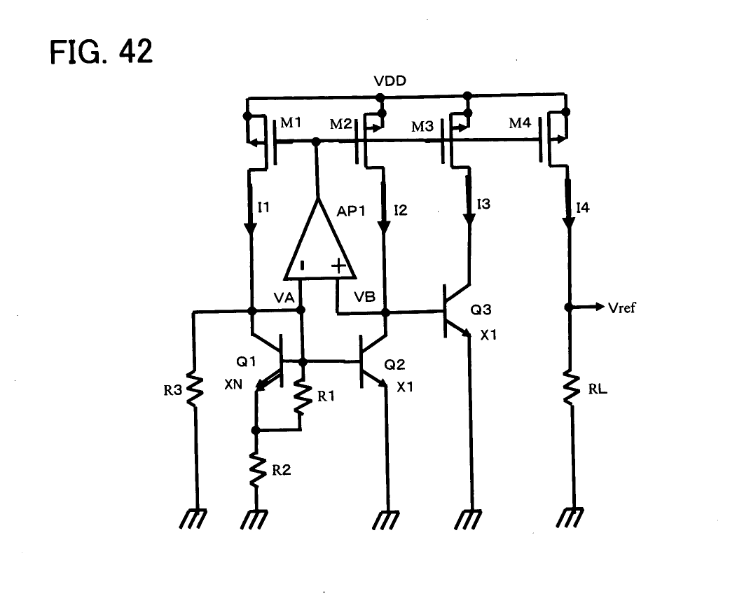

In similar manner, if the configuration of FIG. 38C is used as a non-linear current mirror circuit in FIG. 39, the configuration of FIG. 42 may be obtained. The collector currents IC1 and IC2 of the bipolar transistors Q1 and Q2 may be given by the equations (71), (72), respectively. The output current I1 of the MOS transistor M1 is expressed by

$${I}_{1} = {I}_{C 1} + \frac{{V}_{BE 1}}{{R}_{1}} + \frac{{V}_{BE 2}}{{R}_{3}} \qquad ( 78 )$$

with the output current I2 from the MOS transistor M1 being IC2. Thus, the difference Δ V_{BE} between the base-to-emitter voltage V_{BE2} of the bipolar transistor Q2 and the base-to-emitter voltage V_{BE1} of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1}}{{R}_{1} {I}_{1}} - \frac{{V}_{BE 2}}{{R}_{3} {I}_{1}}} ) \\ = {R}_{2} ( {I}_{1} - \frac{{V}_{BE 2}}{{R}_{3}} )\end{matrix} \qquad ( 79 )$$

Hence, the reference voltage Vref obtained may be found as

$$Vref = {R}_{L} {I}_{4} = \frac{{R}_{L}}{{R}_{3}} ( {V}_{BE 2} + \frac{{R}_{3}}{{R}_{2}} Δ {V}_{BE} ) \qquad ( 80 )$$

It is sufficient to set R4/R3<1 in the equation (80) and to set the value of R3/R1 so that, within the braces { }, the temperature characteristic will be compensated by V_{BE2} having a negative temperature characteristic and by Δ V_{BE} having a positive temperature characteristic.

Δ V_{BE} does not possess a linear positive temperature characteristic, as indicated by the equation (79). The denominator within the braces { } of ln { } is a function having a positive temperature characteristic, such that { } has a negative temperature characteristic. Further, Δ V_{BE} is logarithmically compressed. Δ V_{BE} does not possess a linear positive temperature characteristic but its value is increased and decreased at lower temperature and higher temperature, respectively.

Thus, in the equation (80), it is sufficient to set the term within the braces { } so that temperature non-linearity proper to V_{BE2} will be compensated by Δ V_{BE}.

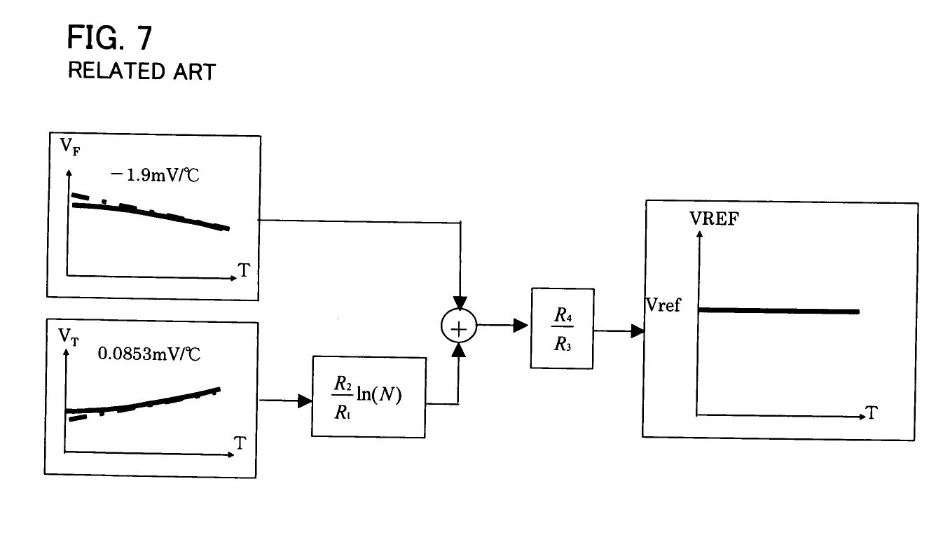

Also, the temperature characteristic of Δ V_{BE}, shown by the equation (79), has a second-order coefficient, and is of a positive temperature characteristic having the PTAT line shown in FIG. 7 as an asymptotic line.

It may thus be expected that characteristic equivalent to that of the reference voltage circuit shown in FIG. 31 may be obtained.

### EXAMPLE 6

If, in the non-linear current mirror circuit, none of the terminal voltages is arbitrary (indefinite), the bipolar transistor Q3, shown in FIG. 39, is redundant and may be dispensed with.

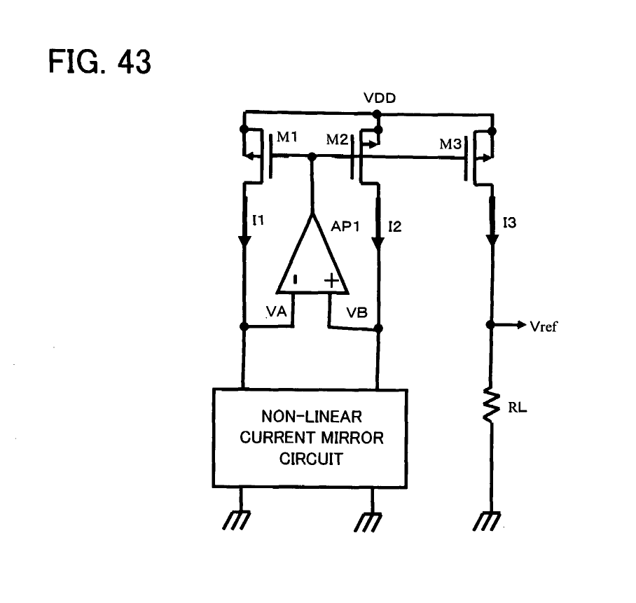

In the reference voltage circuit, shown in FIG. 43, an inverting input terminal (−) and a non-inverting input terminal (+) of the OP amp (AP1) are connected to an input terminal and an output terminal of the non-linear current mirror circuit, respectively.

It is noted that the non-linear current mirror circuit includes two bipolar transistors Q1 and Q2, described with reference to FIG. 38 etc. The output terminal of the OP amp is connected to the common gates of the p-channel MOS transistors M1 and M2 that form the linear current mirror circuit. These p-channel MOS transistors M1 and M2 have sources connected to the power supply VDD, while having the gates connected together. The p-channel MOS transistor M3, having a source connected to the power supply VDD and having a gate connected in common to the gates of M1 and M2, has a drain connected to one end of the resistor RL, the opposite end of which is grounded. The terminal voltage of the resistor RL acts as the reference voltage Vref. The p-channel MOS transistor M3 represents the other output of the linear current mirror circuit.

In the reference voltage circuit, shown in FIG. 43, the inverting input terminal (−) and the non-inverting input terminal (+) of the OP amp (AP1) are connected so that the voltages of the input and output terminals of the non-linear current mirror circuit including the first and second bipolar transistors, such as Q1 and Q2 of FIG. 38, will be equal to each other. The output terminal of the OP amp (AP1) controls the common gate voltage of the transistors M1 and M2 that form the linear current mirror circuit. The drain of the MOS transistor M3, as the other output of the linear current mirror circuit, is connected to the resistor RL. The reference voltage Vref is output on current-to-voltage conversion at the terminal of the resistor RL.

Referring to FIG. 43, the bipolar transistors Q1 and Q2 are driven by a 1:1:1 current mirror circuit formed by the MOS transistors M1 to M3. The common gates of the MOS transistors M1 to M3 are connected to the output of the OP amp (AP1). The inverting input terminal (−) and the non-inverting input terminal (+) of the OP amp (AP1) are controlled so that the terminal voltage at the base (collector) of the bipolar transistor Q1 of the non-linear current mirror circuit (see FIG. 38) will be equal to the terminal voltage of the collector of the bipolar transistor Q2 (see FIG. 38) (terminal voltage of the base of the bipolar transistor Q3). Hence,

VA=VB (80)

At this time, the output currents I1, I2 and I3 of the 1:1:1 current mirror circuit, formed by the MOS transistors M1 to M3, are equal to one another, such that

I1=I2=I3 (81)

### EXAMPLE 6-1

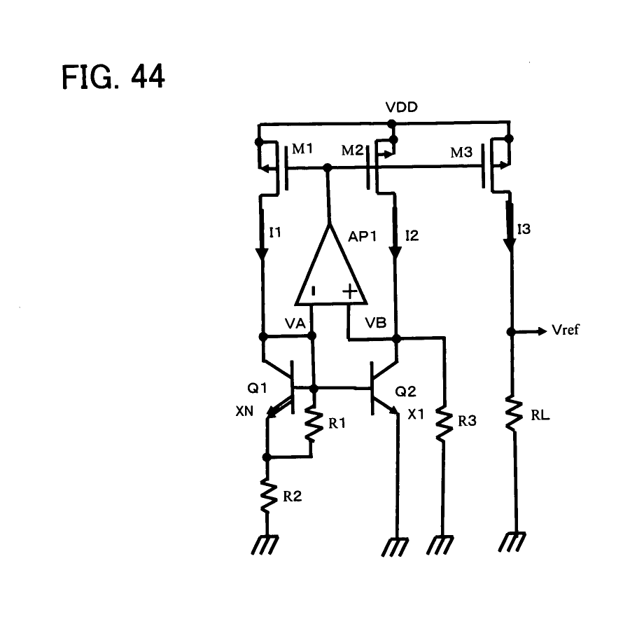

The reference voltage circuit, shown in FIG. 44, includes a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal of the non-linear current mirror circuit. A resistor R1 is connected between the base and the emitter and grounded via an emitter resistor R2. The second bipolar transistor Q2 is a unit bipolar transistor having an emitter directly grounded and having a collector grounded via resistor R3. The collector of the second bipolar transistor forms an output terminal of the non-linear current mirror circuit.

Since the OP amp (API) exercises control so that VA=VB,

V_{BE1}+R₂I₁=R₃(I₂−I_{C2})=V_{BE2} (82)

The output current of the MOS transistor M1 (drain current) I1 is the collector current IC1 of the bipolar transistor Q1 added by V_{BE1}/R1, such that

I₁=I_{C1}+V_{BE1}/R₁ (82-1)

while the output current of the MOS transistor M2 (drain current) I2 is the collector current IC2 of the bipolar transistor Q2 added by V_{BE2}/R3, such that

I₂=I_{C2}+V_{BE2}/R₃ (82-2)

Hence, the difference Δ VBE between the base-to-emitter voltage V_{BE2} of the bipolar transistor Q2 and the base-to-emitter voltage V_{BE1} of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{3} {I}_{1}} )}{1 - \frac{{V}_{BE 1}}{{R}_{1} {I}_{1}}} \} \\ = {R}_{2} {I}_{1}\end{matrix} \qquad ( 83 )$$

In the equation (83), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by {1−V_{BE2}/(R₃I₁)}/{1−V_{BE1}/(R₁I₁)}.

That is, since the term of ln is changed with temperature, the temperature characteristic of Δ VF, shown by the equation (83), has a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₃=(R_{L}/R₂)Δ V_{BE} (84)

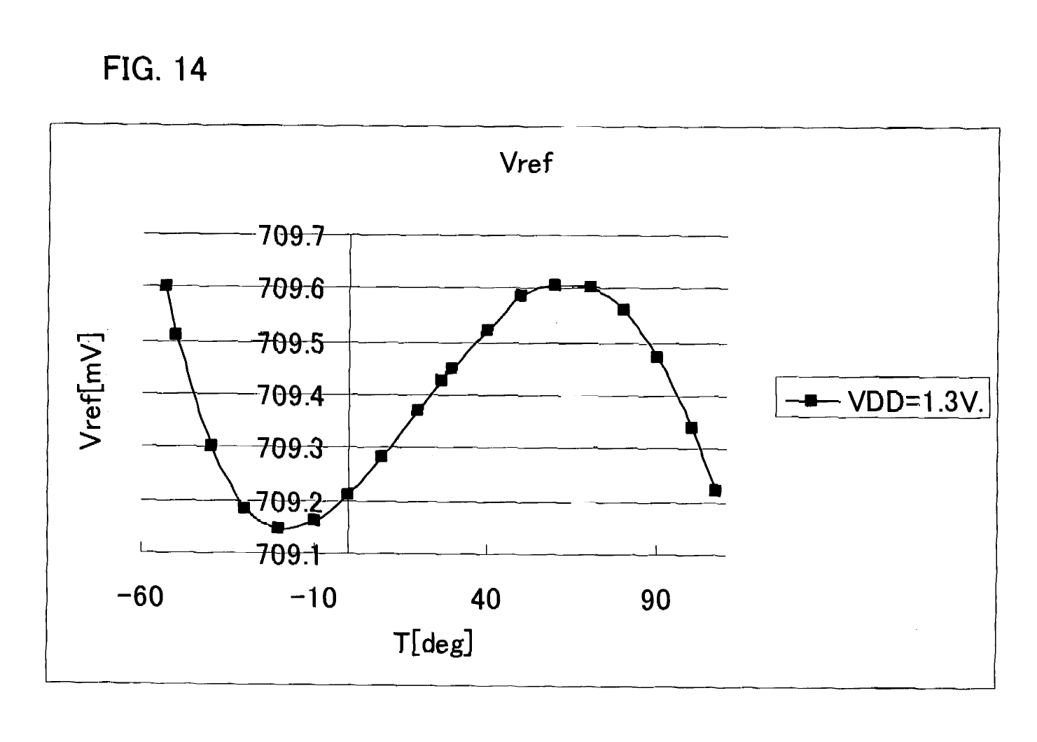

It may thus be expected that characteristic equivalent to that of the reference voltage circuit shown in FIG. 14 may be obtained. The reference voltage, compensated for temperature non-linearity proper to a transistor, may be obtained from the opposite side terminal of the resistor R2 (the terminal distinct from the grounded terminal) as well.

### EXAMPLE 6-2

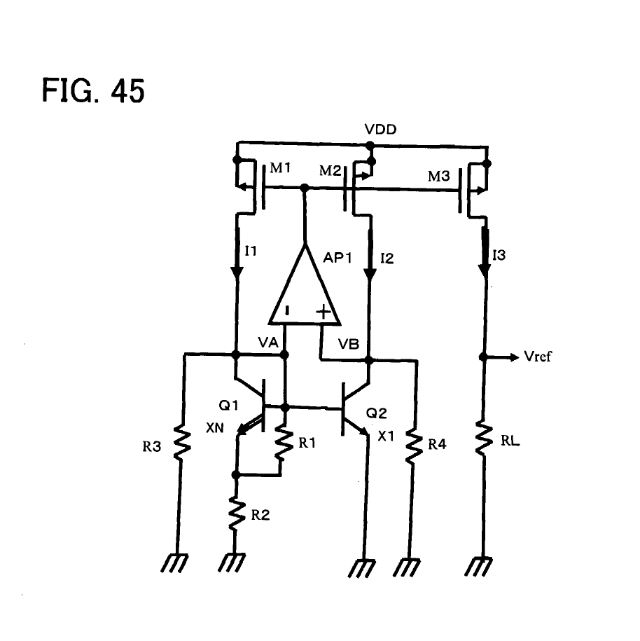

The reference voltage circuit, shown in FIG. 45, includes a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal of the non-linear current mirror circuit. A resistor R1 is connected between the base and the emitter and grounded via an emitter resistor R2. The collector 8base) is grounded via a resistor R3. The second bipolar transistor Q2 is a unit bipolar transistor having an emitter directly grounded and having a collector grounded via resistor R3. The collector of the second bipolar transistor forms an output terminal of the non-linear current mirror circuit.

Since the OP amp (AP1) exercises control so that VA=VB,

V_{BE1}+R₂(I₁−V_{BE2}/R₃)=R₃(I₂−I_{C2})=V_{BE2} (85)

The output current of the MOS transistor M1 (drain current) I1 is the collector current IC1 of the bipolar transistor Q1 added by V_{BE1}/R1 and V_{BE2}/R3, such that

I₁=I_{C1}+V_{BE1}/R₁+V_{BE2}/R₃ (85-1)

while the output current I2 of the MOS transistor M2 (drain current) is the collector current IC2 of the bipolar transistor Q2 added by VBE2/R4, such that

I₂=I_{C2}+V_{BE2}/R₄ (85-2)

Hence, the difference Δ VBE between the base-to-emitter voltage VBE2 of the bipolar transistor Q2 and the base-to-emitter voltage VBE1 of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 1}}{{R}_{4} {I}_{1}} )}{1 - \frac{{V}_{BE 1}}{{R}_{1} {I}_{1}} - \frac{{V}_{BE 2}}{{R}_{3} {I}_{1}}} \} \\ = {R}_{2} ( {I}_{1} - \frac{{V}_{BE 2}}{{R}_{3}} )\end{matrix} \qquad ( 86 )$$

The reference voltage Vref obtained may thus be expressed as

$$Vref = {R}_{L} {I}_{3} = \frac{{R}_{L}}{{R}_{3}} ( {V}_{BE 2} + \frac{{R}_{3}}{{R}_{2}} Δ {V}_{BE} ) \qquad ( 87 )$$

If, in the equation (87), Δ V_{BE} has a positive temperature characteristic, the temperature characteristic within the braces { } in the equation (73) may be compensated. However, since the term of ln in the equation (86) is changed with temperature, the temperature characteristic of Δ V_{BE}, shown by the equation (86), possesses a second-order coefficient, and may be set to a positive temperature characteristic having the PTAT line shown in FIG. 7 as an asymptotic line. It may thus be expected that, with the present example, the characteristic equivalent to that of the reference voltage circuit shown in FIG. 22 may be obtained.

### EXAMPLE 6-3

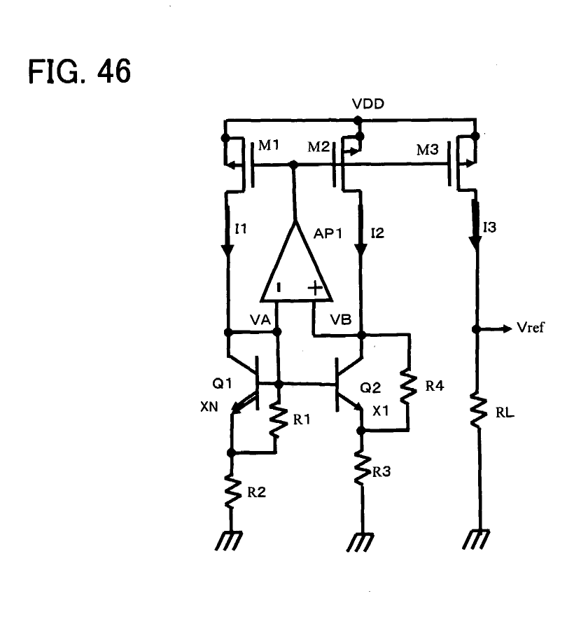

The reference voltage circuit, shown in FIG. 46, includes a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal of the non-linear current mirror circuit. A resistor R1 is connected between the base and the emitter and grounded via an emitter resistor R2. The second bipolar transistor Q2 is a unit bipolar transistor. A resistor R4 is connected between the collector and the emitter and is grounded via an emitter resistor R3. The collector of the second bipolar transistor forms an output terminal of the non-linear current mirror circuit.

Since the OP amp (AP1) exercises control so that VA=VB,

V_{BE1}+R₂(I₁−V_{BE1}/R₁)=V_{BE2}+R₃(I₂−V_{BE2}/R₄) (88)

The output current I1 of the MOS transistor M1 (drain current) is the collector current IC1 of the bipolar transistor Q1 added by VBE1/R1, such that

I₁=I_{C1}+V_{BE1}/R₁ (88-1)

while the output current I2 of the MOS transistor M2 (drain current) is the collector current IC2 of the bipolar transistor Q2 added by VBE2/R4, such that

I₂=I_{C2}+V_{BE2}/R₄ (88-2)

Hence, the difference Δ VBE between the base-to-emitter voltage VBE2 of the bipolar transistor Q2 and the base-to-emitter voltage VBE1 of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{4} {I}_{1}} )}{1 - \frac{{V}_{BE 1}}{{R}_{1} {I}_{1}}} \} \\ = ( {R}_{3} - {R}_{2} ) {I}_{1}\end{matrix} \qquad ( 89 )$$

In the equation (89), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by {1−V_{BE2}/(R₄I₁)}/{1−V_{BE1}/(R₁I₁)}.

That is, since the term of ln is changed with temperature, the temperature characteristic of Δ V_{BE}, shown by the equation (89), has a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₃={(R_{L}/(R₃−R₂))Δ V_{BE} (90)

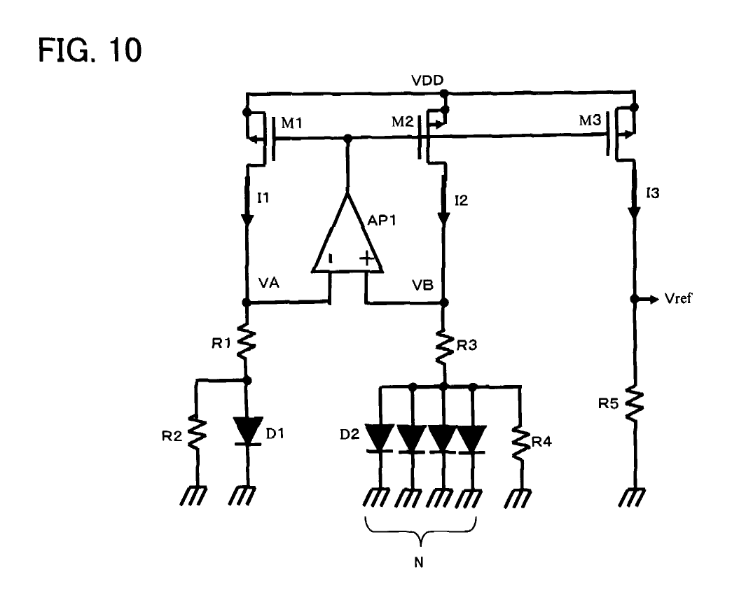

It may thus be expected that characteristic equivalent to that of the reference voltage circuit shown in FIG. 10 may be obtained. The reference voltage, compensated for temperature non-linearity proper to a transistor, may be obtained from the opposite side terminals of the resistors R2 and R3 as well.

### EXAMPLE 6-4

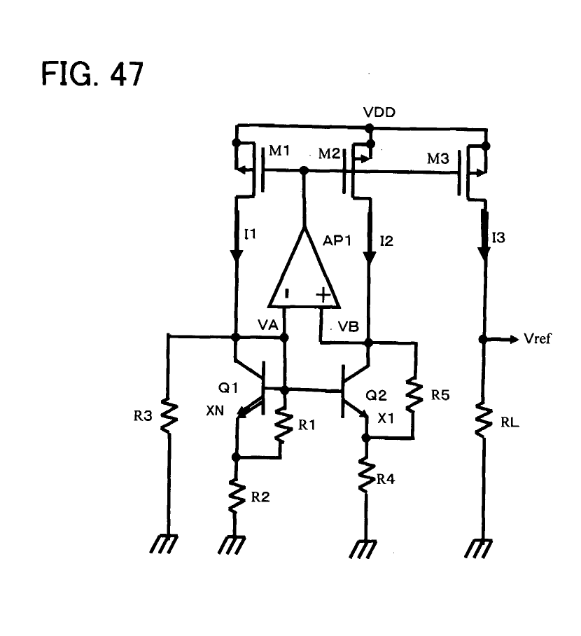

The reference voltage circuit shown in. FIG. 47 has a non-linear current mirror circuit that includes first and second bipolar transistors. The emitter area of the first bipolar transistor Q1 is N times that of the unit bipolar transistor. The first bipolar transistor Q1 has a base and a collector connected in common to form an input terminal of the non-linear current mirror circuit. A resistor R1 is connected between the base and the emitter and grounded via an emitter resistor R2. The collector (base) is grounded via resistor R3. The second bipolar transistor Q2 is a unit bipolar transistor. A resistor R5 is connected between the collector and the emitter of the transistor Q2 and is grounded via emitter resistor R4. The collector of the second bipolar transistor forms an output terminal of the non-linear current mirror circuit.

Since the OP amp (AP1) exercises control so that VA=VB,

R₃(I₁−I_{C1}−V_{BE1}/R₁)=V_{BE2}+R₄(I₁−V_{BE2}/R₅ (91)

The output current I1 of the MOS transistor M1 (drain current) is the collector current IC1 of the bipolar transistor Q1 added by VBE1/R1 and (VBE2+R4I4)/R3, such that

I₁=I_{C1}+V_{BE1}/R₁+(V_{BE2}+R₄I₄)/R₃ (91-1)

while the output current I2 of the MOS transistor M2 (drain current) is the collector current IC2 of the bipolar transistor Q2 added by VBE2/R5, such that

I₂=I_{C2}+V_{BE2}/R₅ (91-2)

Hence, the difference Δ VBE between the base-to-emitter voltage VBE2 of the bipolar transistor Q2 and the base-to-emitter voltage VBE1 of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{5} {I}_{1}} )}{1 - \frac{{V}_{BE 1}}{{R}_{1} {I}_{1}} - \frac{{V}_{BE 2} + {R}_{4} {I}_{1}}{{R}_{3} {I}_{1}}} \} \\ = {R}_{2} ( {I}_{1} - \frac{{V}_{BE 2} + {R}_{4} {I}_{1}}{{R}_{3}} ) - {R}_{4} {I}_{1}\end{matrix} \qquad ( 92 )$$

Hence, the reference voltage Vref obtained may be expressed as

$$Vref = {R}_{L} {I}_{3} = \frac{{R}_{L} {R}_{2}}{{R}_{2} {R}_{3} + {R}_{2} {R}_{4} - {R}_{3} {R}_{4}} ( {V}_{BE 2} + \frac{{R}_{3}}{{R}_{2}} Δ {V}_{BE} ) \qquad ( 93 )$$

If Δ V_{BE} has a positive temperature characteristic, it is possible to cancel temperature characteristic within the braces { } of the equation (93). However, since the term of ln in the equation (92) is changed with temperature, the temperature characteristic of Δ V_{BE}, shown by the equation (92), possesses a second-order coefficient, and may be set to a positive temperature characteristic having the PTAT line shown in FIG. 7 as an asymptotic line.

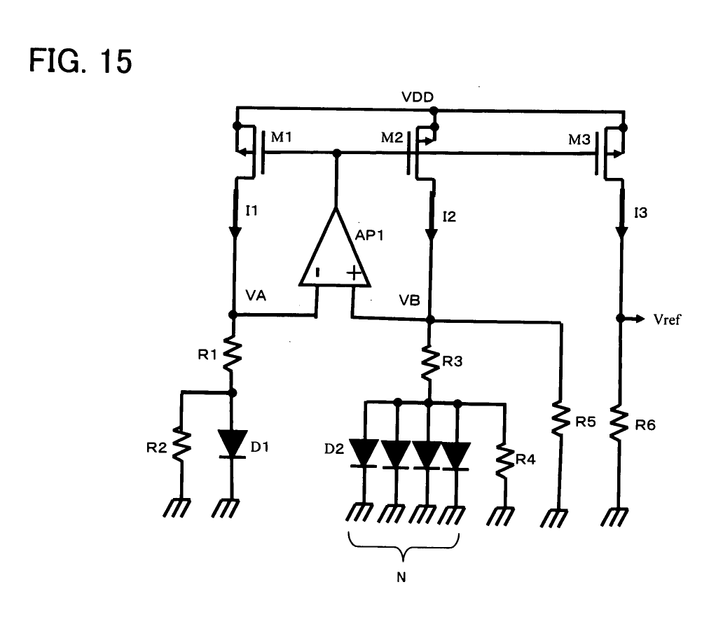

It may thus be expected that, with the present example, the characteristic equivalent to that of the reference voltage circuit shown in FIG. 15 may be obtained. The reference voltage, compensated for temperature non-linearity proper to a transistor, may be obtained from the opposite side terminal of the resistor R4 as well.

### EXAMPLE 6-5

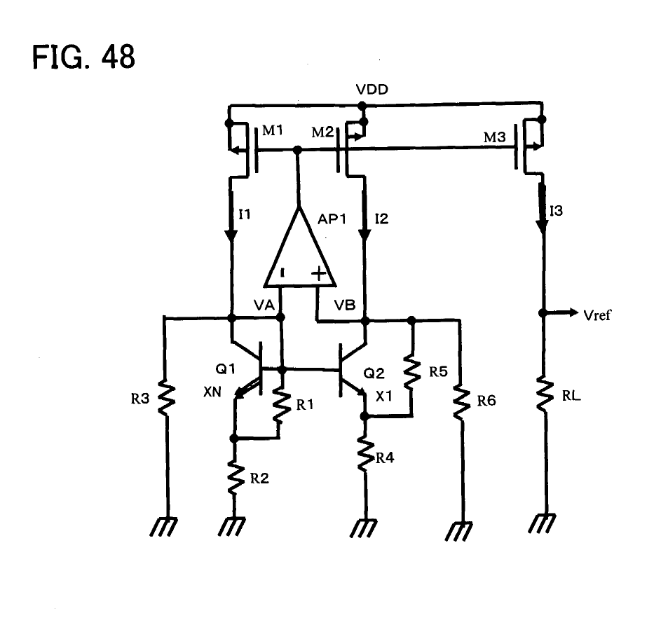

The reference voltage circuit shown in FIG. 48 has a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal of the non-linear current mirror circuit. A resistor R1 is connected between the base and the emitter of the transistor Q1 and grounded via an emitter resistor R2. The collector (base) of the transistor Q1 is grounded via resistor R3. The second bipolar transistor Q2 is a unit bipolar transistor. A resistor R5 is connected between the collector and the emitter of the transistor Q2. The emitter of the second bipolar transistor Q2 is grounded via resistor R4, and the collector thereof, grounded via resistor R6, forms an output terminal of the non-linear current mirror circuit.

Since the OP amp (AP1) exercises control so that VA=VB,

R₃(I₁−I_{C1}−V_{BE1}/R₁)=R₆(I₁−I_{C2}−V_{BE2}/R₅) (94)

The output current I1 of the MOS transistor M1 (drain current) is the collector current IC1 of the bipolar transistor Q1 added by VBE1/R1 and VA/R3, such that

I₁=I_{C1}+V_{BE1}/R₁+V_{A}/R₃ (94-1)

while the output current I2 of the MOS transistor M2 (drain current) is the collector current IC2 of the bipolar transistor Q2 added by VBE2/R5 and VA/R6, such that

I₂=I_{C2}+V_{BE2}/R₅+V_{A}/R₆ (94-2)

Hence, the difference Δ VBE between the base-to-emitter voltage VBE2 of the bipolar transistor Q2 and the base-to-emitter voltage VBE1 of the bipolar transistor Q1 is expressed by

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{5} {I}_{1}} - \frac{{V}_{A}}{{R}_{6}} )}{1 - \frac{{V}_{BE 1}}{{R}_{1} {I}_{1}} - \frac{{V}_{A}}{{R}_{3} {I}_{1}}} \} \\ = {R}_{2} ( {I}_{1} - \frac{{V}_{A}}{{R}_{3}} ) - {R}_{4} ( {I}_{1} - \frac{{V}_{A}}{{R}_{6}} )\end{matrix} \qquad ( 95 )$$

The reference voltage Vref obtained may thus be expressed as

$$\begin{matrix}Vref = {R}_{L} {I}_{3} \\ = \frac{{R}_{L}}{{R}_{2} - {R}_{4}} \frac{{R}_{2} {R}_{6} - {R}_{3} {R}_{4}}{{R}_{3} {R}_{6}} ( {V}_{A} + \frac{{R}_{3} {R}_{6}}{{R}_{2} {R}_{6} - {R}_{3} {R}_{4}} Δ {V}_{BE} )\end{matrix} \qquad ( 96 )$$

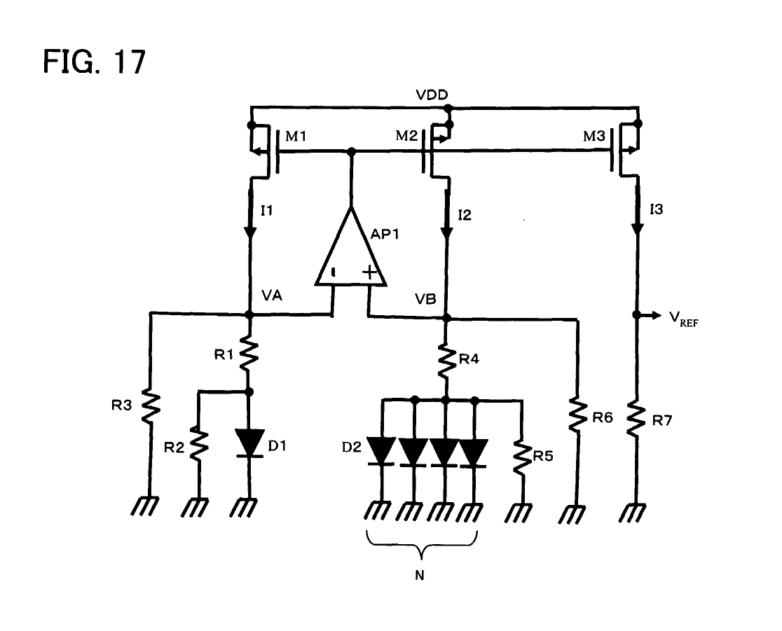

If, in the equation (96), V_{A} has negative temperature characteristic and Δ V_{BE} has a positive temperature characteristic, it is possible to compensate temperature characteristic within the braces { } of the equation (96). However, since the term of ln in the equation (95) is changed with temperature, the temperature characteristic of Δ V_{BE}, shown by the equation (95), possesses a second-order coefficient, and may be set to a positive temperature characteristic having the PTAT line shown in FIG. 7 as an asymptotic line. Thus, it may be expected that, with the present example, the characteristic equivalent to that of the reference voltage circuit shown in FIG. 17 may be obtained.

### EXAMPLE 7

In the reference voltage circuit, shown in FIG. 39, the OP amp (AP1) is used as means for exercising control to render the two terminal voltages VA and VB of the non-linear current mirror circuit equal to each other. However, if desired to lower the voltage and the current consumption further, and to improve the insusceptibility to device variations, the self-biasing technique that does not use an OP amp is felt to be effective.

In particular, in the present application, the non-linear current mirror circuit is limited to a circuit that retains the characteristic of the reverse Widlar current mirror circuit (FIGS. 38A to 38C). Hence, the current loop of the non-linear current mirror circuit and the linear current mirror circuit that self-biases it may readily be set in the negative feedback circuit loop to implement a reference voltage circuit.

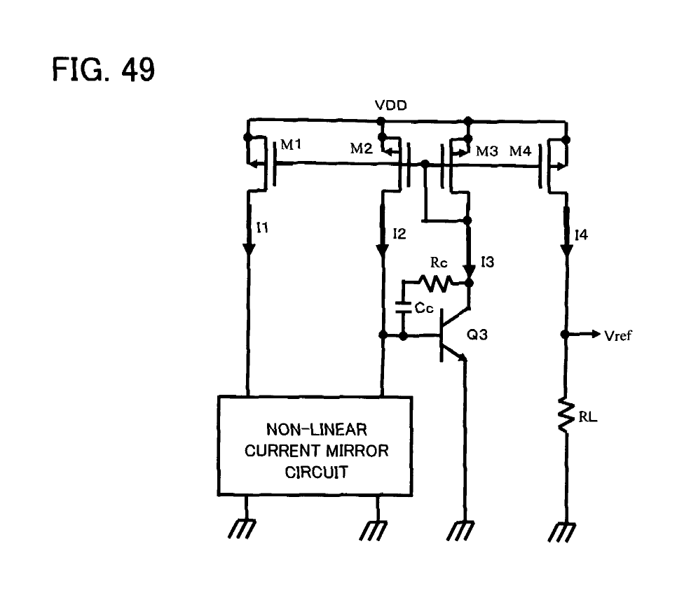

In the reference voltage circuit, shown in FIG. 49, there flows the current in such a manner that the input current I1 and the output current I2 in the non-linear current mirror circuit inclusive of the first and second bipolar transistors will be equal to each other, with the voltage at the input terminal of the non-linear current mirror circuit being equal to that at its output terminal. The bipolar transistor Q3 has a base connected to an output terminal of the non-linear current mirror circuit, while having an emitter grounded and having a collector connected to the drain of the p-channel MOS transistor M3. This p-channel MOS transistor has a gate and a drain connected together. The MOS transistor M3 forms a current mirror circuit with the MOS transistors M1, M2 and M4. The MOS transistor M4 has a drain grounded via resistor RL. The terminal voltage at the resistor RL, obtained on current-to-voltage conversion, is output as a reference voltage Vref.

In the reference voltage circuit, shown in FIG. 49, the p-channel MOS transistors M1, M2 have sources connected to the power supply, while having drains connected to the input and output terminals of the non-linear current mirror circuit. The p-channel MOS transistors M1, M2 and M3 have gates connected together to form a current mirror circuit. The MOS transistor M3 has a gate and a drain connected together and is driven by the collector current flowing through the bipolar transistor Q3 so that the input current and the output current of the non-linear current mirror circuit inclusive of the first and second bipolar transistors will be equal to each other.

A series connection of a capacity C_{C} and a resistor R_{C} for phase compensation are connected between the base (input) and the collector (output) of the bipolar transistor Q3 as shown.

If the non-linear current mirror circuit is arranged so that, when the output currents I1 and I2 of the current mirror circuit composed of the MOS transistors M1 and M2 are increased, the base voltage of the bipolar transistor Q3 is lowered, a feedback current loop is formed to form a reference voltage circuit. If the other output of the linear current mirror circuit is connected to a resistor to effect current-to-voltage conversion, a reference voltage Vref is generated. The circuit may thus be used as a reference voltage circuit.

The output currents I1, I2, I3 and I4 of the 1:1:1:1 current mirror circuit, made up of the MOS transistors M1 to M4, are equal, such that

I1=I2=I3=I4 (97)

### EXAMPLE 7-1

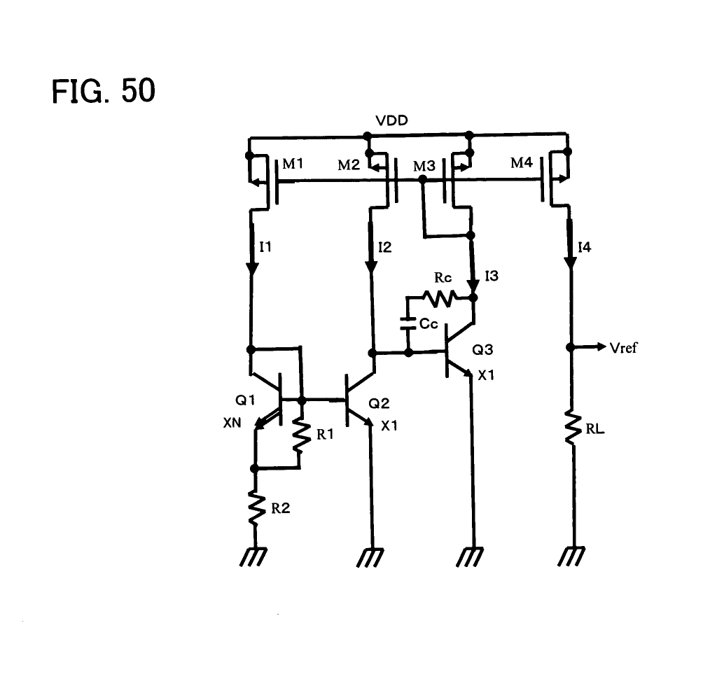

FIG. 50 is a circuit diagram showing a configuration in case the configuration of FIG. 38A is used as the non-linear current mirror circuit in FIG. 49.

In FIG. 50, the collector currents IC1 and IC2 of the bipolar transistors Q1 and Q2 may be expressed respectively by

$$\begin{matrix}{I}_{C 1} = {NI}_{S} exp ( \frac{{V}_{BE 1}}{{V}_{T}} ) \\ and & ( 98 ) \\ {I}_{C 2} = {I}_{S} exp ( \frac{{V}_{BE 2}}{{V}_{T}} ) = {I}_{2} & ( 99 )\end{matrix}$$

The output currents (drain currents) I1, I2 from the MOS transistors M1 and M2, where I1=I2, may be expressed respectively by

I₁=I_{C1}+V_{BE1}/R₁ (100)

and by

I₂=I_{C2} (101)

Hence, the difference Δ VBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1}}{{R}_{1} {I}_{1}}} ) \\ = {R}_{2} {I}_{1}\end{matrix} \qquad ( 102 )$$

From FIG. 50, the equation V_{BE2}=V_{BE1}+R₂I₁ holds, such that Δ VBE=R₂I₁ of the equation (102) holds.

In the equation (102), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−V_{BE1}/(R₁I₁)}.

That is, since the term within the round brackets ( ) of ln( ) in the equation (102) is changed with temperature, the temperature characteristic of Δ V_{BE}, shown by the equation (102), possesses a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₄=(R_{L}/R₂)Δ V_{BE} (103)

It may thus be expected that, with the present example, shown in FIG. 50, the characteristic equivalent to that of the reference voltage circuit shown in FIG. 19 may be obtained. The reference voltage, compensated for temperature non-linearity proper to a transistor, may be obtained from the opposite side terminal of the resistor R2 as well.

### EXAMPLE 7-2

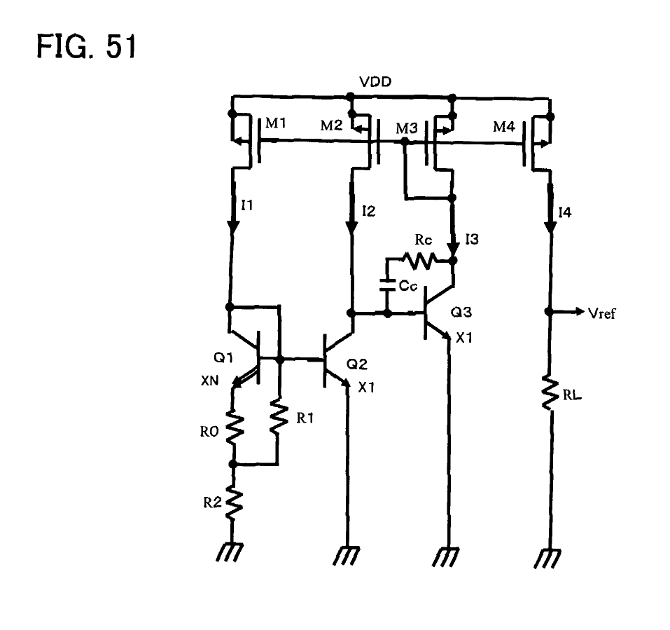

FIG. 51 is a circuit diagram showing a configuration in which the configuration of FIG. 38B is used as a non-linear current mirror circuit.

In FIG. 51, the collector currents IC1 and IC2 of the bipolar transistors Q1 and Q2, may be expressed respectively by the equations (98) and (99).

The output currents (drain currents) I1 and I2 from the MOS transistors M1 and M2, where I1=I2, may be expressed respectively by

I₁=I_{C1}+(R₀I_{C1}+V_{BE1})/R₁ (104)

and by

I₂=I_{C2} (105)

Hence, the difference Δ VBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1} + {R}_{0} {I}_{C 1}}{{R}_{1} {I}_{1}}} ) \\ = {R}_{2} {I}_{1} + {R}_{0} {I}_{C 1}\end{matrix} \qquad ( 106 )$$

From FIG. 51, V_{BE2}=V_{BE1}+R₂I₁+R₀I_{C1}, so that, in the equation (106), Δ V_{BE}=R₂I₁+R₀I_{C1} holds.

In the equation (106), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−(V_{BE1}+R₀I_{C1})/(R₁I₁)}.

That is, since the term within the round brackets ( ) of ln( ) in the equation (106) is changed with temperature, the temperature characteristic of ΔBE, shown by the equation (106), has a second-order coefficient, and represents a characteristic close to a positive temperature characteristic having a PTAT line of FIG. 7 as an asymptotic line.

Thus, the reference voltage Vref obtained is expressed by

Vref=R_{L}I₄=(R_{L}/R₂)(Δ V_{BE}−R₀I_{C1}) (107)

It may thus be expected that, with the present example, shown in FIG. 51, the characteristic equivalent to that of the reference voltage circuit shown in FIG. 8 may be obtained. The reference voltage, compensated for temperature non-linearity proper to a transistor, may be obtained from the opposite side terminal of the resistor R2.

### EXAMPLE 7-3

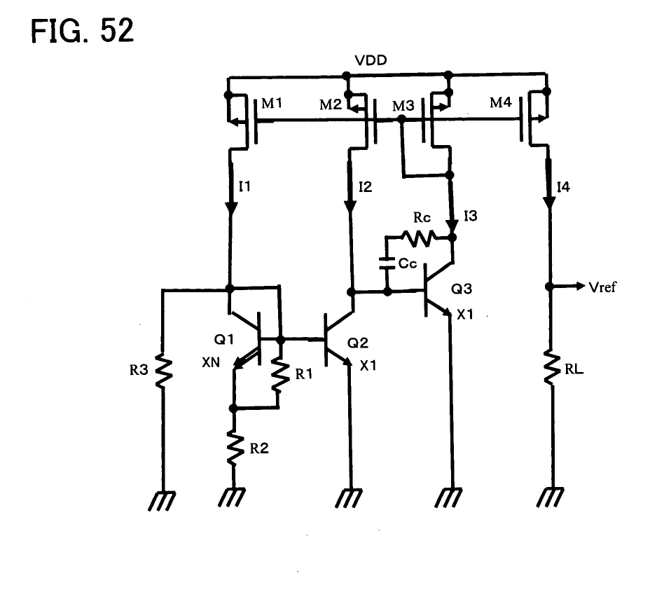

FIG. 52 is a circuit diagram showing a configuration in which the configuration of FIG. 38C is used as the non-linear current mirror circuit.

In FIG. 52, the collector currents IC1 and IC2 of the bipolar transistors Q1 and Q2, may be expressed respectively by the equations (98) and (99).

The output currents (drain currents) I1 and I2 from the MOS transistors M1 and M2, where I1=I2, may be expressed respectively by

$$\begin{matrix}{I}_{1} = {I}_{C 1} + \frac{{V}_{BE 1}}{{R}_{1}} + \frac{{V}_{BE 2}}{{R}_{3}} \\ and by & ( 108 ) \\ {I}_{2} = {I}_{C 2} & ( 109 )\end{matrix}$$

Hence, the difference Δ VBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1}}{{R}_{1} {I}_{1}} - \frac{{V}_{BE 2}}{{R}_{3} {I}_{1}}} ) \\ = {R}_{2} ( {I}_{1} - \frac{{V}_{BE 2}}{{R}_{3}} ) \end{matrix} \qquad ( 110 )$$

The reference voltage Vref obtained may thus be found as

$$Vref = {R}_{L} {I}_{4} = \frac{{R}_{L}}{{R}_{3}} ( {V}_{BE 2} + \frac{{R}_{3}}{{R}_{2}} Δ {V}_{BE} ) \qquad ( 111 )$$

It is sufficient to set R4/R3<1 in the equation (111) and to set the value of R3/R1 so that, within the braces { }, the temperature characteristic will be compensated by V_{BE2} having a negative temperature characteristic and by Δ V_{BE} having a positive temperature characteristic. It is noted that Δ V_{BE} does not have a linear positive temperature characteristic, as indicated by the equation (110). The denominator within the round brackets ( ) of ln( ) is a function having a positive temperature characteristic, such that ( ) of ln( ) has a negative temperature characteristic. Further, due to logarithmic compression, Δ V_{BE} does not exhibit linear positive temperature characteristic but its value is increased and decreased at lower temperature and higher temperature, respectively.

Thus, in the equation (111), the term within the round brackets ( ) may be set so that temperature non-linearity of Δ V_{BE2} will be compensated by Δ V_{BE}. On the other hand, since the term within ( ) of ln( ) of the equation (110) is varied with temperature, the temperature characteristic of Δ V_{BE}, shown by the equation (110), possesses a second-order coefficient, and is approximate to a positive temperature characteristic having the PTAT line as an asymptotic line.

It may thus be expected that, with the present example of FIG. 52, the characteristic equivalent to that of the reference voltage circuit shown in FIG. 31 may be obtained.

### EXAMPLE 7-4

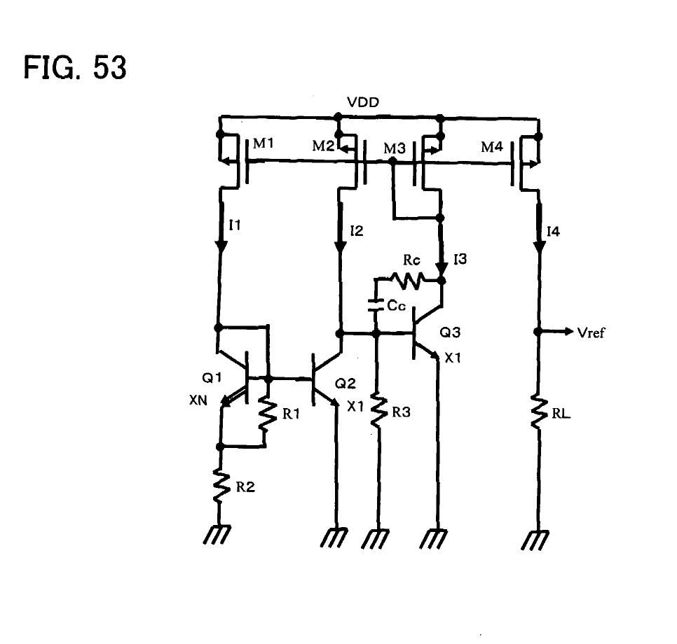

FIG. 53 is a circuit diagram showing the configuration in which the non-linear current mirror circuit of FIG. 49 is the circuit of FIG. 38A in which the collector of the bipolar transistor Q2 is grounded via resistor R3.

The collector currents IC1 and IC2 of the bipolar transistors Q1 and Q2 are respectively expressed by

$$\begin{matrix}{I}_{C 1} = {NI}_{S} exp ( \frac{{V}_{BE 1}}{{V}_{T}} ) \\ and by & ( 112 ) \\ {I}_{C 2} = {I}_{S} exp ( \frac{{V}_{BE 2}}{{V}_{T}} ) & ( 113 )\end{matrix}$$

The output currents (drain currents) I1 and I2 from the MOS transistors M1 and M2, where I1=I2, may be expressed respectively by

I₁=I_{C1}+V_{BE1}/R₁

and by

I₂=I_{C2}+V_{BE2}/R₃ (114)

Hence, the difference Δ VBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{3}} )}{1 - \frac{{V}_{BE 1}}{{R}_{1} {I}_{1}}} \} \\ = {R}_{2} {I}_{1}\end{matrix} \qquad ( 115 )$$

From FIG. 53, V_{BE2}=V_{BE1}+R₂I₁, so that, in the equation (115), Δ V_{BE}=R₂I₁ holds.

In the equation (115), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by{1−V_{BE2}/(R₃ I₁)}/{1−V_{BE1}/(R₁I₁)}.

That is, since the term within ( ) of ln( ) in the equation (115) is changed with temperature, the temperature characteristic of Δ V_{BE}, shown by the equation (115), possesses a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₄=(R_{L}/R₂)(Δ V_{BE}) ( 116)

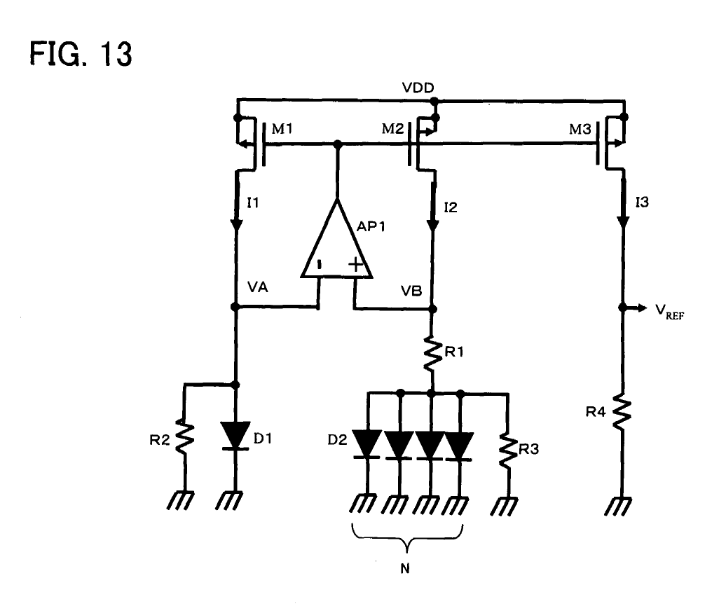

It may thus be expected that, with the present example, the characteristic equivalent to that of the reference voltage circuit shown in FIG. 13 may be obtained. The reference voltage, compensated for temperature non-linearity proper to a transistor, may be obtained from the opposite side terminal of the resistor R2 as well.

### EXAMPLE 7-5

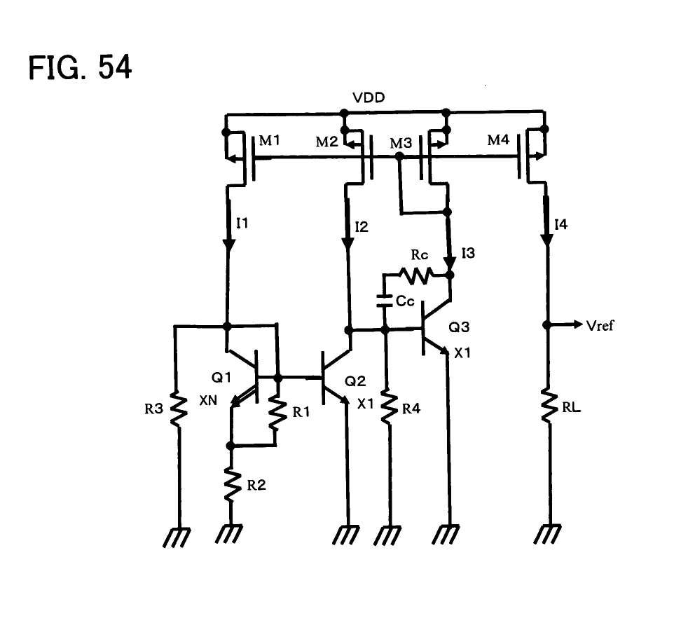

FIG. 54 is a circuit diagram showing the configuration in which the non-linear current mirror circuit of FIG. 49 is the circuit of FIG. 38C having the collector of the bipolar transistor Q2 grounded via resistor R4.

The collector currents of the bipolar transistors Q1 and Q2 are respectively expressed by the equations (112) and (113). The output currents (drain currents) I1 and I2 from the MOS transistors M1 and M2 are respectively expressed by

$$\begin{matrix}{I}_{1} = {I}_{C 1} + \frac{{V}_{BE 1}}{{R}_{1}} + \frac{{V}_{BE 2}}{{R}_{3}} \\ and by & ( 117 ) \\ {I}_{2} = {I}_{C 2} + {V}_{E 2} / {R}_{4} & ( 118 )\end{matrix}$$

Hence, the difference Δ VBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{4}} )}{1 - \frac{{V}_{BE 1}}{{R}_{1} {I}_{1}} - \frac{{V}_{BE 2}}{{R}_{3} {I}_{1}}} \} \\ = {R}_{2} ( {I}_{1} - \frac{{V}_{BE 2}}{{R}_{3}} )\end{matrix} \qquad ( 119 )$$

From FIG. 54, V_{BE2}=V_{BE1}+R₂{I₁−(V_{BE2}/R₃)}, so that, in the equation (119), Δ VBE=R₂ {I₁−(V_{BE2}/R₃)} holds.

Thus, the reference voltage Vref obtained may be found as

$$Vref = {R}_{L} {I}_{4} = \frac{{R}_{L}}{{R}_{3}} ( {V}_{BE 2} + \frac{{R}_{3}}{{R}_{2}} Δ {V}_{BE} ) \qquad ( 120 )$$

It is sufficient to set R4/R3<1 in the equation (120) and to set the value of R3/R1 so that, within the braces { }, the temperature characteristic will be compensated by V_{BE2} having a negative temperature characteristic and by Δ V_{BE} having a positive temperature characteristic. It is noted that Δ V_{BE} does not possess a linear positive temperature characteristic, as indicated by the equation (116). The denominator within the braces { } of ln{ } is a function having a positive temperature characteristic, and { } of ln{ } has a negative temperature characteristic. Further, due to logarithmic compression, Δ V_{BE} does not possess a positive temperature characteristic but its value is increased and decreased at lower temperature and higher temperature, respectively.

Thus, in the equation (120), the term within ( ) may be set so that temperature non-linearity of Δ V_{BE2} will be compensated by Δ V_{BE}. On the other hand, since the term within ( ) of ln( ) of the equation (119) is varied with temperature, the temperature characteristic of Δ V_{BE}, shown by the equation (119), possesses a second-order coefficient, and is approximate to a positive temperature characteristic having the PTAT line as an asymptotic line.

It may thus be expected that, with the present example, the characteristic equivalent to that of the reference voltage circuit shown in FIG. 22 may be obtained.

### EXAMPLE 7-6

In the present invention, the non-linear current mirror circuit may be replaced by a variant of the Nagata's current mirror circuit.

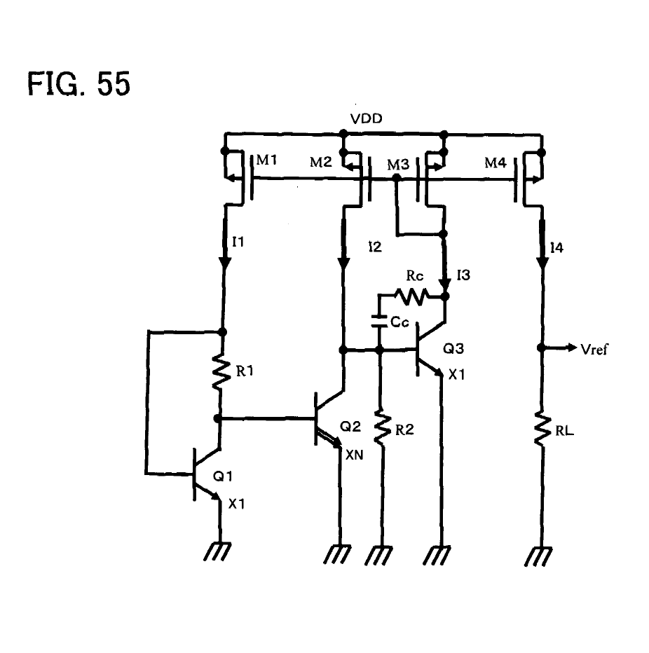

FIG. 55 is a diagram showing a configuration in which the non-linear current mirror circuit is a Nagata's current mirror circuit in which a collector of a bipolar transistor Q2 is grounded via a resistor R2. In the Nagata's current mirror circuit, the bipolar transistor Q1 has an emitter grounded, while having a collector connected to one end of a resistor R1 and having a base connected to the other end of the resistor R1.

The collector currents IC1 and IC2 of the bipolar transistors Q1 and Q2, may respectively be expressed as

$$\begin{matrix}{I}_{C 1} = {I}_{S} exp ( \frac{{V}_{BE 1}}{{V}_{T}} ) = {I}_{1} \\ and as & ( 121 ) \\ {I}_{C 2} = {NI}_{S} exp ( \frac{{V}_{BE 2}}{{V}_{T}} ) & ( 122 )\end{matrix}$$

The output currents (drain currents) I1 and I2 from the MOS transistors M1 and M2 are given respectively by

I₁=I_{C1} (123)

and by

I₂=I_{C2}+V_{BE3}/R₂ (124)

Hence, the difference Δ VBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 1} - {V}_{BE 2} \\ = {V}_{T} ln ( \frac{{I}_{C 1}}{{NI}_{C 2}} ) \\ = {V}_{T} ln \{ \frac{1}{N ( 1 - \frac{{V}_{BE 3}}{{R}_{2} {I}_{1}} )} \} \\ = {R}_{1} {I}_{1}\end{matrix} \qquad ( 125 )$$

In the equation (125), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−V_{BE3}/(R₂I₁)}.

That is, since the term within the braces { } of ln{ } in the equation (125) is changed with temperature, the temperature characteristic of Δ VF, shown by the equation (125), possesses a second-order coefficient. The forward voltages VF1 and VF2 of the respective diodes are as indicated by a chain-dotted line and a double-dotted chain line in FIG. 11, respectively, with the voltage difference Δ VF between VF1 and VF2 being a constant value despite changes in temperature.

Thus, the reference voltage Vref obtained is expressed by

Vref=R_{L}I₄=(R_{L}/R₁)Δ V_{BE} (126)

Thus, with the present example, the characteristic equivalent to that of the reference voltage circuit shown in FIG. 13 are expected to be obtainable.

### EXAMPLE 7-7

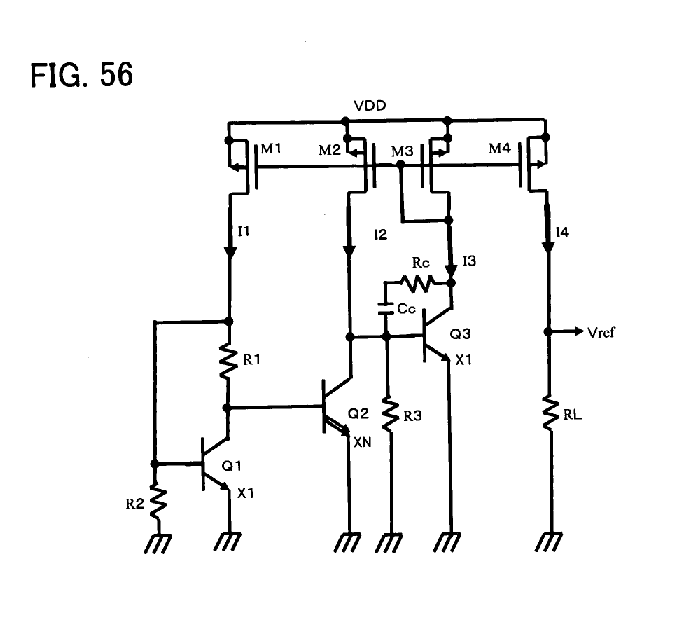

FIG. 56 is a diagram showing a configuration corresponding to the configuration of FIG. 49 in which, in the Nagata's current mirror circuit, the base of the bipolar transistor Q1 is grounded via a resistor R2 and in which the collector of the bipolar transistor Q2 is grounded via resistor R3.

The collector currents IC1 and IC2 of the bipolar transistors Q1 and Q2 are respectively represented by

$$\begin{matrix}{I}_{C 1} = {I}_{S} exp ( \frac{{V}_{BE 1}}{{V}_{T}} ) \\ and by & ( 127 ) \\ {I}_{C 2} = {NI}_{S} exp ( \frac{{V}_{BE 2}}{{V}_{T}} ) & ( 128 )\end{matrix}$$

The output currents (drain currents) I1 and I2 from the MOS transistors M1 and M2, where I1=I2, may be expressed respectively by

I₁=I_{C1}+V_{BE1}/R₂ (129)

and by

I₂=I_{C2}+V_{BE3}/R₃ (130)

Hence, the difference Δ VBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 2} - {V}_{BE 1} \\ = {V}_{T} ln ( \frac{{NI}_{C 1}}{{I}_{C 2}} ) \\ = {V}_{T} ln \{ \frac{1 - \frac{{V}_{BE 1}}{{R}_{2} {I}_{1}}}{N ( \frac{{V}_{BE 3}}{{R}_{1} {I}_{1}} )} \} \\ = {R}_{1} ( {I}_{1} - \frac{{V}_{BE 1}}{{R}_{2}} )\end{matrix} \qquad ( 131 )$$

From FIG. 56, V_{BE1}=R₁I_{C1}+V_{BE2}, so that, in the equation (131), Δ V_{BE1}=R₁(I₁−V_{BE1}/R₂) holds.

The reference voltage Vref may thus be found as

$$Vref = \frac{{R}_{L}}{{R}_{2}} ( {V}_{BE 1} + \frac{{R}_{2}}{{R}_{1}} Δ {V}_{BE} ) \qquad ( 132 )$$

It is sufficient to set RL/R2<1 in the equation (132) and to set the value of R2/R1 so that, within the braces { }, the temperature characteristic will be compensated by V_{BE1} having a negative temperature characteristic and by Δ V_{BE} having a positive temperature characteristic. It is noted that Δ V_{BE} does not possess a linear positive temperature characteristic, as indicated by the equation (131). The denominator of the term within { } of ln{ } is a function having a positive temperature characteristic, and the term within { } of ln{ } has a negative temperature characteristic. Further, due to logarithmic compression, Δ V_{BE} does not possess a linear positive temperature characteristic but its value is increased and decreased at lower and higher temperature, respectively.

Thus, in the equation (132), the term within the round brackets ( ) may be set so that temperature non-linearity of ΔV_{BE1} will be compensated by ΔV_{BE}. On the other hand, since the term within the braces { } of ln{ } of the equation (131) is varied with temperature, the temperature characteristic of ΔV_{BE}, shown by the equation (131), has a second-order coefficient, and is approximate to a positive temperature characteristic having the PTAT line of FIG. 7 as an asymptotic line.

Thus, with the present example, the characteristic equivalent to that of the reference voltage circuit shown in FIG. 22 are expected to be obtainable.

### EXAMPLE 7-8

FIG. 56 is a diagram showing a configuration corresponding to the configuration of FIG. 49 in which, in the Nagata's current mirror circuit, the base of the bipolar transistor Q1 is grounded via a resistor R2 and in which the collector of the bipolar transistor Q2 grounded via resistor R3.

The collector currents IC1 and IC2 of the bipolar transistor Q1 and Q2 are expressed respectively by the equations (127) and (128).

The output currents (drain currents) I1 and I2 of the MOS transistors M1 and M2 are respectively expressed as

I₁=I_{C1}+V_{BE1}/R₂ (133)

and by

I₂=I_{C2}+V_{BE3}/R₃ (134)

Hence, the difference ΔVBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 1} - {V}_{BE 2} \\ = {V}_{T} ln ( \frac{{I}_{C 1}}{{NI}_{C 2}} ) \\ = {V}_{T} ln \{ \frac{1 - \frac{{V}_{BE 2}}{{R}_{2} {I}_{1}}}{N ( 1 - \frac{{V}_{BE 3}}{{R}_{3} {I}_{1}} )} \} = {R}_{1} {I}_{1}\end{matrix} \qquad ( 135 )$$

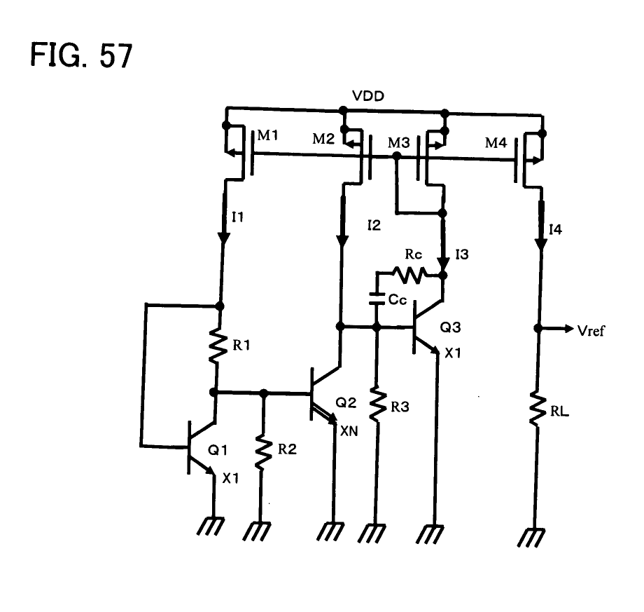

From FIG. 57, V_{BE1}−R₁I₁=V_{BE2}, so that, in the equation (131), Δ V_{BE}=R₁I₁ holds.

In the equation (135), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by {1−V_{BE2}/(R₂I₁)}/{1−V_{BE3}/(R₃I₁)}.

That is, since the term within the braces { } of ln{ } in the equation (135) is changed with temperature, the temperature characteristic of ΔV_{BE}, shown by the equation (135), possesses a second-order coefficient. The forward voltages VF1 and VF2 of the respective diodes are as indicated by a chain-dotted line and a double-dotted chain line in FIG. 11, respectively, with the voltage difference ΔVF between VF1 and VF2 being a constant value despite changes in temperature.

Thus, the reference voltage Vref obtained is expressed by

Vref=R_{L}I₄=(R_{L}/R₁)Δ V_{BE} ( 136)

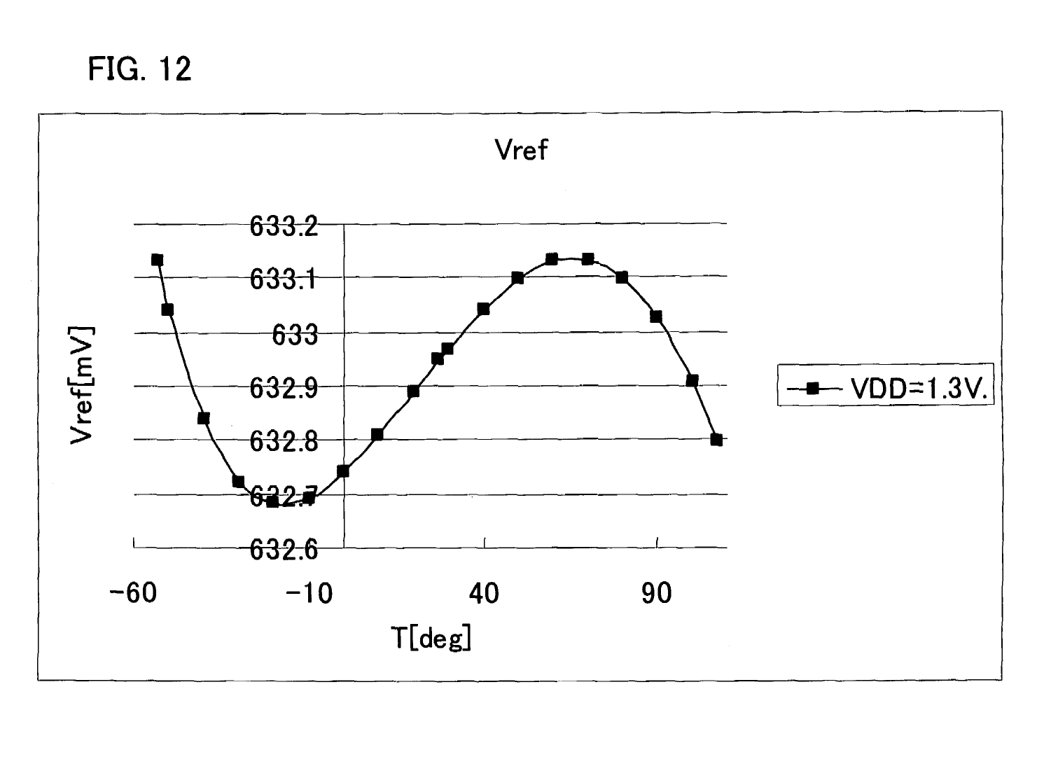

It may thus be expected that, with the present example, the characteristic equivalent to that of the reference voltage circuit shown in FIG. 12 may be obtained.

### EXAMPLE 7-9

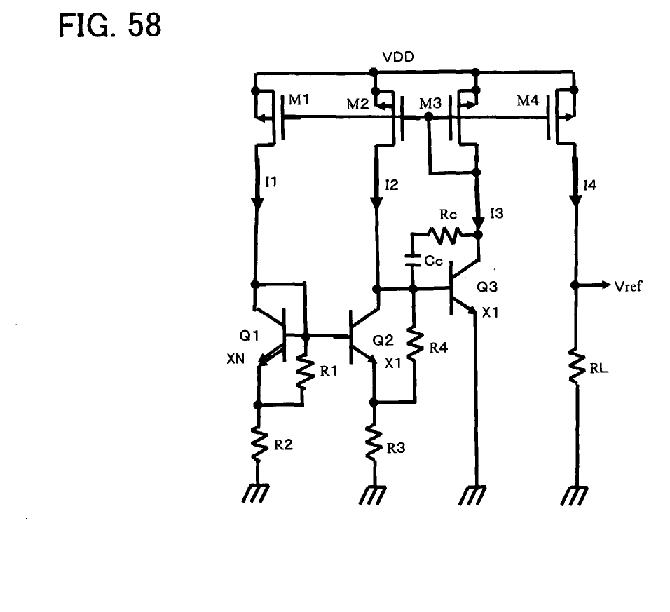

The reference voltage circuit shown in FIG. 58 has a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal. A resistor R1 is connected between the base and the emitter of the transistor and grounded via an emitter resistor R2. The second bipolar transistor Q2 is a unit bipolar transistor. A resistor R4 is connected between the collector and the emitter of the transistor Q2. The emitter of the second bipolar transistor is grounded via resistor R3 and the collector thereof forms an output terminal.

The collector currents IC1 and IC2 of the bipolar transistors Q1 and Q2 are respectively expressed by

$$\begin{matrix}{I}_{C 1} = {NI}_{S} exp ( \frac{{V}_{BE 1}}{{V}_{T}} ) \\ and by & ( 137 ) \\ {I}_{C 2} = {I}_{S} exp ( \frac{{V}_{BE 2}}{{V}_{T}} ) & ( 138 )\end{matrix}$$

The output currents I1, I2 and I3 from the MOS transistors M1, M2 and M3 are such that

I1=I2=I3 (139-1)

and the collector currents IC2, IC3 of the bipolar transistors Q2 and Q3 are such that

I_{C2}<I_{C3}(=I3) (139-2)

The base-to-emitter voltages V_{BE2}, V_{BE3} of the transistors Q2 and Q3 such that

V_{BE2}<V_{BE3} (139-3)

is set, for simplicity, to

V_{BE2}+R₃I₁≈V_{BE3} (140)

The output currents (drain currents) I1 and I2 of the MOS transistors M1 and M2 may respectively be expressed by

I₁=I_{C1}+V_{BE1}/R₁ (140-1)

and by

I₂=I_{C2}+V_{BE3}/R₄ (140-2)

The difference ΔVBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{4} {I}_{1}} )}{1 - \frac{{V}_{BE 3}}{{R}_{1} {I}_{1}}} \} \\ = ( {R}_{3} - {R}_{2} ) {I}_{1}\end{matrix} \qquad ( 141 )$$

In the equation (141), V_{T} is proportionate to the absolute temperature, and hence is varied from 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by {1−V_{BE2}/(R₄I )}/{1−V_{BE1}/(R₁I₁)}.

That is, since the term within the braces { } of ln{ } in the equation (141) is changed with temperature, the temperature characteristic of ΔV_{BE}, shown by the equation (141), possesses a second-order coefficient. The forward voltages VF1 and VF2 of the respective diodes are as indicated by a chain-dotted line and a double-dotted chain line in FIG. 11, respectively, with the voltage difference ΔVF between VF1 and VF2 being a constant value despite changes in temperature.

Thus, the reference voltage Vref obtained is expressed by

Vref=R_{L}I₃={(R_{L}/(R₃−R₂))Δ V_{BE} (142)

Thus, with the present example, the characteristic equivalent to that of the reference voltage circuit shown in FIG. 10 are expected to be obtainable. The reference voltage, compensated for temperature non-linearity proper to a transistor, may be obtained from the opposite side terminals of the resistors R2 and R3 as well.

### EXAMPLE 7-10

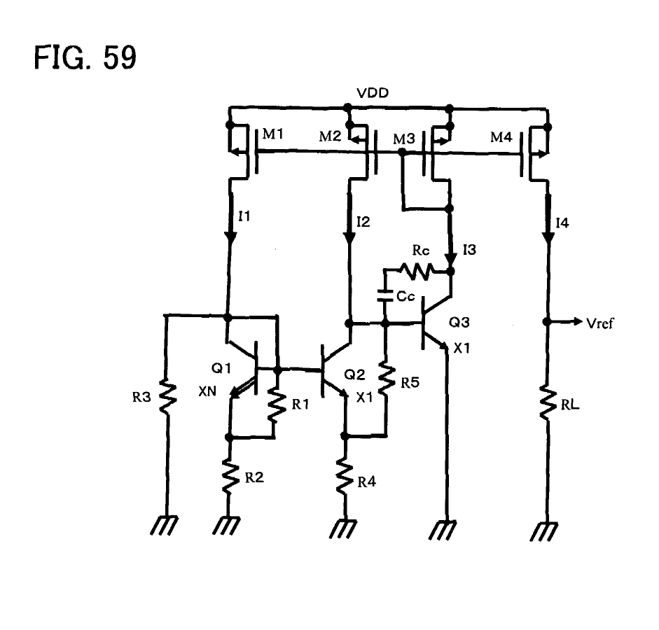

The reference voltage circuit shown in FIG. 59 has a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal. A resistor R1 is connected between the base and the emitter of the transistor and grounded via an emitter resistor R2. The collector (base) is grounded via resistor R3. The second bipolar transistor Q2 is a unit bipolar transistor. A resistor R5 is connected between the collector and the emitter of the transistor Q2. The emitter of the second bipolar transistor is grounded via resistor R4 and the collector thereof forms an output terminal.

The collector currents IC1 and IC2 of the bipolar transistors are expressed by the equations (137) and (138), respectively.

The output currents (drain currents) I1, I2 and I3 from the MOS transistors M1, M2 and M3 are such that

I₁=I₂=I₃ (143-1)

I_{C2}<I_{C3}(=I₃) (143-2)

and

V_{BE2}<V_{BE3} (143-3)

However, for simplicity,

V_{BE2}+R₃I₁≈V_{BE3} (143-4)

The output currents (drain currents) I1 and I2 from the MOS transistors M1 and M2 are expressed respectively by

I₁=I_{C1}+V_{BE1}/R₁+(V_{BE2}+R₄I₁)/R₃ (143 -5)

and by

I₂=I_{C2}+V_{BE3}/R₅ (143-6)

Hence, the ΔVBE between the base-to-emitter voltage VBE2 of the bipolar transistor Q2 and the base-to-emitter voltage VBE1 of the bipolar transistor Q1 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{5} {I}_{1}} )}{1 - \frac{{V}_{BE 1}}{{R}_{1} {I}_{1}} - \frac{{V}_{BE 2} + {R}_{4} {I}_{1}}{{R}_{3} {I}_{1}}} \} \\ = {R}_{2} ( {I}_{1} - \frac{{V}_{BE 2} + {R}_{4} {I}_{1}}{{R}_{3}} ) - {R}_{4} {I}_{1}\end{matrix} \qquad ( 144 )$$

The reference voltage obtained may thus be expressed by

$$Vref = {R}_{L} {I}_{3} = \frac{{R}_{L} {R}_{2}}{{R}_{2} {R}_{3} + {R}_{2} {R}_{4} - {R}_{3} {R}_{4}} ( {V}_{BE 2} + \frac{{R}_{3}}{{R}_{2}} Δ {V}_{BE} ) \qquad ( 145 )$$

If ΔV_{BE} has a positive temperature characteristic, the temperature characteristic within round brackets ( ) of the equation (245) may be compensated. On the other hand, since the term within the braces { } of ln{ } of the equation (131) is varied with temperature, the temperature characteristic of ΔV_{BE}, shown by the equation (119), possesses a second-order coefficient, and may be set to a positive temperature characteristic having the PTAT line of FIG. 7 as an asymptotic line.

It may thus be expected that, with the present example, the characteristic equivalent to that of the reference voltage circuit shown in FIG. 15 may be obtained. The reference voltage compensated for temperature non-linearity may be obtained at the opposite terminal of the resistor R4 as well.

### EXAMPLE 7-11

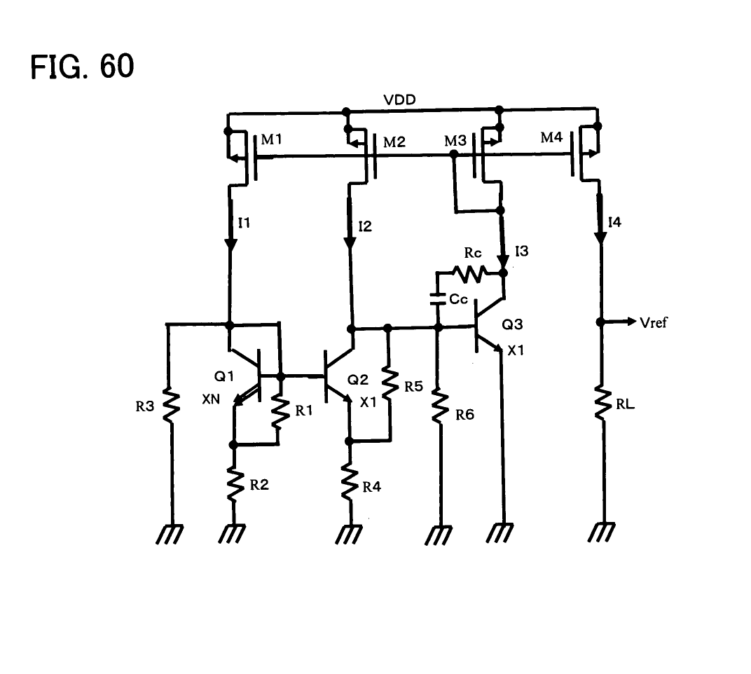

The reference voltage circuit shown in FIG. 60 has a non-linear current mirror circuit that includes first and second bipolar transistors Q1 and Q2. The emitter area of the first bipolar transistor Q1 is N times that of the unit bipolar transistor. The first bipolar transistor Q1 has a base and a collector connected in common to form an input terminal. A resistor R1 is connected between the base and the emitter of the transistor and grounded via an emitter resistor R2. The collector (base) is grounded via resistor R1. The second bipolar transistor Q2 is a unit bipolar transistor. A resistor R5 is connected between the collector and the emitter of the transistor Q2. The emitter of the second bipolar transistor is grounded via resistor R3 and the collector thereof forms an output terminal.

The collector currents of the bipolar transistors Q1 and Q2 are respectively expressed by the equations (137) and (138), respectively.

The output currents (drain currents) I1, I2 and I3 from the MOS transistors M1, M2 and M3 are such that

I1=I2=I3 (146-1)

I_{C2}<I_{C3}(=I3) (146-2)

and

V_{BE2}<V_{BE3} (146-3)

However, for simplicity,

V_{BE2}+R₃I₁≈V_{BE3} (146-4)

The output currents (drain currents) I1 and I2 from the MOS transistors M1 and M2 are expressed respectively by

I₁=I_{C1}+V_{BE1}/R₁+V_{BE3}/R₃ (146-5)

and by

I₂=I_{C2}+V_{BE2}/R₅+V_{BE3}/R6 (146-6)

Hence, the difference ΔVBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln \{ \frac{N ( 1 - \frac{{V}_{BE 2}}{{R}_{5} {I}_{1}} - \frac{{V}_{BE 3}}{{R}_{6}} )}{1 - \frac{{V}_{BE 1}}{{R}_{1} {I}_{1}} - \frac{{V}_{BE 3}}{{R}_{3} {I}_{1}}} \} \\ = {R}_{2} ( {I}_{1} - \frac{{V}_{BE 3}}{{R}_{3}} ) - {R}_{4} ( {I}_{1} - \frac{{V}_{BE 3}}{{R}_{6}} )\end{matrix} \qquad ( 147 )$$

The reference voltage obtained may thus be expressed as

$$Vref = {R}_{L} {I}_{3} = \frac{{R}_{L}}{{R}_{2} - {R}_{4}} \frac{{R}_{2} {R}_{6} - {R}_{3} {R}_{4}}{{R}_{3} {R}_{6}} ( {V}_{A} + \frac{{R}_{3} {R}_{6}}{{R}_{2} {R}_{6} - {R}_{3} {R}_{4}} Δ {V}_{BE} ) \qquad ( 148 )$$

If V_{BE3} has a negative temperature characteristic and ΔV_{BE} has a positive temperature characteristic, the temperature characteristic within the round brackets ( ) of the equation (148) may be compensated. On the other hand, since the term within the braces { } of ln{ } is varied with temperature, the temperature characteristic of ΔV_{BE}, shown by the equation (147), possesses a second-order coefficient, and may be set to a positive temperature characteristic having the PTAT line of FIG. 7 as an asymptotic line.

It may thus be expected that, with the present example, the characteristic equivalent to that of the reference voltage circuit shown in FIG. 17 may be obtained. A reference voltage compensated for temperature non-linearity may be obtained at the opposite terminal of the resistor R4 as well.

### EXAMPLE 8

The number of transistors of the non-linear current mirror circuit may be matched to that of the linear current mirror circuit that self-biases the non-linear current mirror circuit to further simplify the circuit configuration.

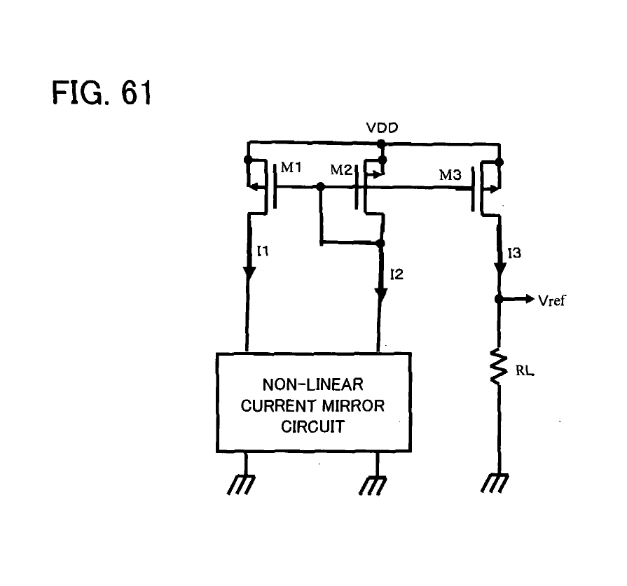

If, in the self-biased reference voltage circuit, shown in FIG. 49, the collector of the bipolar transistor Q2 of the non-linear current mirror circuit by itself is able to set the collector current and the current supplied from the linear current mirror circuit equal to each other, it is possible to simplify the self-biasing linear current mirror circuit as shown in FIG. 61.

Referring to FIG. 61, the MOS transistors M1 to M3 form a linear current mirror circuit. The MOS transistors M1 and M3 form outputs and are connected to an input of the non-linear current mirror circuit and to an output terminal of the non-linear current mirror circuit, respectively.

The MOS transistor M2 has a gate and a drain connected together to form an input terminal of the linear current mirror circuit. The gate-drain current path is also connected to an output terminal of the non-linear current mirror circuit.

Referring to FIG. 61, the MOS transistors M1 to M3 form a linear current mirror circuit, and the MOS transistors M1 and M3 form outputs one of which operates as an input to the non-linear current mirror circuit and the other of which actuates an output circuit of the reference voltage circuit. The MOS transistor M2 has a gate and a drain connected together to form an input of the linear current mirror circuit. The linear current mirror circuit is driven by the output current of the non-linear current mirror circuit to form a self-biased circuit.

### EXAMPLE 8-1

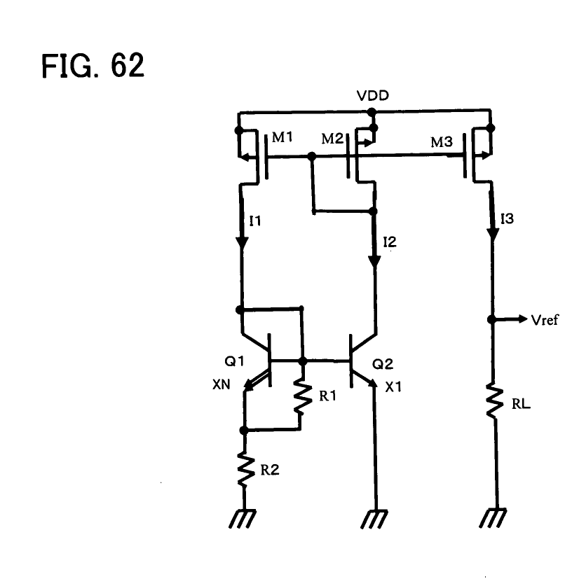

FIG. 62 is a diagram showing the configuration of FIG. 61 in case the non-linear current mirror circuit is one shown in FIG. 38A. The collector currents IC1 and IC2 of the bipolar transistors Q1 and Q2 are expressed respectively as

$$\begin{matrix}{I}_{C 1} = {NI}_{S} exp ( \frac{{V}_{BE 1}}{{V}_{T}} ) \\ and by & ( 149 ) \\ {I}_{C 2} = {I}_{S} exp ( \frac{{V}_{BE 2}}{{V}_{T}} ) = {I}_{2} & ( 150 )\end{matrix}$$

The output currents (drain currents) from the MOS transistor M1 are respectively expressed by

I₁=I_{C1}+V_{BE1}/R₁ (150-1)

and by

I₂=I_{C2} (150-2)

Hence, the difference ΔVBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1}}{{R}_{1} {I}_{1}}} ) = {R}_{2} {I}_{1}\end{matrix} \qquad ( 151 )$$

In the equation (151), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−V_{BE1}/(R₁I₁)}.

That is, since the term within ( ) of ln( ) in the equation (151) is changed with temperature, the temperature characteristic of ΔV_{BE}, shown by the equation (151), possesses a second-order coefficient. The forward voltages VF1 and VF2 of the respective diodes are as indicated by a chain-dotted line and a double-dotted chain line in FIG. 11, respectively, with the voltage difference ΔVF between VF1 and VF2 being a constant value despite changes in temperature.

Thus, the reference voltage Vref obtained is expressed by

Vref=R_{L}I₄=(R_{L}/R₂)Δ V_{BE} (152)

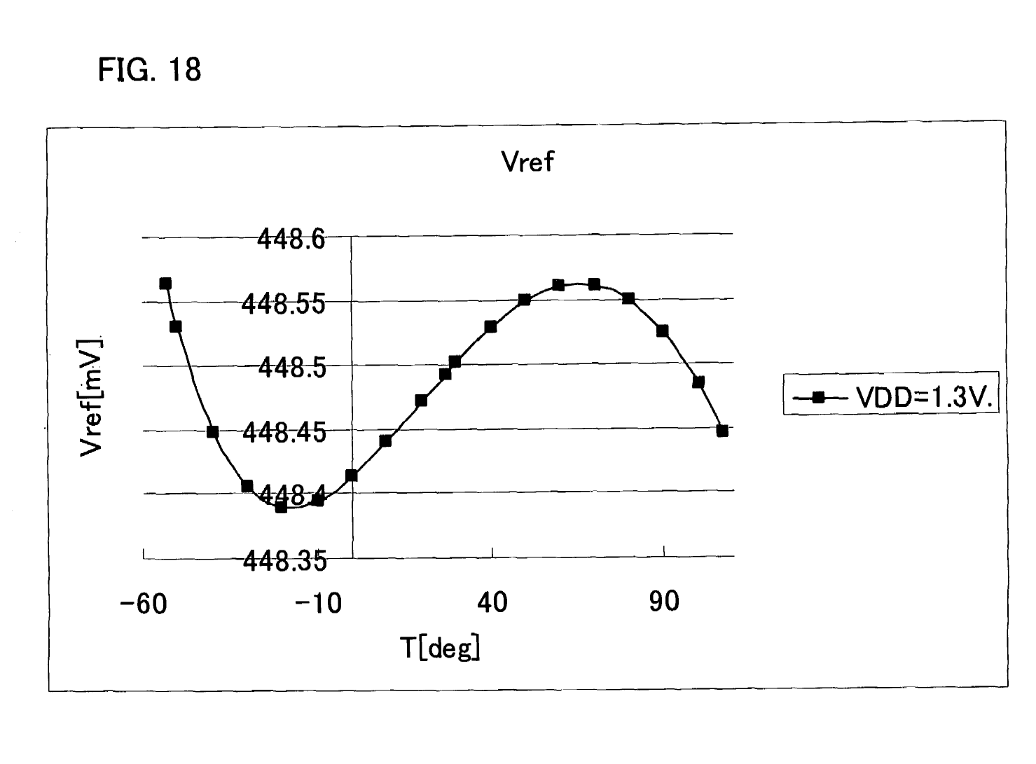

It may thus be expected that, with the present example, the characteristic equivalent to that of the reference voltage circuit shown in FIG. 18 may be obtained. The reference voltage, compensated for temperature non-linearity proper to a transistor, may be obtained from the opposite side terminal of the resistor R2 as well.

### EXAMPLE 8-2

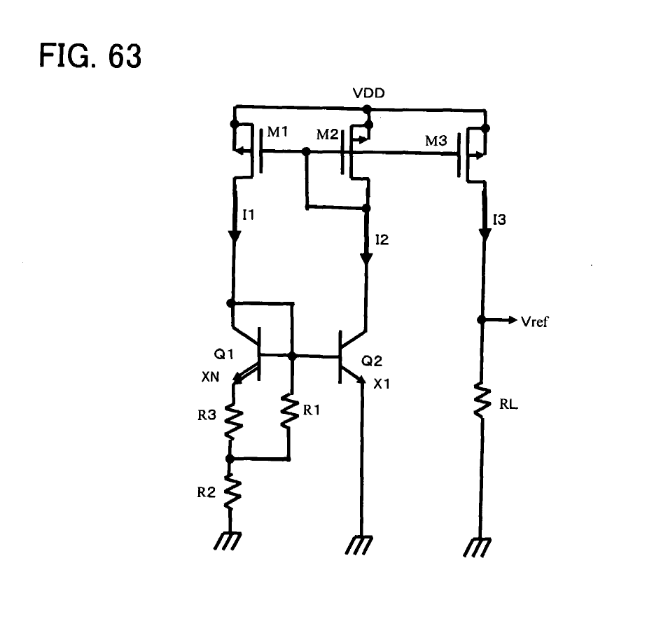

FIG. 63 is a circuit diagram showing the configuration of FIG. 61 in which the non-linear current mirror circuit is that shown in FIG. 38B. The collector currents I1 and I2 of the bipolar transistor Q1, Q2 are indicated by the equations (149) and (150), respectively.

In FIG. 63, the output currents (drain currents) I1 and I2 from the MOS transistors M1 and M2 are given by

I₁=I_{C1}+(V_{BE1}+R₃I_{C1})/R1 (153)

and by

I₂=I_{C2} (154)

Hence, the difference ΔVBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 2} - {V}_{BE 1} \\ = {V}_{T} ln ( \frac{{NI}_{C 2}}{{I}_{C 1}} ) \\ = {V}_{T} ln ( \frac{N}{1 - \frac{{V}_{BE 1} + {R}_{0} {I}_{C 1}}{{R}_{1} {I}_{1}}} ) \\ = {R}_{2} {I}_{1} + {R}_{0} {I}_{C 1}\end{matrix} \qquad ( 155 )$$

In the equation (141), V_{T} is proportionate to the absolute temperature, and hence is varied in a range of 224/300˜1˜376/300 for temperature changes of ±76° C. The corresponding exponential values are 2.10995˜2.71828˜3.501997, with the rate of change being −22.4%˜0%˜+28.8%. However, since the width of temperature change of ±76° C. is 152°, the rate of change of 51.2% divided by the width of temperature change is −0.337%/° C. at most. It appears that this order of temperature changes may safely be coped with by 1/{1−(V_{BE1}+R₃I_{C1})/(R₁I₁)}.

That is, since the term within ( ) of ln( ) of the equation (155) is changed with temperature, the temperature characteristic of ΔV_{BE}, shown by the equation (155), possesses a second-order coefficient, and may be set to a positive temperature characteristic having the PTAT line as an asymptotic line.

The reference voltage Vref obtained may thus be expressed by

Vref=R_{L}/I₄=(R_{L}/R₂)(Δ V_{BE}−R₀I^{C1}) ( 156)

It may thus be expected that, with the present example, the characteristic equivalent to that of the reference voltage circuit shown in FIG. 8 may be obtained. The reference voltage, compensated for temperature non-linearity proper to a transistor, may also be obtained from the opposite side terminal of the resistor R2.

### EXAMPLE 8-3

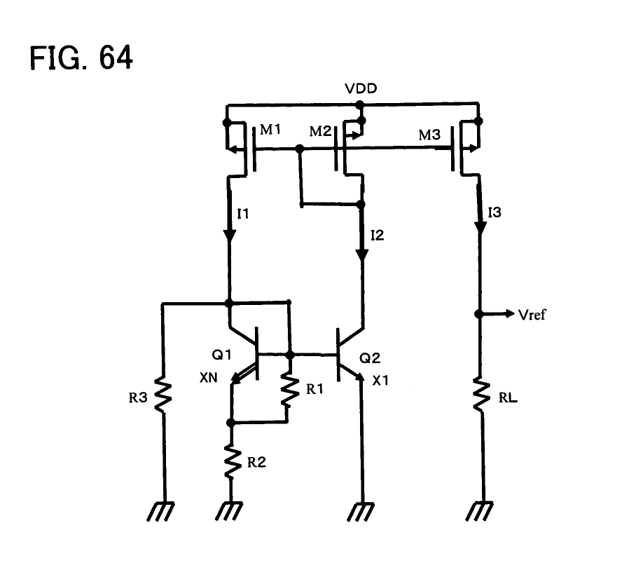

FIG. 64 is a circuit diagram showing the configuration of FIG. 61 in which the non-linear current mirror circuit is that shown in FIG. 38C.

The collector currents I1 and I2 of the bipolar transistor Q1, Q2 are indicated by the equations (149) and (150), respectively.

The output current (drain current) I1 from the MOS transistor M1 is expressed by

$${I}_{1} = {I}_{C 1} + \frac{{V}_{BE 1}}{{R}_{1}} + \frac{{V}_{BE 2}}{{R}_{3}} \qquad ( 157 )$$

The output current (drain current) from the MOS transistor M2 is IC2.

Hence, the difference ΔVBE between the base-to-emitter voltage VBE1 of the bipolar transistor Q1 and the base-to-emitter voltage VBE2 of the bipolar transistor Q2 may be expressed as

$$\begin{matrix}Δ {V}_{BE} = {V}_{BE 2} - {V}_{BE 1} \\ = {V}_{T} ln ( \frac{{NI}_{C 2}}{{I}_{C 2}} ) \\ = {V}_{T} ln ( \frac{N}{1 - \frac{{V}_{BE 1}}{{R}_{1} {I}_{1}} - \frac{{V}_{BE 2}}{{R}_{3} {I}_{1}}} ) \\ = {R}_{2} ( {I}_{1} - \frac{{V}_{BE 2}}{{R}_{3}} )\end{matrix} \qquad ( 158 )$$

The reference voltage Vref may thus be found as

$$Vref = {R}_{L} {I}_{4} = \frac{{R}_{L}}{{R}_{3}} ( {V}_{BE 2} + \frac{{R}_{3}}{{R}_{2}} Δ {V}_{BE} ) \qquad ( 159 )$$

It is sufficient to set R4/R3<1 in the equation (159) and to set the value of R3/R1 so that, within ( ) the temperature characteristic will be compensated by VBE2 having a negative temperature characteristic and by ΔV_{BE} having a positive temperature characteristic. It is noted that ΔV_{BE} does not possess a linear positive temperature characteristic, as indicated by the equation (158). The denominator of the term within ( ) of ln( ) is a function having a positive temperature characteristic, and the term within ( ) of ln( ) has a negative temperature characteristic. Further, as a result of logarithmic compression, ΔV_{BE} does not possess a linear positive temperature characteristic but its value is increased and decreased at lower temperature and higher temperature, respectively.

Thus, in the equation (159), the term within ( ) may be set so that temperature non-linearity of ΔV_{BE2} will be compensated by ΔV_{BE}. On the other hand, since the term within ( ) of ln( ) of the equation (158) is changed with temperature, the temperature characteristic of ΔVBE, shown by the equation (158), possesses a second-order coefficient, and is approximate to a positive temperature characteristic having the PTAT line of FIG. 7 as an asymptotic line.

Thus, with the present example, the characteristic equivalent to that of the reference voltage circuit shown in FIG. 31 are expected to be obtainable.

### EXAMPLE 9

With the self-biased reference voltage circuit, shown in FIG. 61, an output transistor may be removed from the self-biasing linear current mirror circuit to further simplify the circuit. That is, the circuit may be stacked on an output resistor to cause the circuit current to flow through the output resistor to generate the reference voltage.

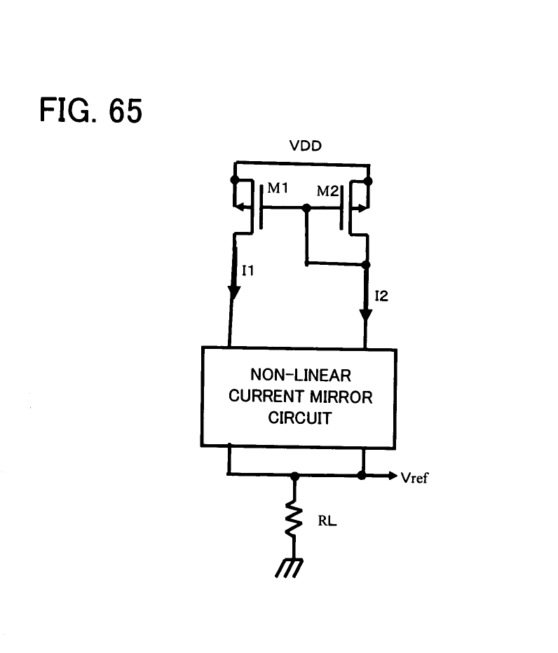

In the self-biased reference voltage circuit, shown in FIG. 61, the output transistor may be removed from the self-biasing linear current mirror circuit, as shown in FIG. 65, thereby simplifying the circuit.

Referring to FIG. 65, the MOS transistor M2 has a gate and a drain connected together. The MOS transistors M1 and M2 have gates connected together to form a linear current mirror circuit and are respectively connected to an input and an output of the non-linear current mirror circuit. The lower end of the non-linear current mirror circuit is connected to a resistor RL and is grounded via this resistor. The terminal voltage of the resistor RL operates as an output of the reference voltage circuit. Hence, a current sum (I1+I2) flows through the resistor RL.

Referring to FIG. 65, the MOS transistor M2 has a gate and a drain connected together. The MOS transistors M1 and M2 form a linear current mirror circuit and are respectively connected to an input and an output of the non-linear current mirror circuit. A current I1 flows through the MOS transistor M1, whilst a current I2 flows through the MOS transistor M2. The non-linear current mirror circuit has its lower end connected to the resistor RL and is grounded via this resistor. The terminal voltage of this resistor RL serves as an output of the reference voltage circuit. Hence, a current sum (I1+I2) flows through the resistor RL.

Comparison with the reference voltage circuit of FIG. 61 indicates that the MOS transistor M3 is eliminated. However, since the circuit is stacked on the output resistor, the power supply voltage needs to be higher by an amount corresponding to the output voltage of the reference voltage circuit.

### EXAMPLE 9-1

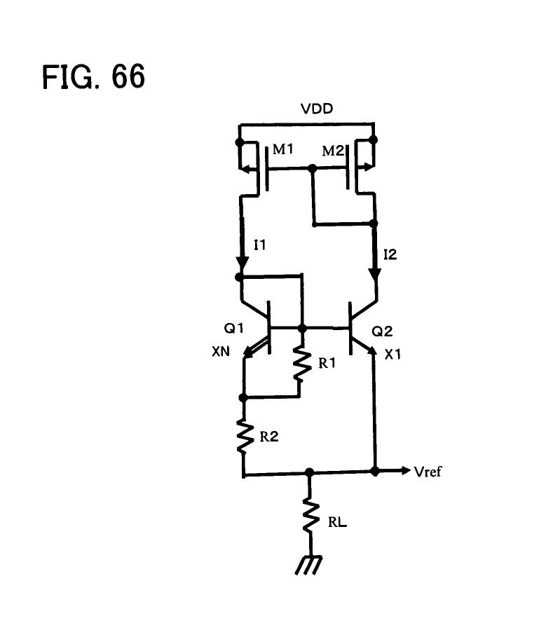

The reference voltage circuit, shown in FIG. 62, may be modified to a reference voltage circuit shown in FIG. 65. FIG. 66 is a circuit diagram showing the so obtained reference voltage circuit.

Referring to FIG. 66, a non-linear current mirror circuit is made up of bipolar transistors Q1 and Q2, and resistors R1, R2. A resistor RL is connected between a connection node of the resistor R2 and an emitter of the transistor Q2 and the ground. A linear current mirror circuit (M1, M2) is connected to the collectors of the transistors Q1 and Q2. A reference voltage, compensated for temperature non-linearity of transistors, may also be obtained from the opposite terminal of the resistor R2.

### EXAMPLE 9-2

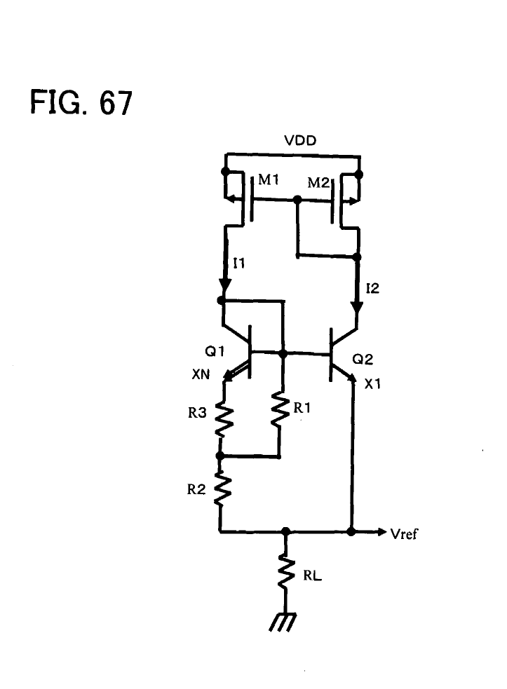

The reference voltage circuit, shown in FIG. 63, may be modified to a reference voltage circuit shown in FIG. 65. FIG. 67 shows the so obtained reference voltage circuit.

In FIG. 67, a non-linear current mirror circuit is made up of bipolar transistors Q1 and Q2, and resistors R1, R2 and R3. A resistor RL is connected between a connection node of the resistor R2 and an emitter of the transistor Q2 and the ground. A linear current mirror circuit (M1, M2) is connected to the collectors of the transistors Q1 and Q2. A reference voltage, compensated for temperature non-linearity of transistors, may also be obtained from the opposite terminal of the resistor R2.

### EXAMPLE 9-3

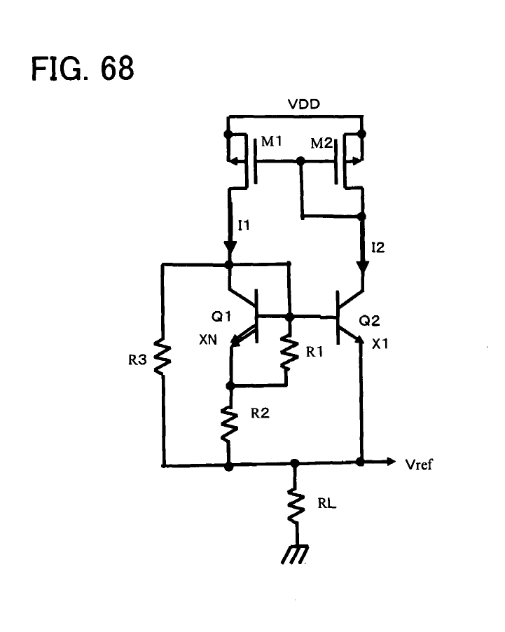

The reference voltage circuit, shown in FIG. 64, may be modified to a reference voltage circuit shown in FIG. 65. FIG. 68 shows the so obtained reference voltage circuit.

Referring to FIG. 68, a non-linear current mirror circuit is made up of bipolar transistors Q1 and Q2, and resistors R1, R2. A resistor RL is connected between a junction point of resistors R2 and R3 and the emitter of the transistor Q2 and the ground. A linear current mirror circuit (M1, M2) is connected to the collectors of the transistors Q1 and Q2.

### EXAMPLE 10

In similar manner, an output transistor may be eliminated from the self-biasing linear current mirror circuit shown in FIG. 21, thereby further simplifying the circuit. That is, the circuit may be stacked on an output resistor to cause the circuit current to flow through the output resistor to generate the reference voltage.

In the self-biased reference voltage circuit of FIG. 21, including an OP amp as control means, an output transistor may be eliminated from the self-biasing linear current mirror circuit thereby further simplifying the circuit.

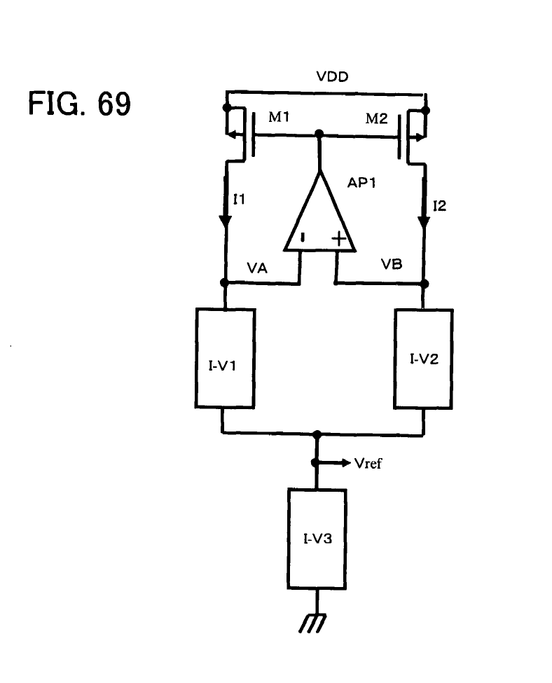

Referring to FIG. 69, a MOS transistor M2 has a gate and a drain connected together, and MOS transistors M1 and M2 have gates connected in common to form a linear current mirror circuit. An end VA of a first current-to-voltage converter I-V1 is connected to a connection node of the drain of the MOS transistor M1 and an inverting input terminal of an OP amp. An enc VB of a second current-to-voltage converter I-V2 is connected to a connection node of the drain of the MOS transistor M2 and a non-inverting input terminal of the OP amp. The opposite ends of the first current-to-voltage converter I-V1 and the second current-to-voltage converter I-V2 are connected together. A third current-to-voltage converter I-V3 is connected to the lower sides of the first and second current-to-voltage converters I-V1 and I-V2. It is via this third current-to-voltage converter I-V3 that the reference voltage circuit is grounded.

A sum current (I1+I2) of the drain currents I1 and I2 of the MOS transistor flows through the third current-to-voltage converter I-V3. The terminal voltage of the third current-to-voltage converter I-V3 acts as the reference voltage Vref.

Comparison to the reference voltage circuit shown in FIG. 21 indicates that the MOS transistor M3 has now been eliminated. However, since the circuit is stacked, the power supply voltage needed is higher by an amount corresponding to the output voltage of the reference voltage circuit.

### EXAMPLE 10-1

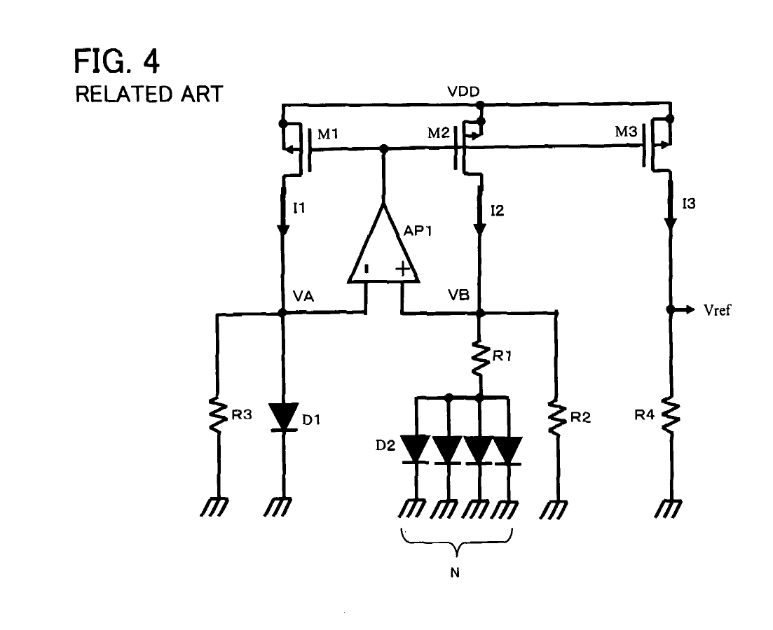

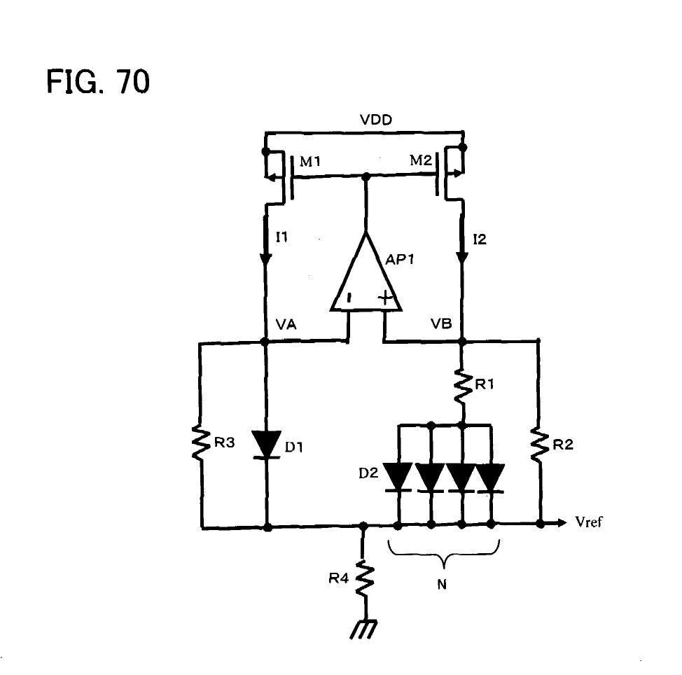

The Bamba's reference voltage circuit, shown in FIG. 4, may be modified to a reference voltage circuit shown in FIG. 69. FIG. 70 shows a so obtained reference voltage circuit.

In the configuration of FIG. 70, the output transistor M3 is eliminated from the linear current mirror circuit (M1, M2, M3), and a resistor R4 (third current-to-voltage converter I-V3) is connected to the lower side of the first current-to-voltage converter I-V (diode D1 and resistor R3) and the second current-to-voltage converter I-V2 (a plurality of diodes D2 and resistors R1, R2). The reference voltage circuit is grounded via the resistor R4 (third current-to-voltage converter I-V3).

With the Bamba's reference voltage circuit, the temperature non-linearity of diodes may be compensated only by about one-half. However, it may be expected that the temperature non-linearity of diodes is compensated to an acceptable extent.

### EXAMPLE 10-2

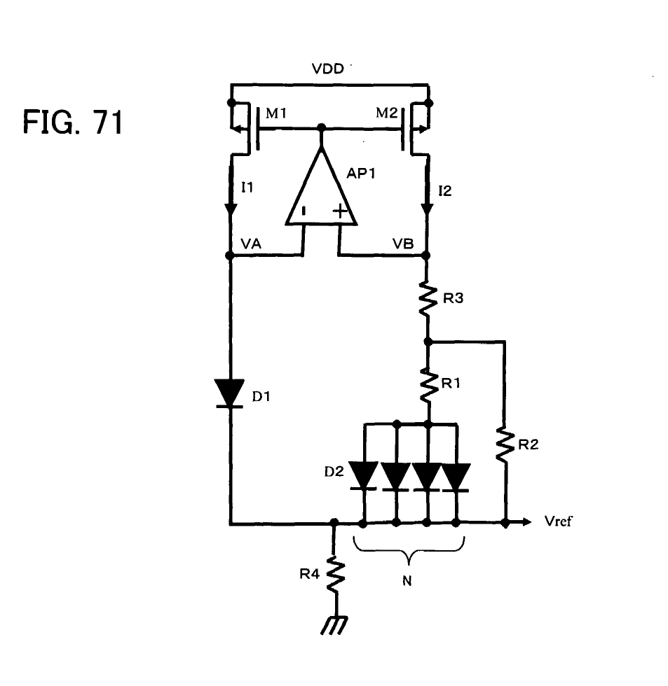

The reference voltage circuit of FIG. 8 may be modified to a reference voltage circuit shown in FIG. 69. FIG. 71 shows a so obtained reference voltage circuit.

Referring to FIG. 71, showing the present example, the output transistor M3 is omitted from the linear current mirror circuit (M1, M2, M3) of FIG. 8, and a resistor R4 (third current-to-voltage converter I-V3) is connected to the lower end of the first current-to-voltage converter (diode D1) and the second current-to-voltage converter (a plurality of diodes D2 and resistors R1 to R3) of FIG. 8. The reference voltage circuit is grounded via this resistor R4 (third current-to-voltage converter I-V3).

In this circuit, the resistor R1 is redundant. It may however be expected that the temperature non-linearity is appreciably compensated to lead to an improved characteristic. If the point of connection of the resistor R3 is changed to a point between D2/R2 and Vref terminal, that is, between a junction point of the parallel connection of diodes D2, more precisely, the cathodes of the diodes D2, and the resistor R2, and the Vref terminal, the reference voltage, compensated for temperature non-linearity, may also be obtained from the opposite terminal of the resistor R3, that is, from the terminal of the resistor R3 opposite to the terminal connected to the Vref terminal.

### EXAMPLE 10-3

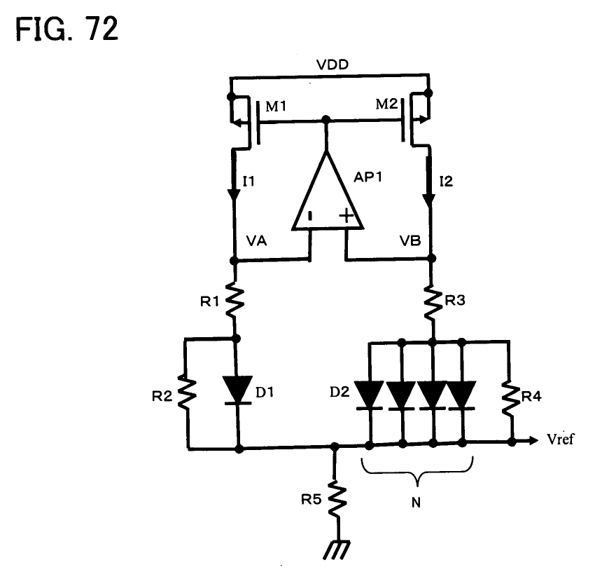

The reference voltage circuit, shown in FIG. 10, may be changed to a reference voltage circuit shown in FIG. 69. FIG. 72 shows the so obtained reference voltage circuit.

In the present example, shown in FIG. 72, the output transistor M3 is omitted from the linear current mirror circuit (M1, M2, M3) of FIG. 10. A resistor R5 (third current-to-voltage converter) is connected to the lower side of the first current-to-voltage converter (diode D1 and resistor R2) and the second current-to-voltage converter (a plurality of diodes D2 and resistors R4, R3). The reference voltage circuit is grounded via resistor R5 (third current-to-voltage converter). In the present example, temperature non-linearity proper to a diode may be expected to be compensated to lead to improved characteristic equivalent to that of the circuit of FIG. 13. If the point of connection of the resistors R1 and R3 is changed, more specifically, the point of connection of the resistor R1 is changed to a point between D1/R2 and the Vref terminal, that is, between a point of connection of the parallel-connected diodes D1, more precisely, the cathode of D1, and the resistor R2, and the Vref terminal, and the point of connection of the resistor R3 is changed to a point between D2/R4 and the Vref terminal, that is, between a point of connection of the parallel-connected diodes D2, more precisely, the cathodes of these diodes, and the resistor R4, and the Vref terminal, it is possible to take out the reference voltage, compensated for temperature non-linearity of transistors, also from the opposite side terminals of the resistors R1 and R3, that is, the terminals distinct from the terminals thereof connected to the Vref terminal.

### EXAMPLE 10-4

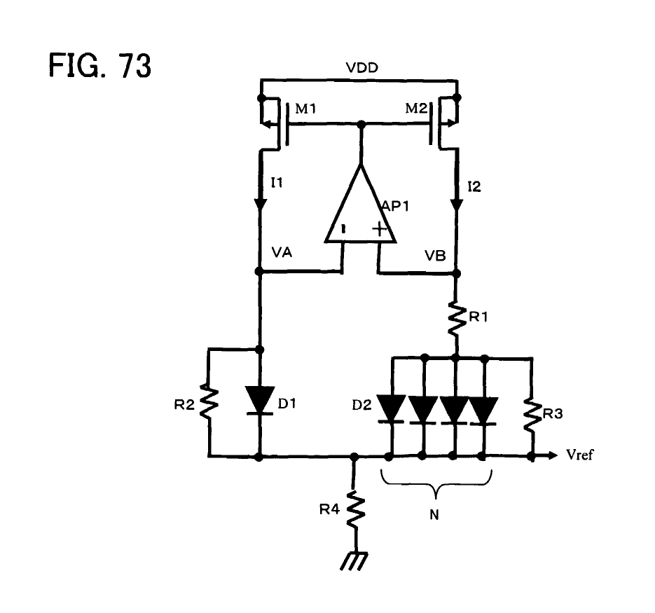

The reference voltage circuit, shown in FIG. 13, may be changed to the reference voltage circuit shown in FIG. 69. FIG. 73 shows the so obtained reference voltage circuit.

In the present example, shown in FIG. 73, the output transistor M3 is omitted from the linear current mirror circuit (M1, M2, M3) of FIG. 13. A resistor R5 (third current-to-voltage converter) is connected to the lower side of the first current-to-voltage converter (diode D1 and resistor R2) and the second current-to-voltage converter I-V2 (a plurality of diodes D2 and resistors R1, R3). The reference voltage circuit is grounded via resistor R5 (third current-to-voltage converter). In the present example, temperature non-linearity proper to a diode is expected to be compensated to lead to improved characteristic equivalent to that of the circuit of FIG. 13. If the point of connection of the resistors R1 is changed, more specifically, the point of connection of the resistor R1 is changed to a point between D2/R3 and the Vref terminal, that is, between a point of connection of the parallel-connected diodes D2, more precisely, the cathodes of these diodes, and the resistor R3, and the Vref terminal, it is possible to obtain the reference voltage, compensated for temperature non-linearity of transistors, also from the opposite side terminal of the resistor R1, that is, the terminal distinct from the terminal thereof connected to the Vref terminal.

### EXAMPLE 10-5

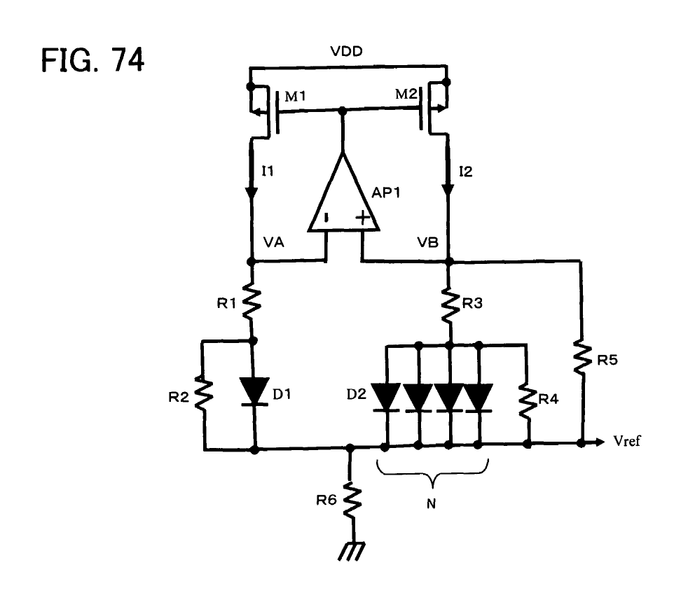

The reference voltage circuit, shown in FIG. 15, may be changed to the reference voltage circuit shown in FIG. 69. FIG. 74 shows the so obtained reference voltage circuit.

In the present example, shown in FIG. 74, the output transistor M3 is omitted from the linear current mirror circuit (M1, M2, M3) of FIG. 15. A resistor R6 (third current-to-voltage converter) is connected to the lower side of the first current-to-voltage converter (diode D1 and resistor R2) and the second current-to-voltage converter (a plurality of diodes D2 and resistors R4, R3). The reference voltage circuit is grounded via resistor R6 (third current-to-voltage converter). In the present example, temperature non-linearity proper to a diode may be expected to be compensated to lead to improved characteristic equivalent to that of the circuit of FIG. 15. If the point of connection of the resistors R1 is changed, more specifically, the point of connection of the resistor R1 is changed to a point between D1/R2 and the Vref terminal, that is, between a point of connection of the parallel-connected diode D1, more precisely, its cathode, and the resistor R2, and the Vref terminal, it is possible to obtain the reference voltage, compensated for temperature non-linearity of transistors, also from the opposite side terminals of the resistor R1, that is, the terminal distinct from the terminal thereof connected to the Vref terminal.

### EXAMPLE 10-6

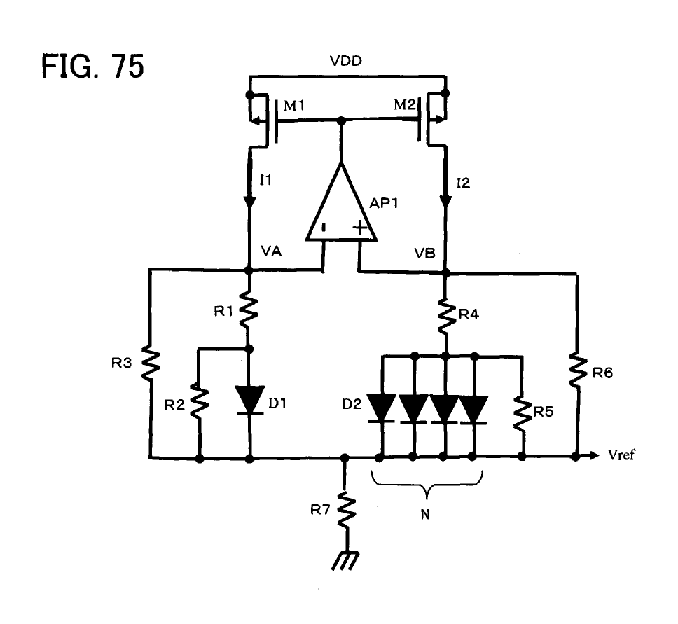

The reference voltage circuit, shown in FIG. 17, may be changed to the reference voltage circuit shown in FIG. 69. FIG. 75 shows the so obtained reference voltage circuit.

In the present example, shown in FIG. 75, the output transistor M3 is omitted from the linear current mirror circuit (M1, M2, M3) of FIG. 17. A resistor R7 (third current-to-voltage converter) is connected to the lower sides of the first current-to-voltage converter (diode D1 and resistors R2, R3) and the second current-to-voltage converter (a plurality of diodes D2 and resistors R4, R5). The reference voltage circuit is grounded via resistor R7 (third current-to-voltage converter). In the present example, temperature non-linearity proper to a diode may be expected to be compensated to lead to improved characteristic equivalent to that of the circuit of FIG. 15.

### EXAMPLE 10-7

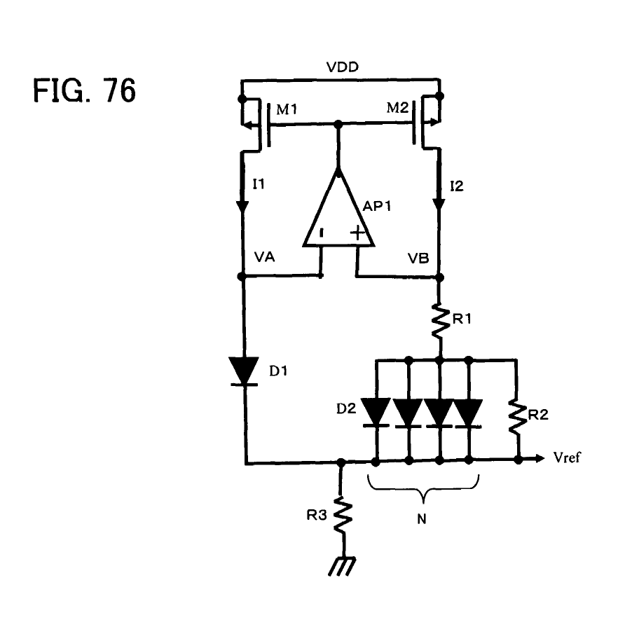

The reference voltage circuit, shown in FIG. 19, may be changed to the reference voltage circuit shown in FIG. 69. FIG. 76 shows the so obtained reference voltage circuit.

In the present example, shown in FIG. 76, the output transistor M3 is omitted from the linear current mirror circuit (M1, M2, M3) of FIG. 19, and a resistor R3 (third current-to-voltage converter) is connected to the lower sides of the first current-to-voltage converter (diode D1) and the second current-to-voltage converter (a plurality of diodes D2 and resistors R1, R2) of FIG. 19, The reference voltage circuit is grounded via the resistor R3 (third current-to-voltage converter). With the present example, temperature no-linearity of diodes may be expected to be compensated to lead to an improved characteristic to the same extent as in FIG. 17. If the point of connection of the resistor R1 is changed, more specifically, the point of connection of the resistor R1 is changed to a point between D1/R2 and the Vref terminal, that is, between a point of connection of the parallel-connected diode D1, more precisely its cathode, and the resistor R2, and the Vref terminal, the reference voltage, compensated for temperature non-linearity of transistors, may also be obtained from the opposite side terminal of the resistor R1, that is, the terminal thereof distinct from the terminal connected to the Vref terminal.

### EXAMPLE 10-8

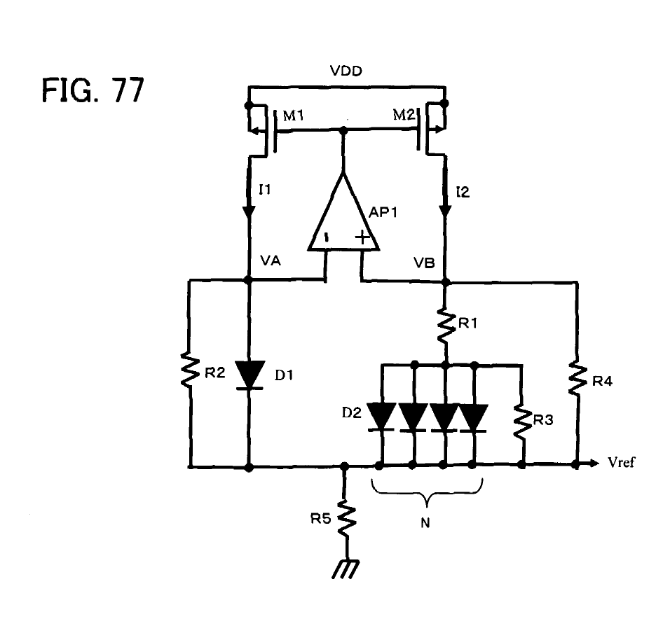

The reference voltage circuit, shown in FIG. 22, may be changed to the reference voltage circuit shown in FIG. 69. FIG. 77 shows the so obtained reference voltage circuit.

In the present example, shown in FIG. 77, the output transistor M3 is omitted from the linear current mirror circuit (M1, M2, M3) of FIG. 22. A resistor R5 (third current-to-voltage converter) is connected to the lower sides of the first current-to-voltage converter (diode D1 and resistor R2) and the second current-to-voltage converter (a plurality of diodes D2 and resistors R1, R3, R4). The reference voltage circuit is grounded via resistor R5 (third current-to-voltage converter). In the present example, temperature non-linearity proper to a diode may be expected to be compensated to lead to an improved characteristic to the same extent as in FIG. 22.

### EXAMPLE 10-9

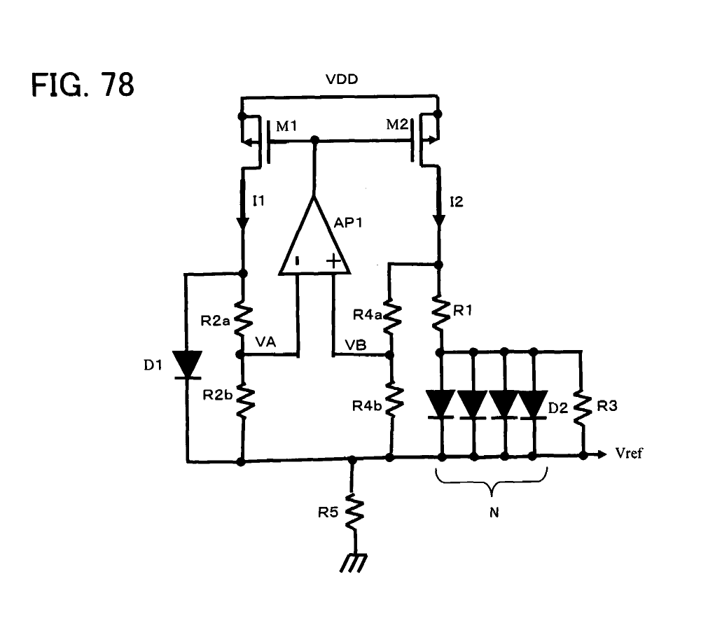

The reference voltage circuit, shown in FIG. 30, may be changed to the reference voltage circuit shown in FIG. 69. FIG. 78 shows the so obtained reference voltage circuit.

In the present example, shown in FIG. 78, the output transistor M3 is omitted from the linear current mirror circuit (M1, M2, M3) of FIG. 30. A resistor R5 (third current-to-voltage converter) is connected to the lower sides of the first current-to-voltage converter (diode D1 and resistor R2a, R2b) and the second current-to-voltage converter (a plurality of diodes D2 and resistors R1, R3, R4a, R4b). The reference voltage circuit is grounded via resistor R5 (third current-to-voltage converter). In the present example, temperature non-linearity proper to a diode may be expected to be compensated to lead to an improved characteristic to the same extent as in FIG. 30.

### EXAMPLE 10-10

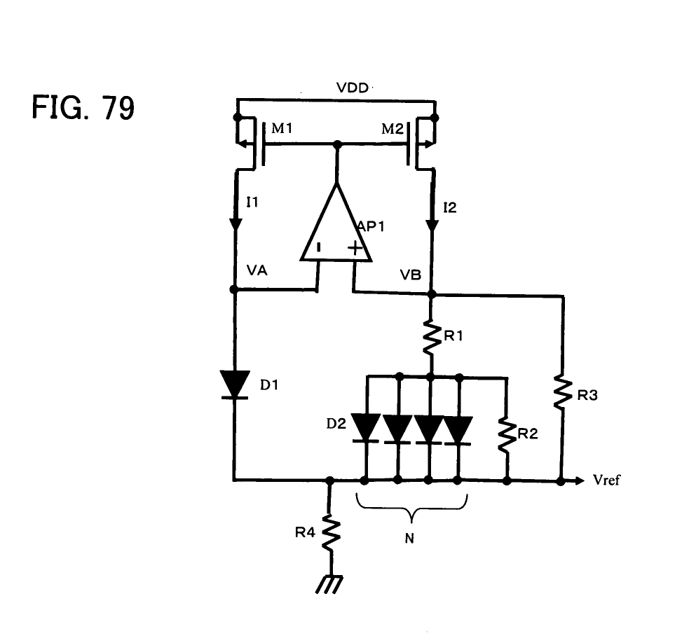

The reference voltage circuit, shown in FIG. 31, may be changed to the reference voltage circuit shown in FIG. 69. FIG. 79 shows the so obtained reference voltage circuit.

In the present example, shown in FIG. 79, the output transistor M3 is omitted from the linear current mirror circuit (M1, M2, M3) of FIG. 31. A resistor R4 (third current-to-voltage converter) is connected to the lower sides of the first current-to-voltage converter (diode D1) and the second current-to-voltage converter (a plurality of diodes D2 and resistors R1, R2). The reference voltage circuit is grounded via resistor R4 (third current-to-voltage converter). In the present example, temperature non-linearity proper to a diode may be expected to be compensated to lead to an improved characteristic to the same extent as in FIG. 31.

### EXAMPLE 11

With the self-biased reference voltage circuit, shown in FIG. 24, an output transistor (M3) may be eliminated from the self-biasing linear current mirror circuit (M1, M2, M3) thereby further simplifying the circuit. That is, the circuit may be stacked on an output resistor R4 to cause the circuit current to flow through the output resistor to generate the reference voltage.

In the self-biased reference voltage circuit, shown in FIG. 24, the output transistor may be eliminated from the self-biasing linear current mirror circuit to simplify the circuit.

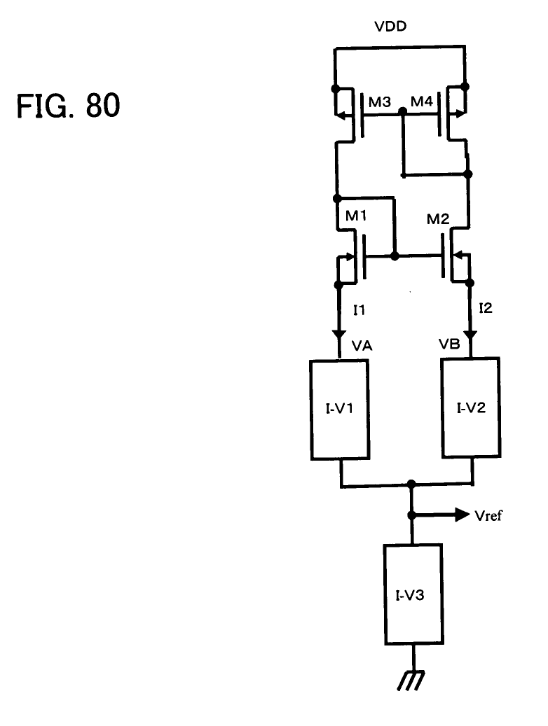

Referring to FIG. 80, an n-channel MOS transistor M1 has a gate and a drain connected together, and n-channel MOS transistors M1 and M2 have gates connected together to form a linear current mirror circuit to drive a first current-to-voltage converter I-V1 and a second current-to-voltage converter l-V2. A p-channel MOS transistor M4 has a gate and a drain connected together, and p-channel MOS transistors M3, M4 form a linear current mirror circuit which biases a linear current mirror circuit made up of n-channel MOS transistors M1 and M2. A third current-to-voltage converter I-V3 is connected to the lower side of the first and second current-to-voltage converter I-V1 and I-V2. The reference voltage circuit is grounded via this third current-to-voltage converter I-V3. The terminal voltage of the third current-to-voltage converter I-V3 forms an output of the reference voltage circuit Vref.

Referring to FIG. 80, the n-channel MOS transistors M1 and M2 form a current mirror circuit that drives the first current-to-voltage converter I-V1 and the second current-to-voltage converter l-V2. The p-channel MOS transistor M4 has a gate and a drain connected together. The p-channel MOS transistors M3 and M4 form a linear current mirror circuit which self-biases the linear current mirror circuit made up of the n-channel MOS transistors M1 and M2. These n-channel MOS transistors M1 and M2 have gates connected together. The currents I1 and I2 flow through the n-channel MOS transistors M1 and M2, respectively, to drive the first current-to-voltage converter I-V1 and the second current-to-voltage converter I-V2, respectively.

The third current-to-voltage converter I-V3 is connected to the lower sides of the first and second current-to-voltage converters I-V1 and I-V2. The reference voltage circuit is grounded via the third current-to-voltage converter I-V3.

A sum current (I1+I2) flows through the third current-to-voltage converter I-V3. The terminal voltage of the third current-to-voltage converter I-V3 represents an output Vref of the reference voltage circuit.

Comparison of the present reference voltage circuit to the reference voltage circuit shown in FIG. 24 indicates that the MOS transistor M3 has been dispensed with. However, since the circuit is stacked on the output resistor, the power supply voltage needs to be higher by an amount corresponding to the output voltage of the reference voltage circuit.

### EXAMPLE 11-1

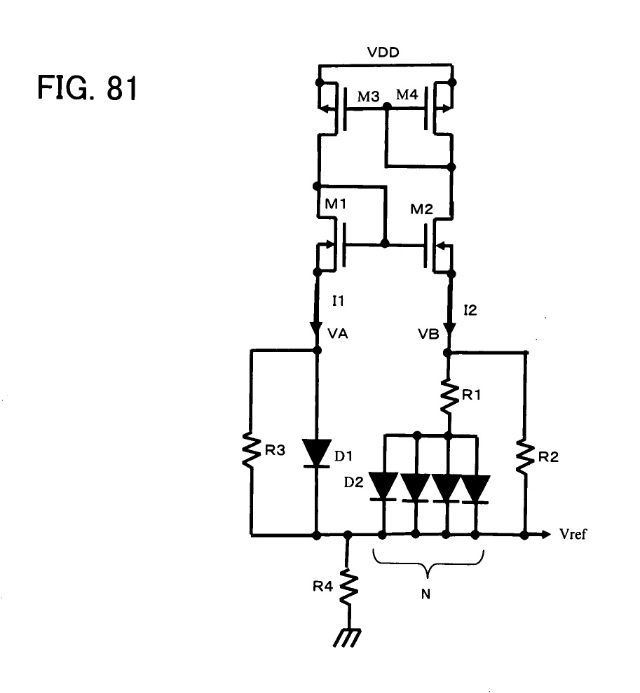

The Bamba's reference voltage circuit, shown in FIG. 4, may be modified to a reference voltage circuit shown in FIG. 80. FIG. 81 shows a so obtained reference voltage circuit.

Referring to FIG. 81, a linear current mirror circuit (M1, M2, M3) and an OP amp are deleted from FIG. 4 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter I-V1 (diode D1 and resistor R3) and the second current-to-voltage converter I-V2 (a plurality of diodes D2 and resistors R1, R2) of FIG. 4. The reference voltage circuit is grounded via this resistor R4 (third current-to-voltage converter).

With the Bamba's reference voltage circuit, the temperature non-linearity proper to a diode can be compensated only by approximately one half. With the present example, the temperature non-linearity proper to a diode is expected to be compensated satisfactorily.

### EXAMPLE 11-2

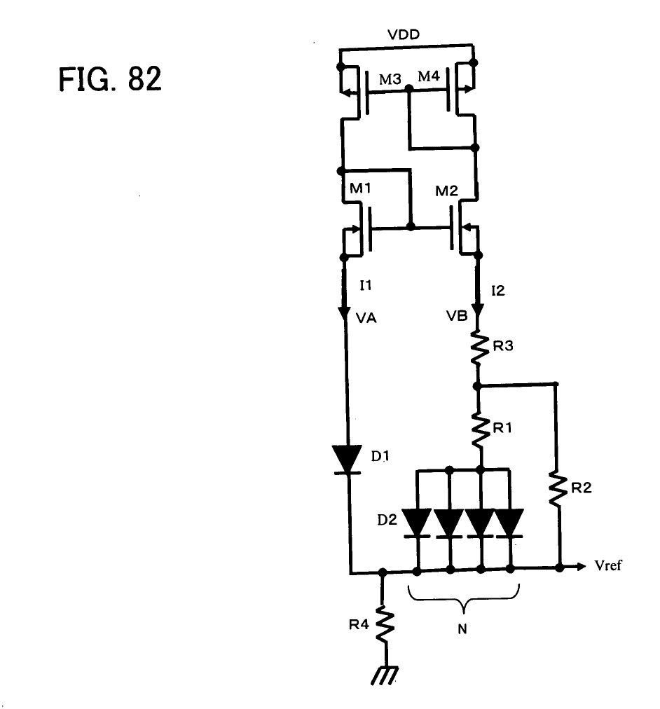

The reference voltage circuit, shown in FIG. 8, may be modified to the reference voltage circuit shown in FIG. 80. FIG. 82 shows a so obtained reference voltage circuit.

Referring to FIG. 82, a linear current mirror circuit (M1, M2, M3) and an OP amp are deleted from FIG. 8 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1) and the second current-to-voltage converter I-V2 (a plurality of diodes D2 and resistors R1, R2) shown in FIG. 8. It is via this resistor R4 (third current-to-voltage converter) that the reference voltage circuit is grounded.

In this circuit, the resistor R1 is redundant. It may however be expected that the temperature non-linearity is appreciably compensated to lead to an improved characteristic. If the point of connection of the resistor R3 is changed to a point between D2/R2 and the Vref terminal, the reference voltage, compensated for temperature non-linearity, may be obtained also from the opposite terminal of the resistor R3, that is, from the terminal of the resistor R3 opposite to its terminal connected to the Vref terminal.

### EXAMPLE 11-3

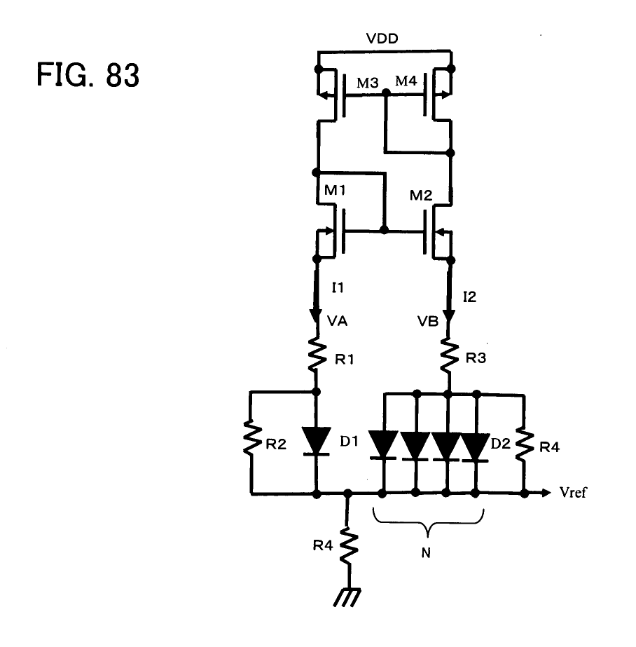

The reference voltage circuit, shown in FIG. 10, may be modified to the reference voltage circuit shown in FIG. 80. FIG. 83 shows a so obtained reference voltage circuit.

Referring to FIG. 83, a linear current mirror circuit (M1, M2, M3) and an OP amp are deleted from FIG. 10 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1 and resistor R2) and the second current-to-voltage converter (a plurality of diodes D2 and resistors R4 and R3). With the present example, the temperature non-linearity may be expected to be appreciably compensated to lead to an improved characteristic. If the points of connection of the resistors R1 and R3 are changed respectively to a point between D1/R2 and the Vref terminal and to a point between D2/R4 and the Vref terminal, the reference voltage, compensated for temperature non-linearity, may be obtained also from the opposite terminals of the resistors R1 and R3, that is, from the terminals of the resistors R1 and R3 opposite to the terminals thereof connected to the Vref terminal.

### EXAMPLE 11-4

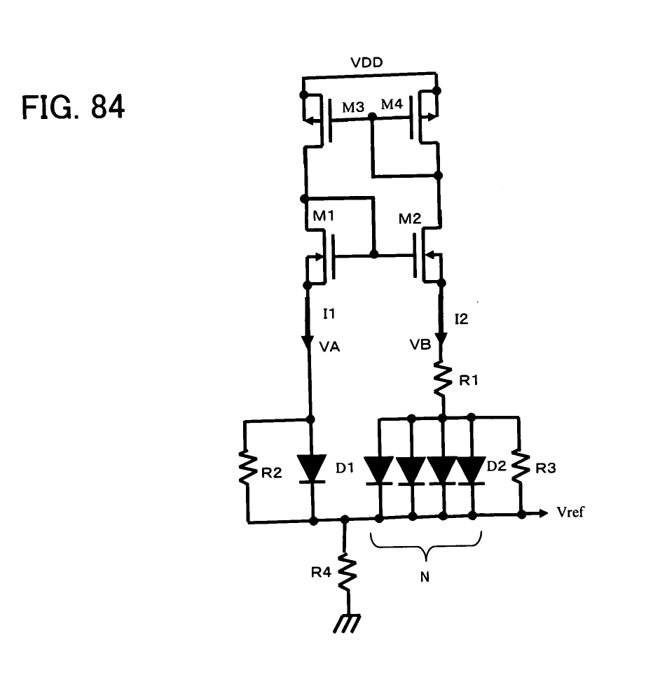

The reference voltage circuit, shown in FIG. 13, may be modified to the reference voltage circuit shown in FIG. 80. FIG. 84 shows a so obtained reference voltage circuit.

Referring to FIG. 84, a linear current mirror circuit (M1, M2, M3) and an OP amp are deleted from FIG. 13 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1 and resistor R2) and the second current-to-voltage converter (a plurality of diodes D2 and resistors R3, R1). It is via this resistor R4 (third current-to-voltage converter) that the present reference voltage circuit is grounded. With the present example, temperature non-linearity proper to a diode may be expected to be compensated to lead to an improved characteristic comparable to those obtained with FIG. 13. If the point of connection of the resistor R1 is changed to a point between D2/R3 and the Vref terminal, the reference voltage, compensated for temperature non-linearity, may be obtained also from the opposite terminal of the resistor R1, that is, from the terminal of the resistor R1 opposite to the terminal thereof connected to the Vref terminal.

### EXAMPLE 11-5

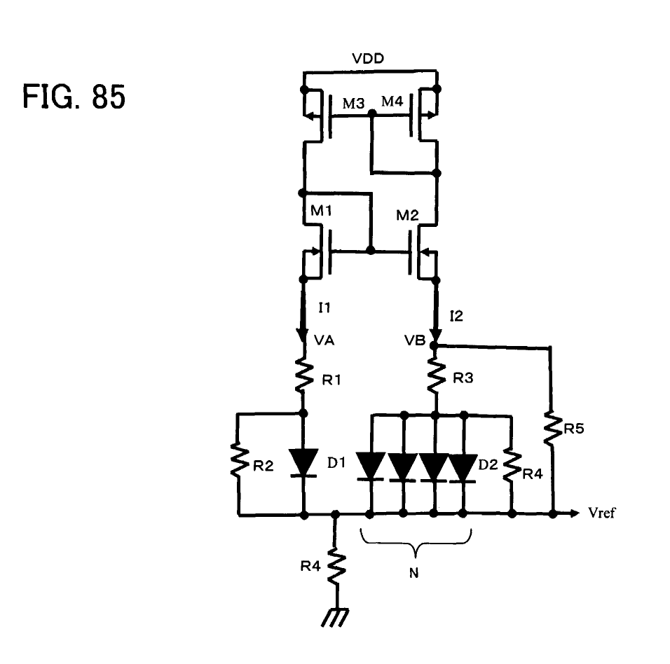

The reference voltage circuit, shown in FIG. 15, may be modified to the reference voltage circuit shown in FIG. 80. FIG. 85 shows a so obtained reference voltage circuit.

Referring to FIG. 85, a linear current mirror circuit (M1, M2, M3) and an OP amp are deleted from FIG. 15 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1 and resistor R2) and the second current-to-voltage converter (a plurality of diodes D2 and resistors R4, R3, R5) of FIG. 15.

The reference voltage circuit of the present example is grounded via this resistor R4 (third current-to-voltage converter). With the present example, temperature non-linearity proper to a diode may be expected to be compensated to lead to an improved characteristic comparable to those obtained with FIG. 15. If the point of connection of the resistor R1 is changed to a point between D1/R2 and the Vref terminal, the reference voltage, compensated for temperature non-linearity, may be obtained also from the opposite terminal of the resistor R1, that is, from the terminal of the resistor R1 opposite to the terminal thereof connected to the Vref terminal.

### EXAMPLE 11-6

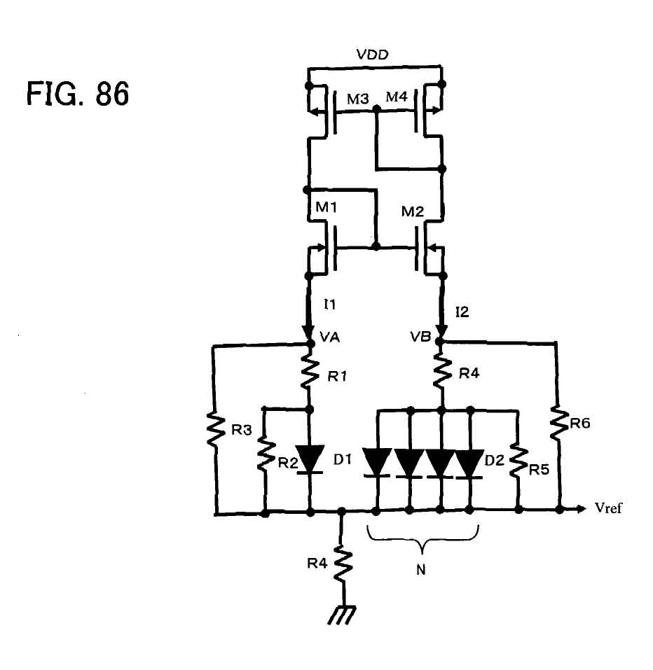

The reference voltage circuit, shown in FIG. 17, may be modified to the reference voltage circuit shown in FIG. 80. FIG. 86 shows a so obtained reference voltage circuit.

Referring to FIG. 86, the linear current mirror circuit (M1, M2, M3) and the OP amp are deleted from FIG. 17 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1 and resistors R2, R3) and the second current-to-voltage converter (a plurality of diodes D2 and resistors R2, R5, R4 and R6). It is via this resistor R4 (third current-to-voltage converter) that the present reference voltage circuit is grounded. With the present example, temperature non-linearity proper to a diode may be expected to be compensated to lead to an improved characteristic comparable to those obtained with FIG. 17.

### EXAMPLE 11-7

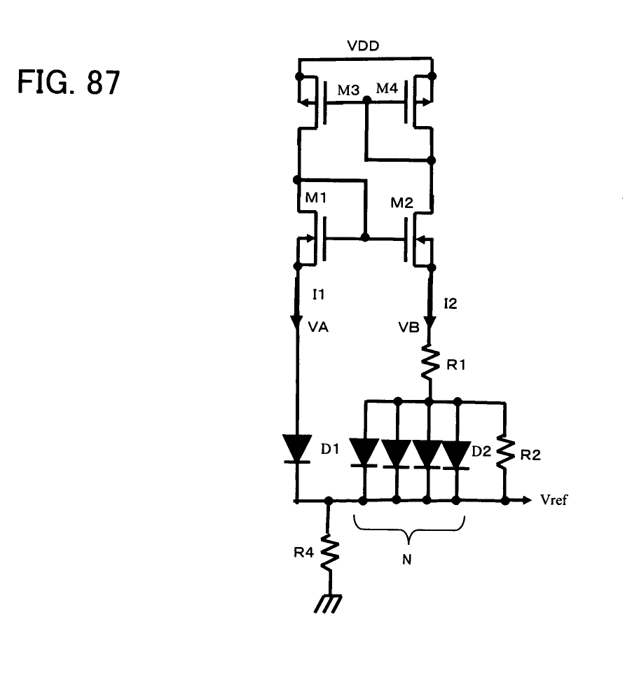

The reference voltage circuit, shown in FIG. 19, may be modified to the reference voltage circuit shown in FIG. 80. FIG. 87 shows a so obtained reference voltage circuit.

Referring to FIG. 87, the linear current mirror circuit (M1, M2, M3) and then OP amp are deleted from FIG. 19 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1) and the second current-to-voltage converter (a plurality of diodes D2 and resistors R2, R1). The present reference voltage circuit is grounded via the resistor R4 (third current-to-voltage converter). With the present example, temperature non-linearity proper to a diode may be expected to be compensated to lead to an improved characteristic comparable to those obtained with FIG. 19. If the point of connection of the resistor R1 is changed to a point between D1/R2 and the Vref terminal, the reference voltage, compensated for temperature non-linearity, may be obtained also from the opposite terminal of the resistor R1, that is, from the terminal of the resistor R1 opposite to the terminal thereof connected to the Vref terminal.

### EXAMPLE 11-8

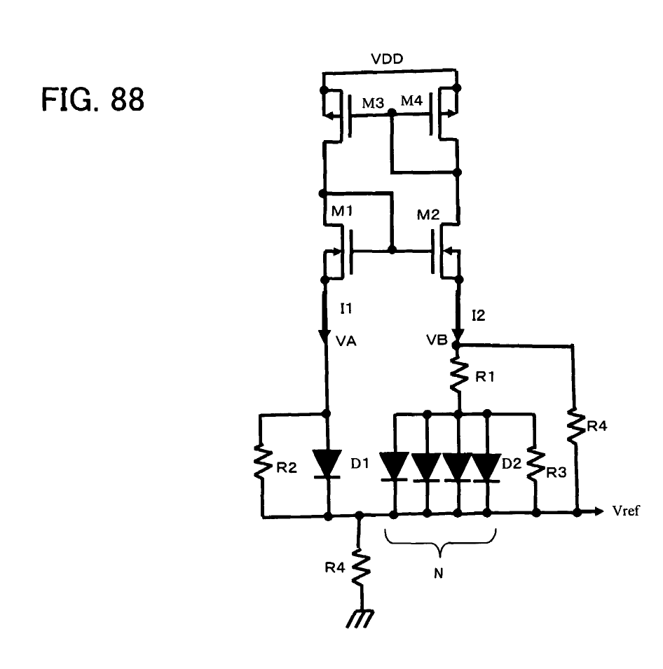

The reference voltage circuit, shown in FIG. 22, may be modified to the reference voltage circuit shown in FIG. 80. FIG. 88 shows a so obtained reference voltage circuit.

Referring to FIG. 88, the linear current mirror circuit (M1, M2, M3) and the OP amp are deleted from FIG. 22 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1 and resistor R2) and the second current-to-voltage converter (a plurality of diodes D2 and resistors R1, R3 and R4) of FIG. 22. It is via the resistor R4 (third current-to-voltage converter) that the present reference voltage circuit is grounded. With the present example, temperature non-linearity proper to a diode may be expected to be compensated to lead to an improved characteristic comparable to those obtained with FIG. 22.

### EXAMPLE 11-9

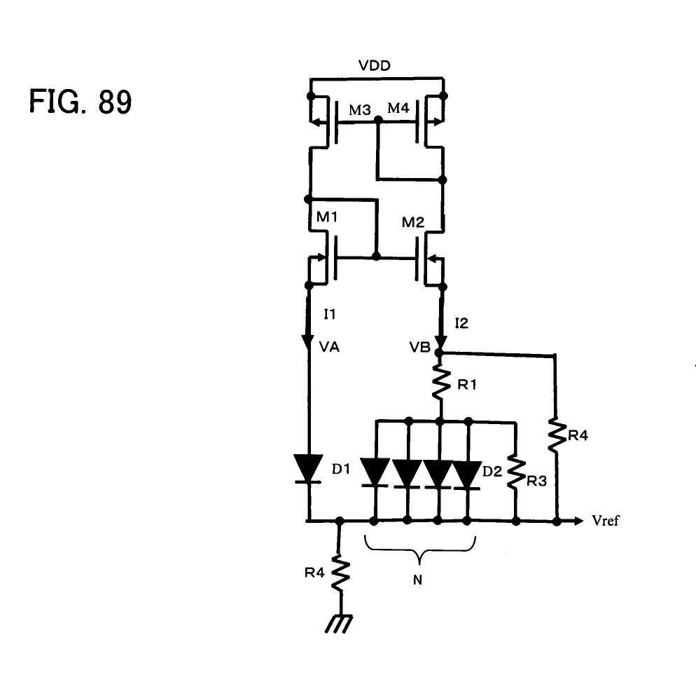

The reference voltage circuit, shown in FIG. 31, may be modified to the reference voltage circuit shown in FIG. 80. FIG. 89 shows a so obtained reference voltage circuit.

Referring to FIG. 89, the linear current mirror circuit (M1, M2, M3) and the OP amp are deleted from FIG. 31 and, in their stead, a linear current mirror circuit composed of the p-channel MOS transistors M3 and M4 self-biases the linear current mirror circuit composed of the n-channel MOS transistors M1 and M2. A resistor R4 (third current-to-voltage converter) is connected to the lower side of the first current-to-voltage converter (diode D1) and the second current-to-voltage converter (a plurality of diodes D2 and resistors R1, R3 and R4) of FIG. 31. The present reference voltage circuit is grounded via the resistor R4 (third current-to-voltage converter). With the present example, temperature non-linearity proper to a diode may be expected to be compensated to lead to an improved characteristic comparable to those obtained with FIG. 31.

### EXAMPLE 12

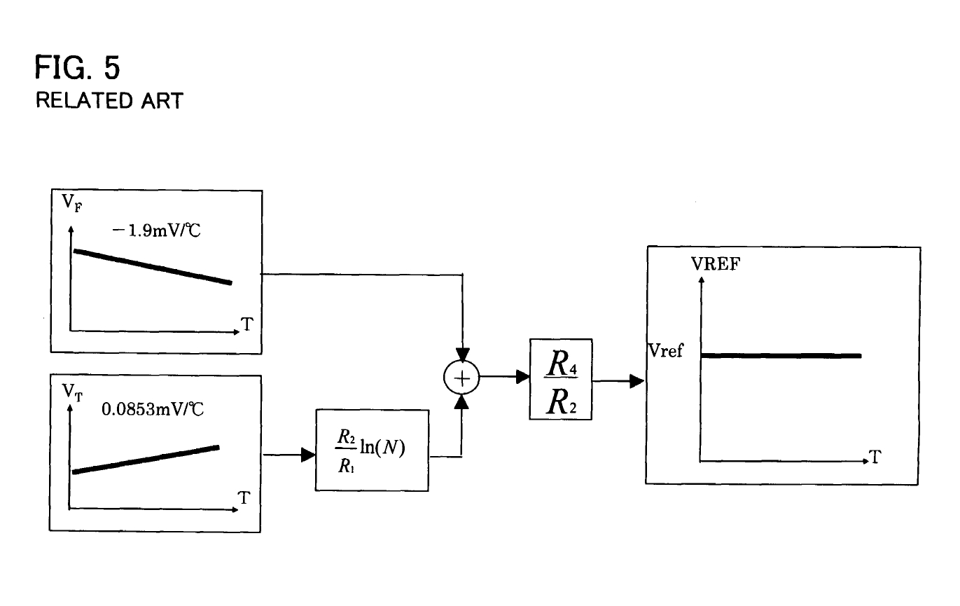

With the self-biased reference voltage circuit, shown in FIG. 25, an output transistor (M7) may be eliminated from the self-biasing linear current mirror circuit (M5, M6, M7) thereby further simplifying the circuit. That is, the circuit may be stacked on an output resistor (I-V3) of FIG. 5 to cause the circuit current to flow through the output resistor to generate the reference voltage.

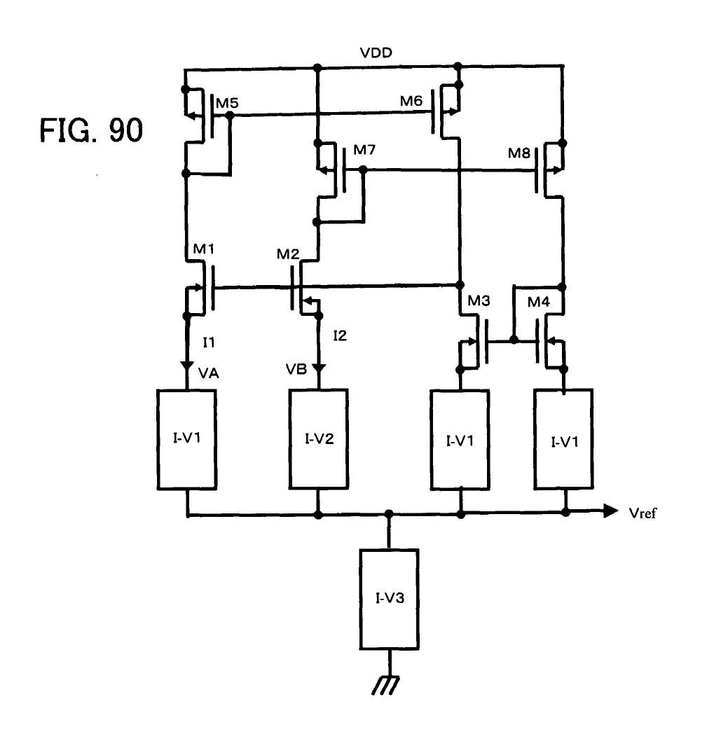

In the self-biased reference voltage circuit, shown in FIG. 25, the output transistor may be eliminated from the self-biasing linear current mirror circuit to simplify the circuit, as shown in FIG. 90.

Referring to FIG. 90, n-channel MOS transistors M1 and M2, having sources connected to the first current-to-voltage converter I-V1 and the second current-to-voltage converter I-V2, form a current mirror circuit. p-channel MOS transistors M5 and M7 are connected between the drains of the n-channel MOS transistors M1 and M2 and the power supply VDD, and have drains and gates connected in common. n-channel MOS transistors M3 and M4, having sources connected to two first current-to-voltage converter I-V1 and having gates connected in common, also form a current mirror circuit. The gates of the n-channel MOS transistors M1 and M2 are connected in common and connected to the drain of the n-channel MOS transistor M3. P-channel MOS transistors M7 and M8 have gates connected in common to form a current mirror circuit, while n-channel MOS transistors M5 and M6 also have gates connected in common to form a current mirror circuit.

Hence, a current I1 flows through the transistors M1, M5 to drive the first current-to-voltage converter I-V1 to generate a terminal voltage VA. Similarly, a current I2 flows through the transistors M2, M8 to drive the second current-to-voltage converter I-V2 to generate a terminal voltage VB.

A third current-to-voltage converter I-V3 is connected to the lower sides of the first, second, first (fourth) and first (fifth) current-to-voltage converters I-V1, I-V2, I-V1 and I-V1. It is via the third current-to-voltage converter I-V3 that the present reference voltage circuit is grounded. Hence, the terminal voltage of this third current-to-voltage converter I-V3 represents an output of the reference voltage circuit to generate the reference voltage Vref.

The operation of the present example is now described. Referring to FIG. 90, the currents flowing through the n-channel MOS transistors M1 and M2, connected respectively to the first current-to-voltage converter I-V1 and the second current-to-voltage converter I-V2, are compared to each other in the current mirror circuit, composed of the n-channel MOS transistors M3 and M4, via the current mirror circuit composed of the p-channel MOS transistors M5 and M6 and the current mirror circuit composed of p-channel MOS transistors M7 and M8. The common gates of the n-channel MOS transistors M1 and M2 are controlled so that the currents flowing through the n-channel MOS transistors M1 and M2 will be equal to each other.

Since the gate-to-source voltages of the n-channel MOS transistors M1 and M2 are equal to each other, in this manner, the voltage VA applied to the first current-to-voltage converter I-V1 and the voltage VB applied to the second current-to-voltage converter I-V2 are equal to each other, thus providing the operating condition equivalent to the case of using the OP amp described above. That is, the characteristic equivalent to that obtained with FIG. 21 may be achieved to implement a reference voltage circuit. It is noted that the two current-to-voltage converters I-V1 are provided so that the gate-to-source voltage of the n-channel MOS transistor M3 will be equal to that of the n-channel MOS transistor M4 and hence the drain current of the n-channel MOS transistor M3 will be equal to that of the n-channel MOS transistor M4.

A third current-to-voltage converter I-V3 is connected to the lower sides of the first, second, first (fourth) and first (fifth) current-to-voltage converters I-V1, I-V2, I-V1 and I-V1. It is via the third current-to-voltage converter I-V3 that the present reference voltage circuit is grounded. Hence, the terminal voltage of the third current-to-voltage converter I-V3 represents an output of the reference voltage circuit to generate the reference voltage Vref.

### EXAMPLE 12-1

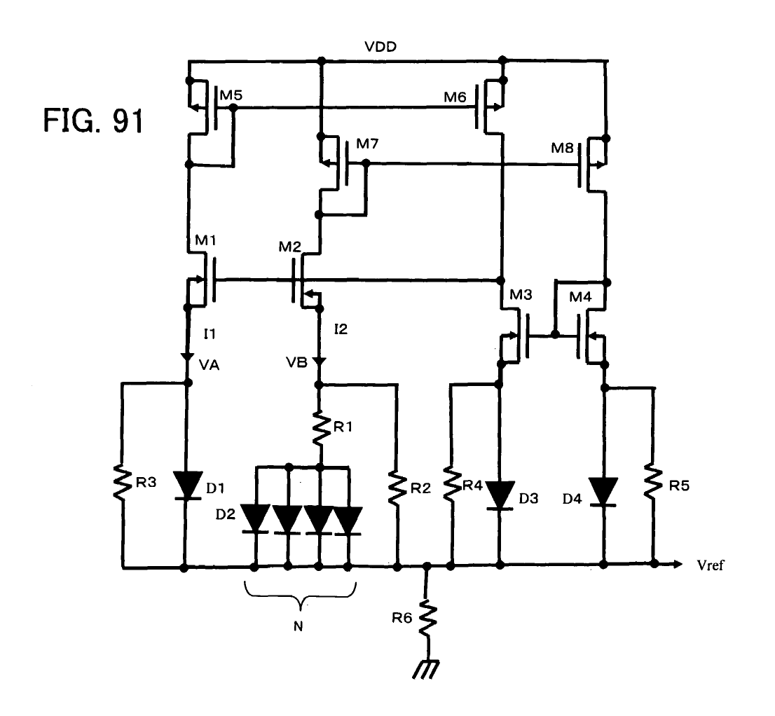

The Bamba's reference voltage circuit, shown in FIG. 4, may be modified to a reference voltage circuit shown in FIG. 90. FIG. 91 shows a so obtained reference voltage circuit.

Referring to FIG. 91, the linear current mirror circuit (M1, M2, M3) and the OP amp are deleted from FIG. 4 and, in their stead, n-channel MOS transistors M1 to M4 and p-channel MOS transistors M5 to M8 are provided in accordance with the configuration of FIG. 90. To the transistors M1, M2, M3 and M4, there are respectively connected the first current-to-voltage converter I-V1 (diode D1 and resistor R3), the second current-to-voltage converter I-V2 (a plurality of diodes D2 and resistors R1, R2), the first (fourth) current-to-voltage converter I-V1 (diode D3 and resistor R4) and the first (fifth) current-to-voltage converter I-V1 (diode D4 and resistor R5). A resistor R6 (third current-to-voltage converter) is connected to the lower side of the first (fourth) current-to-voltage converter, first (fifth) current-to-voltage converter and the second current-to-voltage converter. The reference voltage circuit is grounded via the resistor R6 (third current-to-voltage converter).

With the Bamba's reference voltage circuit, the temperature non-linearity proper to a diode can be compensated only by approximately one half. With the present example, the temperature non-linearity proper to a diode may be expected to be compensated satisfactorily.

### EXAMPLE 12-2

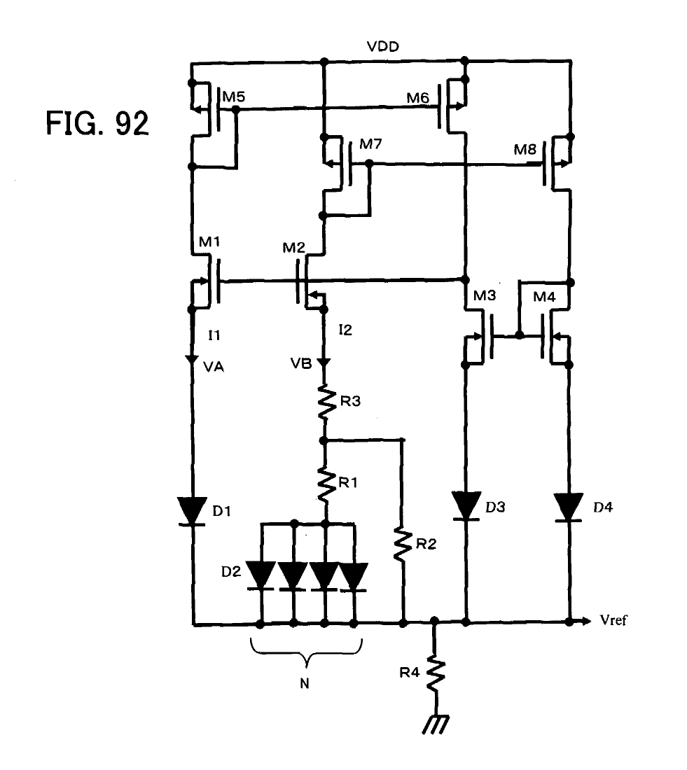

The reference voltage circuit, shown in FIG. 8, may be modified to the reference voltage circuit shown in FIG. 90. FIG. 92 shows a so obtained reference voltage circuit.

Referring to FIG. 92, the linear current mirror circuit (M1, M2, M3) and the OP amp is deleted from FIG. 8 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1), a second current-to-voltage converter (a plurality of diodes D2 and resistors R1, R2, R3), a first (fourth) current-to-voltage converter (diode D3) and a first (fifth) current-to-voltage converter (diode D4). A resistor R4 (third current-to-voltage converter) is connected to the lower side of the first (fourth) current-to-voltage converter, first (fifth) current-to-voltage converter and the second current-to-voltage converter. The reference voltage circuit is grounded via the resistor R4 (third current-to-voltage converter). With the present example, the resistor R1 is redundant. However, temperature non-linearity proper to a diode may be expected to be compensated to lead to an improved characteristic. If the point of connection of the resistor R3 is changed to a point between D2/R2 and the Vref terminal, the reference voltage, compensated for temperature non-linearity, may also be obtained from the opposite terminal of the resistor R3, that is, from the terminal of the resistor R3 opposite to the terminal thereof connected to the Vref terminal.

### EXAMPLE 12-3

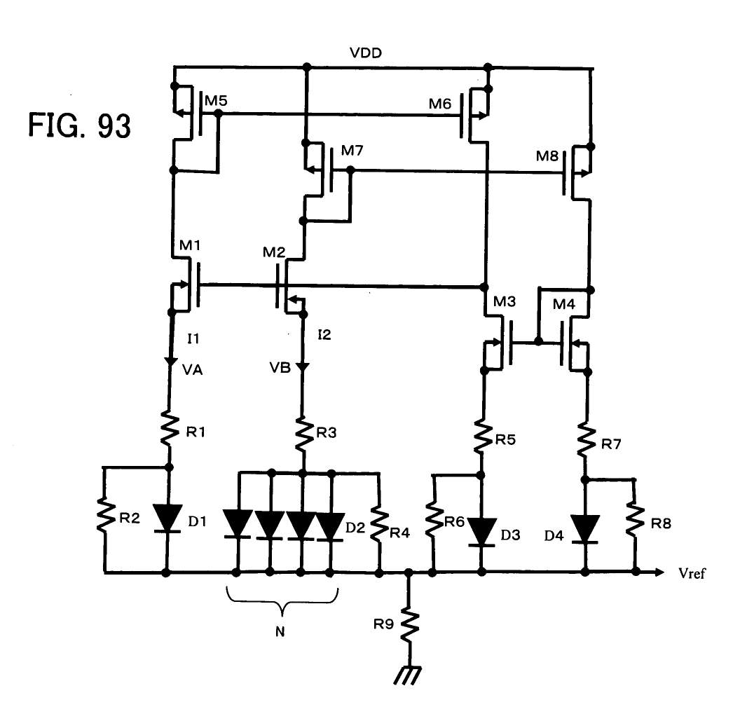

The reference voltage circuit, shown in FIG. 10, may be modified to the reference voltage circuit shown in FIG. 90. FIG. 93 shows a so obtained reference voltage circuit.

Referring to FIG. 93, a linear current mirror circuit (M1, M2, M3) and an OP amp are deleted from FIG. 10 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1 and resistor R2), a second current-to-voltage converter (a plurality of diodes D2 and resistors R4, R3), a first (fourth) current-to-voltage converter (diode D3 and resistor R6) and a first (fifth) current-to-voltage converter (diode D4 and resistor R8). A resistor R4 (third current-to-voltage converter) is connected to the lower side of the first (fourth) current-to-voltage converter, first (fifth) current-to-voltage converter and the second current-to-voltage converter. The reference voltage circuit is grounded via the resistor R4 (third current-to-voltage converter). With the present example, temperature non-linearity proper to a diode may be expected to be compensated to lead to an improved characteristic comparable to those obtained with FIG. 10. If the points of connection of the resistors R1, R3 are respectively changed to a point between D1/R2 and the Vref terminal and to a point between D2/R2 and the Vref terminal, the reference voltage, compensated for temperature non-linearity, may also be obtained from the opposite terminal of the resistor R3, that is, from the terminal of the resistor R3 opposite to its terminal connected to the Vref terminal.

### EXAMPLE 12-4

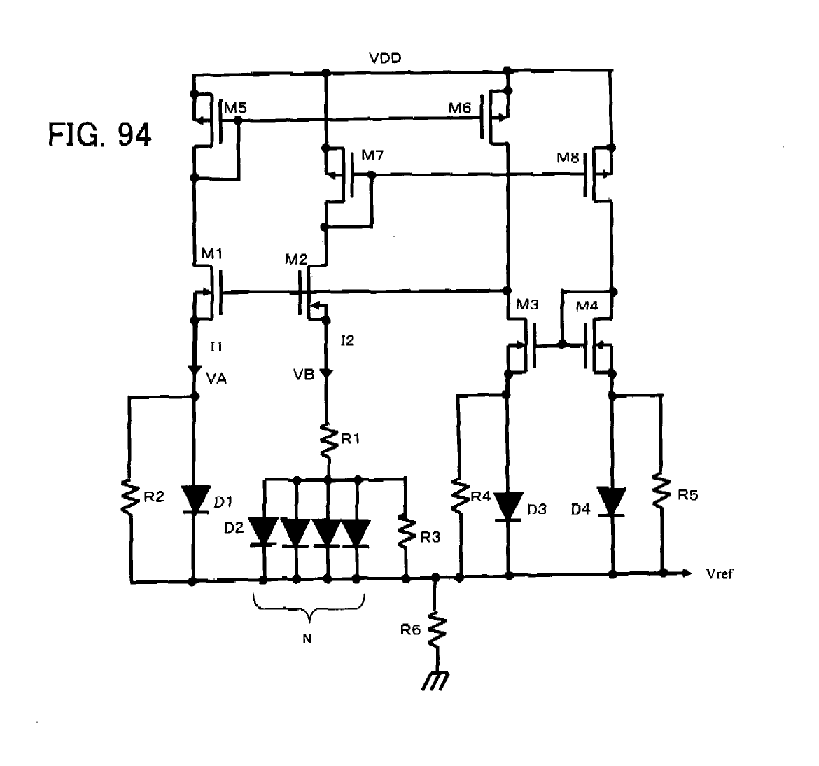

The reference voltage circuit, shown in FIG. 13, may be modified to the reference voltage circuit shown in FIG. 90. FIG. 94 shows a so obtained reference voltage circuit.

Referring to FIG. 94, the linear current mirror circuit (M1, M2, M3) and the OP amp are deleted from FIG. 13 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1 and resistor R2), a second current-to-voltage converter (a plurality of diodes D2 and resistors R3, R1), a first (fourth) current-to-voltage converter (diode D3 and resistor R4) and a first (fifth) current-to-voltage converter (diode D4 and resistor R5). A resistor R6 (third current-to-voltage converter) is connected to the lower side of the first (fourth) current-to-voltage converter, first (fifth) current-to-voltage converter and the second current-to-voltage converter. It is via the resistor R6 (third current-to-voltage converter) that the reference voltage circuit is grounded. The temperature non-linearity proper to a diode may be expected to be compensated to lead to improved characteristic equivalent to that obtained with FIG. 13. If the point of connection of the resistor R1 is changed to a point between D2/R3 and the Vref terminal, the reference voltage, compensated for temperature non-linearity, may also be obtained from the opposite terminal of the resistor R3, that is, from the terminal of the resistor R3 opposite to its terminal connected to the Vref terminal.

### EXAMPLE 12-5

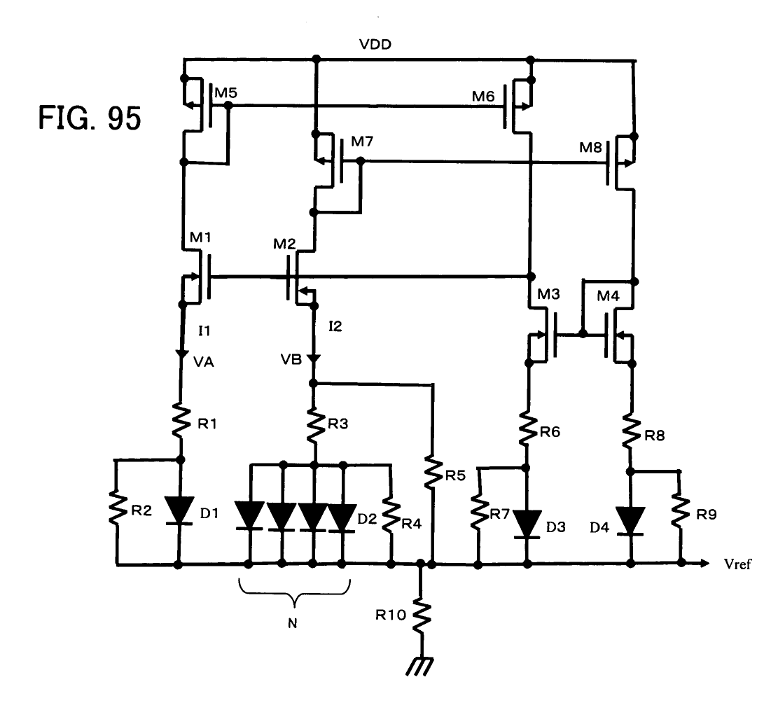

The reference voltage circuit, shown in FIG. 15, may be modified to the reference voltage circuit shown in FIG. 90. FIG. 95 shows a so obtained reference voltage circuit.

Referring to FIG. 95, the linear current mirror circuit (M1, M2, M3) and the OP amp are deleted from FIG. 15 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1 and resistors R2, R1), a second current-to-voltage converter (a plurality of diodes D2 and resistors R4, R3, R5), a first (fourth) current-to-voltage converter (diode D3 and resistors R7, R6) and a first (fifth) current-to-voltage converter (diode D4 and resistors R9, R8). A resistor R10 (third current-to-voltage converter) is connected to the lower side of the first (fourth) current-to-voltage converter, first (fifth) current-to-voltage converter and the second current-to-voltage converter. The reference voltage circuit is grounded via the resistor R6 (third current-to-voltage converter). The temperature non-linearity proper to a diode may be expected to be compensated to lead to improved characteristic equivalent to that obtained with FIG. 15. If the point of connection of the resistor R1 is changed to a point between D1/R2 and the Vref terminal, the reference voltage, compensated for temperature non-linearity, may also be obtained from the opposite terminal of the resistor R1, that is, from the terminal of the resistor R1 distinct from its terminal connected to the Vref terminal.

### EXAMPLE 12-6

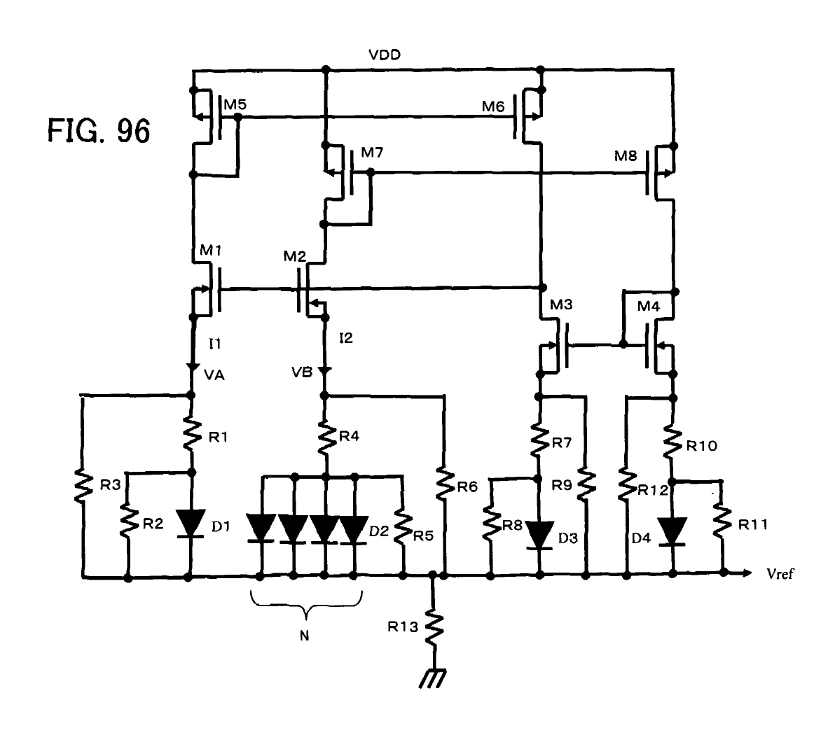

The reference voltage circuit, shown in FIG. 17, may be modified to the reference voltage circuit shown in FIG. 90. FIG. 96 shows a so obtained reference voltage circuit.

Referring to FIG. 96, the linear current mirror circuit (M1, M2, M3) and the OP amp are deleted from FIG. 17 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1 and resistors R2, R1, R3), a second current-to-voltage converter (a plurality of diodes D2 and resistors R5, R4, R6), a first (fourth) current-to-voltage converter (diode D3 and resistors R8, R7, R9) and a first (fifth) current-to-voltage converter (diode D4 and resistors R11, R12, R10). A resistor R13 (third current-to-voltage converter) is connected to the lower side of the first (fourth) current-to-voltage converter, first (fifth) current-to-voltage converter and the second current-to-voltage converter. The reference voltage circuit is grounded via the resistor R13 (third current-to-voltage converter). With the present example, temperature non-linearity proper to a diode may be expected to be compensated to lead to improved characteristic equivalent to that obtained with FIG. 17.

### EXAMPLE 12-7

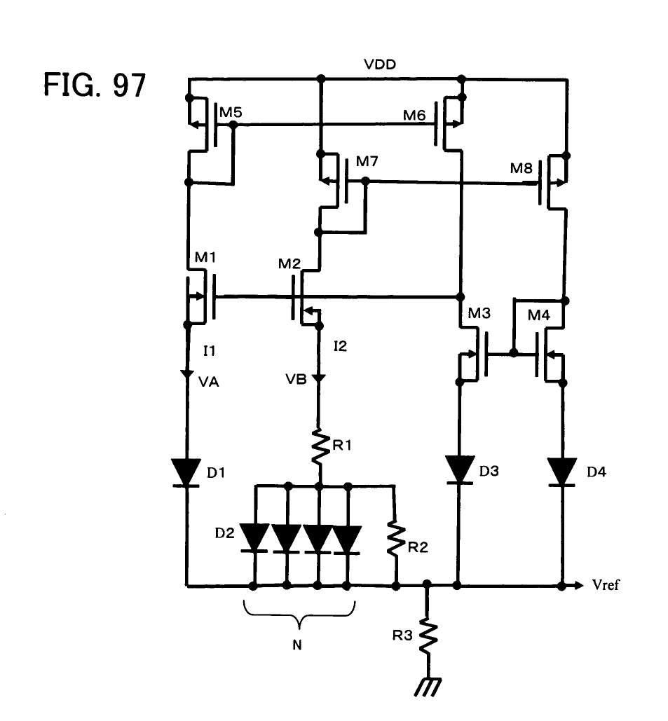

The reference voltage circuit, shown in FIG. 19, may be modified to the reference voltage circuit shown in FIG. 90. FIG. 97 shows a so obtained reference voltage circuit.

Referring to FIG. 97, the linear current mirror circuit (M1, M2, M3) and the OP amp are deleted from FIG. 19 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1), a second current-to-voltage converter (a plurality of diodes D2 and resistors R2, R1), a first (fourth) current-to-voltage converter (diode D3) and a first (fifth) current-to-voltage converter (diode D4). A resistor R3 (third current-to-voltage converter) is connected to the lower side of the first (fourth) current-to-voltage converter, first (fifth) current-to-voltage converter and the second current-to-voltage converter. The reference voltage circuit is grounded via the resistor R3 (third current-to-voltage converter). With the present example, the temperature non-linearity proper to a diode may be expected to be compensated to lead to improved characteristic equivalent to that obtained with FIG. 19. If the point of connection of the resistor R1 is changed to a point between D1/R2 and the Vref terminal, the reference voltage, compensated for temperature non-linearity, may also be obtained from the opposite terminal of the resistor R1, that is, from the terminal of the resistor R1 opposite to its terminal connected to the Vref terminal.

### EXAMPLE 12-8

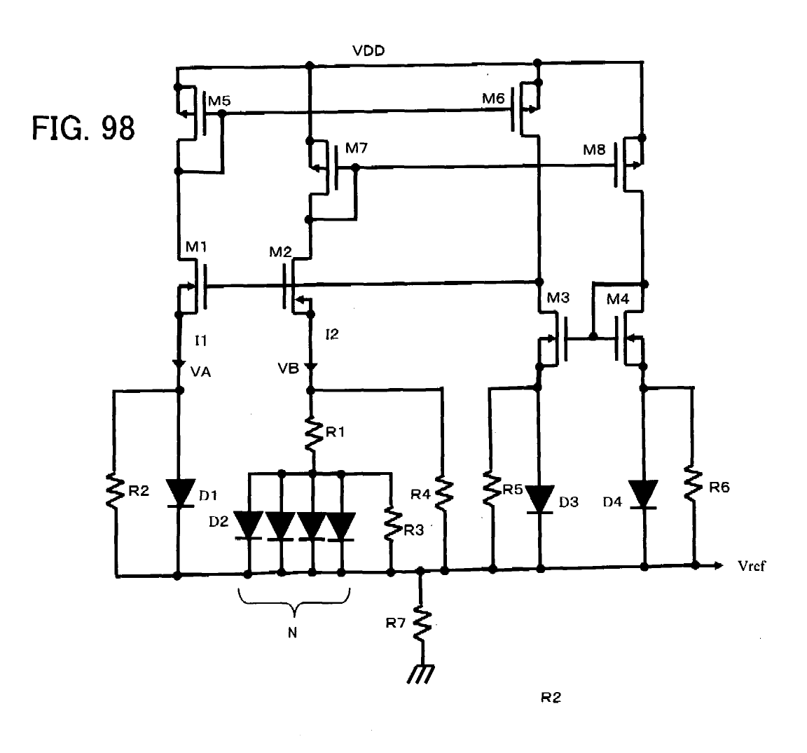

The reference voltage circuit, shown in FIG. 22, may be modified to the reference voltage circuit shown in FIG. 90. FIG. 98 shows a so obtained reference voltage circuit.

Referring to FIG. 98, the linear current mirror circuit (M1, M2, M3) and the OP amp are deleted from FIG. 22 and, in their stead, n-channel MOS transistors Ml to M4 and p-channel MOS transistors M5 to M8 are provided in accordance with the configuration of FIG. 90. To the transistors M1, M2, M3 and M4, there are respectively connected a first current-to-voltage converter (diode D1 and resistor R2), a second current-to-voltage converter (a plurality of diodes D2 and resistors R2, R1), a first (fourth) current-to-voltage converter (diode D3 and resistor R5) and a first (fifth) current-to-voltage converter (diode D4 and resistor R6). A resistor R7 (third current-to-voltage converter) is connected to the lower side of the first (fourth) current-to-voltage converter, first (fifth) current-to-voltage converter and the second current-to-voltage converter. The reference voltage circuit is grounded via the resistor R13 (third current-to-voltage converter). In the present example, temperature non-linearity proper to a diode may be expected to be compensated to lead to an improved characteristic comparable to those obtained with FIG. 22.

### EXAMPLE 12-9

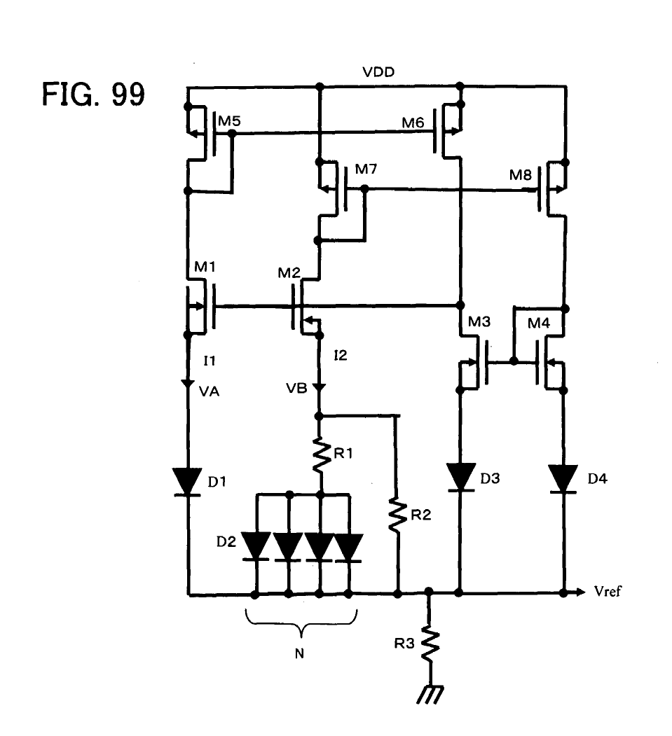

The reference voltage circuit, shown in FIG. 31, may be modified to the reference voltage circuit shown in FIG. 90. FIG. 99 shows a so obtained reference voltage circuit.

Referring to FIG. 99, the linear current mirror circuit (M1, M2, M3) and the OP amp are deleted from FIG. 22 and, in their stead, n-channel MOS transistors M1 to M4 and p-channel MOS transistors M5 to M8 are provided in accordance with the configuration of FIG. 90. To the transistors M1, M2, M3 and M4, there are respectively connected a first current-to-voltage converter (diode D1), a second current-to-voltage converter (a plurality of diodes D2 and resistors R2, R1), a first (fourth) current-to-voltage converter (diode D3) and a first (fifth) current-to-voltage converter (diode D4). A resistor R3 (third current-to-voltage converter) is connected to the lower side of the first (fourth) current-to-voltage converter, first (fifth) current-to-voltage converter and the second current-to-voltage converter. It is via the resistor R3 (third current-to-voltage converter) that the reference voltage circuit is grounded. In the present example, temperature non-linearity proper to a diode may be expected to be compensated to lead to an improved characteristic comparable to those of FIG. 31.

### EXAMPLE 13

In similar manner, an output transistor may be eliminated from the self-biasing linear current mirror circuit shown in FIG. 26 thereby further simplifying the circuit. That is, the circuit may be stacked on an output resistor to cause the circuit current to flow through the output resistor to generate the reference voltage.

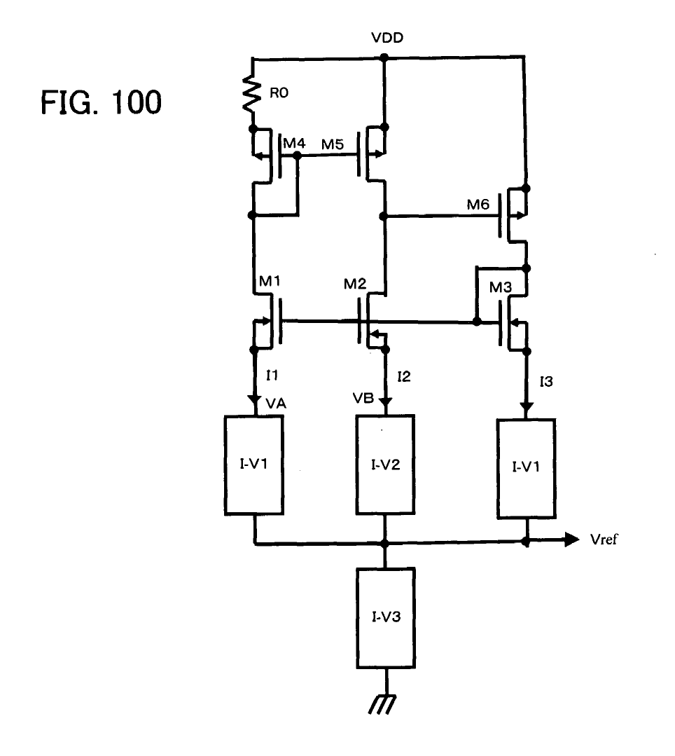

In FIG. 100, a resistor R0 is connected between the source of the p-channel MOS transistor M4 and the power supply VDD. The p-channel MOS transistor M4 has the gate voltage in common with the p-channel MOS transistor M5. Hence, the transistor size of the p-channel MOS transistor M4 is selected to be larger than the transistor size of the p-channel MOS transistor M5. It is noted that the current mirror circuit, formed by the p-channel MOS transistors M4 and M5, forms a reverse Widlar current mirror circuit.

This reverse Widlar current mirror circuit reverse-biases the n-channel MOS transistors M1 and M2, which then drive the first current-to-voltage converter I-V1 and the second current-to-voltage converter I-V2, respectively. The gate and the drain of the n-channel MOS transistor M3 are connected in common and connected to the gates of the n-channel MOS transistors M1 and M2, with the n-channel MOS transistors M1, M2 and M3 forming a current mirror circuit.

The p-channel MOS transistor M4, driving the n-channel MOS transistor M3, has a gate connected to a drain of the p-channel MOS transistor M5 that forms an output of the reverse Widlar current mirror circuit. The n-channel MOS transistor M3 drives a fourth current-to-voltage converter I-V1. This fourth current-to-voltage converter I-V1 is provided so that the currents of the same value will flow through the n-channel MOS transistors M1, M2 and M3.

A third current-to-voltage converter I-V3 is provided on the lower side of the first, second and fourth current-to-voltage converters I-V1, I-V2 and I-V1. The reference voltage circuit is grounded via the third current-to-voltage converter I-V3. Hence, the terminal voltage of this third current-to-voltage converter I-V3 represents the output of the reference voltage circuit to generate the reference voltage Vref.

The operation of the present example is now described. If the current that flows through the n-channel MOS transistor M1 is increased, the current that flows through the p-channel MOS transistor M4 is correspondingly increased.

However, the current that flows through the p-channel MOS transistor M5 is increased in an amount larger than that of the current flowing through the p-channel MOS transistor M4. Hence, the n-channel MOS transistor M2 cannot afford to cause the so increased current to flow therethrough, so that the drain voltage of the p-channel MOS transistor M5 is increased, with the result that the current flowing through the p-channel MOS transistor M6, the gate of which is connected to the drain of the p-channel MOS transistor M5, is decreased. The current that flows through the n-channel MOS transistor M3, which has a drain current in common with that of the transistor M6, is also decreased.

It is noted that the n-channel MOS transistors M3, M2 form a current mirror circuit, and the n-channel MOS transistors M1 and M2 have the gate voltage in common. Hence, the common gate voltages of the transistors M1 to M3 are decreased, with the result that the current flowing through the n-channel MOS transistor M1 is decreased.

Since the gate-to-source voltages of the n-channel MOS transistors M1 and M2 are thus equal to each other, the voltage VA applied to the first current-to-voltage converter I-V1 and the voltage VB applied to the second current-to-voltage converter I-V2 are equal to each other, thus providing the operating condition equivalent to the case of using the OP amp described above. That is, the characteristic equivalent to that of FIG. 21 may be achieved to implement a reference voltage circuit. It is noted that the two current-to-voltage converters I-V1 are provided so that the gate-to-source voltage of the n-channel MOS transistor M3 will be equal to the drain voltage of each of the n-channel MOS transistor M1 and M2.

In this manner, the currents I1, I2, flowing respectively through the n-channel MOS transistors M1 and M2, are controlled to be equal to each other. The current I3, flowing through the n-channel MOS transistor M3, is also proportionate to the currents I1, I2.

The third current-to-voltage converter I-V3 is provided on the lower side of the first, second and the first (fourth) current-to-voltage converters IV-1, IV-2 and IV-1. The reference voltage circuit is grounded via the third current-to-voltage converter I-V3. The terminal voltage of the third current-to-voltage converter I-V3 thus becomes an output of the reference voltage circuit to generate the reference voltage Vref.

### EXAMPLE 13-1

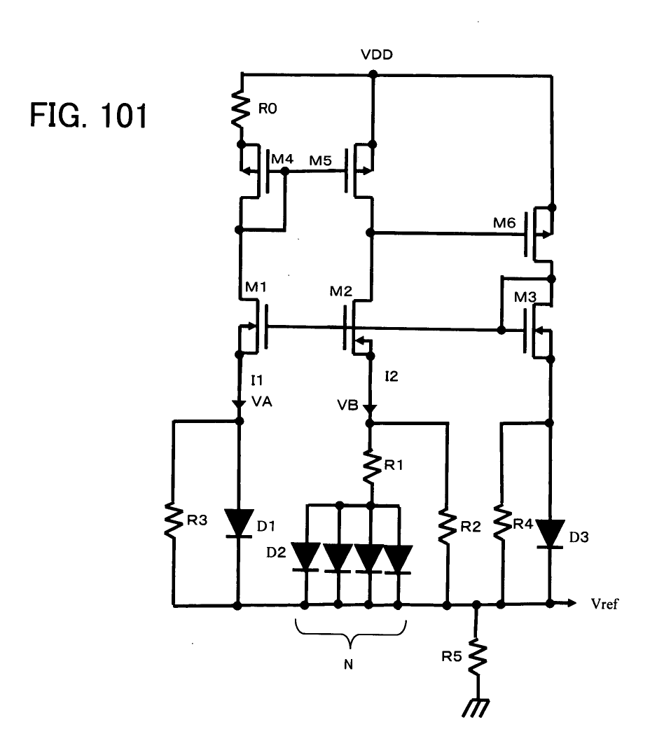

The Bamba's reference voltage circuit, shown in FIG. 4, may be modified to the reference voltage circuit shown in FIG. 100. FIG. 101 shows a so obtained reference voltage circuit.

Referring to FIG. 101, the linear current mirror circuit (M1, M2, M3) and the OP amp are deleted from FIG. 4 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter I-V1 (diode D1 and resistor R3), a second current-to-voltage converter (a plurality of diodes D2 and resistors R1, R2) and a first (fourth) current-to-voltage converter I-V1 (diode D3 and resistor R4). A resistor R5 (third current-to-voltage converter) is connected to the lower side of the first (fourth) current-to-voltage converter and the second current-to-voltage converter. It is via the resistor R5 (third current-to-voltage converter) that the reference voltage circuit is grounded.

With the present example, the temperature non-linearity proper to a diode may be compensated only by approximately one half. Nevertheless, the temperature non-linearity proper to a diode may be expected to be compensated to some acceptable extent.

### EXAMPLE 13-2

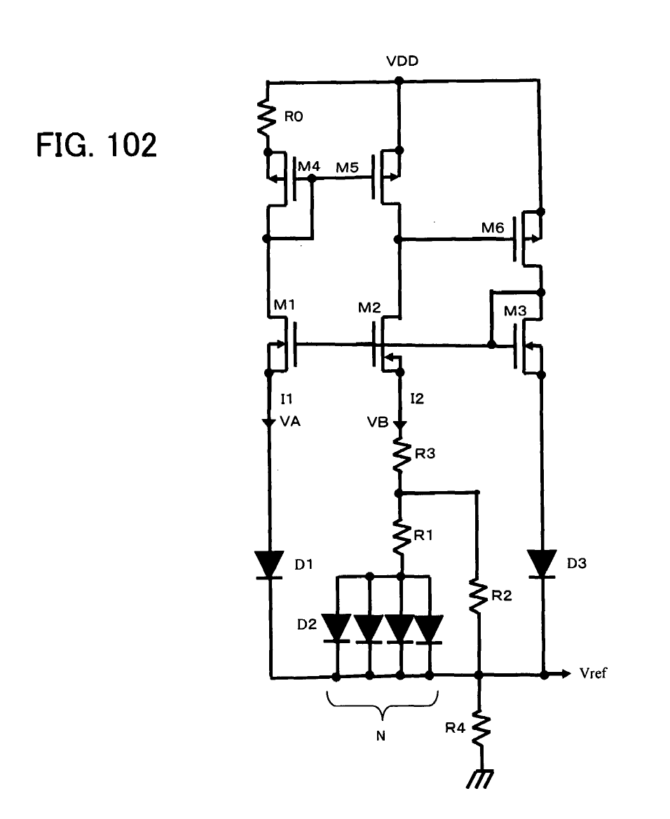

The reference voltage circuit, shown in FIG. 8, may be modified to the reference voltage circuit shown in FIG. 100. FIG. 102 shows a so obtained reference voltage circuit.

Referring to FIG. 102, a linear current mirror circuit (M1, M2, M3) and an OP amp are deleted from FIG. 8 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter (diode D1), a second current-to-voltage converter (a plurality of diodes D2 and resistors R1, R2, R3) and a first (fourth) current-to-voltage converter (diode D3). A resistor R4 (third current-to-voltage converter) is connected to the lower side of the first (fourth) current-to-voltage converter and the second current-to-voltage converter. It is via the resistor R4 (third current-to-voltage converter) that the reference voltage circuit is grounded. With the present example, the resistor R1 is redundant. However, temperature non-linearity proper to a diode may be expected to be compensated to lead to an improved characteristic. If the point of connection of the resistor R3 is changed to a point between D2/R2 and the Vref terminal, the reference voltage, compensated for temperature non-linearity, may also be obtained from the opposite terminal of the resistor R3, that is, from the terminal of the resistor R3 opposite to its terminal connected to the Vref terminal.

### EXAMPLE 13-3

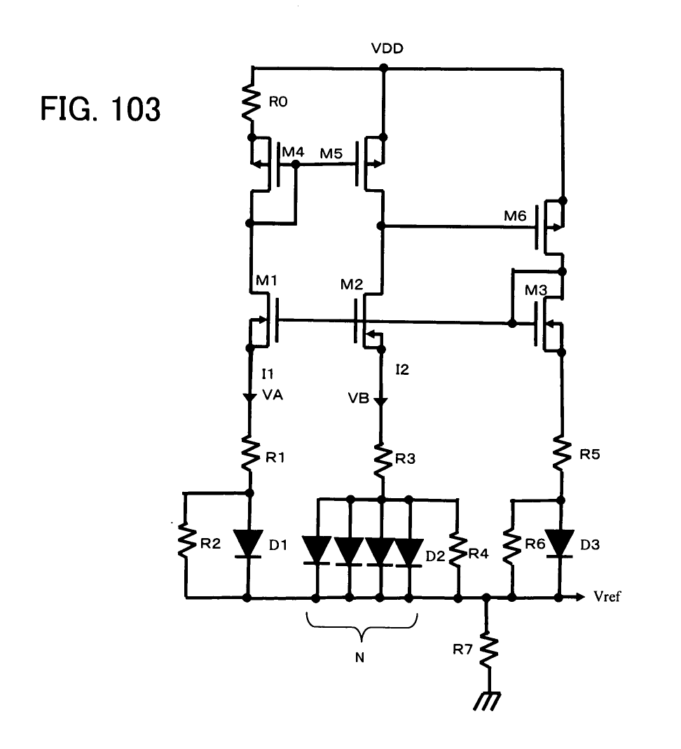

The reference voltage circuit, shown in FIG. 10, may be modified to the reference voltage circuit shown in FIG. 100. FIG. 103 shows a so obtained reference voltage circuit.

Referring to FIG. 103, the linear current mirror circuit (M1, M2, M3) and the OP amp are deleted from FIG. 10 and, in their stead, n-channel MOS transistors M1 to M3 and p-channel MOS transistors M4 to M6 are provided in accordance with the configuration of FIG. 100. To the transistors M1, M2 and M3, there are connected a first current-to-voltage converter (diode D1 and resistors R2, R1), a second current-to-voltage converter (a plurality of diodes D2 and resistors R4, R3) and a first (fourth) current-to-voltage converter (diode D3 and resistors R6, R5). A resistor R7 (third current-to-voltage converter) is connected to the lower side of the first (fourth) current-to-voltage converter and the second current-to-voltage converter. It is via the resistor R7 (third current-to-voltage converter) that the reference voltage circuit is grounded. With the present example, temperature non-linearity proper to a diode may be expected to be compensated to lead to improved characteristic equivalent to that obtained with FIG. 10. If the point of connection of the resistor R1 is changed to a point between D1/R2 and the Vref terminal, and the point of connection of the resistor R3 is changed to a point between D2/R4 and the Vref terminal, the reference voltage, compensated for temperature non-linearity, may be obtained from the opposite terminals of the resistors R1, R3, that is, from the terminals of the resistors R1, R3 opposite to the terminals thereof connected to the Vref terminal as well.

### EXAMPLE 13-4

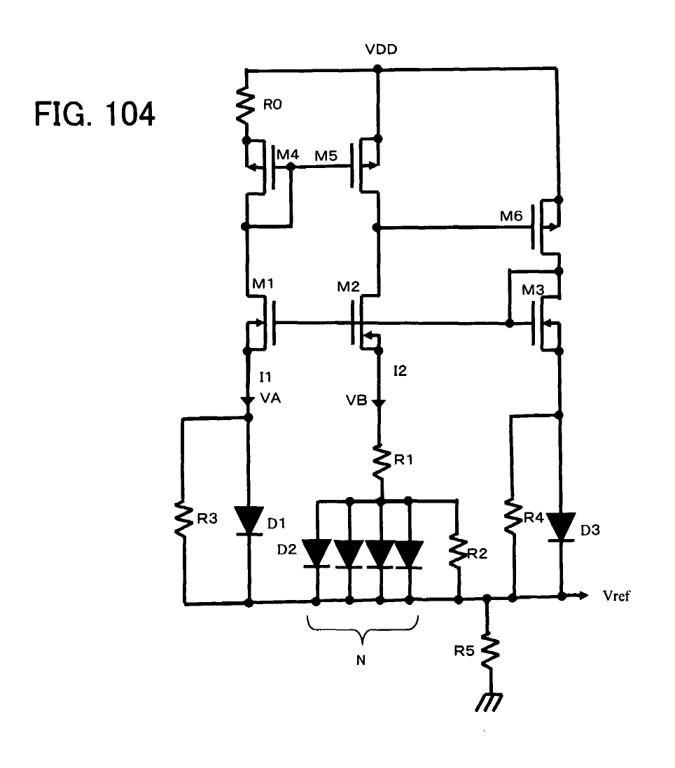

The reference voltage circuit, shown in FIG. 13, may be modified to the reference voltage circuit shown in FIG. 100. FIG. 104 shows a so obtained reference voltage circuit.

Referring to FIG. 104, the linear current mirror circuit (M1, M2, M3) and the OP amp are deleted from FIG. 13 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter (diode D1 and resistor R3), a second current-to-voltage converter (a plurality of diodes D2 and resistors R2, R1) and a first (fourth) current-to-voltage converter (diode D3 and resistor R4). A resistor R5 (third current-to-voltage converter) is connected to the lower side of the first (fourth) current-to-voltage converter and the second current-to-voltage converter, and the reference voltage circuit is grounded via this resistor R5 (third current-to-voltage converter). With the present example, temperature non-linearity proper to a diode may be expected to be compensated to lead to improved characteristic equivalent to that obtained with FIG. 13. If the point of connection of the resistor R1 is changed to a point between D2/R3 and the Vref terminal, the reference voltage, compensated for temperature non-linearity, may similarly be obtained from the opposite terminal of the resistor R1, that is, from the terminal of the resistor R1 distinct from the terminal thereof connected to the Vref terminal.

### EXAMPLE 13-5

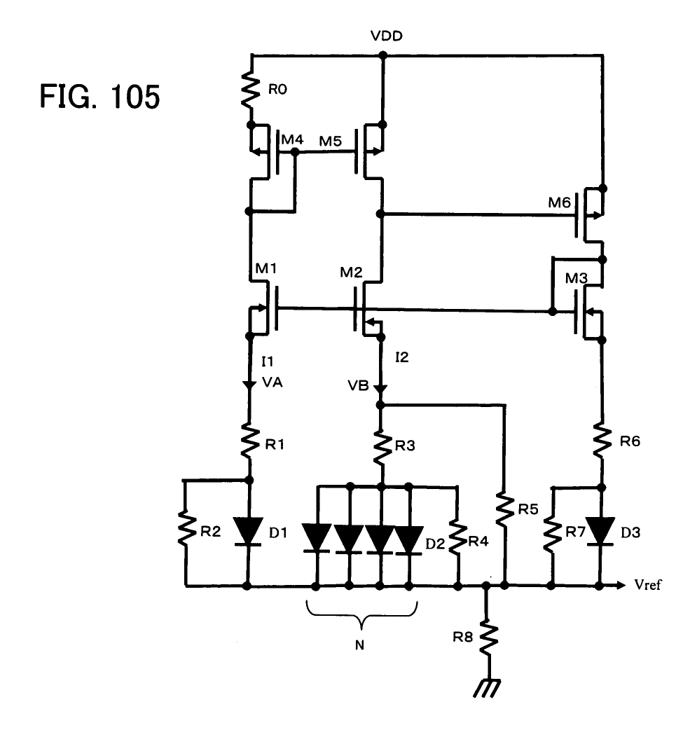

The reference voltage circuit, shown in FIG. 15, may be modified to the reference voltage circuit shown in FIG. 100. FIG. 105 shows a so obtained reference voltage circuit.

Referring to FIG. 105, the linear current mirror circuit (M1, M2, M3) and the OP amp are deleted from FIG. 15 and, in their stead, n-channel MOS transistors M1 to M3 and p-channel MOS transistors M4 to M6 are provided in accordance with the configuration of FIG. 100.

To the transistors M1, M2 and M3, there are respectively connected a first current-to-voltage converter (diode D1 and resistor R2), a second current-to-voltage converter (a plurality of diodes D2 and resistors R4, R3, R5) and a first (fourth) current-to-voltage converter (diode D3 and resistors R7, R6). A resistor R8 (third current-to-voltage converter) is connected to the lower side of the first (fourth) current-to-voltage converter and the second current-to-voltage converter, and the reference voltage circuit is grounded via the resistor R8 (third current-to-voltage converter). With the present example, temperature non-linearity proper to a diode may be expected to be compensated to lead to improved characteristic equivalent to that obtained with FIG. 15. If the point of connection of the resistor R3 is changed to a point between D1/R2 and the Vref terminal, the reference voltage, compensated for temperature non-linearity, may similarly be obtained from the opposite terminal of the resistor R1, that is, from the terminal of the resistor R1 opposite to its terminal connected to the Vref terminal.

### EXAMPLE 13-6

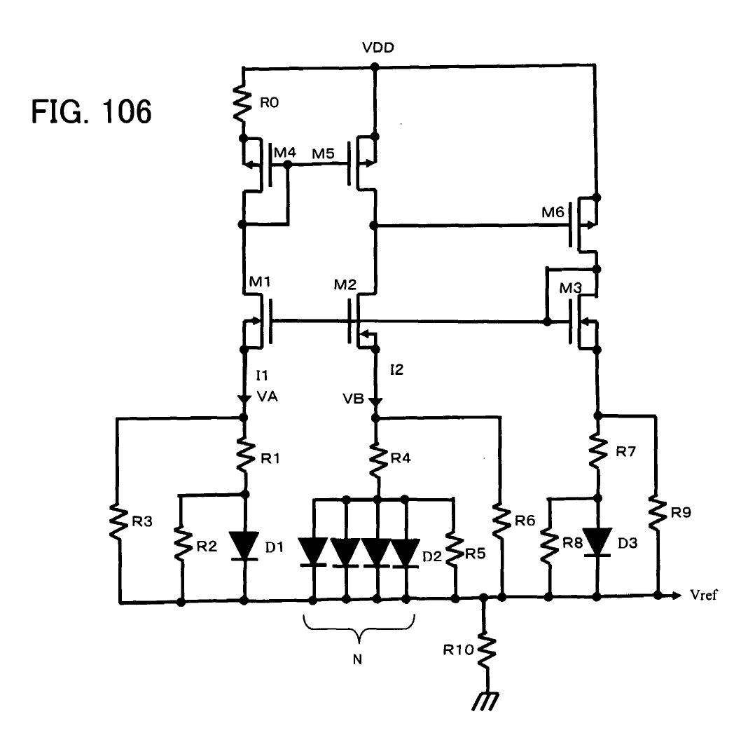

The reference voltage circuit, shown in FIG. 17, may be modified to the reference voltage circuit shown in FIG. 100. FIG. 106 shows a so obtained reference voltage circuit.

Referring to FIG. 106, the linear current mirror circuit (M1, M2, M3) and the OP amp are deleted from FIG. 17 and, in their stead, n-channel MOS transistors M1 to M3 and p-channel MOS transistors M4 to M6 are provided in accordance with the configuration of FIG. 100. To the transistors M1, M2 and M3, there are respective connected a first current-to-voltage converter (diode D1 and resistors R2, R1, R3), a second current-to-voltage converter (a plurality of diodes D2 and resistors R5, R4, R6) and a first (fourth) current-to-voltage converter (diode D3 and resistors R8, R7, R9). A resistor R10 (third current-to-voltage converter) is connected to the lower side of the first (fourth) current-to-voltage converter and the second current-to-voltage converter. The reference voltage circuit is grounded via the resistor R10 (third current-to-voltage converter). With the present example, temperature non-linearity proper to a diode may be expected to be compensated to lead to an improved characteristic comparable to those obtained with FIG. 17.

### EXAMPLE 13-7

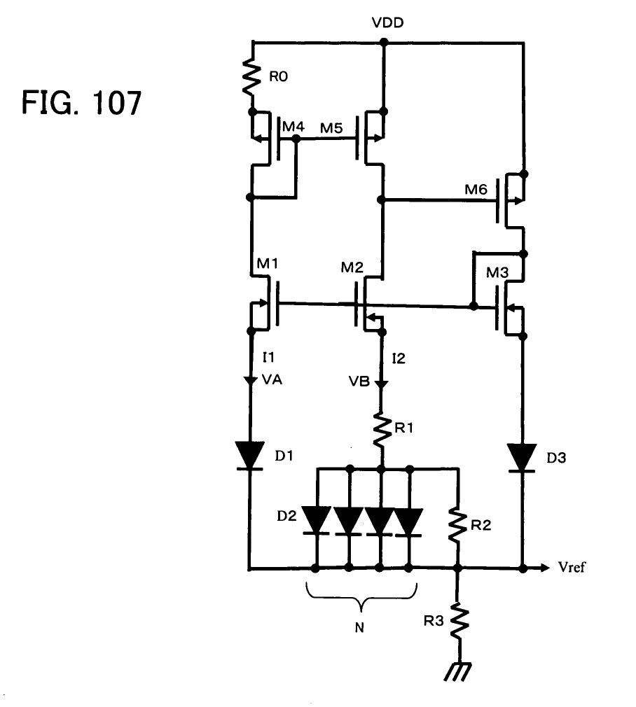

The reference voltage circuit, shown in FIG. 19, may be modified to the reference voltage circuit shown in FIG. 100. FIG. 107 shows a so obtained reference voltage circuit.

Referring to FIG. 107, the linear current mirror circuit (M1, M2, M3) and the OP amp are deleted from FIG. 19 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter (diode D1), a second current-to-voltage converter (a plurality of diodes D2 and resistors R2, R1) and a first (fourth) current-to-voltage converter (diode D3). A resistor R3 (third current-to-voltage converter) is connected to the lower side of the first (fourth) current-to-voltage converter and the second current-to-voltage converter. It is via the resistor R3 (third current-to-voltage converter) that the reference voltage circuit is grounded. With the present example, temperature non-linearity proper to a diode may be expected to be compensated to lead to improved characteristic equivalent to that of FIG. 19. If the point of connection of the resistor R1 is changed to a point between D1/R2 and the Vref terminal, the reference voltage, compensated for temperature non-linearity, may likewise be obtained from the opposite terminal of the resistor R1, that is, from the terminal of the resistor R1 opposite to its terminal connected to the Vref terminal.

### EXAMPLE 13-8

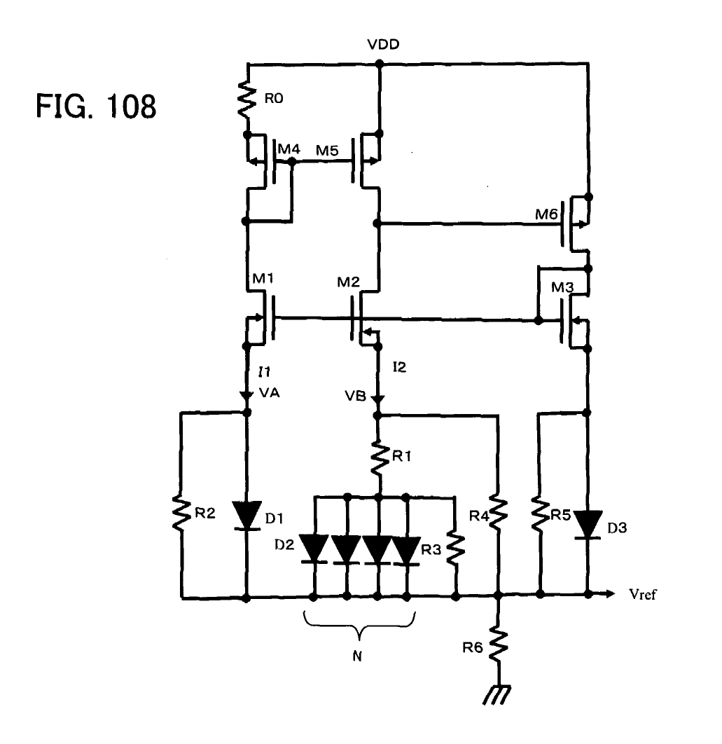

The reference voltage circuit, shown in FIG. 22, may be modified to the reference voltage circuit shown in FIG. 100. FIG. 108 shows a so obtained reference voltage circuit.

Referring to FIG. 108, the linear current mirror circuit (M1, M2, M3) and the OP amp are deleted from FIG. 22 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter (diode D1 and resistor R2), a second current-to-voltage converter (a plurality of diodes D2 and resistors R3, R1) and a first (fourth) current-to-voltage converter (diode D3 and resistor R5). A resistor R6 (third current-to-voltage converter) is connected to the lower side of the first (fourth) current-to-voltage converter and the second current-to-voltage converter. It is via the resistor R6 (third current-to-voltage converter) that the reference voltage circuit is grounded. With the present example, temperature non-linearity proper to a diode may be expected to be compensated to lead to improved characteristic equivalent to that of FIG. 22.

### EXAMPLE 13-9

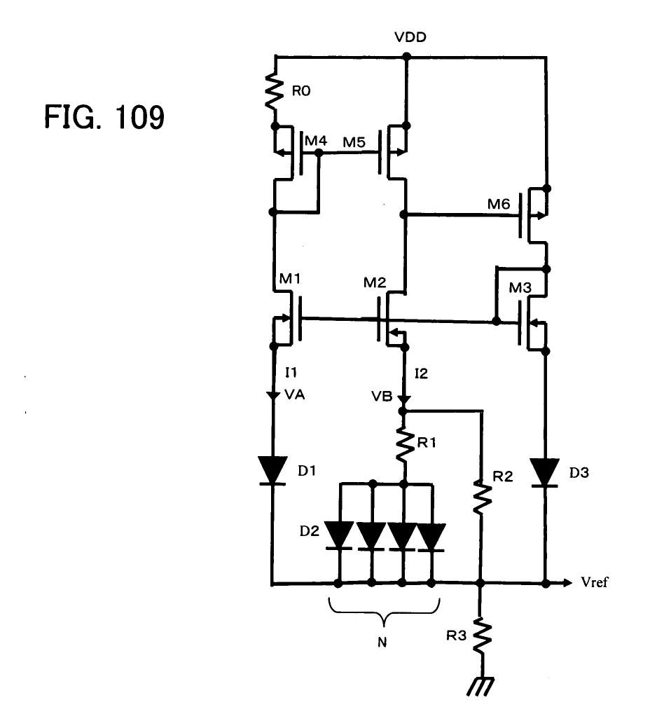

The reference voltage circuit, shown in FIG. 31, may be modified to the reference voltage circuit shown in FIG. 100. FIG. 109 shows a so obtained reference voltage circuit.

Referring to FIG. 109, the linear current mirror circuit (M1, M2, M3) and the OP amp are deleted from FIG. 31 and, in their stead, n-channel MOS transistors M1 to M3 and p-channel MOS transistors M4 to M6 are provided in accordance with the configuration of FIG. 100. To the transistors M1, M2 and M3, there are respectively connected a first current-to-voltage converter (diode D1), a second current-to-voltage converter (a plurality of diodes D2 and resistors R2, R1) and a first (fourth) current-to-voltage converter (diode D3). A resistor R3 (third current-to-voltage converter) is connected to the lower side of the first (fourth) current-to-voltage converter and the second current-to-voltage converter. It is via the resistor R3 (third current-to-voltage converter) that the reference voltage circuit is grounded. With the present example, temperature non-linearity proper to a diode may be expected to be compensated to lead to improved characteristic equivalent to that of FIG. 31.

### EXAMPLE 14

In similar manner, an output transistor may be eliminated from the self-biasing linear current mirror circuit shown in FIG. 39 thereby further simplifying the circuit. That is, the circuit may be stacked on an output resistor to cause the circuit current to flow through the output resistor to generate the reference voltage.

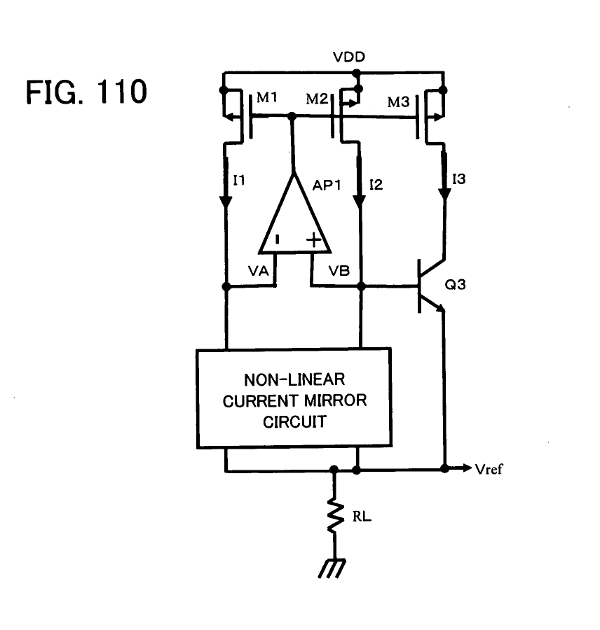

Referring to FIG. 110, a 1:1:1 current mirror circuit, composed of MOS transistors M1 to M3, drives a non-linear current mirror circuit, made up of first and second bipolar transistors, and a bipolar transistor Q3. The bipolar transistor Q3 has a base connected to an output terminal of the non-linear current mirror circuit an input terminal of which is connected to an inverting input terminal of an OP amp. An output terminal of the OP amp is connected to the common gates of the MOS transistors M1 to M3.

The non-linear current mirror circuit and the bipolar transistor Q3 are grounded via resistor RL. Hence, the terminal voltage of the resistor RL acts as an output of the reference voltage circuit to generate the reference voltage Vref.

An equal amount of the current is caused to flow through each of the non-linear current mirror circuit, including the first and second bipolar transistors, and the bipolar transistor Q3, such as to render the voltages VA and VE (VBE3) equal to each other. The common gates of the MOS transistors M1 to M4 are connected to an output of the OP amp. The inverting input terminal and the non-inverting input terminal of the OP amp exercise control so that the voltage VA of the input terminal of the non-linear current mirror circuit and the voltage VB of its output terminal will be equal to each other. It is noted that the voltage VB is the terminal voltage of the bipolar transistor Q3. Hence, the currents flowing through the MOS transistors M1 to M3 are equal to one another. The current sum (I1+I2+I3) flows through the resistor RL to generate the reference voltage Vref which is the output of the reference voltage circuit.

As may be surmised from the reference voltage circuit, shown in FIG. 39, the currents I1, I2 and I3 are the currents compensated for temperature characteristic and for temperature non-linearity of bipolar transistor VBE. The reference voltage Vref is thus a reference voltage compensated for temperature non-linearity of bipolar transistor and which is freed of temperature characteristic.

### EXAMPLE 14-1

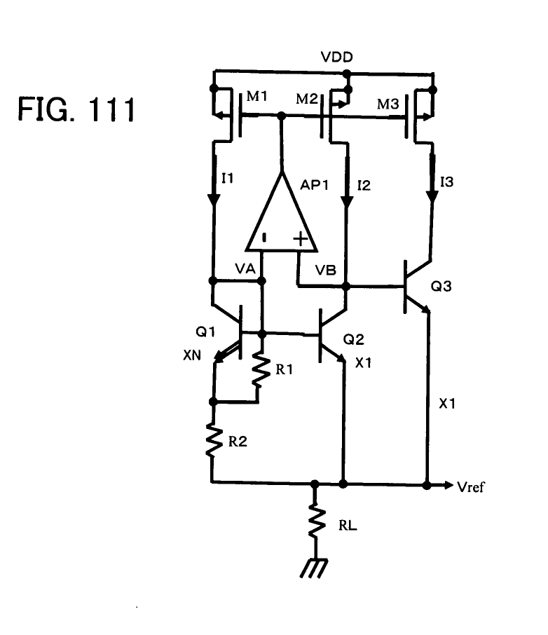

The reference voltage circuit, shown in FIG. 40, may be modified to a reference voltage circuit shown in FIG. 110. FIG. 111 shows a so obtained reference voltage circuit.

Referring to FIG. 111, the circuit of the present example is a circuit of FIG. 40 in which the output transistor M4 is eliminated from the linear current mirror circuit M1 to M4, and in which, instead of directly grounding the resistor R2 and the emitter of the transistor Q2, in the non-linear current mirror circuit in the configuration of FIG. 38A, and the emitter of the transistor Q3, a common connection point of the resistor R2 and the emitter of the transistor Q2 in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those obtained with FIG. 40. A reference voltage, compensated for temperature non-linearity proper to a transistor, may also be obtained at the opposite side terminal of the resistor R2.

### EXAMPLE 14-2

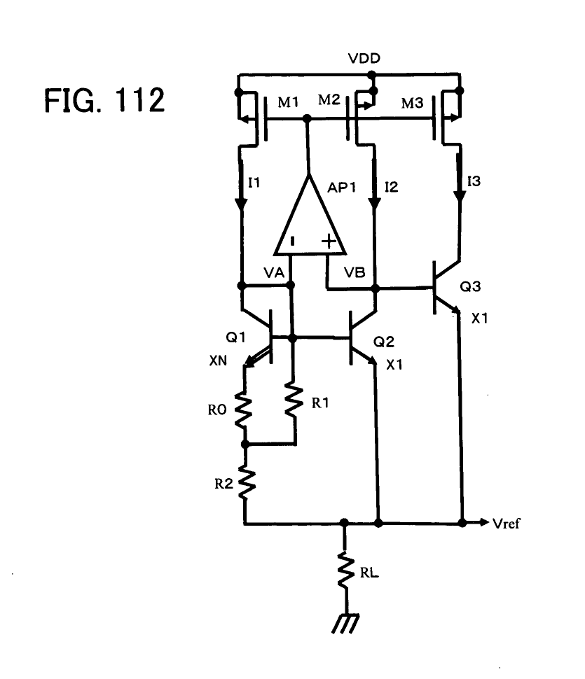

The reference voltage circuit, shown in FIG. 41, may be modified to a reference voltage circuit shown in FIG. 110. FIG. 112 shows a so obtained reference voltage circuit.

Referring to FIG. 112, the circuit of the present example is a circuit of FIG. 41 in which the output transistor M4 is eliminated from the linear current mirror circuit M1 to M4, and in which, instead of directly grounding the resistor R2 and the emitter of the transistor Q2 in the non-linear current mirror circuit in the configuration of FIG. 38B, and the emitter of the transistor Q3, a common connection point of the resistor R2 and the emitter of the transistor Q2 in the non-linear current mirror circuit and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those obtained with FIG. 41. A reference voltage, compensated for temperature non-linearity proper to a transistor, may also be obtained at the opposite side terminal of the resistor R2.

### EXAMPLE 14-3

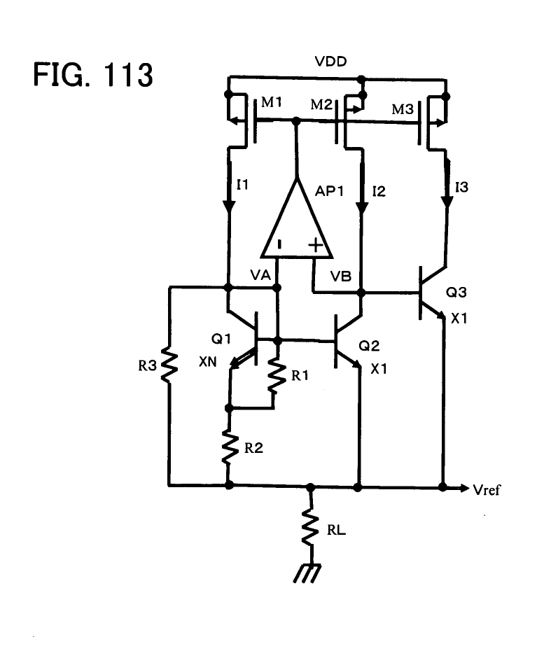

The reference voltage circuit, shown in FIG. 42, may be modified to a reference voltage circuit shown in FIG. 110. FIG. 113 shows a so obtained reference voltage circuit.

Referring to FIG. 113, the circuit of the present example is a circuit of FIG. 42 in which the output transistor M4 is eliminated from the linear current mirror circuit M1 to M4, and in which, instead of directly grounding the resistors R2 and R3 and the emitter of the transistor Q2 in the non-linear current mirror circuit in the configuration of FIG. 38C, and the emitter of the transistor Q3, a common connection point of the resistors R2, R3 and the emitter of the transistor Q2 in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 42.

In similar manner, an output transistor may be eliminated from the self-biasing linear current mirror circuit, in the self-biased reference voltage circuit shown in FIG. 49, thereby further simplifying the circuit. That is, the circuit may be stacked on an output resistor to cause the circuit current to flow through the output resistor to generate the reference voltage.

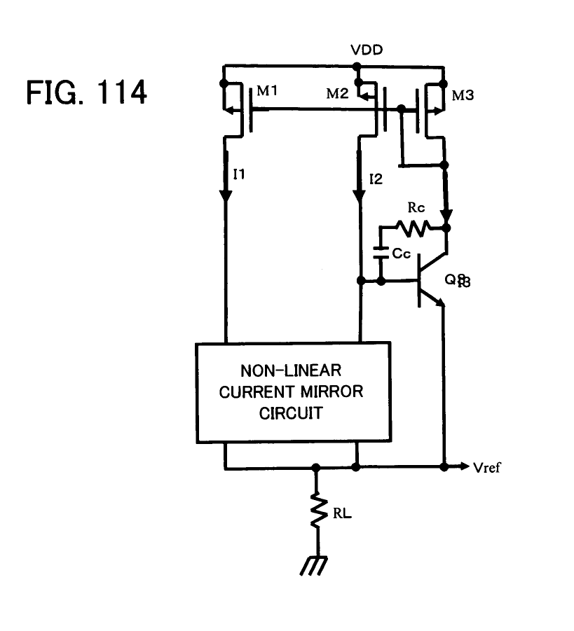

In the reference voltage circuit, shown in FIG. 114, there flows the current so that the input current I1 and the output current I2 of the non-linear current mirror circuit, inclusive of the first and second bipolar transistors, will be equal to each other. Thus, the voltage at the input terminal and that at the output terminal are equal to each other. The bipolar transistor Q3 has a base connected to the output terminal of the non-linear current mirror circuit, while having an emitter grounded and having a collector connected to a MOS transistor M3 that has a gate and a drain connected together. The MOS transistors M1 to M3 form a current mirror circuit.

The non-linear current mirror circuit and the bipolar transistor Q3 are grounded via resistor RL. Hence, the terminal voltage of this resistor RL represents an output of the reference voltage circuit to give the reference voltage Vref.

In the reference voltage circuit, the gates of the MOS transistors M1 to M3 are connected together to form a current mirror circuit. The gate and the drain of the MOS transistor M3 are connected together and driven by the collector current flowing through the bipolar transistor Q3 to operate so that the input current and the output current of the non-linear current mirror circuit including the first and second bipolar transistors will be equal to each other. Here, a series connection of a capacity C_{C} and a resistor R_{C} is shown added for phase compensation between the base (input) and the collector (output) of the bipolar transistor Q3.

If the non-linear current mirror circuit is arranged in such a manner that, when the output currents I1 and I2 of the current mirror circuit formed by the MOS transistors M1 and M2 are increased, the base voltage of the bipolar transistor Q3 is lowered, a negative feedback current loop is established to implement a reference current circuit. If the other output of the linear current mirror circuit is connected to a resistor to convert the current into a voltage, a reference voltage Vref is generated. The linear current mirror circuit may thus be used as a reference voltage circuit.

The output currents I1, I2 and I3 of the 1:1:1 current mirror circuit, formed by the MOS transistors M1 to M3, are equal to one another. The sum current (I1+I2+I3) flows through the resistor RL, and hence the reference voltage Vref, operating as an output of the reference voltage circuit, is generated from the terminal voltage.

As may be surmised from the reference voltage circuit, shown in FIG. 49, the current (I1+I2+I3) is a current compensated for temperature characteristic and for temperature non-linearity of bipolar transistor VBE. The reference voltage Vref is thus a reference voltage compensated for temperature non-linearity of bipolar transistor VBE and which is freed of temperature characteristic.

### EXAMPLE 15-1

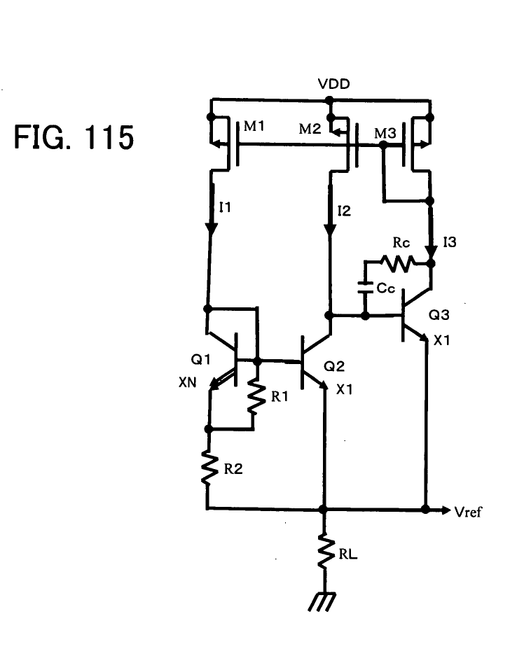

The reference voltage circuit, shown in FIG. 50, may be modified to a reference voltage circuit shown in FIG. 114. FIG. 115 shows a so obtained reference voltage circuit.

Referring to FIG. 115, the circuit of the present example is a circuit of FIG. 50 in which the output transistor M4 is eliminated from the linear current mirror circuit M1 to M4, and in which, instead of directly grounding the resistor R2 and the emitter of the transistor Q2, in the non-linear current mirror circuit in the configuration of FIG. 38(a), and the emitter of the transistor Q3, a common connection point of the resistor R2 and the emitter of the transistor Q2 in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 50. A reference voltage, compensated for temperature non-linearity proper to a transistor, may also be obtained at the opposite side terminal of the resistor R2.

### EXAMPLE 15-2

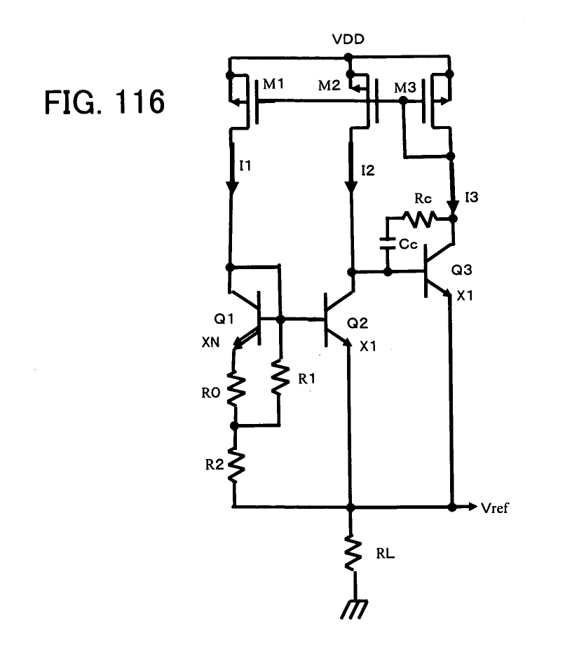

The reference voltage circuit, shown in FIG. 51, may be modified to a reference voltage circuit shown in FIG. 114. FIG. 116 shows a so obtained reference voltage circuit.

Referring to FIG. 116, the circuit of the present example is a circuit of FIG. 51 in which the output transistor M4 is deleted from the linear current mirror circuit M1 to M4, and in which, instead of directly grounding the resistor R2 and the emitter of the transistor Q2 in the non-linear current mirror circuit in the configuration of FIG. 38(b), and the emitter of the transistor Q3, a common connection point of the resistor R2 and the emitter of the transistor Q2 in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those obtained with FIG. 51. A reference voltage, compensated for temperature non-linearity proper to a transistor, may be obtained at the opposite side terminal of the resistor R2 as well.

### EXAMPLE 15-3

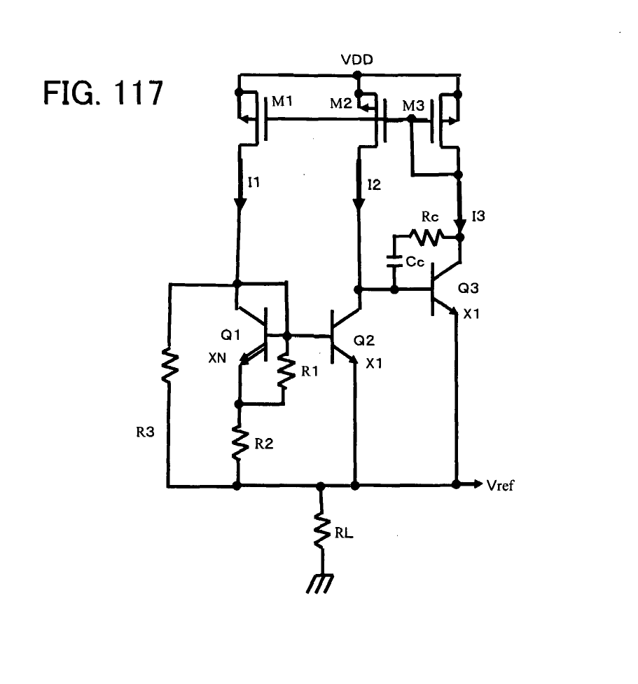

The reference voltage circuit, shown in FIG. 52, may be modified to a reference voltage circuit shown in FIG. 114. FIG. 117 shows a so obtained reference voltage circuit.

Referring to FIG. 117, the circuit of the present example is a circuit of FIG. 52 in which the output transistor M4 is eliminated from the linear current mirror circuit M1 to M4, and in which, instead of directly grounding the resistors R2, R3 and the emitter of the transistor Q2, in the non-linear current mirror circuit in the configuration of FIG. 38(c), and the emitter of the transistor Q3, a common connection point of the resistors R2, R3 and the emitter of the transistor Q2, in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those obtained with FIG. 52.

### EXAMPLE 15-4

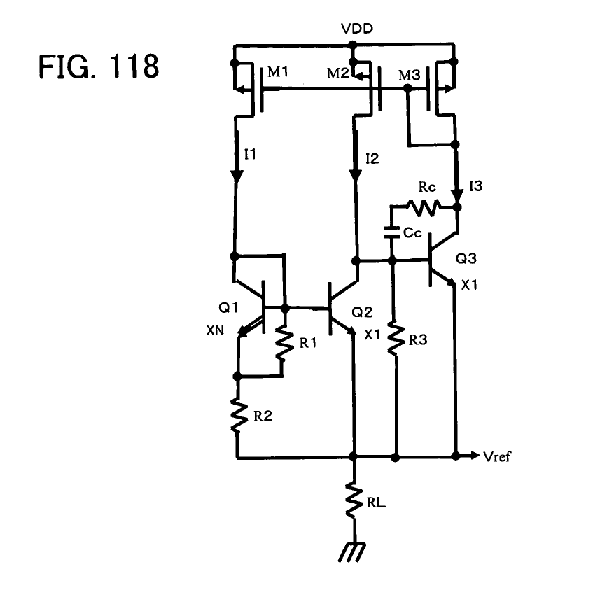

The reference voltage circuit, shown in FIG. 55, may be modified to a reference voltage circuit shown in FIG. 114. FIG. 118 shows a so obtained reference voltage circuit.

Referring to FIG. 118, the circuit of the present example is a circuit of FIG. 53 in which, in the non-linear current mirror circuit, the collector of the bipolar transistor Q2 of FIG. 38(a) is grounded via resistor R3, the output transistor M4 is eliminated from the linear current mirror circuit M1 to M4, and in which, instead of directly grounding the resistor R2 and the emitter of the transistor Q2, in the non-linear current mirror circuit in the configuration of FIG. 38(a), and the emitter of the transistor Q3, a common connection point of the resistor R2 of the non-linear current mirror circuit, emitter of the transistor Q2, resistor R3 and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 53. A reference voltage, compensated for temperature non-linearity proper to a transistor, may also be obtained at the opposite side terminal of the resistor R2.

### EXAMPLE 15-5

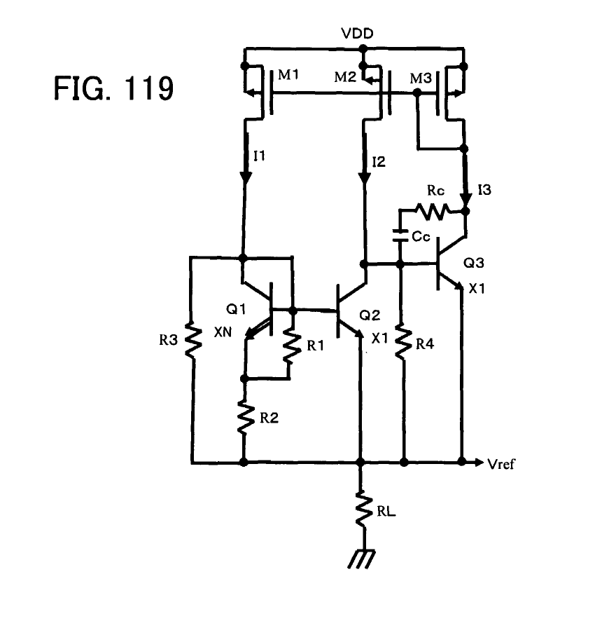

The reference voltage circuit, shown in FIG. 54, may be modified to a reference voltage circuit shown in FIG. 114. FIG. 119 shows a so obtained reference voltage circuit.

Referring to FIG. 119, the circuit of the present example is a circuit of FIG. 54 in which, in the non-linear current mirror circuit, the collector of the bipolar transistor Q2 of FIG. 38(c) is grounded via resistor R4, the output transistor M4 is eliminated from the linear current mirror circuit M1 to M4, and in which, instead of directly grounding the resistors R2, R3 and the emitter of the transistor Q2, in the non-linear current mirror circuit, the resistor R4 and the emitter of the transistor Q3, a common connection point of the resistors R2, R3 and the emitter of the transistor Q2 of the non-linear current mirror circuit, the resistor R4 and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 54.

### EXAMPLE 15-6

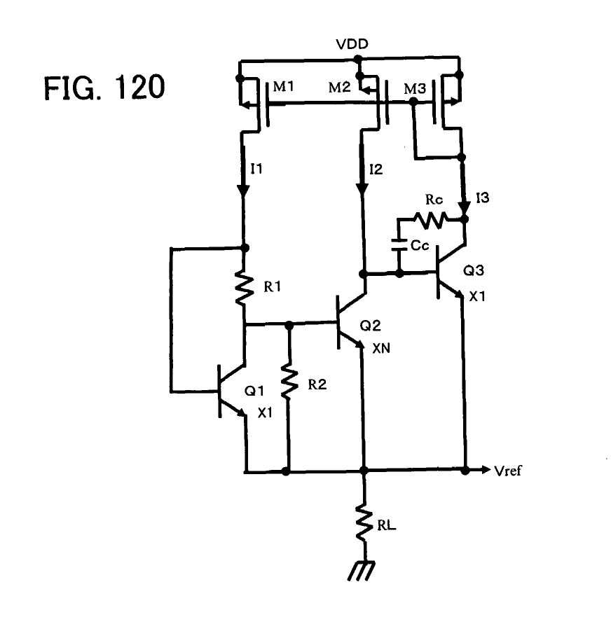

The reference voltage circuit, shown in FIG. 55, may be modified to a reference voltage circuit shown in FIG. 114. FIG. 120 shows a so obtained reference voltage circuit.

Referring to FIG. 120, the circuit of the present example is a circuit of FIG. 55 in which the non-linear current mirror circuit is the Nagata's current mirror circuit with the collector of the bipolar transistor Q2 grounded via resistor R2, the output transistor M4 is eliminated from the linear current mirror circuit M1 to M4, and in which, instead of directly grounding the emitters of the transistors Q1 and Q2, and the resistor R2, in the non-linear current mirror circuit, the resistor R2 and the emitter of the transistor Q3, a common connection point of the emitters of the transistors Q1 and Q2, and the resistor R2, in the non-linear current mirror circuit, the resistor R4 and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 54.

### EXAMPLE 15-7

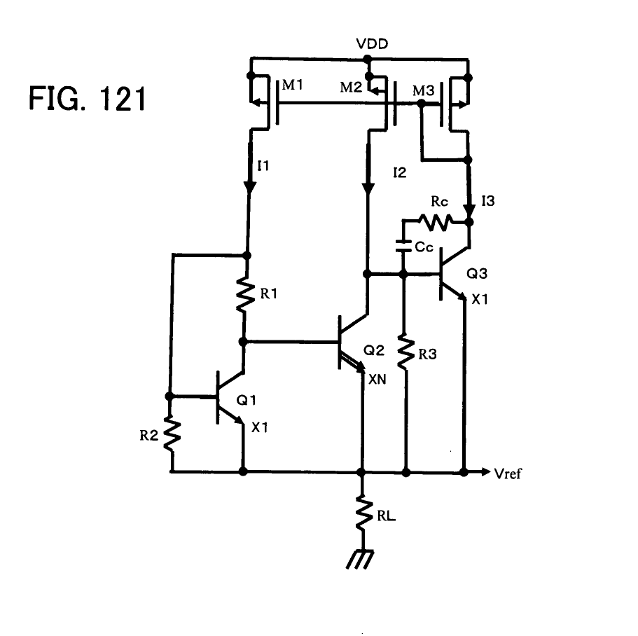

The reference voltage circuit, shown in FIG. 56, may be modified to a reference voltage circuit shown in FIG. 114. FIG. 121 shows a so obtained reference voltage circuit.

Referring to FIG. 121, the circuit of the present example is a circuit of FIG. 56 in which the non-linear current mirror circuit is the Nagata's current mirror circuit with the base of the bipolar transistor Q1 grounded via resistor R2 and with the collector of the bipolar transistor Q2 grounded via resistor R3, the output transistor M4 is eliminated from the linear current mirror circuit M1 to M4. Instead of directly grounding the emitter of the transistors Q1 and Q2, and the resistors R2, R3 in the non-linear current mirror circuit, and the emitter of the transistor Q3, a common connection point of the emitters of the transistors Q1 and Q2, and the resistors R2, R3 in the non-linear current mirror circuit, and the emitter of the transistor Q3, is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 56.

### EXAMPLE 15-8

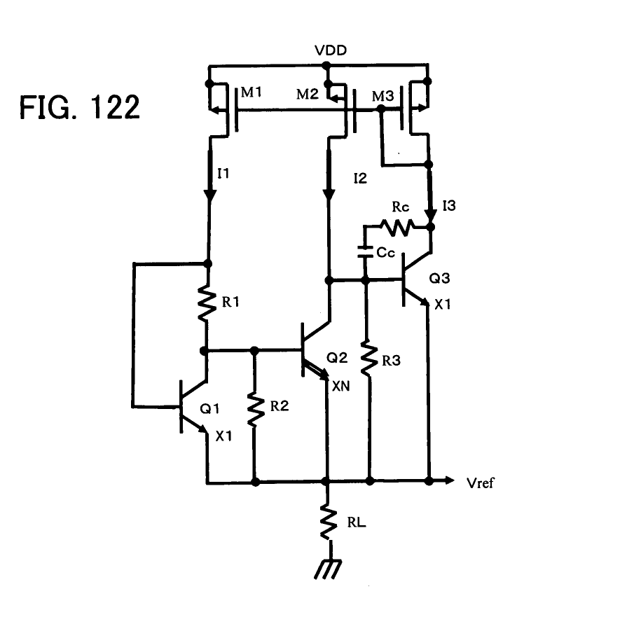

The reference voltage circuit, shown in FIG. 57, may be modified to a reference voltage circuit shown in FIG. 114. FIG. 122 shows a so obtained reference voltage circuit.

Referring to FIG. 122, the circuit of the present example is a circuit of FIG. 57 in which the non-linear current mirror circuit is the Nagata's current mirror circuit with the base of the bipolar transistor Q1 grounded via resistor R2 and with the collector of the bipolar transistor Q2 grounded via resistor R3, an output transistor M4 is eliminated from the linear current mirror circuit M1 to M4, and in which, instead of directly grounding the resistors R2 and R3 and the emitter of the transistor Q2 and the emitter of the transistor Q3, a common connection point of the resistors R2 and R3 in the non-linear current mirror circuit, and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, it may be expected that the temperature non-linearity proper to a diode may be compensated to lead to an improved characteristic comparable to those of FIG. 53.

### EXAMPLE 15-9

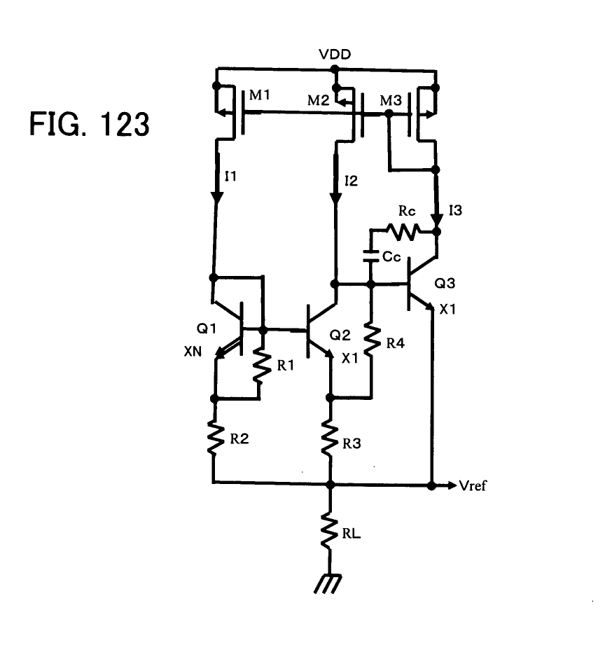

The reference voltage circuit, shown in FIG. 58, may be modified to a reference voltage circuit shown in FIG. 114. FIG. 123 shows a so obtained reference voltage circuit.

Referring to FIG. 123, the circuit of the present example is a circuit of FIG. 58 in which a bipolar transistor Q1 has a base and a collector connected together, a resistor is connected between its base and emitter and grounded via a resistor R2 and resistor R4 is connected between the collector and the emitter of a bipolar transistor Q2 and is grounded via an emitter resistor R3. The output transistor M4 is eliminated from the linear current mirror circuit M1 to M4. Instead of directly grounding the resistors R2, R3 of the non-linear current mirror circuit and the emitter of the transistor Q3, a common connection point of the resistors R2, R3 of the non-linear current mirror circuit and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 58. The reference voltage compensated for temperature non-linearity of transistors may be obtained from the opposite side terminals of the resistors R2 and R3 as well.

### EXAMPLE 15-10

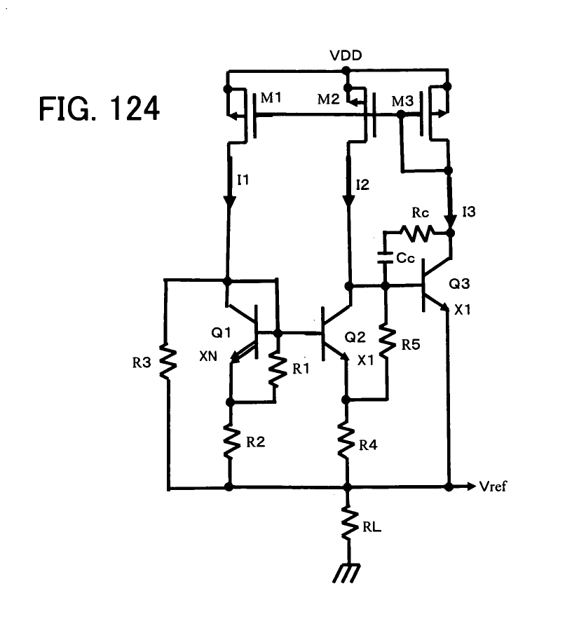

The reference voltage circuit, shown in FIG. 59, may be modified to a reference voltage circuit shown in FIG. 114. FIG. 124 shows a so obtained reference voltage circuit.

Referring to FIG. 124, the circuit of the present example is a circuit of FIG. 59 in which a bipolar transistor Q1 has a base and a collector connected together, a resistor is connected between its base and emitter and grounded via a resistor R2, and a resistor R5 is connected between the collector and the emitter of a bipolar transistor Q2 and is grounded via an emitter resistor R4. The output transistor M4 is eliminated from the linear current mirror circuit M1 to M4 and, instead of directly grounding the resistors R2, R3, R4 in the non-linear current mirror circuit and the emitter of the transistor Q3, a common connection point of the resistors R2, R3, R4 of the non-linear current mirror circuit and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 59. A reference voltage compensated for temperature non-linearity may be obtained from the opposite terminal of the resistor R4 as well.

### EXAMPLE 15-11

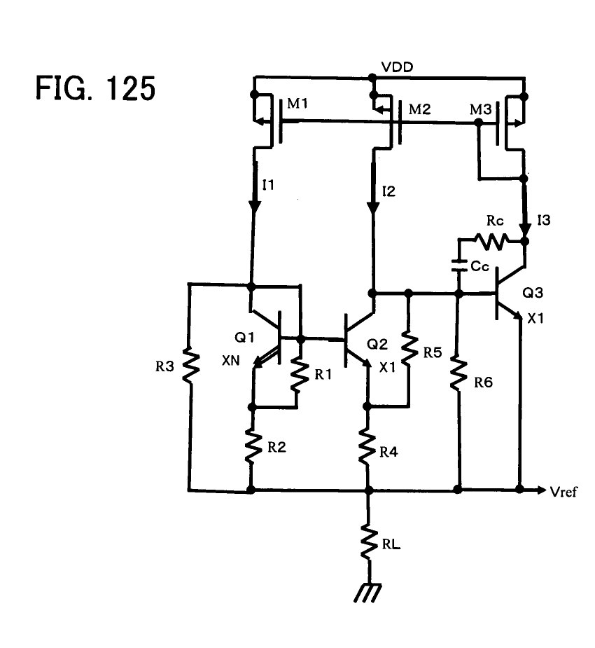

The reference voltage circuit, shown in FIG. 60, may be modified to a reference voltage circuit shown in FIG. 114. FIG. 125 shows a so obtained reference voltage circuit.

Referring to FIG. 125, the circuit of the present example is a circuit of FIG. 60 in which a bipolar transistor Q1 has a base and a collector connected together, a resistor R5 is connected between its base and emitter and grounded via a resistor R2, and the collector (base) of the bipolar transistor Q1 is grounded via resistor R6. A resistor R5 is connected between the collector and the emitter of a bipolar transistor Q2 and is grounded via an emitter resistor R6. The output transistor M4 is eliminated from the linear current mirror circuit M1 to M4 and, instead of directly grounding the resistors R2, R3, R4, R6 in the non-linear current mirror circuit and the emitter of the transistor Q3, a common connection point of the resistors R2, R3, R4, R6 of the non-linear current mirror circuit and the emitter of the transistor Q3 is grounded via resistor RL. The output currents I1, I2 and I3 of the 1:1:1 current mirror circuit, made up of the MOS transistors M1 to M3, are equal to one another. The current sum (I1+I2+I3) flows through the resistor RL to render the terminal voltage of the resistor RL a reference voltage Vref. In the present example, the temperature non-linearity proper to a diode may be expected to be compensated to lead to an improved characteristic comparable to those of FIG. 60. A reference voltage compensated for temperature non-linearity may be obtained from the opposite terminal of the resistor R2 as well.

### EXAMPLE 16

It is now shown that, even with the first generation reference voltage circuit, with the output voltage of 1.2V, it is possible to compensate for temperature non-linearity of transistor VBE by newly adding a resistor.

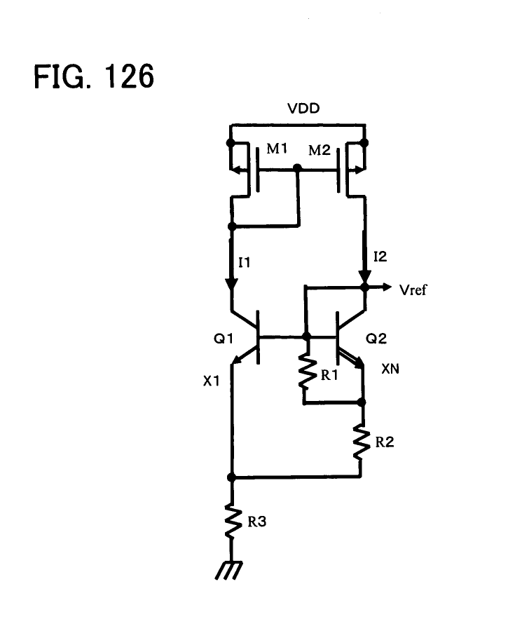

FIG. 126 shows a Brokaw reference voltage circuit added by a resistor R1 that compensates for temperature non-linearity of the transistor's base-to-emitter voltage VBE.

The emitter area ratio of the bipolar transistors Q1 and Q2, is 1:N, where N>0. The bases of the two bipolar transistors are connected together to form an output terminal.

A resistor R1 is connected between the base and the emitter of the bipolar transistor Q2. An emitter resistor R2 is connected to the emitter of the bipolar transistor Q1. The emitter of the bipolar transistor Q1 is grounded via emitter resistor R3.

The p-channel MOS transistor M1 has a gate and a drain connected together. The transistor M1 and the p-channel MOS transistor M2 have gates connected together to form a current mirror circuit that self-biases the bipolar transistors Q1 and Q2.

The current mirror circuit, formed by the transistors M1 and M2, sends the currents I1 and I2 to the bipolar transistors Q1 and Q2, respectively, for self-biasing.

The emitter area ratio of the bipolar transistors Q1 and Q2, is 1:N, where N>0, so that, if I1=I2,

$$\begin{matrix}{V}_{BE 1} = {V}_{T} ln ( \frac{{I}_{1}}{{I}_{2}} ) \\ and & ( 160 ) \\ {V}_{BE 2} = {V}_{T} ln \{ \frac{{I}_{2}}{N ( {I}_{s} - \frac{{V}_{BE 2}}{{R}_{1}} )} \} & ( 161 )\end{matrix}$$

The drain currents I1 and I2 of the MOS transistors M1 and M2 are given by

I₁=I_{C1} (162)

and

I₂=I_{C2}+V_{EB2}/R₁ (163)

where IC1 and IC2 respectively denote collector currents of the bipolar transistors Q1 and Q2.

Hence, the difference Δ VBE of the base-to-emitter voltages VB1, VB2 of the bipolar transistors Q1 and Q2, is expressed by

$$Δ {V}_{BE} = {V}_{BE 1} - {V}_{BE 2} = {V}_{T} ln ( \frac{N}{1 - \frac{{V}_{BE 2}}{{I}_{1} {R}_{1}}} ) = {R}_{2} {I}_{2} \qquad ( 164 )$$

The reference voltage Vref obtained may thus be expressed by

$$Vref = {V}_{BE 1} + {R}_{3} ( {I}_{1} + {I}_{2} ) = {V}_{BE 1} + \frac{2 {R}_{3}}{{R}_{2}} {V}_{T} ln ( \frac{N}{1 - \frac{{V}_{BE 2}}{{I}_{1} {R}_{1}}} ) \qquad ( 165 )$$

If, in the equation (165), the value of 2R3/R1 is set so that V_{BE1} having a negative temperature characteristic and V_{T} having a positive temperature characteristic will compensate temperature characteristic, it is possible to cancel temperature non-linearity proper to Vref. To cancel the temperature non-linearity, proper to V_{BE1}, the configuration shown in FIG. 7 is used. It is noted however that the slope of a positive temperature characteristic is moderate in the vicinity of the center temperature (27° C.). Thus, in order for the positive temperature characteristic to be canceled by V_{BE1} having the negative temperature characteristic of −1.9 mV/° C., the value of the coefficient 2R3/R1 must be correspondingly larger. Hence, the value of the reference voltage Vref obtained is appreciably larger than the value accepted so far (approximately 1.2V).

Thus, in the present example, it may be expected that the reference voltage, compensated for temperature non-linearity of the transistor VBE, may be obtained to achieve the characteristic improved over the characteristic of the Brokaw reference voltage circuit.

It should be noted that similarity of the circuit of FIG. 66 to the Brokaw reference voltage circuit, compensated for temperature non-linearity of transistor VBE, shown in FIG. 126, is worthy of consideration.

There is a method of compensating for temperature non-linearity of FIG. 11, in addition to the method shown in FIG. 7, as discussed above. These methods should be implemented by corresponding two circuits.

### EXAMPLE 17

In similar manner, the temperature non-linearity of transistor VBE may be compensated by the first generation reference voltage circuit having the typical 1.2V as an output voltage. The manner of compensating for temperature non-linearity of diode VF in the first generation reference voltage circuit shown in FIG. 1 is now described.

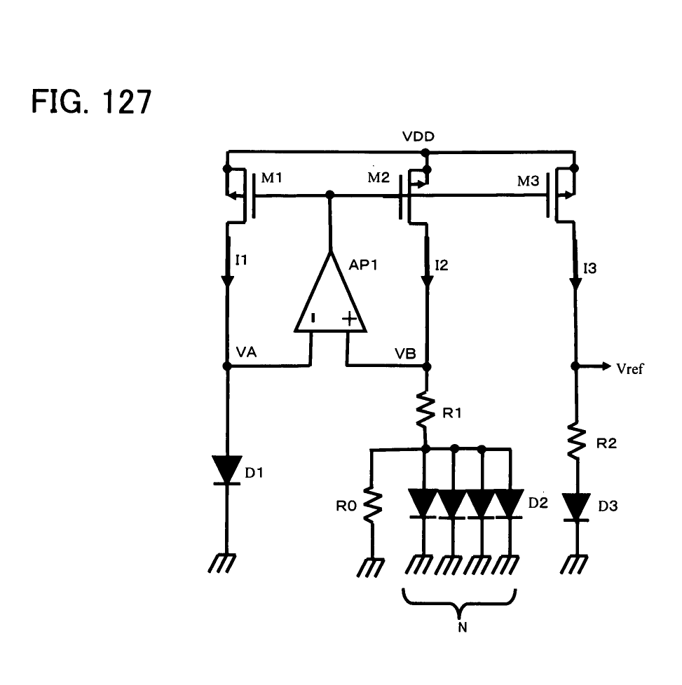

FIG. 127 shows a configuration in which a resistor R0 that compensates for temperature non-linearity of transistor VBE is added to the first generation reference voltage circuit shown in FIG. 1.

In FIG. 127, the first current-to-voltage converter I-V1 is made up only of a diode. The second current-to-voltage converter I-V2 is made up by a series connection of a resistor R1 and a parallel connection of a plurality of diodes and a resistor R0. The third current-to-voltage converter I-V3 is made up of a series connection of a diode and a resistor R2.

The MOS transistors M1 to M3 form a current mirror circuit and drive the first to third current-to-voltage converter I-V1, I-V2 and I-V3, respectively.

The reference voltage Vref is obtained as a terminal voltage of the third current-to-voltage converter I-V3.

In FIG. 127, the first current-to-voltage converter I-V1 is made up only of a diode. The second current-to-voltage converter I-V2 is made up by a series connection of a resistor R1 and a parallel connection of a plurality of diodes and a resistor R0. The third current-to-voltage converter I-V3 is made up of a series connection of a diode and a resistor R2.

It is noted that the OP amp controls the current mirror circuit, made up of the MOS transistors M1 to M3, so that the terminal voltage VA of the first current-to-voltage converter I-V1 will be equal to the terminal voltage VB of the second current-to-voltage converter I-V2.

Hence,

VA=VB=VF1 (166)

With the current ratio 1:1:1 of the current mirror circuit,

I1=I2=I3=Δ VF/R1 (167)

The output current (drain current) I1 of the MOS transistor M1 is equal to the forward current of the diode D1, while the output current (drain current) I2 of the MOS transistor M2 is equal to the sum of the forward current of the diode D2 times N and VF2/R0. That is, the forward current of the diode D2 is given by (I2−VF2/R0)/N, so that

V_{F1}=V_{T} ln(l₁/I_{S})=V_{T} ln(I₂/I_{S}) (168-1)

and

V_{F2}=V_{T} ln{(I₂−V_{F2}/R₀)/(N*I_{S})} (168-2)

where IS denotes the saturation current and V_{T} denotes the thermal temperature. Hence, ΔV_{F}=V_{F1}−V_{F2} is given by

$$Δ {V}_{F} = {V}_{T} ln ( \frac{N}{1 - \frac{{V}_{F 2}}{{I}_{2} {R}_{0}}} ) \qquad ( 169 )$$

The reference voltage Vref is obtained as a terminal voltage of the third current-to-voltage converter I-V3 to which is connected a series circuit of the diode and the resistor R2.

Hence, the reference voltage Vref is found as

$$Vref = {V}_{F 3} + {R}_{2} {I}_{3} = {V}_{F 3} + \frac{{R}_{2}}{{R}_{1}} {V}_{T} ln ( \frac{N}{1 - \frac{{V}_{F 2}}{{I}_{2} {R}_{0}}} ) \qquad ( 170 )$$

If, in the equation (170), the value of R2/R1 is set so that V_{F3} having a negative temperature characteristic and V_{T} having a temperature characteristic will cancel the temperature characteristic, it is possible to cancel the temperature characteristic of Vref.

To cancel the temperature non-linearity, proper to V_{F3}, the configuration shown in FIG. 7 is used. It is noted however that the slope of a positive temperature characteristic is moderate in the vicinity of the center temperature (27° C.). Thus, in order for a positive temperature characteristic to be compensated by V_{F3} having the negative temperature characteristic of −1.9 mV/° C., the value of the coefficient R2/R1 must be correspondingly larger. Hence, the value of the reference voltage Vref obtained is appreciably larger than the value accepted so far (approximately 1.2V). The SPICE simulation value was 3.5V, with the width of temperature variations being 0.146%. While the reference voltage Vref obtained is tripled, the width of temperature variations is one-third. The configuration shown in FIG. 7 is not proper for a low voltage circuit because a power supply voltage as high as 4V or higher is then needed.

### EXAMPLE 18

The temperature non-linearity of diode VF may similarly be compensated even with the conventional 1.5th generation reference voltage circuit having the voltage of the order of 1.0V as the output voltage. In particular, considering that, with this 1.5th generation reference voltage circuit, the temperature non-linearity is increased to approximately twice that of the first generation reference voltage circuit, it may be the that the way according to the present application may overcome the problem connected with increased temperature non-linearity.

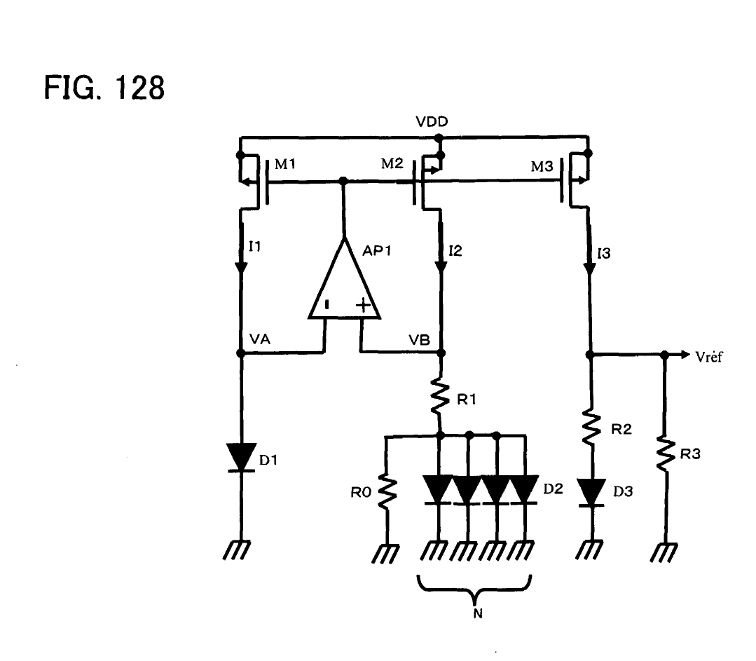

FIG. 128 is a diagram showing a 1.5th generation reference voltage circuit added by a resistor R0 that compensates for temperature non-linearity of diode VF.

In FIG. 128, the first current-to-voltage converter I-V1 is made up only of a diode. The second current-to-voltage converter I-V2 is made up by a series connection of a resistor R1 and a parallel connection of a plurality of diodes and a resistor R0. The third current-to-voltage converter I-V3 is made up of a series connection of a diode and a resistor R2 and a resistor R3 connected in parallel with the series connection.

The MOS transistors M1, M2 and M3 form a current mirror circuit and respectively drive the first, second and third current-to-voltage converters IV-1, IV-2 and IV-3.

The inverting input terminal and the non-inverting input terminal of the OP amp are respectively connected to the terminals of the first current-to-voltage converter I-V1 and the second current-to-voltage converter I-V2. The output of the OP amp is connected to the common gates of the MOS transistors M1 to M3.

The reference voltage Vref is obtained as the terminal voltage of the third current-to-voltage converter I-V3.

In FIG. 128, the first current-to-voltage converter I-V1 is made up only of a diode. The second current-to-voltage converter I-V2 is made up by a series connection of a resistor R1 and a parallel connection of a plurality of diodes and a resistor R0. The third current-to-voltage converter I-V3 is made up of a series connection of a diode and a resistor R2 and a resistor R3 connected in parallel with the series connection.

It is noted that the OP amp controls the current mirror circuit, made up of the MOS transistors M1 to M3, so that the terminal voltage VA of the first current-to-voltage converter I-V1 will be equal to the terminal voltage VB of the second current-to-voltage converter I-V2.

Hence,

VA=VB=VF1 (171)

With the current ratio 1:1:1 of the current mirror circuit,

I1=I2=I3=Δ VF/R1 (172)

It is noted that Δ VF is expressed by

$$Δ {V}_{F} = {V}_{T} ln ( \frac{N}{1 - \frac{{V}_{F 2}}{{I}_{2} {R}_{0}}} ) \qquad ( 173 )$$

The reference voltage Vref is obtained as the terminal voltage of the third current-to-voltage converter I-V3 which is made up of a series connection of a diode and a resistor R2 and a resistor R3 connected in parallel with the series connection.

Hence, I3 and Vref may respectively be found by

$$\begin{matrix}{I}_{3} = \frac{Vref}{{R}_{3}} + \frac{Vref - {V}_{F 3}}{{R}_{2}} \\ and by & ( 174 ) \\ \begin{matrix}Vref = \frac{{R}_{2} {R}_{3}}{{R}_{2} + {R}_{3}} ( {I}_{3} + \frac{{V}_{F 3}}{{R}_{2}} ) \\ = \frac{{R}_{2} {R}_{3}}{{R}_{2} + {R}_{3}} ( \frac{Δ {V}_{F}}{{R}_{1}} + \frac{{V}_{F 3}}{{R}_{2}} ) \\ = \frac{{R}_{3}}{{R}_{2} + {R}_{3}} \{ {V}_{F 3} + \frac{{R}_{2}}{{R}_{1}} {V}_{T} ln ( \frac{N}{1 - \frac{{V}_{F 2}}{{I}_{2} {R}_{0}}} ) \}\end{matrix} & ( 175 )\end{matrix}$$

If, in the equation (175), the value of R2/R1 is set so that VF 3 having a negative temperature characteristic and V_{T} having a positive temperature characteristic will cancel the temperature characteristic, it is possible to cancel the temperature non-linearity of Vref. To cancel the temperature non-linearity, proper to V_{F3}, the configuration shown in FIG. 7 is used. It is noted however that the gradient of a positive temperature characteristic is moderate in the vicinity of the center temperature (27° C.). Thus, in order for the positive temperature characteristic to be canceled by V_{BE1} having the negative temperature characteristic of −1.9 mV/° C., the value of the coefficient R2/R1 must be correspondingly larger.

The reference voltage Vref obtained is operated on by the coefficient R3/(R2+R3) (<1) and hence may be set to a value smaller than the typical value accepted up to now, thus allowing the power supply voltage to be lowered. The reference voltage Vref obtained may however, not be set to lower than the VF3 voltage. It is noted that the typical value is approximately 1.2V and, with the 1.5th generation reference voltage circuit, is on the order of 1V.

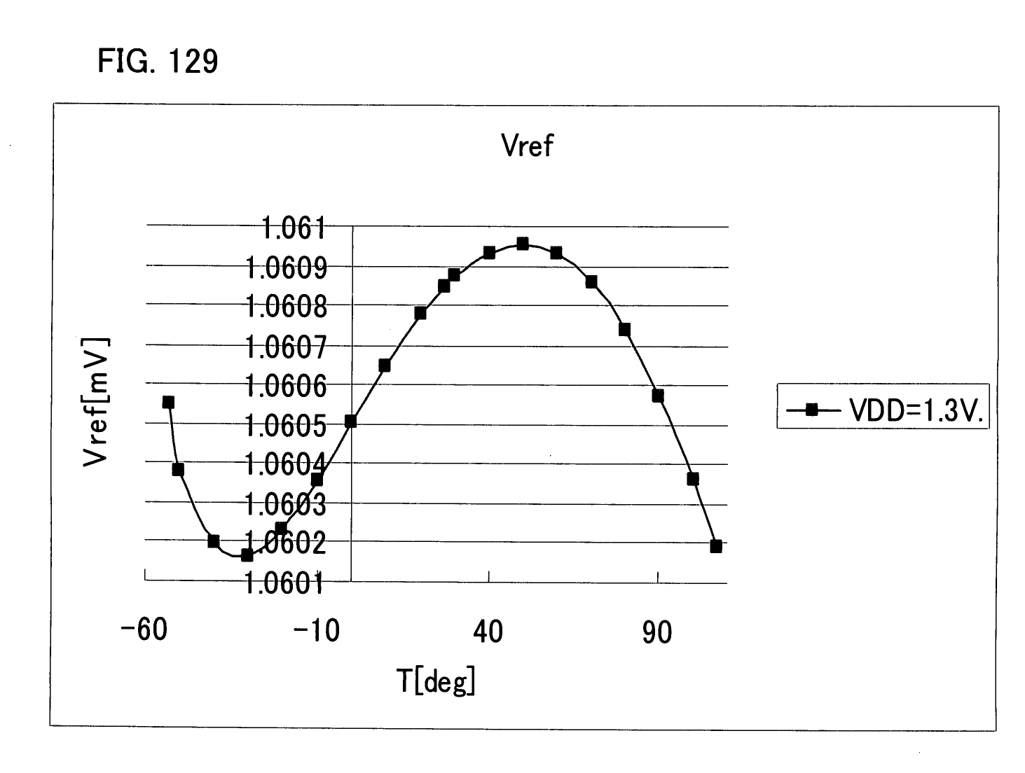

The values of simulation, actually conducted on the circuit of FIG. 128, are shown in FIG. 129. For VDD=1.3V, N=4, R0=16.08 kΩ, R1=0.9 kΩ, R2=130 kΩ, and R3=18 kΩ, were set, the values of Vref were 365.434 mV, 1.060163V, 1.06055V, 1.060502V and 1.060848V, 1.060954V and 1.06019V for −53° C., −30° C., −10° C., 0° C., 27° C., 50° C. and 107° C., respectively, with the curve of Vref being of an undulating shape. The width of temperature variations was suppressed to 0.072%. If the coefficient R3/(R2+R3) (<1) is eliminated, the result is on the order of 8.2V, so that the power supply is severe. However, the power supply voltage may be lowered to approximately 1.3V by adding a resistor R3 to the output circuit to set the output reference voltage to about 1 V. On the other hand, the width of temperature variations for the 1.5th generation reference voltage circuit may be lowered by about one order of magnitude.

### EXAMPLE 18

Another illustrative circuit that compensates for temperature non-linearity of diode VF is shown. The present circuit belongs to the first generation reference voltage circuit having the typical 1.2V as an output voltage.

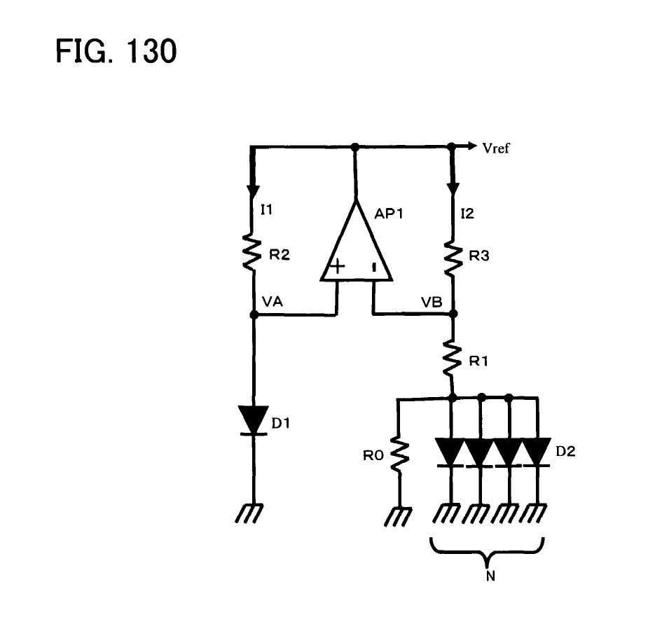

FIG. 130 is a diagram showing a conventional first generation reference voltage circuit added by a resistor R0 that compensates for temperature non-linearity of diode VF.

In FIG. 130, the first current-to-voltage converter I-V1 is made up only of a diode. The second current-to-voltage converter I-V2 is made up of a parallel connection of a plurality of diodes and a resistor R0 and a resistor R1 connected in series with the parallel connection. The third current-to-voltage converter I-V3 is not provided. A non-inverting input terminal and an inverting input terminal of an OP amp are respectively connected to the terminal of the first current-to-voltage converter I-V1 and to the terminal of the second current-to-voltage converter I-V2. The resistors R2, R3, respectively connected in series with the first current-to-voltage converter I-V1 and with the second current-to-voltage converter I-V2, are driven by the output voltage of the OP amp, which output voltage of the OP amp is obtained as the reference voltage Vref.

In FIG. 130, the first current-to-voltage converter I-V1 is made up only of a diode. The second current-to-voltage converter I-V2 is made up of a parallel connection of a plurality of diodes and a resistor R0 and a resistor R1 connected in series with the parallel connection. The third current-to-voltage converter I-V3 is not provided. The resistors R2, R3, respectively connected in series with the first current-to-voltage converter I-V1 and with the second current-to-voltage converter I-V2, are driven by the output voltage of the OP amp, which output voltage of the OP amp is obtained as the reference voltage Vref.

With the OP amp, the terminal voltages of the resistors R2, R3 are applied so that the terminal voltage VA of the first current-to-voltage converter I-V1 will be equal to the terminal voltage VB of the second current-to-voltage converter I-V2.

Hence,

VA=VB=VF1 (176)

If the resistors R2, R3 are set to equal values,

I1=I2=Δ VF/R1 (177)

where

$$Δ {V}_{F} = {V}_{T} ln ( \frac{N}{1 - \frac{{V}_{F 2}}{{I}_{2} {R}_{0}}} ) \qquad ( 178 )$$

The reference voltage Vref is obtained as an output voltage of the OP amp, and thus may be found as

$$Vref = {V}_{F 1} + {R}_{2} {I}_{1} = {V}_{F 1} + \frac{{R}_{22}}{{R}_{1}} {V}_{T} ln ( \frac{N}{1 - \frac{{V}_{F 2}}{{I}_{1} {R}_{0}}} ) \qquad ( 179 )$$

If, in the equation (178), the value of R2/R1 is set so that VF1 having a negative temperature characteristic and V_{T} having a positive temperature characteristic will cancel the temperature characteristic, it is possible to cancel the temperature non-linearity of Vref. To cancel the temperature non-linearity, proper to V_{F1}, the configuration shown in FIG. 7 is used. However, the gradient of a positive temperature characteristic is moderate in the vicinity of the center temperature (27° C.). Thus, in order for a positive temperature characteristic to be canceled by VF3 having a negative temperature characteristic of −1.9 mV/° C., the value of the coefficient R2/R1 must be correspondingly larger. The resulting reference voltage Vref is of a value appreciably larger than the value accepted so far (approximately 1.2V).

### EXAMPLE 19

Another illustrative circuit that compensates for temperature non-linearity of transistor VBE is shown. The present circuit belongs to the first generation reference voltage circuit having the typical 1.2V as an output voltage.

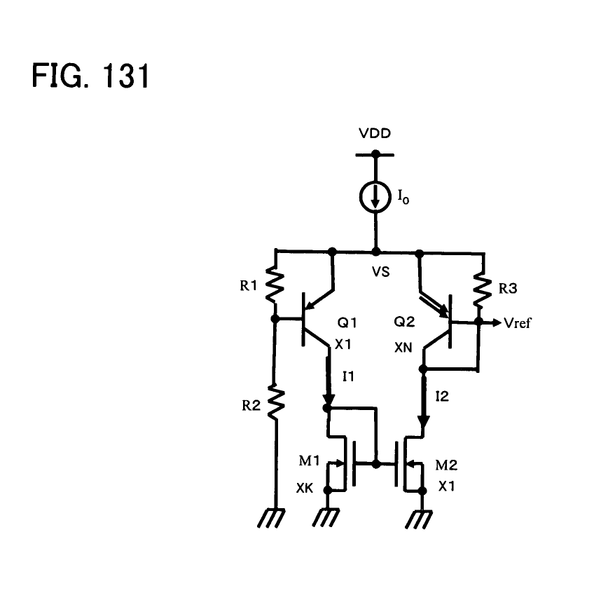

FIG. 131 is a diagram showing a conventional first generation reference voltage circuit added by a resistor R3 that compensates for temperature non-linearity of transistor VBE.

The bipolar transistors Q1 and Q2 are of an emitter area ratio of 1:N, where N>1. The emitters of the respective transistors are connected together and driven by a constant current source I0.

A resistor R1 is connected between the base and the emitter of the bipolar transistor Q1. The base of the transistor is grounded via the resistor R2.

The base and the collector of the bipolar transistor Q2 are connected together to form an output terminal that outputs the reference voltage Vref. A resistor R3 is connected between the base and the emitter of the bipolar transistor Q2.

The gate W/gate L (gate width/gate length) ratio of each of the transistors M1 and M2 is 1:K, where K>0. The transistor M1 has a gate and a drain connected together. The transistors M1 and M2 form a current mirror circuit by having the gates connected together, and respectively self-bias the bipolar transistors Q1 and Q2.

The current mirror circuit, formed by the transistors M1 and M2, sends the currents I1 and I2 to the bipolar transistors Q1 and Q2, to self-bias the transistors.

Since the gate W/L ratio of each of the transistors M1 and M2 is 1:K, where K>0, I2=KI1.

The drain currents I1 and I2 of the MOS transistors M1 and M2 are related with the collector currents IC1 and IC2 of the bipolar transistors Q1 and Q2, by

I₁=I_{C1} (180)

and by

I₂=I_{C2}+V_{BE2}/R₃ (18 1)

Therefore, since the emitter area ratio of the bipolar transistors Q1 and Q2, is 1:N, where N>0, the base-to-emitter voltages VBE1, VBE2 are respectively expressed by

$$\begin{matrix}{V}_{BE 1} = {V}_{T} ln ( \frac{{I}_{1}}{{I}_{s}} ) \\ and by & ( 182 ) \\ {V}_{BE 2} = {V}_{T} ln \{ \frac{{I}_{2}}{N ( {I}_{s} - \frac{{V}_{BE 2}}{{R}_{3}} )} \} . & ( 183 )\end{matrix}$$

Therefore, the difference Δ VBE between the base-to-emitter voltages VBE1 and VBE2 of the bipolar transistors Q1 and Q2 is expressed by

$$Δ {V}_{BE} = {V}_{BE 1} - {V}_{BE 2} = {V}_{T} ln ( \frac{KN}{1 - \frac{{V}_{BE 2}}{{I}_{2} {R}_{3}}} ) \qquad ( 184 )$$

Thus, if the emitter voltage is set to V_{S}, the reference voltage Vref obtained is expressed by

$$\begin{matrix}Vref = {V}_{S} - {V}_{BE 2} \\ = ( 1 + \frac{{R}_{2}}{{R}_{1}} ) {V}_{BE 1} - {V}_{BE 2} \\ = \frac{{R}_{2}}{{R}_{1}} {V}_{BE 1} + Δ {V}_{BE} \\ = \frac{{R}_{2}}{{R}_{1}} \{ {V}_{BE 1} + \frac{{R}_{1}}{{R}_{2}} Δ {V}_{BE} \} {R}_{3} \\ = \frac{{R}_{2}}{{R}_{1}} \{ {V}_{BE 1} + \frac{{R}_{1}}{{R}_{2}} {V}_{T} ln ( \frac{KN}{1 - \frac{{V}_{BE 2}}{{I}_{2} {R}_{3}}} ) \}\end{matrix} \qquad ( 185 )$$

In the present example, it is sufficient to set so that R2/R1<1 and to set the value of R1/R2 so that, as for the term within the braces { }, the temperature characteristic will be compensated by V_{BE1} having a negative temperature characteristic and by Δ V_{BE} having a positive temperature characteristic.

Also, as indicated by the equation (184), Δ VF does not possess a linear positive temperature characteristic. The denominator within { } of ln{ } is a function having a positive temperature characteristic, such that { } has a negative temperature characteristic. Further, due to logarithmic compression, Δ V_{BE} does not possess a linear positive temperature characteristic but its value is increased and decreased at lower temperature, and higher temperature, respectively.

Thus, in the equation (185), the term within the braces { } may be set so that the temperature non-linearity proper to V_{BE1} will be compensated by Δ V_{BE}.

Also, since the term of ln of the temperature characteristic of Δ V_{BE}, shown by the equation (184), is varied with the temperature, the temperature characteristic has a second-order coefficient and hence is a positive temperature characteristic having the PTAT line of FIG. 7 as an asymptotic line. However, the gradient of a positive temperature characteristic is moderate in the vicinity of the center temperature (27° C.). Thus, in order for a positive temperature characteristic to be canceled by V_{BE1} having the negative temperature characteristic of −1.9 mV/° C., the value of the coefficient R2/R1 must be correspondingly larger. Hence, the value of the reference voltage Vref obtained is appreciably larger than the value accepted so far (approximately 1.2V).

Worthy of note is the fact that, since R2>R1<<1 cannot be set in the equation (185), K (>1) is introduced so that the aim in view will be achieved for a value of N other than a larger value. The result is a reference voltage compensated for temperature non-linearity of transistor VBE to lead to an improved characteristic.

### EXAMPLE 20

Two other illustrative circuits that compensate for temperature non-linearity of diode VF are now described. These circuits are of the type of the conventional first generation reference voltage circuit having 1.2V as the output voltage.

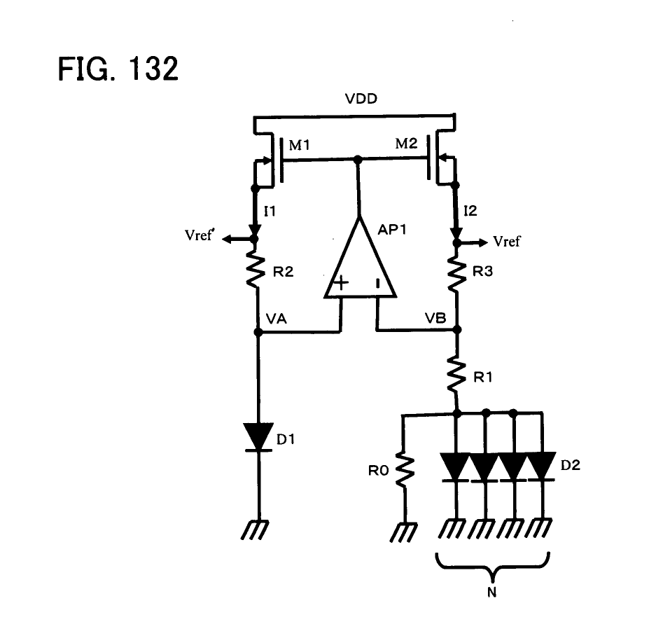

FIG. 132 is a diagram showing an example according to claim 24. Specifically, FIG. 132 shows a circuit configuration corresponding to the above conventional reference voltage circuit added by a resistor R0 that compensates for temperature non-linearity of diode VF.

In FIG. 132, the first current-to-voltage converter I-V1 is made up only of a diode. The second current-to-voltage converter I-V2 is made up of a parallel connection of a plurality of diodes and a resistor R0 and a resistor R1 connected in series with the parallel connection. The third current-to-voltage converter I-V3 is not provided. An inverting input terminal and a non-inverting input terminal of an OP amp are respectively connected to the terminal of the first current-to-voltage converter I-V1 and to the terminal of the second current-to-voltage converter I-V2. The resistors R2 and R3, respectively connected in series with the first current-to-voltage converter I-V1 and with the second current-to-voltage converter I-V2, are driven by the currents from the transistors M1 and M2 that form a current mirror circuit. The output terminal of the OP amp is connected to the common gates of the transistors M1 and M2 so that the non-inverting input terminal voltage and the inverting input terminal voltage of the OP amp will be equal to each other. It is noted that the transistors M1 and M2 that form the current mirror circuit are n-channel transistors, and respective source voltages of the transistors M1 and M2 are obtained as reference voltages Vref′ and Vref, respectively.

The circuit of FIG. 132 is equivalent to the circuit of FIG. 130 to which the transistors M1 and M2 forming the current mirror circuit are added with changes in the connection of the output terminal of the OP amp, with the circuit operation remaining the same. However, two reference voltages Vref′ and Vref of equal values are obtained due to addition of the transistors M1 and M2.

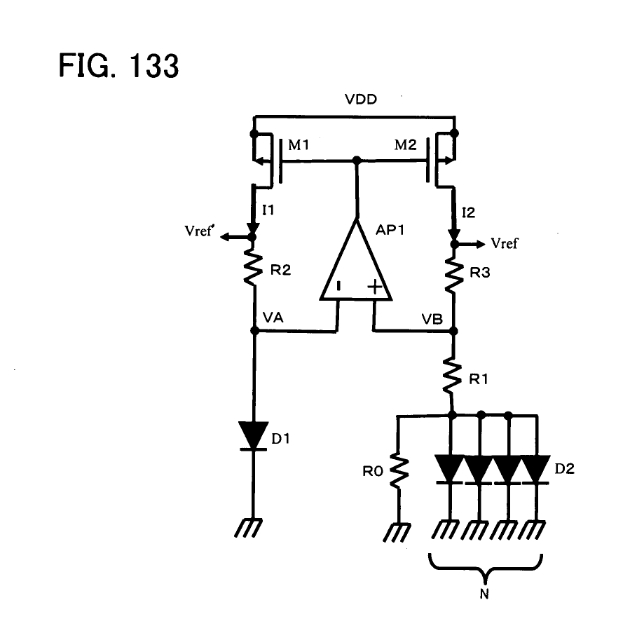

In similar manner, the same operation may be obtained by using p-channel transistors as the transistors M1 and M2 that form the current mirror circuit. It is however necessary to interchange the connections of the non-inverting and inverting input terminals of the OP amp. FIG. 133 is a diagram showing the circuit configuration for this case (circuit the configuration of a modification according to claim 24).

The circuit of FIG. 133 has a favorable effect that the power supply voltage may slightly be lowered by using p-channel transistors as the transistors M1 and M2 that form the current mirror circuit. In the reference voltage circuits, so far known, the transistors M1 and M2 that form the current mirror circuit are prevalently p-channel transistors, while n-channel transistors are used only on extremely rare occasions as the transistors M1 and M2 forming the current mirror circuit.

### EXAMPLE 21

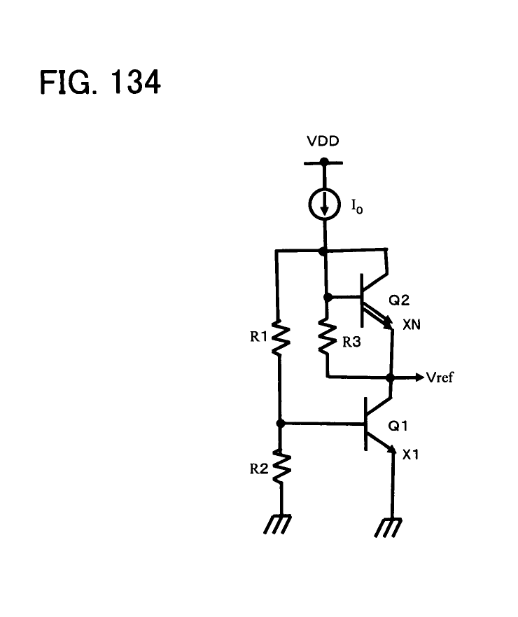

A further example of the first generation reference voltage circuit, having a voltage not higher than 0.25V as an output voltage, and which compensates for temperature non-linearity of diode VF, is now described. FIG. 134 is a diagram showing an example according to claim 25. Specifically, FIG. 134 shows a circuit the configuration of the above first generation reference voltage circuit added by a resistor R3 that compensates for temperature non-linearity of diode VF.

Referring to FIG. 134, the bipolar transistors Q1 and Q2 are of an emitter area ratio of 1:N, where N>1. The bipolar transistors Q1 and Q2 are connected to each other in cascode and driven by a constant current source I0. The base and the collector of the bipolar transistor Q1 are connected together, and its base and emitter are interconnected by a resistor R3. The base of the bipolar transistor Q1 and the base of the bipolar transistor Q2 are connected together via a resistor R1. The base of the bipolar transistor Q1 is grounded via a resistor R2. The emitter voltage of the bipolar transistor Q2 is obtained as the reference voltage Vref.

In FIG. 134, the reference voltage Vref is expressed as

$$Vref = \frac{{R}_{2}}{{R}_{1} + {R}_{2}} {V}_{BE 1} - {V}_{BE 2} = \frac{{R}_{1}}{{R}_{1} + {R}_{2}} {V}_{BE 1} + Δ {V}_{BE} \qquad ( 186 )$$

In the above equation, Δ V_{BE} is expressed by

$$Δ {V}_{BE} = {V}_{BE 1} - {V}_{BE 2} = {V}_{T} ln ( \frac{N}{1 - \frac{{V}_{BE 2}}{{I}_{1} {R}_{3}}} ) \qquad ( 187 )$$

where I1 is the current flowing through the bipolar transistor Q1 and which is delivered via the bipolar transistor Q2 and the resistor R3.

In the equation (186),

$$\frac{{R}_{1}}{{R}_{1} + {R}_{2}} {V}_{BE 1}$$

obtained on division from VBE1 having the negative temperature characteristic also has a negative temperature characteristic. Thus, the temperature characteristic of Vref may be compensated by setting

$$\frac{{R}_{1}}{{R}_{1} + {R}_{2}}$$

so that the temperature characteristic will be compensated with the divided voltage having a negative temperature characteristic and with Δ VBE having a positive temperature characteristic.

Since the term within round brackets ( ) of ln( ) of the equation (187) is usually set to not greater than 150, the reference voltage obtained is not greater than 0.25V. In general, it is set to 0.2V or thereabouts. Further, to cancel temperature non-linearity of VBE2, it is sufficient to set the value of I1·R3 in the equation (187) so that V_{T} characteristic shown in FIG. 7 will be achieved.

### EXAMPLE 22

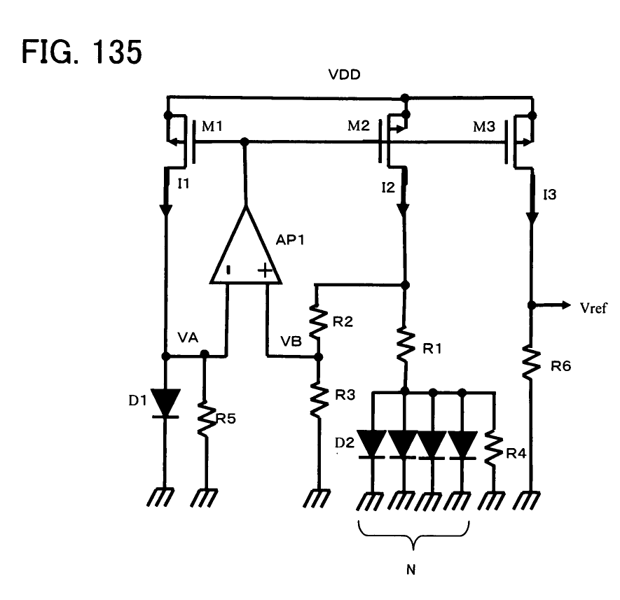

FIG. 135 is a diagram showing the circuit configuration of a reference voltage circuit according to claim 26. The circuit of the present example is equivalent to a circuit of FIG. 36 in which a resistor R5 is connected in parallel with the diode D1 of the first current-to-voltage converter. However, the number of diodes of the first current-to-voltage converter I-V1 differs from that of the second current-to-voltage converter I-V2. In the first current-to-voltage converter I-V1 and the second current-to-voltage converter I-V2, compared to each other, the ratio of the numbers of the parallel-connected diodes or bipolar transistors connected as diodes is set to 1:N. Specifically, the first current-to-voltage converter I-V1 includes a dole diode D1, while the second current-to-voltage converter I-V2 includes two to six (N-number) diodes D2 connected in parallel with one another.

If, in FIG. 135, the forward voltages of the diodes (or bipolar transistors connected as diodes) are labeled VF1, VF2, the Op amp exercises control so that two input terminal voltages will be equal to each other (VA=VB). If the output currents I1 to I3 from the current mirror circuits M1 to M3 are equal to one another.

I1=I2=I3 (188)

On the other hand, the current I1 is divided into a current I1A that flows through the diode D1 and into a current I1B that flows through a resistor R5 connected in parallel with the diode D1. Similarly, the current I2 is divided into a current I2A that flows through the parallel connection of the N-number of diodes D2, a current I2B that flows through the resistor R4 connected in parallel with the N-number of diodes D2, and a current I2C that flows through the resistors (R2+R3).

Hence,

I1=I1A+I1B (189)

and

I2=I2A+I2B+I2C (190)

where (191)

I2B=VF2/R4 (192)

I2C=VF1/R3 (193)

If we put

Δ VF=VF1−VF2 (194)

then

$${I}_{2} = \frac{( \frac{{R}_{2} + {R}_{3}}{{R}_{3}} ) {V}_{F 1} - {V}_{F 2}}{{R}_{1}} + \frac{{V}_{F 1}}{{R}_{3}} = \frac{{R}_{1} + {R}_{2}}{{R}_{1} {R}_{3}} {V}_{F 1} + \frac{Δ {V}_{F 1}}{{R}_{1}} \qquad ( 195 )$$

The reference voltage Vref obtained may thus be expressed as

$$Vref = {R}_{6} {I}_{3} = \frac{{R}_{6} ( {R}_{1} + {R}_{2} )}{{R}_{1} {R}_{3}} \{ {V}_{F 1} + \frac{{R}_{3}}{{R}_{1} + {R}_{2}} Δ {V}_{F 1} \} \qquad ( 196 )$$

It is sufficient that, in the equation (196), R6(R1+R2)/(R1R3)<1 is set, and that, as for the term within the braces { }, the value of R3/(R1+R2) is set so that the temperature characteristic will be compensated by VF1 having a negative temperature characteristic and Δ VF having a positive temperature characteristic.

Since

$$\begin{matrix}Δ {V}_{F} = {V}_{T} ln \{ \frac{{NI}_{1 A}}{{I}_{2 A}} \} \\ = {V}_{T} ln \{ \frac{N ( {I}_{1} - \frac{{V}_{F 1}}{{R}_{5}} )}{{I}_{2} - \frac{{V}_{F 1}}{{R}_{3}} - \frac{{V}_{F 2}}{{R}_{4}}} ) \} \\ = {V}_{T} ln \{ \frac{N ( 1 - \frac{{V}_{F 1}}{{I}_{1} {R}_{5}} )}{1 - \frac{{V}_{F 1}}{{I}_{1} {R}_{3}} - \frac{{V}_{F 2}}{{I}_{1} {R}_{4}}} ) \}\end{matrix} \qquad ( 197 )$$

Δ VF does not have liner a positive temperature characteristic. Both the numerator and the denominator of the term within braces { } of ln{ } are the functions having a positive temperature characteristic and VF1 and VF2 are set to approximately constant values. The values of I1R3, I1R4 and I1R5 may be set by properly setting the values of R3 to R5 (resistors). By so doing, the variable within the braces { } of ln{ } may be set so as to have a negative temperature characteristic. Due to logarithmic compression, Δ VF and does not possess a liner positive temperature characteristic, but is larger and smaller at lower temperature and higher temperature, respectively.

Thus, in the equation (196), the term within the braces { } may be set so that the temperature non-linearity proper to diode VF will be compensated by Δ VF.

### EXAMPLE 23

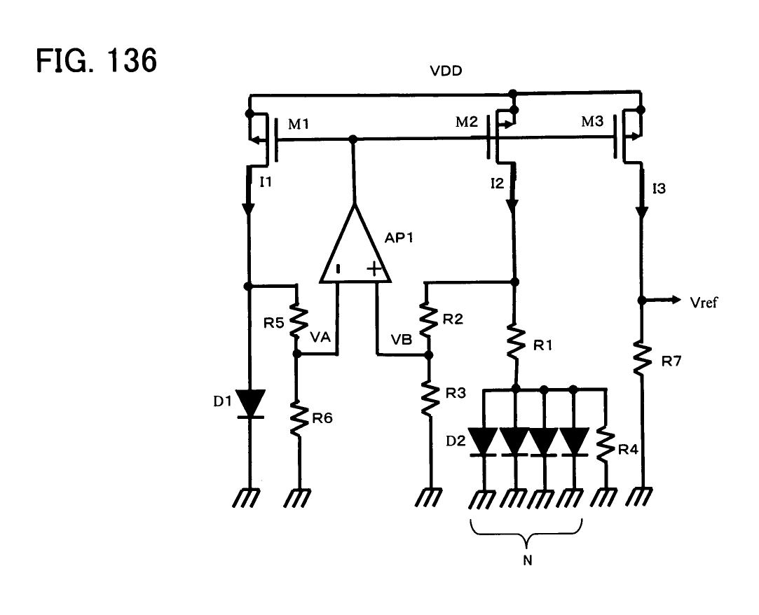

FIG. 136 is a diagram showing the circuit configuration of an example of a reference voltage circuit according to claim 27. The present example is equivalent to the circuit of Example 22 shown in FIG. 135 in which a first intermediate voltage is tapped at a connection node of resistors (series resistors (R5+R6)) connected in parallel with the diode D1, and in which a second intermediate voltage is tapped at a connection node of resistors (series resistors (R2+R3)) connected in parallel with the series connection of the parallel connection of the diodes D2 and the resistor R4 and the resistor R1. The first and second intermediate voltages are respectively supplied to the inverting input terminal (−) and to the non-inverting input terminal (+) to render it possible to set the input terminal voltage of the Op amp to a lower value.

In the present example, the first intermediate voltage VA tapped at the series resistors (R5+R6) is controlled by the OP amp (AP1) to be equal to the second intermediate voltage tapped at the series resistors (R2+R3), whereby the operation like that of FIG. 135 may be achieved.

According to the present invention, described above in connection with the respective examples, the characteristic and the performance may be improved (an output voltage not smaller than and smaller than 1V may be achieved). In addition, the operation may be improved in accuracy, while the voltage may be lowered (the operation from a voltage of the order of 1.2V is possible by setting the output voltage to less than 1V).

In the examples shown e.g., in FIG. 21, the current mirror circuit (M1, M2 and M3) is formed by p-channel MOS transistors. However, it is of course possible to construct the current mirror circuit (M1, M2 and M3) by source common n-channel MOS transistor and to connect one ends of the first to third current-to-voltage converters (I-V1 to I-V3) to the power supply VDD. It is also possible to construct the current mirror circuit (M1, M2, M3 and M4) in FIG. 39 by source common n-channel MOS transistors, to form the bipolar transistors Q1 and Q2, of the non-linear current mirror circuit and the bipolar transistor Q3 as pnp transistors having emitters connected to the power supply either directly or via resistors, or to connect one end of the resistor RL to the power supply.

Among practical uses of the present invention are a wide variety of reference voltage generating circuits integrated on LSIs. In keeping up with ultra-miniaturization of up-to-date integrated circuit processes, the supply power voltage to LSIs is decreasing, and a demand is raised for a reference voltage generating circuit which may be in operation at a power supply voltage of 1V or so with only little temperature variations. The present invention is up to this demand.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A reference voltage circuit comprising:
first, second and third current-to-voltage converters, a preset voltage of the third current-to-voltage converter being output as a reference voltage;
a current mirror circuit that supplies currents to the first, second and third current-to-voltage converters; and
a control circuit that performs control so that a preset output voltage of the first current-to-voltage converter will be equal to a preset output voltage of the second current-to-voltage converter;
wherein the first current-to-voltage converter includes a diode and a resistor connected in parallel with the diode;
the second current-to-voltage converter includes a plurality of diodes connected in parallel with one another, a first resistor connected in parallel with the diodes, a second resistor connected in series with the parallel circuit composed of the diodes and the first resistor, and a third resistor connected in parallel with a series circuit of the parallel circuit and the second resistor; and
the third current-to-voltage converter includes a resistor.

2. A reference voltage circuit comprising:
first, second and third current-to-voltage converters, a preset voltage of the third current-to-voltage converter being output as a reference voltage;
a current mirror circuit that supplies currents to the first, second and third current-to-voltage converters; and
a control circuit that performs control so that a preset intermediate terminal voltage of the first current-to-voltage converter will be equal to a preset intermediate terminal voltage of the second current-to-voltage converter;
wherein the first current-to-voltage converter includes a diode, a first resistor connected in parallel with the diode, a second resistor connected in series with the parallel circuit of the diode and the first resistor, and a third resistor connected in parallel with the series circuit of the parallel circuit and the second resistor, the intermediate terminal voltage of the first current-to-voltage converter being output at the parallel-connected third resistor;
the second current-to-voltage converter includes a plurality of parallel-connected diodes, a fourth resistor connected in parallel with the diodes, a fifth resistor connected in series with the parallel circuit of the diodes and the fourth resistor, and a sixth resistor connected in parallel with the series circuit of the parallel circuit and the fifth resistor, the intermediate terminal voltage of the second current-to-voltage converter being output at the parallel-connected sixth resistor; and
the third current-to-voltage converter including a resistor.

3. A reference voltage circuit comprising:
first, second and third current-to-voltage converters, a preset voltage of the third current-to-voltage converter being output as a reference voltage;
a current mirror circuit that supplies currents to the first, second and third current-to-voltage converters; and
a control circuit that performs control so that a preset output voltage of the first current-to-voltage converter will be equal to a preset output voltage of the second current-to-voltage converter;
wherein the first current-to-voltage converter includes a diode;
the second current-to-voltage converter includes a plurality of parallel-connected diodes, a first resistor connected in parallel with the diodes, a second resistor connected in series with the parallel circuit of the diodes and the first resistor, and a third resistor connected in parallel with the series circuit of the parallel circuit and the second resistor; and
the third current-to-voltage converter includes a resistor.

4. A reference voltage circuit comprising:
first, second and third current-to-voltage converters, a preset voltage of the third current-to-voltage converter being output as a reference voltage;
a current mirror circuit that supplies currents to the first, second and third current-to-voltage converters; and
a control circuit that performs control so that a preset intermediate terminal voltage of the first current-to-voltage converter will be equal to a preset intermediate terminal voltage of the second current-to-voltage converter;
wherein the first current-to-voltage converter includes a diode;
the second current-to-voltage converter includes a plurality of parallel-connected diodes, a first resistor connected in parallel with the diodes, a second resistor connected in series with the parallel circuit of the diodes and the first resistor, and a third resistor connected in parallel with the series circuit of the parallel circuit and the second resistor, the intermediate terminal voltage of the second current-to-voltage converter being output at the parallel connected resistor; and
the third current-to-voltage converter includes a resistor.

5. The reference voltage circuit according to claim 1, wherein the control circuit includes an operational amplifier having an inverting input terminal and a non-inverting input terminal respectively supplied with a voltage from the first current-to-voltage converter and a voltage from the second current-to-voltage converter, and having an output terminal connected to coupled gates of the current mirror circuit.

6. The reference voltage circuit according to claim 1, wherein the control circuit includes another current mirror circuit arranged between the current mirror circuit and the current-to-voltage converter.

7. The reference voltage circuit according to claim 1, wherein the diode is composed of a diode connected bipolar junction transistor.

8. A reference voltage circuit comprising:
a non-linear current mirror circuit that includes first and second bipolar transistors;
a third bipolar transistor connected to an output of the non-linear current mirror circuit;
an output resistor, a preset terminal voltage of the output resistor being output as a reference voltage;
a linear current mirror circuit that supplies currents to the non-linear current mirror circuit, the third bipolar transistor and the output resistor; and
an operational amplifier that controls an input terminal voltage and an output terminal voltage of the non-linear current mirror circuit to be equal to each other.

9. A reference voltage circuit comprising:
a non-linear current mirror circuit that includes first and second bipolar transistors;
an output resistor, a preset terminal voltage of the output resistor being output as a reference voltage;
a linear current mirror circuit that supplies currents to the non-linear current mirror circuit and the output resistor; and
an operational amplifier that controls an input terminal voltage and an output terminal voltage of the non-linear current mirror circuit to be equal to each other.

10. A reference voltage circuit comprising:
a non-linear current mirror circuit that includes first and second bipolar transistors;
a third bipolar transistor connected to an output of the non-linear current mirror circuit;
an output resistor, a preset terminal voltage of the output resistor being output as a reference voltage; and
a linear current mirror circuit that supplies currents to the non-linear current mirror circuit and the output resistor, the linear current mirror circuit being driven by an output of the third bipolar transistor.

11. A reference voltage circuit comprising:
a non-linear current mirror circuit that includes first and second bipolar transistors;
an output resistor, a preset terminal voltage of the output resistor being output as a reference voltage; and
a linear current mirror circuit that supplies currents to the non-linear current mirror circuit and the output resistor, the linear current mirror circuit being self-biased by being driven by an output current of the non-linear current mirror circuit.

12. A reference voltage circuit comprising:
a non-linear current mirror circuit that includes first and second bipolar transistors;
an output resistor, a preset terminal voltage of the output resistor being output a reference voltage; and
a linear current mirror circuit that supplies a current to the non-linear current mirror circuit, the linear current mirror circuit being self-biased by being driven by an output current of the non-linear current mirror circuit, and the linear current mirror circuit being grounded via the output resistor.

13. A reference voltage circuit comprising:
first, second and third current-to-voltage converters;
a current mirror circuit that supplies currents to the first and second current-to-voltage converters; and
a control circuit that performs control so that a preset output voltage of the first current-to-voltage converter will be equal to a preset output voltage of the second current-to-voltage converter;
wherein a terminal voltage of the third current-to-voltage converter, connected in series with the first and second current-to-voltage converters and grounded, is output as a reference voltage;
the first current-to-voltage converter includes a diode or a combination of a diode and a resistor;
the second current-to-voltage converter includes a combination of a parallel connection of a plurality of diodes and a resistor; and
the third current-to-voltage converter includes a resistor.

14. A reference voltage circuit comprising:
first, second and third current-to-voltage converters;
a first current mirror circuit that supplies currents to the first and second current-to-voltage converters; and
a second current mirror circuit that self-biases the first current mirror circuit;
wherein a terminal voltage of the third current-to-voltage converter, connected in series with the first and second current-to-voltage converters and grounded, is output as a reference voltage;
the first current-to-voltage converter includes a diode or a combination of a diode and a resistor;
the second current-to-voltage converter includes a combination of a parallel connection of a plurality of diodes and a resistor; and
the third current-to-voltage converter includes a resistor.

15. A reference voltage circuit comprising:
first to fifth current-to-voltage converters;
first and second transistors that respectively supplies currents to the first and second current-to-voltage converters, the first and second transistors having gates connected together to form a first current mirror circuit;
a second current mirror circuit that supplies a current flowing through the first transistor to the third transistor; and
a third current mirror circuit that supplies a current flowing through the second transistor to a fourth transistor;
wherein the third and fourth transistor respectively supply currents to the fourth and fifth current-to-voltage converters;
the third and fourth transistors have gates coupled together to form a fourth current mirror circuit;
the third transistor has a drain connected to the coupled gates of the first and second transistors,
a terminal voltage of the third current-to-voltage converter, connected in series with the first, second, fourth and fifth current-to-voltage converters and grounded, being output as a reference voltage;
the first current-to-voltage converter includes a diode or a combination of a diode and a resistor,
the second current-to-voltage converter includes a combination of a parallel connection of a plurality of diodes and a resistor, and
the third current-to-voltage converter includes a resistor;
the fourth and fifth current-to-voltage converters being of the same configuration as the first current-to-voltage converter.

16. A reference voltage circuit comprising:
first to fourth current-to-voltage converters;
first to third transistors, respectively supplying currents to the first to third current-to-voltage converters, the first to third transistors having gates connected together to form a first current mirror circuit;
a second current mirror circuit that self-biases the first and second transistors; and
a fourth transistor controlled by an output signal of the second current mirror circuit and connected in cascode to the third transistor;
wherein the second current mirror circuit includes a non-linear current mirror circuit (reverse Widlar current mirror circuit);
a terminal voltage of the third current-to-voltage converter, connected in series with the first, second and fourth current-to-voltage converters and grounded, is output as a reference voltage;
the first current-to-voltage converter includes a diode or a combination of a diode and/or a resistor;
the second current-to-voltage converter includes a combination of a plurality of parallel-connected diodes and a resistor;
the third current-to-voltage converter includes a resistor;
the fourth current-to-voltage converter is of the same configuration as the first current-to-voltage converter.

17. A reference voltage circuit comprising:
a non-linear current mirror circuit that includes first and second bipolar transistors;
a third bipolar transistor connected to an output of the non-linear current mirror circuit;
an operational amplifier having an inverting input terminal and a non-inverting input terminal, respectively connected to an input terminal and an output terminal of the non-linear current mirror circuit;
an output resistor, a preset terminal voltage of the output resistor being output as a reference voltage; and
a linear current mirror circuit that supplies the current to the non-linear current mirror circuit;
wherein the linear current mirror circuit is self-biased by being driven by an output current of the non-linear current mirror circuit;
the operational amplifier controls the linear current mirror circuit by an output thereof and operating so that an input terminal voltage and an output terminal voltage of the non-linear current mirror circuit will be equal to each other;
the current flowing through the non-linear current mirror circuit and the current flowing through the third bipolar transistor flowing through the output resistor.

18. A reference voltage circuit comprising:
a non-linear current mirror circuit that includes first and second bipolar transistors;
a third bipolar transistor connected to an output of the non-linear current mirror circuit;
an output resistor, a preset terminal voltage of the output resistor being output as a reference voltage; and
a linear current mirror circuit that supplies to the non-linear current mirror circuit a current proportionate or equal to the current flowing through the third bipolar transistor, the linear current mirror circuit being self-biased by being driven by an output current of the non-linear current mirror circuit;
the current flowing through the non-linear current mirror circuit and the current flowing through the third bipolar transistor flowing through the output resistor.

19. A reference voltage circuit comprising:
first and second bipolar transistors having an emitter area ratio of 1:N, where N>0, have bases connected together to form an output terminal,
the second bipolar transistor having a base and a collector connected together;
a first resistor connected between the base and an emitter of the second bipolar transistor; and
a second resistor connected between an emitter of the first bipolar transistor and the emitter of the second bipolar transistor;
wherein the first bipolar transistor has the emitter grounded via a third resistor; and
the first and second bipolar transistors are self-biased by a current mirror circuit.

20. A reference voltage circuit comprising:
a first diode;
second diodes made up of a plurality of parallel-connected diodes;
a first resistor connected in parallel with the second diodes;
a second resistor connected in series with the second diodes and the first resistor;
an output circuit made up of a series connection of a third resistor and a third diode, a preset terminal voltage of the output circuit being output as a reference voltage;
a linear current mirror circuit that supplies currents to the first diode, the second diodes, the first and second resistors and the output circuit; and
an operational amplifier, as control means, exercising control so that the terminal voltage of the first diode and the terminal voltage of the second diodes and the first and second resistors will be equal to each other.

21. A reference voltage circuit comprising:
a first diode;
second diodes made up of a plurality of parallel-connected diodes;
a first resistor connected in parallel with the second diodes;
a second resistor connected in series with the second diodes and the first resistor;
an output circuit made up of a series connection of a third resistor and a third diode and a fourth resistor connected in parallel with the series connection, a preset terminal voltage of the output circuit being output as a reference voltage;
a linear current mirror circuit that supplies currents to the first diode, the second diodes, the first and second resistors and the output circuit; and
an operational amplifier, as control means, exercising control so that a terminal voltage of the first diode and a terminal voltage of the second diodes and the first and second resistors will be equal to each other.

22. A reference voltage circuit comprising:
a first diode;
second diodes made up of a plurality of parallel-connected diodes;
a first resistor connected in parallel with the second diodes;
a second resistor connected in series with the second diodes and the first resistor;
a third resistor connected in series with the first diode;
a fourth resistor connected in series with the second diodes and the first and second resistors; and
an operational amplifier, as control means, having an output connected to the third and fourth resistors, the operational amplifier exercising control so that a terminal voltage of the first diode will be equal to a terminal voltage of the second diodes and the first and second resistors, an output voltage of the operational amplifier being output as a reference voltage.

23. A reference voltage circuit comprising:
first and second bipolar transistors having an emitter area ratio of 1:N, where N>0;
first and second resistors connected between an emitter of the first bipolar transistor and the ground
a third resistor connected between a base and an emitter of the second bipolar transistor; and
a current mirror circuit;
wherein the first and second bipolar transistor have emitters connected together and are driven by a constant current source;
a voltage across the emitter of the first bipolar transistor and the ground, divided by the first and second resistors, is applied to the base of the first bipolar transistor;
the second bipolar transistor has a base and a collector thereof connected together to form an output terminal; and
the first and second bipolar transistors are self-biased by the current mirror circuit.

24. A reference voltage circuit comprising:
a first diode;
a diode set made up of a plurality of parallel-connected second diodes;
a first resistor connected in parallel with the diode set;
a second resistor connected in series with a parallel connection of the diode set and the first resistor;
a third resistor connected in series with the first diode;
a fourth resistor connected in series with the serial connection of the second resistor and the parallel connection of the diode set and the first resistor;
a current mirror circuit that supplies the current to the third and fourth resistors; and
an operational amplifier, as control means, having an output connected to commonly coupled bases of two transistors that forms a current mirror circuit,
the operational amplifier exercising control so that the terminal voltage of the first diode will be equal to the voltage at a connection node of the second and third resistors; and
a terminal voltage at the third resistor and/or a terminal voltage of the fourth resistor is a reference voltage.

25. A reference voltage circuit comprising:
a first bipolar transistor, formed as a unit transistor, and having an emitter grounded; and
a second bipolar transistor, having an emitter area N times that of the unit transistor, are connected in cascode;
the second bipolar transistor has a base and a collector connected in common and connected to a constant current source;
the first bipolar transistor has a base connected to a connection terminal of first and second resistors connected in series between the constant current source and the ground;
an emitter of the second bipolar transistor operates as an output terminal for a reference voltage; and
a third resistor is connected between the base and the emitter of the second bipolar transistor.

26. A reference voltage circuit comprising:
first, second and third current-to-voltage converters;
a current mirror circuit that supplies currents to the first, second and third current-to-voltage converters; and
a circuit that exercises control so that a preset output voltage of the first current-to-voltage converter will be equal to a preset intermediate terminal voltage of the second current-to-voltage converter;
wherein a preset voltage of the third current-to-voltage converter is output as a reference voltage;
the first current-to-voltage converter includes:
a first diode; and
a resistor connected in parallel with the first diode;
the second current-to-voltage converter includes:
a diode set made up of a plurality of parallel-connected diodes;
a second resistor connected in parallel with the diode set;
a third resistor connected in series with a parallel connection of the diode set and the second resistor; and
a fourth resistor connected in parallel with the series connection of the parallel connection and the third resistor; and
the preset intermediate terminal voltage of the second current-to-voltage converter is output from the parallel-connected resistor; and
the third current-to-voltage converter including a resistor.

27. A reference voltage circuit comprising:
first, second and third current-to-voltage converters;
a current mirror circuit that supplies currents to the first, second and third current-to-voltage converters; and
a circuit that exercises control so that a preset intermediate terminal voltage of the first current-to-voltage converter will be equal to a preset intermediate terminal voltage of the second current-to-voltage converter,
a preset voltage of the third current-to-voltage converter being output as a reference voltage; wherein
the first current-to-voltage converter includes a first diode; and
a resistor connected in parallel with the first diode;
wherein the preset intermediate terminal voltage of the first current-to-voltage converter is output from the parallel-connected resistor;
the second current-to-voltage converter includes:
a diode set made up of a plurality of parallel-connected diodes;
a first resistor connected in parallel with the diode set;
a second resistor connected in series with a parallel connection of the diode set and the first resistor; and
a third resistor connected in parallel with the parallel connection and the first resistor;
the preset intermediate terminal voltage of the second current-to-voltage converter is output from the resistor connected in parallel; and
the third current-to-voltage converter including a resistor.
